(19) United States
(12) Patent Application Publication
(10) Pub. No.: US 2022/0030009 A1
(43) Pub. Date: Jan. 27, 2022

(54) COMPUTER SECURITY BASED ON ARTIFICIAL INTELLIGENCE

(71) Applicant: Syed Kamran HASAN, Great Falls, VA (US)

(72) Inventor: Syed Kamran HASAN, Great Falls, VA (US)

(73) Assignee: Syed Kamran HASAN, Great Falls, VA (US)

(21) Appl. No.: 17/327,674

(22) Filed: May 22, 2021

Related U.S. Application Data
(63) Continuation of application No. 15/413,666, filed on Jan. 24, 2017, now abandoned.
(60) Provisional application No. 62/286,437, filed on Jan. 24, 2016.
(60) Provisional application No. 62/294,258, filed on Feb. 11, 2016.
(60) Provisional application No. 62/307,558, filed on Mar. 13, 2016.
(60) Provisional application No. 62/323,657, filed on Apr. 16, 2016.
(60) Provisional application No. 62/326,723, filed on Apr. 23, 2016.
(60) Provisional application No. 62/341,310, filed on May 25, 2016.
(60) Provisional application No. 62/439,409, filed on Dec. 27, 2016.
(60) Provisional application No. 62/449,313, filed on Jan. 23, 2017.

(51) Int. Cl. H04L 29/06; G06N 20/00; G06N 3/00; G06N 5/02

(52) U.S. Cl. CPC H04L 63/1408; H04L 63/1416; H04L 63/1425; H04L 63/1433; H04L 63/0272; H04L 63/145; G06N 20/00; G06N 3/006; G06N 5/025; H04L 63/1491

(57) ABSTRACT

COMPUTER SECURITY SYSTEM BASED ON ARTIFICIAL INTELLIGENCE includes Critical Infrastructure Protection & Retribution (CIPR) through Cloud & Tiered Information Security (CTIS), Machine Clandestine Intelligence (MACINT) & Retribution through Covert Operations in Cyberspace, Logically Inferred Zero-database A-priori Realtime Defense (LIZARD), Critical Thinking Memory & Perception (CTMP), Lexical Objectivity Mining (LOM), Linear Atomic Quantum Information Transfer (LAQIT) and Universal BCHAIN Everything Connections (UBEC) system with Base Connection Harmonization Attaching Integrated Nodes.

### CROSS REFERENCE TO RELATED APPLICATIONS

The present application claims priority on U.S. Provisional Application No. 62/286,437 filed on 24 Jan. 2016, entitled Clandestine Machine Intelligence Retribution through Covert Operations in Cyberspace; U.S. Provisional Application No. 62/294,258 filed on 11 Feb. 2016, entitled Logically Inferred Zero-database A-priori Realtime Defense; U.S. Provisional Application No. 62/307,558 filed on 13 Mar. 2016, entitled Critical Infrastructure Protection & Retribution (CIPR) through Cloud & Tiered Information Security (CTIS); U.S. Provisional Application No. 62/323,657 filed on 16 Apr. 2016, entitled Critical Thinking Memory & Perception (CTMP); U.S. Provisional Application No. 62/326,723 filed on 23 Apr. 2016, entitled Linear Atomic Quantum Information Transfer (LAQIT); U.S. Provisional Application No. 62/341,310 filed on 25 May 2016, entitled Objective Debate Machine (ODM); and U.S. Provisional Application No. 62/439,409 filed on 27 Dec. 2016, entitled Lexical Objectivity Mining (LOM); U.S. patent application Ser. No. 15/145,800 filed on 4 May 2016, entitled METHOD AND DEVICE FOR MANAGING SECURITY IN A COMPUTER NETWORK; and U.S. patent application Ser. No. 15/264,744 filed on 14 Sep. 2016, entitled SYSTEM OF PERPETUAL GIVING; the disclosures of which are incorporated by reference as if they are set forth herein.

### FIELD OF THE INVENTION

The present invention is related to a system of computer security based on artificial intelligence. Sub-systems include Critical Infrastructure Protection & Retribution (CIPR) through Cloud & Tiered Information Security (CTIS), Machine Clandestine Intelligence (MACINT) & Retribution through Covert Operations in Cyberspace, Logically Inferred Zero-database A-priori Realtime Defense (LIZARD), Critical Thinking Memory & Perception (CTMP), Lexical Objectivity Mining (LOM), Linear Atomic Quantum Information Transfer (LAQIT) and Universal BCHAIN Everything Connections (UBEC) system with Base Connection Harmonization Attaching Integrated Nodes.

### BACKGROUND OF THE INVENTION

Computer network security related problems have often depended on human experts for complicated issues. Rapid expansion of computer and network capability have been exploited by malicious entities including hackers, which overwhelmed traditional solution that ultimately depended on human experts. Strategies powered by artificial intelligence are becoming solutions that overcome the limits of such situation. The new strategies require, however, advanced models that effectively mimic human thought processes and are adapted to be implemented by computer hardware.

### SUMMARY OF THE INVENTION

COMPUTER SECURITY SYSTEM BASED ON ARTIFICIAL INTELLIGENCE, wherein the system having a memory that stores programmed instructions, a processor that is coupled to the memory and executes the programmed instructions and at least one database, wherein the system comprising a computer implemented system of providing designated function.

The computer implemented system is Critical Infrastructure Protection & Retribution (CIPR) through Cloud & Tiered Information Security (CTIS), further comprising:

a) Trusted Platform, which comprises network of agents that report hacker activity;
b) Managed Network & Security Services Provider (MNSP), which provides Managed Encrypted Security, Connectivity & Compliance Solutions & Services;
wherein virtual private network (VPN) connects the MNSP and the Trusted Platform, wherein VPN provides a communication channel to and from the Trusted Platform, wherein the MNSP is adapted to analyze all traffic in the enterprise network, wherein the traffic is routed to the MSNP.

The MNSP comprises:

a) Logically Inferred Zero-database A-priori Realtime Defense (LIZARD), which derive purpose and functionality from foreign code, and hence block it upon presence of malicious intent or absence of legitimate cause, and analyzes threats in and of themselves without referencing prior historical data;
b) Artificial Security Threat (AST), which provides a hypothetical security scenario to test the efficacy of security rulesets;
c) Creativity Module, which performs process of intelligently creating new hybrid forms out of prior forms;
d) Conspiracy Detection, which discerns information collaboration and extracts patterns of security related behavior and provides a routine background check for multiple conspiratorial security events, and attempts to determine patterns and correlations between seemingly unrelated security events;
e) Security Behavior, which stores and indexes events and their security responses and traits, wherein the response comprises block/approval decisions;
f) Iterative Intelligence Growth/Intelligence Evolution (I²GE), which leverages big data and malware signature recognition, and emulates future potential variations of Malware by leveraging the AST with the Creativity Module; and
g) Critical Thinking, Memory, Perception (CTMP), which criticizes the block/approval decisions and acts as a supplemental layer of security, and leverages cross-references intelligence from I²GE, LIZARD, and Trusted Platform, wherein CTMP estimates its own capacity of forming an objective decision on a matter, and will refrain from asserting a decision made with internal low confidence.

A LIZARD Lite Client is adapted to operate in a device of the enterprise network, securely communicates with the LIZARD in the MNSP.

Demilitarized Zone (DMZ) comprises a subnetwork which contains an HTTP server which has a higher security liability than a normal computer so that the rest of the enterprise network is not exposed to such a security liability.

The I²GE comprises Iterative Evolution, in which parallel evolutionary pathways are matured and selected, iterative generations adapt to the same Artificial Security Threats (AST), and the pathway with the best personality traits ends up resisting the security threats the most.

The LIZARD comprises:

a) Syntax Module, which provides a framework for reading & writing computer code;
b) Purpose Module, which uses the Syntax Module to derive a purpose from code, and outputs the purpose in its complex purpose format;
c) Virtual Obfuscation, in which the enterprise network and database is cloned in a virtual environment, and sensitive data is replaced with mock (fake) data, wherein depending on the behavior of a target, the environment can by dynamically altered in real time to include more fake elements or more real elements of the system at large;
d) Signal Mimicry, which provides a form of Retribution when the analytical conclusion of Virtual Obfuscation has been reached;
e) Internal Consistency Check, which checks that all the internal functions of a foreign code make sense;
f) Foreign Code Rewrite, which uses the Syntax and Purpose modules to reduce foreign code to a Complex Purpose Format;
g) Covert Code Detection, which detects code covertly embedded in data & transmission packets;
h) Need Map Matching, which is a mapped hierarchy of need & purpose and is referenced to decide if foreign code fits in the overall objective of the system;
wherein for writing the Syntax Module receives a complex formatted purpose from the Purpose Module, then writes code in arbitrary code syntax, then a helper function translates that arbitrary code to real executable code; wherein for reading the Syntax Module provides syntactical interpretation of code for the Purpose Module to derive a purpose for the functionality of such code;
wherein the Signal Mimicry uses the Syntax Module to understand a malware's communicative syntax with its hackers, then hijacks such communication to give malware the false impression that it successfully sent sensitive data back to the hackers, wherein the hackers are also sent the malware's error code by LIZARD, making it look like it came from the malware;
wherein the Foreign Code Rewrite builds the codeset using the derived Purpose whereby ensuring that only the desired and understood purpose of the foreign code is executed within the enterprise, and any unintended function executions do not gain access to the system.

For the Foreign Code Rewrite to syntactically reproduce foreign code to mitigate potentially undetected malicious exploits, Combination Method compares and matches Declared Purpose with Derived Purpose, wherein the Purpose Module is used to manipulate Complex Purpose Format, wherein with the Derived Purpose, the Need Map Matching keeps a hierarchical structure to maintain jurisdiction of all enterprises needs whereby the purpose of a block of code can be defined and justified, depending on vacancies in the jurisdictionally orientated Need Map, wherein Input Purpose is the intake for Recursive Debugging process.

The Recursive Debugging loops through code segments to test for bugs and applies bug fixes, wherein if a bug persists, the entire code segment is replaced with the original foreign code segment, wherein the original code segment is subsequently tagged for facilitating Virtual Obfuscation and Behavioral Analysis, wherein with Foreign Code, the original state of the code is interpreted by the Purpose Module and the Syntax Module for a code rewrite, wherein the Foreign Code is directly referenced by the debugger in case an original foreign code segment needs to be installed because there was a permanent bug in the rewritten version, wherein at Rewritten Code, Segments are tested by Virtual Runtime Environment to check for Coding Bugs, wherein the Virtual Runtime Environment executes Code Segments, and checks for runtime errors, wherein with Coding Bug, errors produced in the Virtual Runtime Environment are defined in scope and type, wherein with Purpose Alignment, a potential solution for the Coding Bug is drafted by re-deriving code from the stated purpose, wherein the scope of the Coding Bug is rewritten in an alternate format to avoid such a bug, wherein the potential solution is outputted, and wherein if no solutions remain, the code rewrite for that Code Segment is forfeited and the original Code Segment directly from the Foreign Code is used in the final code set.

For operation of the Need Map Matching, LIZARD Cloud and LIZARD Lite reference a Hierarchical Map of enterprise jurisdiction branches, wherein whether the Input Purpose is claimed or derived via the Purpose Module, the Need Map Matching validates the justification for the code/function to perform within the Enterprise System, wherein a master copy of the Hierarchical Map is stored on LIZARD Cloud in the MNSP, wherein Need Index within the Need Map Matching is calculated by referencing the master copy, wherein then the pre-optimized Need Index is distributed among all accessible endpoint clients, wherein the Need Map Matching receives a Need Request for the most appropriate need of the system at large, wherein the corresponding output is a Complex Purpose Format that represents the appropriate need.

An entire LAN infrastructure for the enterprise is reconstructed virtually within the MNSP, wherein the hacker is then exposed to elements of both the real LAN infrastructure and the virtual clone version as the system performs behavioral analysis, wherein if the results of such analysis indicates risk, then the hacker's exposure to the virtual clone infrastructure is increased to mitigate the risk of real data and/or devices becoming compromised.

Malware Root Signature is provided to the AST so that iterations/variations of the Malware Root Signature is formed, wherein Polymorphic Variations of malware are provided as output from I²GE and transferred to Malware Detection.

The Malware Detection is deployed on all three levels of a computer's composition, which includes User Space, Kernel Space and Firmware/Hardware Space, wherein all the Spaces are monitored by Lizard Lite agents.

The computer implemented system is Machine Clandestine Intelligence (MACINT) & Retribution through Covert Operations in Cyberspace, further comprising:

a) Intelligent Information and Configuration Management (I²CM), which provides intelligent information management, viewing and control; and
b) Management Console (MC), which provides input/output channel to users:

wherein the I²CM comprises:

i) Aggregation, which uses generic level criteria to filter out unimportant and redundant information, and merges and tags streams of information from multiple platforms;
ii) Configuration and Deployment Service, which comprises an interface for deploying new enterprise network devices with predetermined security configuration and connectivity setup and for managing deployment of new user accounts;
iii) Separation by Jurisdiction, in which tagged pool of information are separated exclusively according to the relevant jurisdiction of a Management Console User;
iv) Separation by Threat, which organizes the information according to individual threats; and
v) Automated Controls, which accesses MNSP Cloud, Trusted Platform, or additional Third Party Services.

In the MNSP Cloud, Behavioral Analysis observes a malware's state of being and actions performed whilst it is in Mock Data Environment; wherein when the Malware attempts to send Fake Data to Hacker, the outgoing signal is rerouted so that it is received by Fake Hacker; wherein Hacker Interface receives the code structure of the Malware and reverse engineers the Malware's internal structure to output Hacker Interface; wherein Fake Hacker and Fake Malware are emulated within a Virtualized Environment; wherein the virtualized Fake Hacker sends a response signal to the real Malware to observe the malware's next behavior pattern, wherein the hacker is given a fake response code that is not correlated with the behavior/state of the real malware.

Exploit Scan identifies capabilities and characteristics of criminal assets and the resulting scan results are managed by Exploit, which is a program sent by the Trusted Platform via the Retribution Exploits Database that infiltrates target Criminal System, wherein the Retribution Exploits Database contains a means of exploiting criminal activities that are provided by Hardware Vendors in the forms of established backdoors and known vulnerabilities, wherein Unified Forensic Evidence Database contains compiled forensic evidence from multiple sources that spans multiple enterprises.

When a sleeper agent from a criminal system captures a file of an enterprise network, a firewall generates log, which is forwarded to Log Aggregation, wherein Log Aggregation separates the data categorically for a Long-Term/Deep Scan and a Real-Time/Surface Scan.

The Deep Scan contributes to and engages with Big Data whilst leveraging Conspiracy Detection sub-algorithm and Foreign Entities Management sub-algorithm; wherein standard logs from security checkpoints are aggregated and selected with low restriction filters at Log Aggregation; wherein Event Index+Tracking stores event details; wherein Anomaly Detection uses Event Index and Security Behavior in accordance with the intermediate data provided by the Deep Scan module to determine any potential risk events; wherein Foreign Entities Management and Conspiracy Detection are involved in analysis of events.

The Trusted Platform looks up an Arbitrary Computer to check if it or its server relatives/neighbors (other servers it connects to) are previously established double or triple agents for the Trusted Platform; wherein the agent lookup check is performed at Trusted Double Agent Index+Tracking Cloud and Trusted Triple Agent Index+Tracking Cloud; wherein a double agent, which is trusted by the arbitrary computer, pushes an Exploit through its trusted channel, wherein the Exploit attempts to find the Sensitive File, quarantines it, sends its exact state back to the Trusted Platform, and then attempts to secure erase it from the Criminal Computer.

ISP API request is made via the Trusted Platform and at Network Oversight network logs for the Arbitrary System and a potential file transfer to Criminal Computer are found, wherein metadata is used to decide with significant confidence which computer the file was sent to, wherein the Network Oversight discovers the network details of Criminal Computer and reroutes such information to the Trusted Platform, wherein the Trusted Platform is used to engage security APIs provided by Software and Hardware vendors to exploit any established backdoors that can aide the judicial investigation.

The Trusted Platform pushes a software or firmware Update to the Criminal Computer to establish a new backdoor, wherein a Placebo Update is pushed to nearby similar machines to maintain stealth, wherein Target Identity Details are sent to the Trusted Platform, wherein the Trusted Platform communicates with a Software/Firmware Maintainer to push Placebo Updates and Backdoor Updates to the relevant computers, wherein the Backdoor Update introduces a new backdoor into the Criminal Computer's system by the using the pre-established software update system installed on the Computer, wherein the Placebo Update omits the backdoor, wherein the Maintainer transfers the Backdoor to the target, as well as to computers which have an above average amount of exposure to the target, wherein upon implementation of the Exploit via the Backdoor Update the Sensitive File is quarantined and copied so that its metadata usage history can be later analyzed, wherein any supplemental forensic data is gathered and sent to the exploit's point of contact at the Trusted Platform.

A long-term priority flag is pushed onto the Trusted Platform to monitor the Criminal System for any and all changes/updates, wherein the Enterprise System submits a Target to Warrant Module, which scans all Affiliate Systems Input for any associations of the defined Target, wherein if there are any matches, the information is passed onto the Enterprise System, which defined the warrant and seeks to infiltrate the Target, wherein the Input is transferred to Desired Analytical Module, which synchronizes mutually beneficial security information.

The computer implemented system is Logically Inferred Zero-database A-priori Realtime Defense (LIZARD), further comprising:

a) Static Core (SC), which comprises predominantly fixed program modules;
b) Iteration Module, which modifies, creates and destroys modules on Dynamic Shell, wherein the Iteration Module uses AST for a reference of security performance and uses Iteration Core to process the automatic code writing methodology;
c) Differential Modifier Algorithm, which modifies the Base Iteration according to the flaws the AST found, wherein after the differential logic is applied, a new iteration is proposed, upon which the Iteration Core is recursively called and undergoes the same process of being tested by AST;
d) Logic Deduction Algorithm, which receives known security responses of the Dynamic Shell Iteration from the AST, wherein LDA deduces what codeset makeup will achieve the known Correct Response to a security scenario;
e) Dynamic Shell (DS), which contains predominantly dynamic program modules that have been automatically programmed by the Iteration Module (IM);
f) Code Quarantine, which isolates foreign code into a restricted virtual environment;
g) Covert Code Detection, which detects code covertly embedded in data and transmission packets; and
h) Foreign Code Rewrite, which after deriving foreign code purpose, rewrites either parts or the whole code itself and allows only the rewrite to be executed;
wherein all enterprise devices routed through LIZARD, wherein all software and firmware that runs enterprise devices are hardcoded to perform any sort of download/upload via LIZARD as a permanent proxy, wherein LIZARD interacts with three types of data comprising data in motion, data in use, and data at rest, wherein LIZARD interacts with data mediums comprising Files, Email, Web, Mobile, Cloud and Removable Media.

The system further comprises:

a) AST Overflow Relay, wherein data is relayed to the AST for future iteration improvement when the system can only perform a low confidence decision;
b) Internal Consistency Check, which checks if all the internal functions of a block of foreign code make sense;
c) Mirror test, which checks to make sure the input/output dynamic of the rewrite is the same as the original, whereby any hidden exploits in the original code are made redundant and are never executed;
d) Need Map Matching, which comprises a mapped hierarchy of need and purpose that are referenced to decide if foreign code fits in the overall objective of the system;
e) Real Data Synchronizer, which selects data to be given to mixed environments and in what priority whereby sensitive information is inaccessible to suspected malware;
f) Data manager, which is the middleman interface between entity and data coming from outside of the virtual environment;
g) Virtual Obfuscation, which confuses and restricts code by gradually and partially submerging them into a virtualized fake environment;
h) Covert Transportation Module, which transfers malware silently and discretely to a Mock Data Environment; and
i) Data Recall Tracking, which keeps track of all information uploaded from and downloaded to the Suspicious Entity.

The system further comprises Purpose Comparison Module, in which four different types of Purpose are compared to ensure that the entity's existence and behavior are merited and understood by LIZARD in being productive towards the system's overall objectives.

The Iteration Module uses the SC to syntactically modify the code base of DS according to the defined purpose in from the Data Return Relay (DRR), wherein the modified version of LIZARD is stress tested in parallel with multiple and varying security scenarios by the AST.

Inside the SC, Logic Derivation derives logically necessary functions from initially simpler functions whereby an entire tree of function dependencies are built from a stated complex purpose;

wherein Code Translation converts arbitrary generic code which is understood directly by Syntax Module functions to any chosen known computer language and the inverse of translating known computer languages to arbitrary code is also performed;

wherein Logic Reduction reduces logic written in code to simpler forms to produce a map of interconnected functions;

wherein Complex Purpose Format is a storage format for storing interconnected sub-purposes that represent an overall purpose;

wherein Purpose Associations is a hardcoded reference for what functions and types of behavior refer to what kind of purpose;

wherein Iterative Expansion adds detail and complexity to evolve a simple goal into a complex purpose by referring to Purpose Associations;

wherein Iterative Interpretation loops through all interconnected functions and produces an interpreted purpose by referring to Purpose Associations;

wherein Outer Core is formed by the Syntax and Purpose modules which work together to derive a logical purpose to unknown foreign code, and to produce executable code from a stated function code goal;

wherein Foreign Code is code that is unknown to LIZARD and the functionality and intended purpose is unknown and the Foreign Code is the input to the inner core and Derived Purpose is the output, wherein the Derived Purpose is the intention of the given Code as estimated by the Purpose Module, wherein the Derived Purpose is returned in the Complex Purpose Format.

The IM uses AST for a reference of security performance and uses the Iteration Core to process the automatic code writing methodology, wherein at the DRR data on malicious attacks and bad actors is relayed to the AST when LIZARD had to resort to making a decision with low confidence; wherein inside the Iteration Core, Differential Modifier Algorithm (DMA) receives Syntax/Purpose Programming Abilities and System Objective Guidance from the Inner Core, and uses such a codeset to modify the Base Iteration according to the flaws the AST 17 found; wherein Security Result Flaws are presented visually as to indicate the security threats that passed through the Base Iteration whilst running the Virtual Execution Environment.

Inside the DMA, Current State represents Dynamic Shell codeset with symbolically correlated shapes, sizes and positions, wherein different configurations of these shapes indicate different configurations of security intelligence and reactions, wherein the AST provides any potential responses of the Current State that happened to be incorrect and what the correct response is;

wherein Attack Vector acts as a symbolic demonstration for a cybersecurity threat, wherein Direction, size, and color all correlate to hypothetical security properties like attack vector, size of malware, and type of malware, wherein the Attack Vector symbolically bounces off of the codeset to represent the security response of the codeset;

wherein Correct State represents the final result of the DMA's process for yielding the desired security response from a block of code of the Dynamic Shell, wherein differences between the Current State and Correct State result in different Attack Vector responses;

wherein the AST provides Known Security Flaws along with Correct Security Response, wherein Logic Deduction Algorithm uses prior Iterations of the DS to produce a superior and better equipped Iteration of the Dynamic Shell known as Correct Security Response Program.

Inside Virtual Obfuscation, questionable Code is covertly allocated to an environment in which half of the data is intelligently mixed with mock data, wherein any subjects operating within Real System can be easily and covertly transferred to a Partially or Fully Mock Data Environment due to Virtual Isolation; wherein Mock Data Generator uses the Real Data Synchronizer as a template for creating counterfeit & useless data; wherein perceived risk of confidence in perception of the incoming Foreign Code will influence the level of Obfuscation that LIZARD chooses; wherein High confidence in the code being malicious will invoke allocation to an environment that contains large amounts of Mock Data; wherein Low confidence in the code being malicious can invoke either allocation to a Real System or the 100% Mock Data Environment.

Data Recall Tracking keeps track of all information uploaded from and downloaded to the Suspicious Entity; wherein in the case that Mock Data had been sent to a legitimate enterprise entity, a callback is performed which calls back all of the Mock Data, and the Real Data is sent as a replacement; wherein a callback trigger is implemented so that a legitimate enterprise entity will hold back on acting on certain information until there is a confirmation that the data is not fake.

Behavioral Analysis tracks the download and upload behavior of the Suspicious Entity to determine potential Corrective Action, wherein the Real System contains the original Real Data that exists entirely outside of the virtualized environment, wherein Real Data that Replaces Mock Data is where Real data is provided unfiltered to the Data Recall Tracking whereby a Real Data Patch can be made to replace the mock data with real data on the Formerly Suspicious Entity; wherein the Data Manager, which is submerged in the Virtually Isolated Environment, receives a Real Data Patch from the Data Recall Tracking; wherein when Harmless Code has been cleared by Behavioral Analysis to being malicious, Corrective Action is performed to replace the Mock Data in the Formerly Suspicious Entity with the Real Data that it represents; wherein Secret Token is a security string that is generated and assigned by LIZARD allows the Entity that is indeed harmless to not proceed with its job; wherein if the Token is Missing, this indicates the likely scenario that this legitimate entity has been accidentally placed in a partially Mock Data Environment because of the risk assessment of it being malware, thereafter Delayed Session with the Delay Interface is activated; wherein if the Token is found, this indicates that the server environment is real and hence any delayed sessions are Deactivated;

Inside the Behavioral Analysis, Purpose Map is a hierarchy of System Objectives which grants purpose to the entire Enterprise System, wherein the Declared, Activity and Codebase Purposes are compared to the innate system need for whatever the Suspicious Entity is allegedly doing; wherein with Activity Monitoring the suspicious entity's Storage, CPU Processing, and Network Activity are monitored, wherein the Syntax Module interprets such Activity in terms of desired function, wherein such functions are then translated to an intended purpose in behavior by the Purpose Module, wherein Codebase is the source code/programming structure of the Suspicious Entity and is forwarded to the Syntax Module, wherein the Syntax Module understands coding syntax and reduces programming code and code activity to an intermediate Map of Interconnected Functions, wherein the Purpose Module produces the perceived intentions of the Suspicious Entity, the outputs Codebase Purpose and Activity Purpose, wherein the Codebase Purpose contains the known purpose, function, jurisdiction and authority of Entity as derived by LIZARD's syntactical programming capabilities, wherein the Activity Purpose contains the known purpose, function, jurisdiction and authority of Entity as understood by LIZARD's understanding of its storage, processing and network Activity, wherein the Declared Purpose is the assumed purpose, function, jurisdiction, and authority of Entity as declared by the Entity itself, wherein the Needed Purpose contains the expected purpose, function, jurisdiction and authority the Enterprise System requires, wherein all the purposes are compared in the Comparison Module, wherein any inconsistencies between the purposes will invoke a Divergence in Purpose scenario which leads to Corrective Action.

The computer implemented system is Critical Thinking Memory & Perception (CTMP). The system further comprises:

a) Critical Rule Scope Extender (CRSE), which takes known scope of perceptions and upgrade them to include critical thinking scopes of perceptions;
b) Correct rules, which indicates correct rules that have been derived by using the critical thinking scope of perception;
c) Rule Execution (RE), which executes rules that have been confirmed as present and fulfilled as per the memory's scan of the Chaotic Field to produce desired and relevant critical thinking decisions;
d) Critical Decision Output, which produces final logic for determining the overall output of CTMP by comparing the conclusions reached by both Perception Observer Emulator (POE) and the RE;

wherein the POE produces an emulation of the observer and tests/compares all potential points of perception with such variations of observer emulations;

wherein the RE comprises a checkerboard plane which is used to track the transformations of rulesets, wherein the objects on the board represents the complexity of any given security situation, whilst the movement of such objects across the ‘security checkerboard’ indicates the evolution of the security situation which is managed by the responses of the security rulesets.

The system further comprises:

a) Subjective opinion decisions, which decision provided by Selected Pattern Matching Algorithm (SPMA);
b) Input system Metadata, which comprises raw metadata from the SPMA, which describes the mechanical process of the algorithm and how it reached such decisions;
c) Reason Processing, which logically understands the assertions by comparing attributes of properties;
d) Rule Processing, which uses the resultant rules that have been derived are used as a reference point to determine the scope of the problem at hand;
e) Memory Web, which scans market variables logs for fulfillable rules;
f) Raw Perception Production, which receives metadata logs from the SPMA, wherein the logs are parsed and a perception is formed that represents the perception of such algorithm, wherein the perception is stored in a Perception Complex Format (PCF), and is emulated by the POE; wherein Applied Angles of Perception indicates angles of perception that have already been applied and utilized by the SPMA;
g) Automated Perception Discovery Mechanism (APDM), which leverages Creativity Module, which produces hybridized perceptions that are formed according to the input provided by Applied Angles of Perception whereby the perception's scope can be increased;
h) Self-Critical Knowledge Density (SCKD), which estimates the scope and type of potential unknown knowledge that is beyond the reach of the reportable logs whereby the subsequent critical thinking features of CTMP can leverage the potential scope of all involved knowledge; wherein Critical Thinking indicates the outer shell jurisdiction of rule based thinking;
i) Implication Derivation (ID), which derives angles of perception data that can be implicated from the current Applied Angles of Perception;

wherein the SPMA is juxtaposed against the Critical Thinking performed by CTMP via perceptions and rules.

The system further comprises:

a) Resource Management & Allocation (RMA), in which adjustable policy dictates the amount of perceptions that are leveraged to perform an observer emulation, wherein the priority of perceptions chosen are selected according to weight in descending order, wherein the policy then dictates the manner of selecting a cut off, whether than be a percentage, fixed number, or a more complex algorithm of selection;
b) Storage Search (SS), which uses the CVF derived from the data enhanced logs as criteria in a database lookup of the Perception Storage (PS), wherein in PS, perceptions, in addition to their relevant weight, are stored with the comparable variable format (CVF) as their index;
c) Metric Processing, which reverse engineers the variables allocation from the SPMA;
d) Perception Deduction (PD), which uses the allocation response and its corresponding system metadata to replicate the original perception of the allocation response;
e) Metadata Categorization Module (MCM), in which the debugging and algorithm traces are separated into distinct categories using syntax based information categorization, wherein the categories are used to organize and produce distinct allocation responses with a correlation to risks and opportunities;
f) Metric Combination, which separates angles of perception into categories of metrics; g) Metric Conversion, which reverses individual metrics back into whole angles of perception;
h) Metric Expansion (ME), which stores the metrics of multiple and varying angles of perception categorically in individual databases;
i) Comparable Variable Format Generator (CVFG), which converts a stream of information into Comparable Variable Format (CVF).

The system further comprises:

a) Perception Matching 503, in which CVF is formed from the perception received from Rule Syntax Derivation (RSD); wherein the newly formed CVF is used to lookup relevant Perceptions in the PS with similar indexes, wherein the potential matches are returned to Rule Syntax Generation (RSG);
b) Memory Recognition (MR), in which a Chaotic Field 613 is formed from input data;
c) Memory Concept Indexing, in which the whole concepts are individually optimized into indexes, wherein the indexes are used by the letter scanners to interact with the Chaotic Field;
d) Rule Fulfillment Parser (RFP), which receives the individual parts of the rule with a tag of recognition, wherein each part is marked as either having been found, or not found in the Chaotic Field by Memory Recognition; wherein the RFP logically deduces which whole rules, the combination of all of their parts, have been sufficiently recognized in the Chaotic Field to merit the RE;
e) Rule Syntax Format Separation (RSFS), in which Correct Rules are separated and organized by type whereby all the actions, properties, conditions, and objects are stacked separately;
f) Rule Syntax Derivation, in which logical ‘black and white’ rules are converted to metric based perceptions, whereby the complex arrangement of multiple rules are converted into a single uniform perception that is expressed via multiple metrics of varying gradients;
g) Rule Syntax Generation (RSG), which receives previously confirmed perceptions which are stored in Perception Format and engages with the perception's internal metric makeup, wherein such gradient-based measures of metrics are converted to binary and logical rulesets that emulates the input/output information flow of the original perception;
h) Rule Syntax Format Separation (RSFS), in which Correct rules represent the accurate manifestation of rulesets that conform to the reality of the object being observed, whereby Correct rules are separated and organized by type and hence all the actions, properties, conditions, and objects are stacked separately enabling the system to discern what parts have been found in the Chaotic Field, and what parts have not;
i) Innate Logical Deduction, which uses logical principles, hence avoiding fallacies, to deduce what kind of rule will accurately represent the many gradients of metrics within the perception;
j) Metric Context Analysis, which analyzes the interconnected relationships within the perceptions of metrics, wherein certain metrics can depend on others with varying degrees of magnitude, wherein this contextualization is used to supplement the mirrored interconnected relationship that rules have within the ‘digital’ ruleset format;
k) Rule Syntax Format Conversion (RSFC), which assorts and separate rules to conform to the syntax of the Rule Syntax Format (RSF);

wherein Intuitive Decision engages in critical thinking via leveraging perceptions, wherein Thinking Decision engages in critical thinking via leveraging rules, wherein Perceptions is data received from Intuitive Decision according to a format syntax defined in Internal Format, wherein Fulfilled Rules is data received from Thinking Decision, which is a collection of fulfillable rulesets from the RE, wherein the data is passed on in accordance with the format syntax defined in Internal Format;

wherein Actions indicates an action that may have already been performed, will be performed, is being considered for activation, wherein Properties indicates some property-like attribute which describes something else, be it an Action, Condition or Object, wherein Conditions indicates a logical operation or operator, wherein Objects indicates a target which can have attributes applied to it;

wherein Separated Rule Format is used as output from the Rule Syntax Format Separation (RSFS), which is considered the pre-Memory Recognition phase, and as output from Memory Recognition (MR), which is considered the post-Memory Recognition phase.

The system further comprises:

a) Chaotic Field Parsing (CFP), which combines the format of the logs into a single scannable Chaotic Field 613;
b) Extra Rules, which are produced from Memory Recognition (MR) to supplement the Correct Rules;

wherein inside Perception Matching (PM), Metric Statistics provides statistical information from Perception Storage, Error Management parses syntax and/or logical errors stemming from any of the individual metrics, Separate Metrics isolates each individual metric since they used to be combined in a single unit which was the Input Perception, Node Comparison Algorithm (NCA) receives the node makeup of two or more CVFs, wherein Each node of a CVF represents the degree of magnitude of a property, wherein a similarity comparison is performed on an individual node basis, and the aggregate variance is calculated, wherein a smaller variance number represents a closer match.

The system of claim further comprises:

a) Raw Perceptions—Intuitive Thinking (Analog), which processes the perceptions according to an ‘analog’ format, wherein Analog Format perceptions pertains to the decision are stored in gradients on a smooth curve without steps;
b) Raw Rules—Logical Thinking (Digital), which processes rules according to a digital format, wherein Digital Format raw rules pertains to the decision are stored in steps with little to no ‘grey area’;

wherein Unfulfilled Rules are rulesets that have not been sufficiently recognized in the Chaotic Field according to their logical dependencies, and Fulfilled Rules are rulesets that have been recognized as sufficiently available in the Chaotic Field 613 according to their logical dependencies;

wherein Queue Management (QM) leverages the Syntactical Relationship Reconstruction (SRR) to analyze each individual part in the most logical order and has access to the Memory Recognition (MR) results whereby the binary yes/no flow questions can be answered and appropriate action can be taken, wherein QM checks every rule segment in stages, if a single segment is missing from the Chaotic Field and not in proper relation with the other segments, the ruleset is flagged as unfulfilled;

Sequential Memory Organization is an optimized information storage for ‘chains’ of sequenced information, wherein in Points of Memory Access, the width of each of the Nodes (blocks) represent the direct accessibility of the observer to the memorized object (node), wherein with Scope of Accessibility each letter represents its point of direct memory access to the observer, wherein a wider scope of accessibility indicates that there are more points of accessibility per sequence node, wherein the more a sequence would be referenced only ‘in order’ and not from any randomly selected node, the more narrow the scope of accessibility (relative to sequence size, wherein with Nested Sub-Sequence Layers, a sequence that exhibits strong non-uniformity is made up of a series of smaller sub-sequences that interconnect.

Non-Sequential Memory Organization deals with the information storage of non-sequentially related items, wherein reversibility indicates a non-sequential arrangement and a uniform scope, wherein non-sequential relation is indicated by the relatively wide point of access per node, wherein the same uniformity exists when the order of the nodes is shuffled, wherein in Nucleus Topic and Associations, the same series of nodes are repeated but with a different nucleus (the center object), wherein the nucleus represents the primary topic, to which the remaining nodes act as memory neighbours to which they can be accessed easier as opposed to if there were no nucleus topic defined.

Memory Recognition (MR) scans Chaotic Field to recognize known concepts, wherein the Chaotic Field is a ‘field’ of concepts arbitrarily submersed in ‘white noise’ information, wherein Memory Concept Retention stores recognizable concepts that are ready to be indexed and referenced for field examination, wherein 3 Letter Scanner scans the Chaotic Field and checks against 3 letter segments that correspond to a target, wherein 5 Letter Scanner scans the Chaotic Field and checks against 5 letter segments that correspond to a target but this time the segment that is checked with every advancement throughout the field is the entire word, wherein the Chaotic field is segmented for scanning in different proportions, wherein as the scope of the scanning decreases, the accuracy increases, wherein as the field territory of the scanner increases, a larger letter scanner is more efficient for performing recognitions, at the expense of accuracy, wherein Memory Concept Indexing (MCI) alternates the size of the scanner in response to their being unprocessed memory concepts left, wherein MCI 500 starts with the largest available scanner and decreases gradually whereby more computing resources can be found to check for the potential existence of smaller memory concept targets.

Field Interpretation Logic (FIL) operates the logistics for managing scanners of differing widths, wherein General Scope Scan begins with a large letter scan, and sifts through a large scope of field with fewer resources, at the expense of small scale accuracy, wherein Specific Scope Scan is used when an area of significance has been located, and needs to be ‘zoomed in’ on whereby ensuring that an expensively accurate scan isn't performed in a redundant and unyielding location, wherein receiving additional recognition of memory concepts in the Chaotic Field indicates that Field Scope contains a dense saturation of memory concepts.

In Automated Perception Discovery Mechanism (APDM), Angle of Perceptions are defined in composition by multiple metrics including Scope, Type, Intensity and Consistency, which define multiple aspects of perception that compose the overall perception, wherein Creativity module produces complex variations of Perception, wherein the Perception Weight defines how much relative influence a Perception has whilst emulated by the POE, wherein the weights of both input Perceptions are considering whilst defining the weight of the Newly Iterated Perception, which contains hybridized metrics that are influenced from the previous generation of Perceptions.

Input for the CVFG is Data Batch, which is an Arbitrary Collection of data that represents the data that must be represented by the node makeup of the generated CVF, wherein a sequential advancement is performed through each of the individual units defined by Data Batch, wherein the data unit is converted to a Node format, which has the same composition of information as referenced by the final CVF, wherein the converted Nodes are then temporarily stored in the Node Holdout upon checking for their existence at Stage, wherein if they are not found then they are created and updated with statistical information including occurrence and usage, wherein all the Nodes with the Holdout are assembled and pushed as modular output as a CVF.

Node Comparison Algorithm compares two Node Makeups, which have been read from the raw CVF, wherein with Partial Match Mode (PMM), if there is an active node in one CVF and it is not found in its comparison candidate (the node is dormant), then the comparison is not penalized, wherein with Whole Match Mode WMM, If there is an active node in one CVF and it is not found in its comparison candidate (the node is dormant), then the comparison is penalized.

System Metadata Separation (SMS) separates Input System Metadata into meaningful security cause-effect relationships, wherein with Subject Scan/Assimilation, the subject/suspect of a security situation is extracted from the system metadata using premade category containers and raw analysis from the Categorization Module, wherein the subject is used as the main reference point for deriving a security response/variable relationship, wherein with Risk Scan/Assimilation, the risk factors of a security situation are extracted from the system metadata using premade category containers and raw analysis from the Categorization Module, wherein the risk is associated with the target subject which exhibits or is exposed to such risk, wherein with Response Scan/Assimilation, the response of a security situation made by the input algorithm is extracted from the system metadata using premade category containers and raw analysis from the Categorization Module, wherein the response is associated with the security subject which allegedly deserves such a response.

In the MCM, Format Separation separates and categorizes the metadata is separated and categorized according to the rules and syntax of a recognized format, wherein Local Format Rules and Syntax contains the definitions that enable the MCM module to recognize pre-formatted streams of metadata, wherein Debugging Trace is a coding level trace that provides variables, functions, methods and classes that are used and their respective input and output variable type/content, wherein the Algorithm Trace is a Software level trace that provides security data coupled with algorithm analysis, wherein the resultant security decision (approve/block) is provided along with a trail of how it reached that decision (justification), and the appropriate weight that each factor contributed into making that security decision.

In Metric Processing (MP), Security Response X represents a series of factors that contribute to the resultant security response chosen by the SPMA, wherein the initial weight is determined by the SPMA, wherein Perception Deduction (PD) uses a part of the security response and its corresponding system metadata to replicate the original perception of the security response, wherein Perception Interpretations of the Dimensional Series displays how PD will take the Security Response of the SPMA and associate the relevant Input System Metadata to recreate the full scope of the intelligent ‘digital perception’ as used originally by the SPMA, wherein Shape Fill, Stacking Quantity, and Dimensional are digital perceptions that capture the ‘perspective’ of an intelligent algorithm.

In the PD, Security Response X is forwarded as input into Justification/Reasoning Calculation, which determines the justification of the security response of the SPMA by leveraging the intent supply of the Input/Output Reduction (IOR) module, wherein the IOR module uses the separated input and output of the various function calls listed in the metadata, wherein the metadata separation is performed by the MCM.

For the POE, Input System Metadata is the initial input that is used by Raw Perception Production (RP2) to produce perceptions in CVF, wherein with Storage Search (SS) the CVF derived from the data enhanced logs is used as criteria in a database lookup of the Perception Storage (PS), wherein in Ranking, the perceptions are ordered according to their final weight, wherein the Data Enhanced Logs are applied to the perceptions to produce block/approve recommendations, wherein the SCKD tags the logs to define the expected upper scope of unknown knowledge, wherein Data Parsing does a basic interpretation of the Data Enhanced Logs and the Input System Metadata to output the original Approve or Block Decision as decided by the original SPMA, wherein CTMP criticizes decisions in the POE according to perceptions, and in Rule Execution (RE) according to logically defined rules.

With Metric Complexity, the outer bound of the circle represents the peak of known knowledge concerning the individual metric, wherein the outer edge of the circle represents more metric complexity, whilst the center represents less metric complexity, wherein the center light grey represents the metric combination of the current batch of Applied Angles of Perception, and the outer dark grey represents metric complexity that is stored and known by the system in general, wherein the goal of ID is to increase the complexity of relevant metrics, so that Angles of Perception can be multiplied in complexity and quantity, wherein the dark grey surface area represents the total scope of the current batch of Applied Angles of Perception, and the amount of scope left over according to the known upper bound, wherein upon enhancement and complexity enrichment the metrics are returned as Metric Complexity, which is passed as input of Metric Conversion, which reverses individual to whole Angles of Perception whereby the final output is assembled as Implied Angles of Perception.

For SCKD, Known Data Categorization (KDC) categorically separates known information from Input so that an appropriate DB analogy query can be performed and separates the information into categories, wherein the separate categories individually provide input to the CVFG, which outputs the categorical information in CVF format, which is used by Storage Search (SS) to check for similarities in the Known Data Scope DB, wherein each category is tagged with its relevant scope of known data according to the SS results, wherein the tagged scopes of unknown information per category are reassembled back into the same stream of original input at the Unknown Data Combiner (UDC).

The computer implemented system is Lexical Objectivity Mining (LOM). The system further comprises:

a) Initial Query reasoning (IQR), to which a question is transferred, and which leverages Central Knowledge Retention (CKR) to decipher missing details that are crucial in understanding and answering/responding to the question;
b) Survey Clarification (SC), to which the question and the supplemental query data is transferred, and which receives input from and send output to human subject, and forms Clarified Question/Assertion;
c) Assertion Construction (AC), which receives a proposition in the form of an assertion or question and provides output of the concepts related to such proposition;
d) Response Presentation, which is an interface for presenting a conclusion drawn by AC to both Human Subject and Rational Appeal (RA);
e) Hierarchical Mapping (HM), which maps associated concepts to find corroboration or conflict in Question/Assertion consistency, and calculates the benefits and risks of having a certain stance on the topic;
f) Central Knowledge Retention (CKR), which is the main database for referencing knowledge for LOM;
g) Knowledge Validation (KV), which receives high confidence and pre-criticized knowledge which needs to be logically separated for query capability and assimilation into the CKR;
h) Accept Response, which is a choice given to the Human Subject to either accept the response of LOM or to appeal it with a criticism, wherein if the response is accepted, then it is processed by KV so that it can be stored in CKR as confirmed (high confidence) knowledge, wherein should the Human Subject not accept the response, they are forwarded to the RA, which checks and criticizes the reasons of appeal given by Human;
i) Managed Artificially Intelligent Services Provider (MAISP), which runs an internet cloud instance of LOM with a master instance of the CKR, and connects LOM to Front End Services, Back End Services, Third Party Application Dependencies, Information Sources, and the MNSP Cloud.

Front End Services include Artificially Intelligent Personal Assistants, Communication Applications and Protocols, Home Automation and Medical Applications, wherein Back End Services include online shopping, online transportation, Medical Prescription ordering, wherein Front End and Back End Services interact with LOM via a documented API infrastructure, which enables standardization of information transfers and protocols, wherein LOM retrieves knowledge from external Information Sources via the Automated Research Mechanism (ARM).

Linguistic Construction (LC) interprets raw question/assertion input from the Human Subject and parallel modules to produce a logical separation of linguistic syntax; wherein Concept Discovery (CD) receives points of interest within the Clarified Question/Assertion and derives associated concepts by leveraging CKR; wherein Concept Prioritization (CP) receives relevant concepts and orders them in logical tiers that represent specificity and generality; wherein Response Separation Logic (RSL) leverages the LC to understand the Human Response and associate a relevant and valid response with the initial clarification request whereby accomplishing the objective of SC; wherein the LC is then re-leveraged during the output phase to amend the original Question/Assertion to include the supplemental information received by the SC; wherein Context Construction (CC) uses metadata from Assertion Construction (AC) and evidence from the Human subject to give raw facts to CTMP for critical thinking; wherein Decision Comparison (DC) determines the overlap between the pre-criticized and post-criticized decisions; wherein Concept Compatibility Detection (CCD) compares conceptual derivatives from the original Question/Assertion to ascertain the logical compatibility result; wherein Benefit/Risk Calculator (BRC) receives the compatibility results from the CCD and weighs the benefits and risks to form a uniform decision that encompasses the gradients of variables implicit in the concept makeup; wherein Concept Interaction (CI) assigns attributes that pertain to AC concepts to parts of the information collected from the Human Subject via Survey Clarification (SC).

Inside the IQR, LC receives the original Question/Assertion; the question is linguistically separated and IQR processes each individual word/phrase at a time leveraging the CKR; By referencing CKR, IQR considers the potential options that are possible considering the ambiguity of the word/phrase.

Survey Clarification (SC) receives input from IQR, wherein the input contains series of Requested Clarifications that are to be answered by the Human Subject for an objective answer to the original Question/Assertion to be reached, wherein provided response to the clarifications are forwarded to Response Separation Logic (RSL), which correlates the responses with the clarification requests; wherein in parallel to the Requested Clarifications being processed, Clarification Linguistic Association is provided to LC, wherein the Association contains the internal relationship between Requested Clarifications and the language structure, which enables the RSL to amend the original Question/Assertion whereby LC outputs the Clarified Question.

For Assertion Construction, which received the Clarified Question/Assertion, LC breaks the question down into Points of Interest, which are passed onto Concept Discovery, wherein CD derives associates concepts by leveraging CKR, wherein Concept Prioritization (CP) orders concepts into logical tiers, wherein the top tier is assigned the most general concepts, whilst the lower tiers are allocated increasingly specific concepts, wherein the top tier is transferred to Hierarchical Mapping (HM) as modular input, wherein in a parallel transfer of information HM receives the Points of Interest, which are processed by its dependency module Concept Interaction (CI), wherein CI assigns attributes to the Points of Interest by accessing the indexed information at CKR, wherein upon HM completing its internal process, its final output is returned to AC after the derived concepts have been tested for compatibility and the benefits/risks of a stance are weighed and returned.

For HM, CI provides input to CCD which discerns the compatibility/conflict level between two concepts, wherein the compatibility/conflict data is forwarded to BRC, which translates the compatibilities and conflicts into benefits and risks concerning taking a holistic uniform stance on the issue, wherein the stances, along with their risk/benefit factors, are forwarded to AC as Modular Output, wherein the system contains loops of information flow indicates gradients of intelligence being gradually supplemented as the subjective nature of the question/assertion a gradually built objective response; wherein CI receives Points of Interest and interprets each one according to the top tier of prioritized concepts.

For RA, Core Logic processes the converted linguistic text, and returns result, wherein if the Result is High Confidence, the result is passed onto Knowledge Validation (KV) for proper assimilation into CKR, wherein if the Result is Low Confidence, the result is passed onto AC to continue the cycle of self-criticism, wherein Core Logic receives input from LC in the form of a Pre-Criticized Decision without linguistic elements, wherein the Decision is forwarded to CTMP as the Subjective Opinion, wherein Decision is also forwarded to Context Construction (CC) which uses metadata from AC and potential evidence from the Human Subject to give raw facts to CTMP as input ‘Objective Fact’, wherein with CTMP having received its two mandatory inputs, such information is processed to output it's best attempt of reaching ‘Objective Opinion,’ wherein the opinion is treated internally within RA as the Post-Criticized Decision, wherein both Pre-Criticized and Post-Criticized decisions are forwarded to Decision Comparison (DC), which determines the scope of overlap between both decisions, wherein the appeal argument is then either conceded as true or the counter-point is improved to explain why the appeal is invalid, wherein indifferent to a Concede or Improve scenario, a result of high confidence is passed onto KV and a result of low confidence is passed onto AC 808 for further analysis.

For CKR, units of information are stored in the Unit Knowledge Format (UKF), wherein Rule Syntax Format (RSF) is a set of syntactical standards for keeping track of references rules, wherein multiple units of rules within the RSF can be leveraged to describe a single object or action; wherein Source attribution is a collection of complex data that keeps track of claimed sources of information, wherein a UKF Cluster is composed of a chain of UKF variants linked to define jurisdictionally separate information, wherein UKF2 contains the main targeted information, wherein UKF1 contains Timestamp information and hence omits the timestamp field itself to avoid an infinite regress, wherein UKF3 contains Source Attribution information and hence omits the source field itself to avoid an infinite regress; wherein every UKF2 must be accompanied by at least one UKF1 and one UKF3, or else the cluster (sequence) is considered incomplete and the information therein cannot be processed yet by LOM Systemwide General Logic; wherein in between the central UKF2 and its corresponding UKF1 and UKF3 units there can be UKF2 units that act as a linked bridge, wherein a series of UKF Clusters will be processed by KCA to form Derived Assertion, wherein Knowledge Corroboration Analysis (KCA) is where UKF Clustered information is compared for corroborating evidence concerning an opinionated stance, wherein after processing of KCA is complete, CKR can output a concluded Opinionated stance on a topic.

For ARM, wherein as indicated by User Activity, as users interact with LOM concepts are either directly or indirectly brought as relevant to answering/responding to a question/assertion, wherein User Activity is expected to eventually yield concepts that CKR has low or no information regarding, as indicated by List of Requested Yet Unavailable Concepts, wherein with Concept Sorting & Prioritization (CSP), Concept definitions are received from three independent sources and are aggregated to prioritize the resources of Information Request, wherein the data provided by the information sources are received and parsed at Information Aggregator (IA) according to what concept definition requested them and relevant meta-data are kept, wherein the information is sent to Cross-Reference Analysis (CRA) where the information received is compared to and constructed considering pre-existing knowledge from CKR.

Personal Intelligence Profile (PIP) is where an individual's personal information is stored via multiple potential end-points and front-ends, wherein their information is isolated from CKR, yet is available for LOM Systemwide General Logic, wherein Personal information relating to Artificial Intelligence applications are encrypted and stored in the Personal UKF Cluster Pool in UKF format, wherein with Information Anonymization Process (IAP) information is supplemented to CKR after being stripped of any personally identifiable information, wherein with Cross-Reference Analysis (CRA) information received is compared to and constructed considering pre-existing knowledge from CKR.

Life Administration & Automation (LAA) connects internet enabled devices and services on a cohesive platform, wherein Active Decision Making (ADM) considers the availability and functionality of Front End Services, Back End Services, IoT devices, spending rules and amount available according to Fund Appropriations Rules & Management (FARM); FARM receives human input defining criteria, limits and scope to the module to inform ADM for what it's jurisdiction of activity is, wherein cryptocurrency funds is deposited into the Digital Wallet, wherein the IoT Interaction Module (IIM) maintains a database of what IoT devices are available, wherein Data Feeds represents when IoT enabled devices send information to LAA.

The system further comprises Behavior Monitoring (BM) which monitors personally identifiable data requests from users to check for unethical and/or illegal material, wherein with Metadata Aggregation (MDA) user related data is aggregated from external services so that the digital identity of the user can be established, wherein such information is transferred to Induction/Deduction, and eventually PCD, where a sophisticated analysis is performed with corroborating factors from the MNSP; wherein all information from the authenticated user that is destined for PIP passes through Information Tracking (IT) and is checked against the Behavior Blacklist, wherein at Pre-Crime Detection (PCD) Deduction and Induction information is merged and analyzed for pre-crime conclusions, wherein PCD makes use of CTMP, which directly references the Behavior Blacklist to verify the stances produced by Induction and Deduction, wherein the Blacklist Maintenance Authority (BMA) operates within the Cloud Service Framework of MNSP.

LOM is configured to manage a personalized portfolio on an individual's life, wherein LOM receives an initial Question which leads to conclusion via LOM's Internal Deliberation Process, wherein it is connected to connect to the LAA module which connects to internet enabled devices which LOM can receive data from and control, wherein with Contextualization LOM deduces the missing links in constructing an argument, wherein LOM has deciphers with its logic that to solve the dilemma posed by the original assertion it must first know or assume certain variables about the situation.

The computer implemented system is Linear Atomic Quantum Information Transfer (LAQIT). The system comprises:

a) recursively repeating same consistent color sequence within a logically structured syntax; and
b) using the sequence recursively to translate with the English alphabet;

wherein when structuring the ‘base’ layer of the alphabet, the color sequence is used with a shortened and unequal weight on the color channel and leftover space for syntax definitions within the color channel is reserved for future use and expansion;

wherein a complex algorithm reports its log events and status reports with LAQIT, status/log reports are automatically generated, wherein the status/log reports are converted to a transportable text-based LAQIT syntax, wherein syntactically insecure information is transferred over digitally, wherein the transportable text-based syntax is converted to highly readable LAQIT visual syntax (linear mode), wherein Key is optimized for human memorization and is based on relatively short sequence of shapes;

wherein locally non-secure text is entered by the sender for submission to the Recipient, wherein the text is converted to a transportable encrypted text-based LAQIT syntax, wherein syntactically secure information is transferred over digitally, wherein the data is converted to a visually encrypted LAQIT syntax;

wherein Incremental Recognition Effect (IRE) is a channel of information transfer, and recognizes the full form of a unit of information before it has been fully delivered, wherein this effect of a predictive index is incorporated by displaying the transitions between word to word, wherein Proximal Recognition Effect (PRE) is a channel of information transfer, and recognizes the full form of a unit of information whilst it is either corrupted, mixed up or changed.

In the Linear mode of LAQIT, a Block shows the ‘Basic Rendering’ version of linear mode and a Point displays its absence of encryption, wherein with Word Separator, the color of the shape represents the character that follows the word and acts as a separation between it and the next word, wherein Single Viewing Zone incorporates a smaller viewing zone with larger letters and hence less information per pixel, wherein in Double Viewing Zone, there are more active letters per pixel, wherein Shade Cover makes incoming and outgoing letters dull so that the primary focus of the observer is on the viewing zone.

In Atomic Mode, which is capable of a wide range of encryption levels, the Base main character reference will specify the general of which letter is being defined, wherein a Kicker exists with the same color range as the bases, and defines the specific character exactly, wherein with Reading Direction, the information delivery reading begins on the top square of orbital ring one, wherein once an orbital ring has been completed, reading continues from the top square of the next sequential orbital ring, wherein the Entry/Exit Portals are the points of creation and destruction of a character (its base), wherein a new character, belonging to the relevant orbital, will emerge from the portal and slide to its position clockwise, wherein the Atomic Nucleus defines the character that follows the word;

wherein with Word Navigation, each block represents an entire word (or multiple words in molecular mode) on the left side of the screen, wherein when a word is displayed, the respective block moves outwards to the right, and when that word is complete the block retreats back, wherein the color/shape of the navigation block is the same color/shape as the base of the first letter of the word; wherein with Sentence Navigation, each block represents a cluster of words, wherein a cluster is the maximum amount of words that can fit on the word navigation pane; wherein Atomic State Creation is a transition that induces the Incremental Recognition Effect (IRE), wherein with such a transition Bases emerge from the Entry/Exit Portals, with their Kickers hidden, and move clockwise to assume their positions; wherein Atomic State Expansion is a transition that induces the Proximal Recognition Effect (PRE), wherein once the Bases have reached their position, they move outwards in the ‘expand’ sequence of the information state presentation, which reveals the Kickers whereby the specific definition of the information state can be presented; wherein Atomic State Destruction is a transition that induces the Incremental Recognition Effect (IRE), wherein Bases have retracted, (reversed the Expansion Sequence) to cover the Kickers again, wherein they are now sliding clockwise to reach the entry/exit portal.

With Shape Obfuscation, the standard squares are replaced with five visually distinct shapes, wherein the variance of shapes within the syntax allows for dud (fake) letters to be inserted at strategic points of the atomic profile and the dud letters obfuscate the true and intended meaning of the message, wherein deciphering whether a letter is real or a dud is done via the securely and temporarily transferred decryption key;

wherein with Redirection Bonds, a bond connects two letters together and alters the flow of reading, wherein whilst beginning with the typical clockwise reading pattern, encountering a bond that launches (starts with) and lands on (ends with) legitimate/non-dud letters will divert the reading pattern to resume on the landing letter;

wherein with Radioactive Elements, some elements can ‘rattle’ which can inverse the evaluation of if a letter is a dud or not, wherein Shapes shows the shapes available for encryption, wherein Center Elements shows the center element of the orbital which defines the character that comes immediately after the word.

With Redirection Bonds, the bonds start on a ‘launching’ letter and end on a ‘landing’ letter, either of which may or may not be a dud, wherein if none of them are duds, then the bond alters the reading direction and position, wherein If one or both are duds, then the entire bond must be ignored, or else the message will be decrypted incorrectly, wherein with Bond Key Definition, if a bond must be followed in the reading of the informations state depends on if it has been specifically defined in the encryption key.

With Single Cluster, both neighbors are non-radioactive, hence the scope for the cluster is defined, wherein since the key specifies double clusters as being valid, the element is to be treated is if it wasn't radioactive in the first place, wherein with Double Cluster, Key Definition defines double clusters as being active, hence all other sized clusters are to be considered dormant whilst decrypting the message, wherein Incorrect Interpretation shows how the interpreter did not treat the Double Cluster as a reversed sequence (false positive).

In Molecular Mode with Encryption and Streaming enabled, with Covert Dictionary Attack Resistance, an incorrect decryption of the massage leads to a ‘red herring’ alternate message, wherein with Multiple Active Words per Molecule, the words are presented in parallel during the molecular procedure whereby increasing the information per surface area ratio, however with a consistent transition speed, wherein Binary and Streaming Mode shows Streaming Mode whilst in a typical atomic configuration the reading mode is Binary, wherein Binary Mode indicates that the center element defines which character follows the word, wherein Molecular mode is also binary; except when encryption is enabled which adheres to Streaming mode, wherein Streaming mode makes references within the orbital to special characters.

The computer implemented system is Universal BCHAIN Everything Connections (UBEC) system with Base Connection Harmonization Attaching Integrated Nodes. The system further comprises:

a) Communications Gateway (CG), which is the primary algorithm for BCHAIN Node to interact with its Hardware Interface thereafter leading to communications with other BCHAIN nodes;
b) Node Statistical Survey (NSS), which interprets remote node behavior patterns;
c) Node Escape Index, which tracks the likelihood that a node neighbor will escape a perceiving node's vicinity;
d) Node Saturation Index, which tracks the amount of nodes in a perceiving node's range of detection;
e) Node Consistency Index, which tracks the quality of nodes services as interpreted by a perceiving node, wherein a high Node Consistency Index indicates that surrounding neighbor nodes tend to have more availability uptime and consistency in performance, wherein nodes that have dual purposes in usage tend to have a lower Consistency Index, wherein nodes that are dedicated to the BCHAIN network exhibit a higher value; and
f) Node Overlap Index, which tracks the amount of overlap nodes have with one another as interpreted by a perceiving node.

The system further comprises:

a) Customchain Recognition Module (CRM), which connects with Customchains including Appchains or Microchains that have been previously registered by the node, wherein CRM informs the rest of the BCHAIN Protocol when an update has been detected on an Appchain's section in the Metachain or a Microchain's Metachain Emulator;
b) Content Claim Delivery (CCD), which receives a validated CCR and thereafter sends the relevant CCF to fulfill the request;
c) Dynamic Strategy Adaptation (DSA), which manages the Strategy Creation Module (SCM), which dynamically generates a new Strategy Deployment by using the Creativity Module to hybridize complex strategies that have been preferred by the system via Optimized Strategy Selection Algorithm (OSSA), wherein New Strategies are varied according to input provided by Field Chaos Interpretation;
d) Cryptographic Digital Economic Exchange (CDEE) with a variety of Economic Personalities managed by the Graphical User Interface (GUI) under the UBEC Platform Interface (UPI); wherein with Personality A, Node resources are consumed to only match what you consume, wherein Personality B Consumes as many resources as possible as long as the profit margin is greater than predetermined value, wherein Personality C pays for work units via a traded currency, wherein with Personality D Node resources are spent as much as possible and without any restriction of expecting anything in return, whether that be the consumption of content or monetary compensation;
e) Current Work Status Interpretation (CWSI), which References the Infrastructure Economy section of the Metachain to determine the current surplus or deficit of this node with regards to work done credit;
f) Economically Considered Work Imposition (ECWI), which considers the selected Economic Personality with the Current Work Surplus/Deficit to evaluate if more work should currently be performed; and
g) Symbiotic Recursive Intelligence Advancement (SRIA), which is a triad relationship between different algorithms comprising LIZARD, which improves an algorithm's source code by understanding code purpose, including itself, I2GE, which emulates generations of virtual program iterations, and the BCHAIN network, which is a vast network of chaotically connected nodes that can run complex data-heavy programs in a decentralized manner.

### BRIEF DESCRIPTION OF THE DRAWINGS

The invention will be more fully understood by reference to the detailed description in conjunction with the following figures, wherein:

FIGS. 1-26 are schematic diagrams showing Critical Infrastructure Protection & Retribution (CIPR) through Cloud & Tiered Information Security (CTIS), known together as CIPR/CTIS; In detail:

FIGS. 1-2 are schematic diagrams showing how definitions for multiple angles of security interpretation are presented as a methodology for analysis;

FIG. 3 is a schematic diagram showing Cloud based Managed Encrypted Security Service Architecture for Secure EI² (Extranet, Intranet, Internet) Networking;

FIGS. 4-8 are schematic diagrams showing an overview of the Managed Network & Security Services Provider (MNSP);

FIG. 9 is a schematic diagram showing Realtime Security Processing in regards to LIZARD Cloud Based Encrypted Security;

FIG. 10 is a schematic diagram showing Critical Infrastructure Protection & Retribution (CIPR) through Cloud & Tiered Information Security (CTIS) example in an energy system;

FIG. 11 is a schematic diagram showing stage 1—initial system intrusion;

FIG. 12 is a schematic diagram showing stage 2—deployment of initial Trojan horse;

FIG. 13 is a schematic diagram showing stage 3—download of advanced executable malware;

FIG. 14 is a schematic diagram showing stage 4—compromise of intrusion defense/prevention systems;

FIG. 15 is a schematic diagram showing hacker desired behavior and actual security response;

FIG. 16 is a schematic diagram showing Scheduled Internal Authentication Protocol Access (SIAPA);

FIG. 17 is a schematic diagram showing root level access and standard level access;

FIG. 18 is a schematic diagram showing Oversight Review;

FIG. 19 is a schematic diagram showing Iterative Intelligence Growth/Intelligence Evolution (I²GE);

FIG. 20 is a schematic diagram showing Infrastructure System;

FIG. 21 is a schematic diagram showing Criminal System, Infrastructure System and Public Infrastructure;

FIGS. 22 and 23 are schematic diagrams showing how Foreign Code Rewrite syntactically reproduces foreign code from scratch to mitigate potentially undetected malicious exploits;

FIGS. 24 and 25 are schematic diagrams showing how Recursive Debugging loops through code segments;

FIG. 26 is a schematic diagram showing inner workings of Need Map Matching;

FIGS. 27-42 are schematic diagrams showing Machine Clandestine Intelligence (MACINT) & Retribution through Covert Operations in Cyberspace; In detail:

FIG. 27 is a schematic diagram showing intelligent information management, viewing and control;

FIG. 28 is a schematic diagram showing actions by Behavioral Analysis;

FIGS. 29 and 30 are schematic diagrams showing criminal system and retribution against the criminal system;

FIGS. 31 and 32 are schematic diagrams showing flow of MACINT;

FIG. 33 is a schematic diagram showing MACINT covert operations overview and how criminals exploit an enterprise system;

FIG. 34 is a schematic diagram showing details to Long-Term/Deep Scan which uses Big Data;

FIG. 35 is a schematic diagram showing how Arbitrary Computer is looked up on Trusted Platform;

FIG. 36 is a schematic diagram showing how known double or triple agents from the Trusted Platform are engaged to further the forensic investigation;

FIG. 37 is a schematic diagram showing how the Trusted Platform is used to engage ISP APIs;

FIG. 38 is a schematic diagram showing how the Trusted Platform is used to engage security APIs provided by Software and Hardware vendors to exploit any established backdoors;

FIGS. 39-41 are schematic diagrams showing how Generic and Customizable Exploits are applied to the Arbitrary and Criminal Computers;

FIG. 42 is a schematic diagram showing how a long-term priority flag is pushed onto the Trusted Platform to monitor the Criminal System;

FIGS. 43-68 are schematic diagrams showing Logically Inferred Zero-database A-priori Realtime Defense (LIZARD); In detail:

FIGS. 43 and 44 are schematic diagrams showing the dependency structure of LIZARD;

FIG. 45 is a schematic diagram showing overview of LIZARD;

FIG. 46 is a schematic diagram showing overview of the major algorithm functions concerning LIZARD;

FIG. 47 is a schematic diagram showing the inner workings of the Static Core (SC);

FIG. 48 is a schematic diagram showing how Inner Core houses the essential core functions of the system;

FIG. 49 is a schematic diagram showing the inner workings of the Dynamic Shell (DS);

FIG. 50 is a schematic diagram showing the Iteration Module (IM) which intelligently modifies, creates and destroys modules on the Dynamic Shell;

FIG. 51 is a schematic diagram showing Iteration Core which is the main logic for iterating code for security improvements;

FIGS. 52-57 are schematic diagrams showing the logical process of the Differential Modifier Algorithm (DMA);

FIG. 58 is a schematic diagram showing overview of Virtual Obfuscation;

FIGS. 59-61 are schematic diagrams showing the Monitoring and Responding aspect of Virtual Obfuscation;

FIGS. 62 and 63 are schematic diagrams showing Data Recall Tracking that keeps track of all information uploaded from and downloaded to the Suspicious Entity;

FIGS. 64 and 65 are schematic diagrams showing the inner workings of Data Recall Trigger;

FIG. 66 is a schematic diagram showing Data Selection, which filters out highly sensitive data and mixes Real Data with Mock Data;

FIGS. 67 and 68 are schematic diagrams showing the inner workings of Behavioral Analysis;

FIGS. 69-120 are schematic diagrams showing Critical Thinking Memory & Perception (CTMP); In detail:

FIG. 69 is a schematic diagram showing the main logic of CTMP;

FIG. 70 is a schematic diagram showing Angles of Perception;

FIGS. 71-73 are schematic diagrams showing the dependency structure of CTMP;

FIG. 74 is a schematic diagram showing the final logic for processing intelligent information in CTMP;

FIG. 75 is a schematic diagram showing the two main inputs of Intuitive/Perceptive and Thinking/Logical assimilating into a single terminal output which is representative of CTMP;

FIG. 76 is a schematic diagram showing the scope of intelligent thinking which occurs in the original Select Pattern Matching Algorithm (SPMA);

FIG. 77 is a schematic diagram showing the conventional SPMA being juxtaposed against the Critical Thinking performed by CTMP via perceptions and rules;

FIG. 78 is a schematic diagram showing how Correct Rules are produced in contrast with the conventional Current Rules;

FIGS. 79 and 80 are schematic diagrams showing Perception Matching (PM) module;

FIG. 81-85 are schematic diagrams showing Rule Syntax Derivation/Generation;

FIGS. 86-87 are schematic diagrams showing the workings of the Rule Syntax Format Separation (RSFS) module;

FIG. 88 is a schematic diagram showing the workings of the Rule Fulfillment Parser (RFP);

FIGS. 89-90 are schematic diagrams showing Fulfillment Debugger;

FIG. 91 is a schematic diagram showing Rule Execution;

FIGS. 92 and 93 are schematic diagrams showing Sequential Memory Organization;

FIG. 94 is a schematic diagram showing Non-Sequential Memory Organization;

FIGS. 95-97 are schematic diagrams showing Memory Recognition (MR);

FIGS. 98-99 are schematic diagrams showing Field Interpretation Logic (FIL);

FIGS. 100-101 are schematic diagrams showing Automated Perception Discovery Mechanism (APDM);

FIG. 102 is a schematic diagram showing Raw Perception Production (RP2);

FIG. 103 is a schematic diagram showing the logic flow of the Comparable Variable Format Generator (CVFG);

FIG. 104 is a schematic diagram showing Node Comparison Algorithm (NCA);

FIGS. 105 and 106 are schematic diagrams showing System Metadata Separation (SMS);

FIGS. 107 and 108 are schematic diagrams showing Metadata Categorization Module (MCM);

FIG. 109 is a schematic diagram showing Metric Processing (MP);

FIGS. 110 and 111 are schematic diagrams showing the internal design of Perception Deduction (PD);

FIGS. 112-115 are schematic diagrams showing Perception Observer Emulator (POE);

FIGS. 116 and 117 are schematic diagrams showing Implication Derivation (ID);

FIGS. 118-120 are schematic diagrams showing Self-Critical Knowledge Density (SCKD);

FIGS. 121-165 are schematic diagrams showing Lexical Objectivity Mining (LOM); In detail:

FIG. 121 is a schematic diagram showing the main logic for Lexical Objectivity Mining (LOM);

FIGS. 122-124 are schematic diagrams showing shows Managed Artificially Intelligent Services Provider (MAISP);

FIGS. 125-128 are schematic diagrams showing the Dependency Structure of LOM;

FIGS. 129 and 130 are schematic diagrams showing the inner logic of Initial Query Reasoning (IQR);

FIG. 131 is a schematic diagram showing Survey Clarification (SC);

FIG. 132 is a schematic diagram showing Assertion Construction (AC);

FIGS. 133 and 134 are schematic diagrams showing the inner details of how Hierarchical Mapping (HM) works;

FIGS. 135 and 136 are schematic diagrams showing the inner details of Rational Appeal (RA);

FIGS. 137 and 138 are schematic diagrams showing the inner details of Central Knowledge Retention (CKR);

FIG. 139 is a schematic diagram showing Automated Research Mechanism (ARM);

FIG. 140 is a schematic diagram showing Stylometric Scanning (SS);

FIG. 141 is a schematic diagram showing Assumptive Override System (AOS);

FIG. 142 is a schematic diagram showing Intelligent Information & Configuration Management (I²CM) and Management Console;

FIG. 143 is a schematic diagram showing Personal Intelligence Profile (PIP);

FIG. 144 is a schematic diagram showing shows Life Administration & Automation (LAA);

FIG. 145 is a schematic diagram showing Behavior Monitoring (BM);

FIG. 146 is a schematic diagram showing Ethical Privacy Legal (EPL);

FIG. 147 is a schematic diagram showing overview of the LIZARD algorithm;

FIG. 148 is a schematic diagram showing Iterative Intelligence Growth;

FIGS. 149 and 150 are schematic diagrams showing Iterative Evolution;

FIGS. 151 and 154 are schematic diagrams showing Creativity Module;

FIGS. 155 and 156 are schematic diagrams showing LOM being used as a Personal Assistant;

FIG. 157 is a schematic diagram showing LOM being used as a Research Tool;

FIGS. 158 and 159 are schematic diagrams showing LOM exploring the merits and drawbacks of a Proposed theory;

FIGS. 160 and 161 are schematic diagrams showing LOM performing Policy Making for foreign policy war games;

FIGS. 162 and 163 are schematic diagrams showing LOM performing Investigative Journalism tasks;

FIGS. 164 and 165 are schematic diagrams showing LOM performing Historical Validation;

FIGS. 166-179 are schematic diagrams showing a secure and efficient digitally-oriented language LAQIT; In detail:

FIG. 166 is a schematic diagram showing the concept of LAQIT;

FIG. 167 is a schematic diagram showing major types of usable languages;

FIGS. 168 and 169 are schematic diagrams showing the Linear mode of LAQIT;

FIGS. 170 and 171 are schematic diagrams showing the characteristics of Atomic Mode;

FIGS. 172-174 are schematic diagrams showing overview for the encryption feature of Atomic Mode;

FIGS. 175 and 176 are schematic diagrams showing the mechanism of Redirection Bonds;

FIGS. 177 and 178 are schematic diagrams showing the mechanism of Radioactive Elements; and

FIG. 179 is a schematic diagram showing Molecular Mode with Encryption and Streaming enabled;

FIGS. 180-184 are schematic diagrams showing a summary of the UBEC Platform and front end which connects to a decentralized information distribution system BCHAIN; In detail:

FIG. 180 is a schematic diagram showing a BCHAIN Node which contains and runs the BCHAIN Enabled Application;

FIG. 181 is a schematic diagram showing the Core Logic of the BCHAIN Protocol;

FIG. 182 is a schematic diagram showing Dynamic Strategy Adaptation (DSA) that manages Strategy Creation Module (SCM);

FIG. 183 is a schematic diagram showing Cryptographic Digital Economic Exchange (CDEE) with a variety of Economic Personalities

FIG. 184 is a schematic diagram showing Symbiotic Recursive Intelligence Advancement (SRIA).

### DETAILED DESCRIPTION OF THE INVENTION

### Critical Infrastructure Protection & Retribution (CIPR) Through Cloud & Tiered Information Security (CTIS)

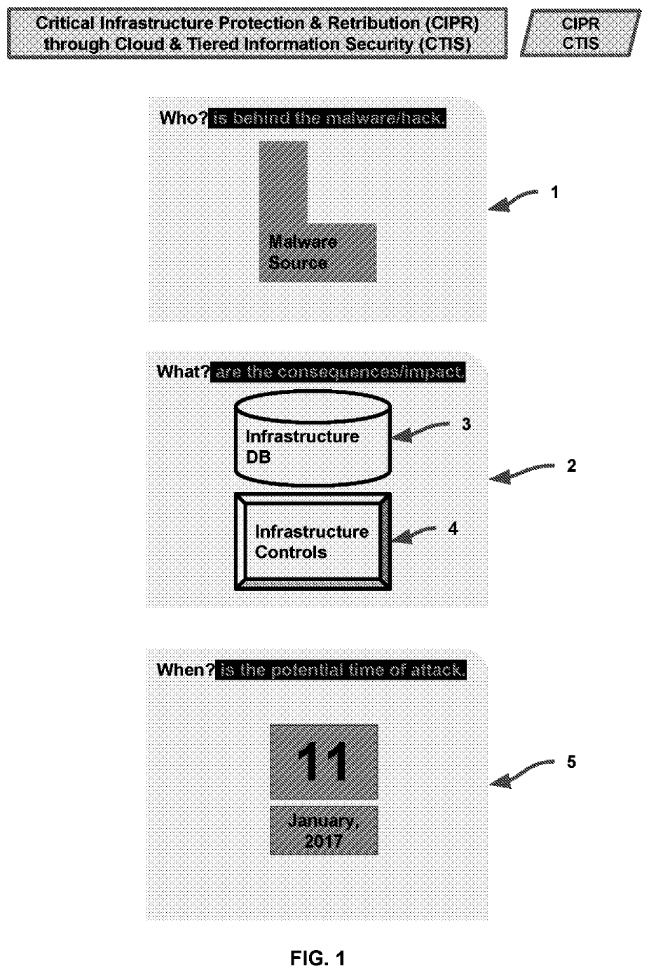

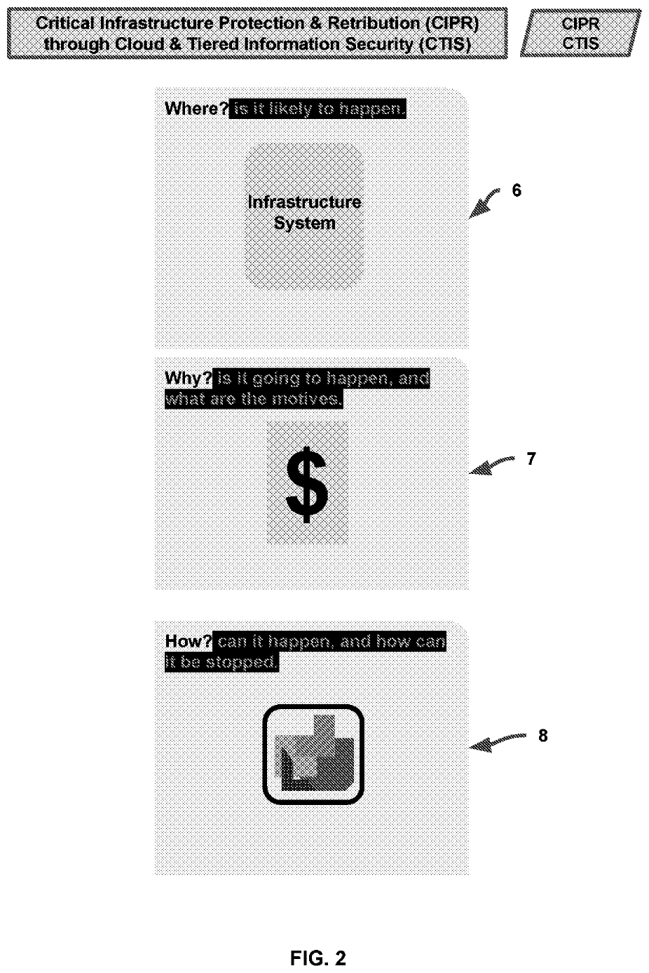

FIGS. 1-2 show how definitions for multiple angles of security interpretation are presented as a methodology for analysis. In reference numeral 1 an established network of beacons and agents are used to form a map of aggressors and bad actors. When such a map/database is paired with sophisticated predictive algorithms, potential pre-crime threats emerge. I²GE 21 leverages big data and malware signature recognition to determine the who factor. Security Behavior 20 storage forms a precedent of security events, their impact, and the appropriate response. Such an appropriate response can be criticized by CTMP 22 (Critical Thinking, Memory, Perception) as a supplemental layer of security. Reference Numeral 2 refers to what assets are at risk, what potential damage can be done. Example: A Hydroelectric dam can have all of it's floodgates opened which could eventually flood a nearby village and lead to loss of life and property. Infrastructure DB 3 refers to a generic database containing sensitive and nonsensitive information pertaining to a public or private company involved with national infrastructure work. Infrastructure Controls 4 potentially technical, digital, and/or mechanical means of controlling industrial infrastructure equipment such as dam flood gates, electric wattage on the national electric grid etc. In reference numeral 5 traffic patterns are analyzed to highlight times of potential blind spots. Such attacks could be easily masked to blend with and underneath legitimate traffic. The question is asked: are there are any political/financial/sporting/other events that may be a point of interest for bad actors. The Trusted Platform's network of external agents report back hacker activity and preparation. Therefore attack timing can be estimated. In reference numeral 6 the question is asked: Who are the more vulnerable enterprises that might be targeted for an attack. What types of enterprises might be vulnerable in given geographic locations. What are their most vulnerable assets/controls and what are the best means of protecting them. The Trusted Platform's network of external agents report back hacker activity and preparation. Therefore attack location can be estimated. In reference numeral 7 the question is asked: What geopolitical, corporate, and financial pressures exist in the world to facilitate the funding and abetting of such an attack. Who would benefit and by how much. The Trusted Platform's network of external agents report back hacker activity and preparation. Therefore attack motive can be estimated. In reference numeral 8 the question is asked: What are potential points of exploits and hiding spots for malware. How can such blind spots and under-fortified points of access be used to compromise critical assets and points of infrastructure control. LIZARD 16 can derive purpose and functionality from foreign code, and hence block it upon presence of malicious intent or absence of legitimate cause. CTMP 22 is able to think critically about block/approval decisions and acts as a supplemental layer of security.

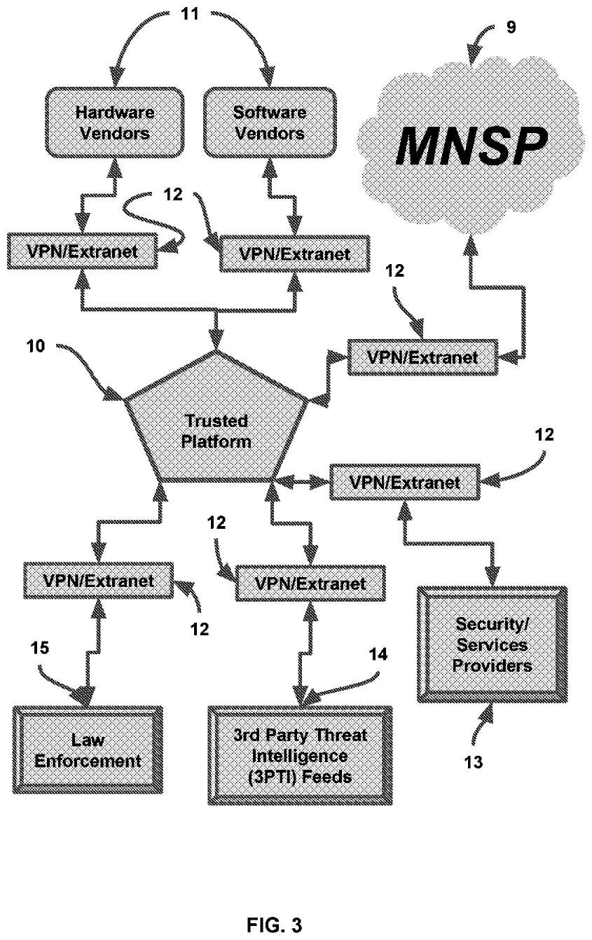

FIG. 3 shows the Cloud based Managed Encrypted Security Service Architecture for Secure EI² (Extranet, Intranet, Internet) Networking. Managed Network & Security Services Provider (MNSP) 9 provides Managed Encrypted Security, Connectivity & Compliance Solutions & Services to critical infrastructure industry segments: Energy, Chemical, Nuclear, Dam, etc. Trusted Platform 10 is a congregation of verified companies and systems that mutually benefit from each other by sharing security information and services. Hardware & Software Vendors 11 are industry recognized manufacturers of hardware/software (i.e. Intel, Samsung, Microsoft, Symantec, Apple etc.). In this context they are providing the Trusted Platform 10 any potential means of access and/or exploitation to their products that enable backdoor access in a limited or full capacity. This has been enabled for potential security and/or retributive processes that the Trusted Platform may, in collaboration with its partners and joint security division, want to enact. Virtual Private Network (VPN) 12 is an industry standard technology that enables secure and logistically separate communication between the MNSP 9, Trusted Platform, and their associated partners. The Extranet allows digital elements to be virtually shared as if they were in the same local vicinity (i.e. LAN). Hence the combination of these two technologies promotes efficient and secure communication between partners to enhance the operation of the Trusted Platform. Security Service Providers 13 is a collection of public and/or private companies that offer digital security strategies and solutions. Their solutions/products have been organized contractually so that the Trusted Platform is able to benefit from original security information (i.e. new malware signatures) and security analysis. Such an increase in security strength in turn benefits the Security Service Providers themselves as they have access to additional security tools and information. Third Party Threat Intelligence (3PTI) Feeds 14 is the mutual sharing of security information (i.e. new malware signatures). The Trusted Platform acts as a centralized hub to send, receive and assimilate such security information. With multiple feeds of information more advanced patterns of security related behavior (by leveraging Security Service Providers) can be obtained via analytical modules that discern information collaboration (i.e. Conspiracy Detection 19). Law Enforcement 15 refers to the relevant law enforcement division whether it be state (i.e. NYPD), national (i.e. FBI), or international (i.e. INTERPOL). Communication is established to receive and send security information to facilitate or accomplish retribution against criminal hackers. Such retribution typically entails locating and arresting the appropriate suspects and trying them in a relevant court of law.

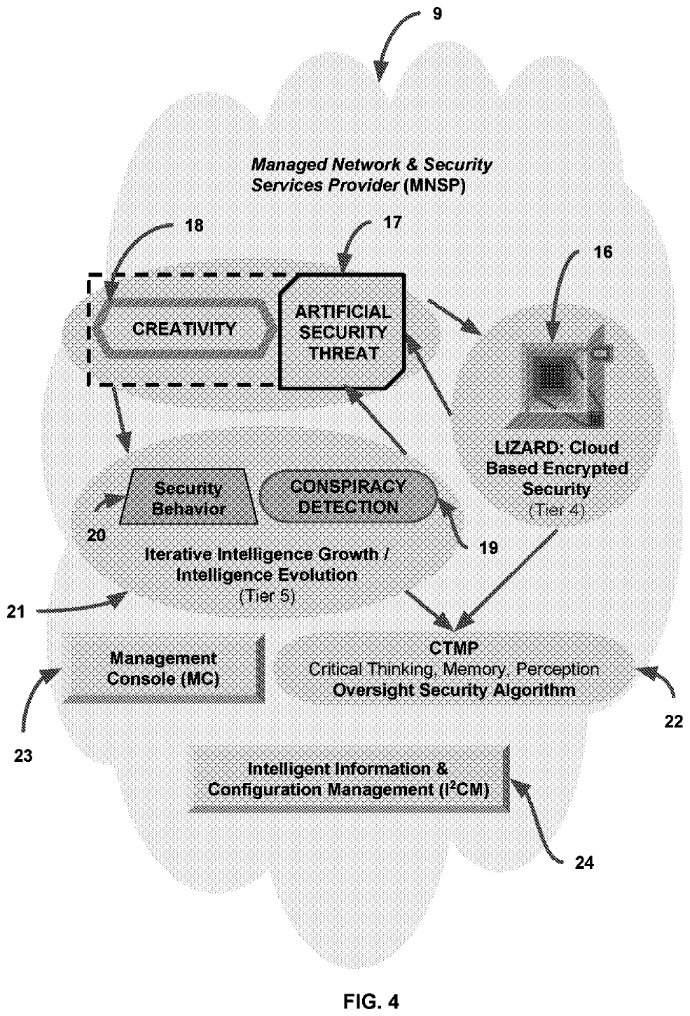

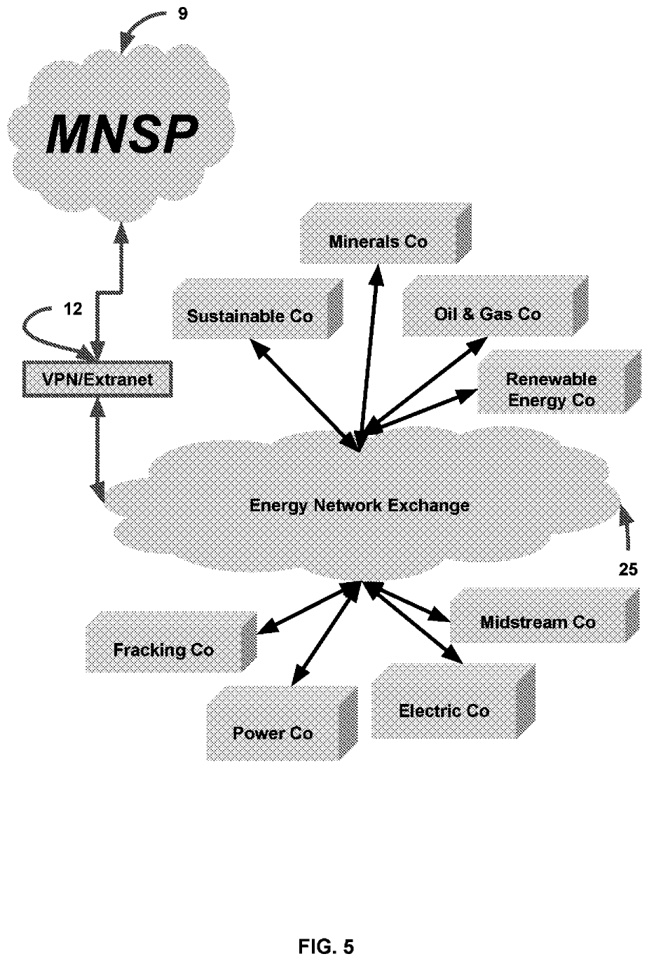

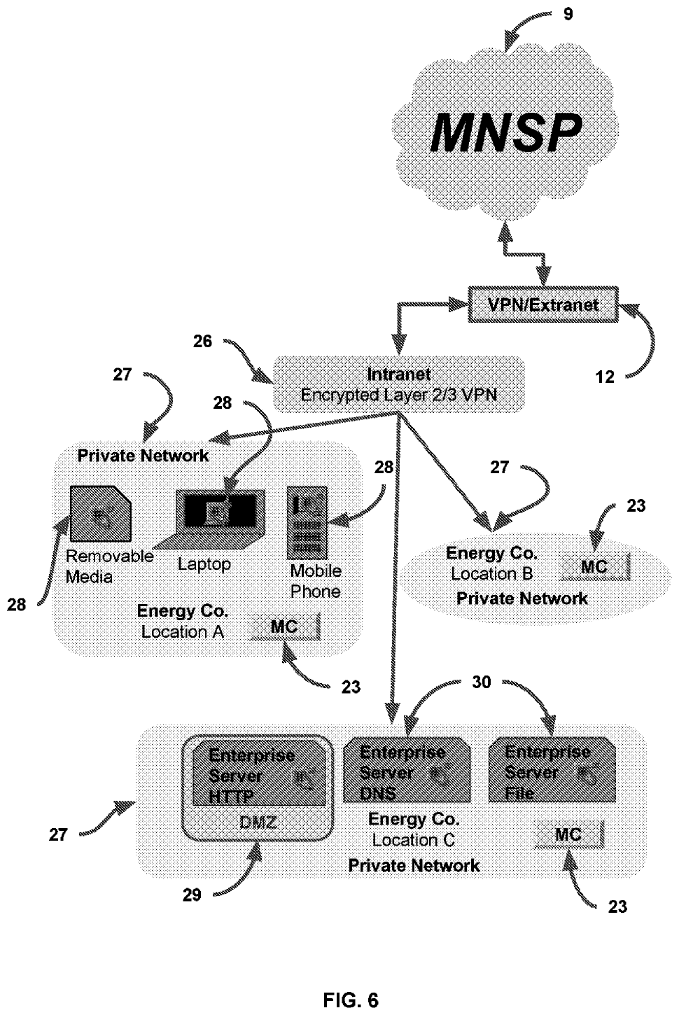

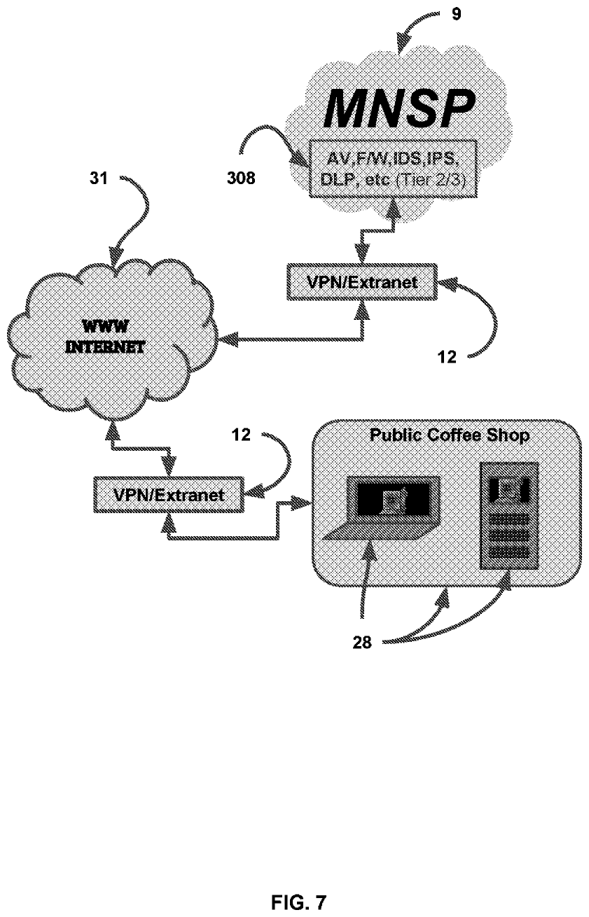

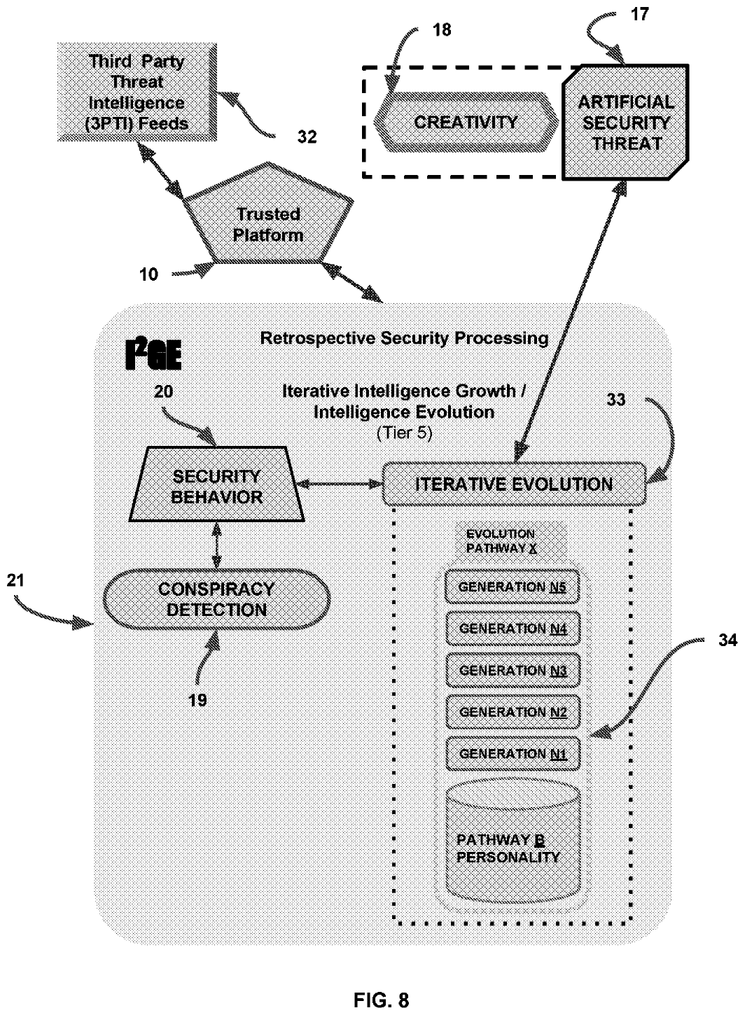

FIGS. 4-8 show an overview of the Managed Network & Security Services Provider (MNSP) 9 and internal submodule relationships. LIZARD 16 analyzes threats in and of themselves without referencing prior historical data. Artificial Security Threat (AST) 17 provides a hypothetical security scenario to test the efficacy of security rulesets. Security threats are consistent in severity and type in order to provide a meaningful comparison of security scenarios. Creativity Module 18 performs the process of intelligently creating new hybrid forms out of prior forms. Used as a plug in module to service multiple algorithms. Conspiracy Detection 19 provides a routine background check for multiple ‘conspiratorial’ security events, and attempts to determine patterns and correlations between seemingly unrelated security events. Security Behavior 20: Events and their security responses and traits are stored and indexed for future queries. I²GE 21 is the big data, retrospective analysis branch of the MNSP 9. Among standard signature tracking capabilities, it is able to emulate future potential variations of Malware by leveraging the AST with the Creativity Module. CTMP 22 leverages cross-references intelligence from multiple sources (i.e. I²GE, LIZARD, Trusted Platform, etc.) and learns about expectations of perceptions and reality. CTMP estimates it's own capacity of forming an objective decision on a matter, and will refrain from asserting a decision made with internal low confidence. Management Console (MC) 23 is an intelligent interface for humans to monitor and control complex and semi-automated systems. Intelligent Information & Configuration Management (I²CM) 24 contains an assortment of functions that control the flow of information and authorized system leverage.

The Energy Network Exchange 25 is a large private extranet that connects Energy Suppliers, Producers, Purchasers, etc. This enables them to exchange security information pertaining to their common industry. The Energy Network Exchange then communicates via VPN/Extranet 12 to the MNSP Cloud 9. Such cloud communications allows for bidirectional security analysis in that 1) Important security information data is provided from the Energy Network Exchange to the MNSP cloud and 2) Important security corrective actions are provided from the MNSP cloud to the Energy Network Exchange. All EI² (Extranet, Intranet, Internet) networking traffic of Energy Co. is always routed via VPN 12 to the MNSP cloud. Certification & encryption utilized by the MNSP for all services is in compliance with national (country specific e.g., FedRAMP, NIST, OMB, etc.) & international (ETSI, ISO/IEC, IETF, IEEE, etc.) standards, and encryption requirements (e.g., FIPS, etc.). The Intranet 26 (Encrypted Layer % VPN) maintains a secure internal connection within enterprise (Energy Co.) Private Networks 27. This allows the LIZARD Lite Client 43 to operate within enterprise infrastructure whilst being able to securely communicate with LIZARD Cloud 16 the exists in the MNSP Cloud 9. Reference numeral 27 represents a local node of a private network. Such private networks exist offer multiple locations (labelled as Locations A, B, and C). Different technology infrastructure setups can exist within each private network, such as a server cluster (Location C) or a shared employee's office with mobile devices and a private WiFi connection (Location A). Each node of a private network has it's own Management Console (MC) 23 assigned. Portable Media Devices 28 are configured to securely connect to the private network and hence by extension the Intranet 26, and hence they are indirectly connected to the MNSP 9 via a secure VPN/Extranet connection 12. In using this secure connection, all traffic is routed via the MNSP for maximal exposure to deployed realtime and retrospective security analysis algorithms. Such portable devices can maintain this secure connection whether it be from inside a secured private network or a public coffee shop's WiFi access. The Demilitarized Zone (DMZ) 29 is a subnetwork which contains an HTTP server which has a higher security liability than a normal computer. The security liability of the server is not out of security negligence, but because of the complex software and hardware makeup of a public server. Because so many points of potential attack exist despite best efforts to tighten security, the server is placed in the DMZ so that the rest of the private network (Location C) is not exposed to such a security liability. Due to this separation, the HTTP server is unable to communicate with other devices inside the private network that are not inside the DMZ. The LIZARD Lite Client 43 is able to operate within the DMZ due to it's installation on the HTTP server. An exception is made in the DMZ policy so that MC 23 can access the HTTP server and hence the DMZ. The Lite client communicates with the MNSP via the encrypted channels formed from events 12 and 26. In reference numeral 30 these servers are isolated in the private network yet are not submerged in the DMZ 29. This allows for inter-communication of devices within the private network. They each have an independent instance of the LIZARD Lite Client 43 and are managed by MC 23. Internet 31 is referenced in relation to its being a medium of information transfer between the MNSP 9 and Enterprise Devices 28 that are running the LIZARD Lite client. The internet is the most risk-prone source of security threats to the enterprise device, as opposed to a locally situation threat originating from the Local Area Network (LAN). Because of the high security risks, all information transfer on individual devices are routed to the MNSP like a proxy. Potential bad actors from the internet will only be able to see encrypted information due to the VPN/Extranet structure 12 in place. Third Party Threat Intelligence (3PTI) Feeds 32 represent custom tuned information inputs provided by third parties and in accordance with pre-existing contractual obligations. Iterative Evolution 33: parallel evolutionary pathways are matured and selected. Iterative generations adapt to the same Artificial Security Threats (AST), and the pathway with the best personality traits ends up resisting the security threats the most. Evolutionary Pathways 34: A virtually contained and isolated series of ruleset generations. Evolutionary characteristics and criterion are defined by such Pathway Personality X.

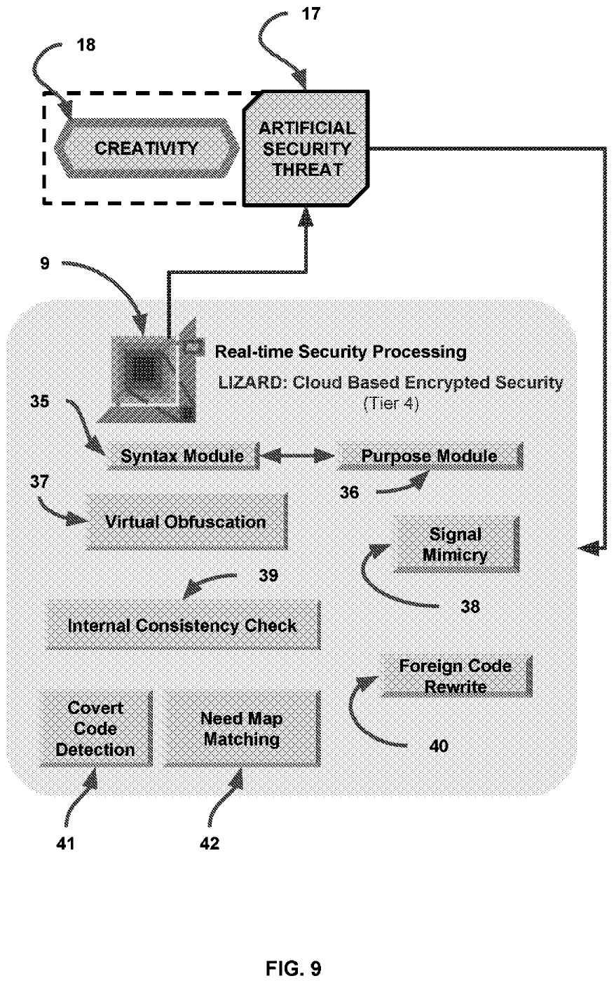

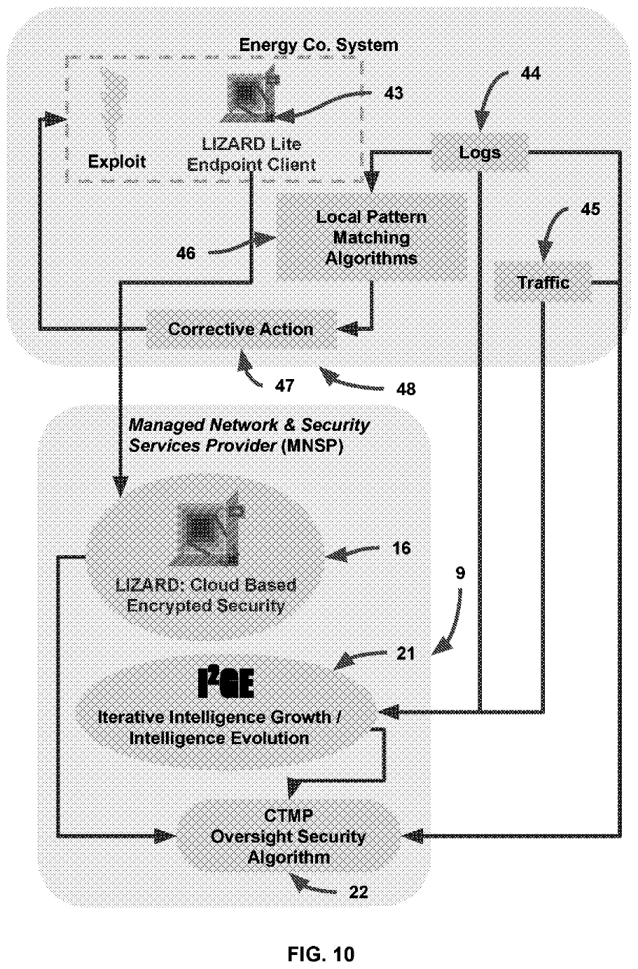

FIG. 9 shows Realtime Security Processing in regards to LIZARD Cloud Based Encrypted Security. Syntax Module 35 provides a framework for reading & writing computer code. For writing; receives a complex formatted purpose from PM, then writes code in arbitrary code syntax, then a helper function can translate that arbitrary code to real executable code (depending on the desired language). For reading; provides syntactical interpretation of code for PM to derive a purpose for the functionality of such code. Purpose Module 36 uses Syntax Module 35 to derive a purpose from code, & outputs such a purpose in it's own ‘complex purpose format’. Such a purpose should adequately describe the intended functionality of a block of code (even if that code was covertly embedded in data) as interpreted by SM. Virtual Obfuscation 37 the enterprise network and database is cloned in a virtual environment, and sensitive data is replaced with mock (fake) data. Depending on the behavior of the target, the environment can by dynamically altered in real time to include more fake elements or more real elements of the system at large. Signal Mimicry 38 provides a form of Retribution typically used when the analytical conclusion of Virtual Obfuscation (Protection) has been reached. Signal Mimicry uses the Syntax Module to understand a malware's communicative syntax with it's hackers. It then hijacks such communication to give malware the false impression that it successfully sent sensitive data back to the hackers (even though it was fake data sent to a virtual illusion of the hacker). The real hackers are also sent the malware's error code by LIZARD, making it look like it came from the malware. This diverts the hacker's time and resources to false debugging tangents, and eventually abandoning working malware with the false impression that it doesn't work. Internal Consistency Check 39 checks that all the internal functions of a foreign code make sense. Makes sure there isn't a piece of code that is internally inconsistent with the purpose of the foreign code as a whole. Foreign Code Rewrite 40 uses the Syntax and Purpose modules to reduce foreign code to a Complex Purpose Format. It then builds the codeset using the derived Purpose. This ensures that only the desired and understood purpose of the foreign code is executed within the enterprise, and any unintended function executions do not gain access to the system. Covert Code Detection 41 detects code covertly embedded in data & transmission packets. Need Map Matching 42 is a mapped hierarchy of need & purpose and is referenced to decide if foreign code fits in the overall objective of the system. LIZARD Lite Client 43 is a lightweight version of the LIZARD program which omits resource heavy functions such as Virtual Obfuscation 208 and Signal Mimicry. It performs instantaneous and realtime threat assessment with minimal computer resource usage by leveraging an objective a priori threat analysis that does not use a signature database for reference. With Logs 44 the Energy Co. System 48 has multiple points of log creation such as standard software error/access logs, operating system logs, monitoring probes etc. These logs are then fed to Local Pattern Matching Algorithms 46 and CTMP 22 for an in depth and responsive security analysis. With Traffic 45 all internal and external traffic that exists in the Energy Co. Local Pattern Matching Algorithms 46 consist of industry-standard software that offers an initial layer of security such as anti-viruses, adaptive firewalls etc. Corrective Action 47 is to be undertaken by the Local Pattern Matching Algorithm 46 that is initially understood to solve the security problem/risk. This may include blocking a port, a file transfer, an administrative function request etc. The energy corporation has it's System 48 isolated from the specialized security algorithms that it sends its logs and traffic information too. This is because these algorithms, LIZARD 16, I²GE 21, and CTMP 22 are based in the MNSP Cloud 9. This separation occurs to offer a centralized database model, which leads to a larger pool of security data/trends and hence a more comprehensive analysis.

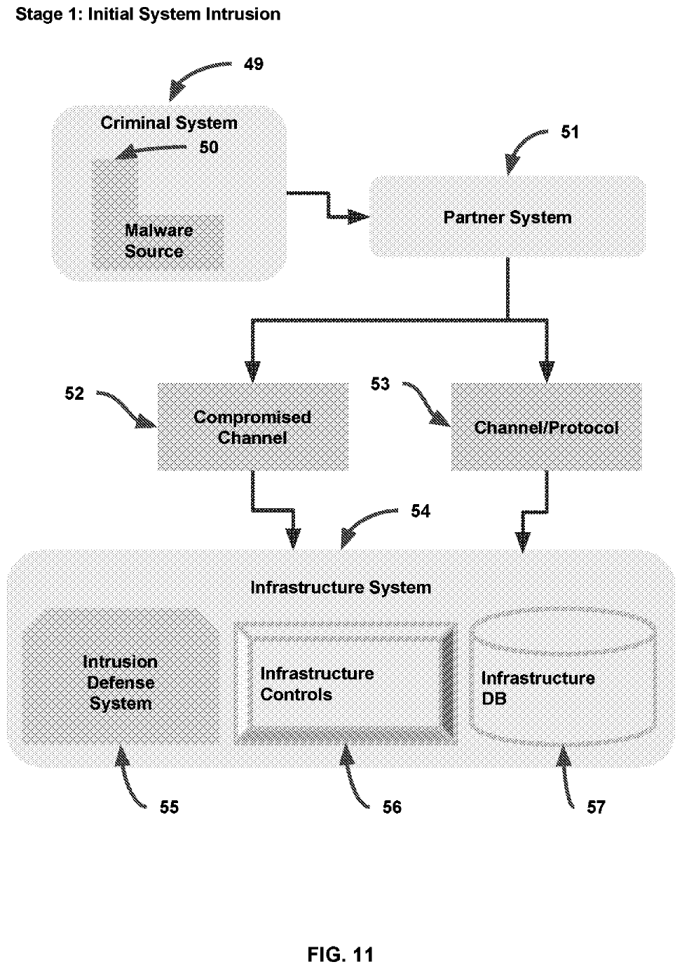

With FIG. 11 the Criminal System scans for an exploitable channel of entry into the target system. If possible it compromises the channel for delivering a small payload. The Criminal System 49 is used by the rogue criminal party to launch a malware attack to the Partner System 51 and hence eventually the Infrastructure System 54. The malware source 50 is the container for the non-active form of the malicious code (malware). Once the code eventually reaches (or attempts to reach) the targeted Infrastructure System 54, the malware is activated to perform its prescribed or on-demand malicious tasks. The Partner System 51 interacts with the infrastructure system as per the contractual agreement between the infrastructure company (Energy Co.) and the partner company. Such an agreement reflects some sort of business interest, such as a supply chain management service, or an inventory tracking exchange. To fulfill the agreed upon services, the two parties interact electronically as per previously agreed upon security standards. The Malware Source 50, on behalf of the malicious party that runs the Criminal System 49, attempts to find an exploit in the partner system for infiltration. This way the malware can get to it's final goal of infection which is the Infrastructure System 54. This way the partner system has been used in a proxy infection process originating for the Malware Source 50. Out of the many channels of communication between the Partner System 51 and the Infrastructure System 54, this channel 52 has been compromised by the malware which originated from the malware source 50. With Channel/Protocol 53: shows a channel of communication between the Partner System 51 and the Infrastructure System 54 which has not been compromised. Such channels can include file system connections, database connections, email routing, VOIP connections etc. The Infrastructure System 54 is a crucial element of Energy Co.'s operation which has direct access to the infrastructure DB 57 and the infrastructure controls 56. An industry-standard Intrusion Defense System 55 is implemented as a standard security procedure. The Infrastructure Controls 56 are the digital interface that connects to energy related equipment. For example, this could include the opening and closing of water flow gates in a hydroelectric dam, the angle which an array of solar panels are pointing towards etc. The infrastructure database 57 contains sensitive information that pertains to the core operation of the infrastructure system and Energy Co. at large. Such information can include contact information, employee shift tracking, energy equipment documentation and blueprints etc.

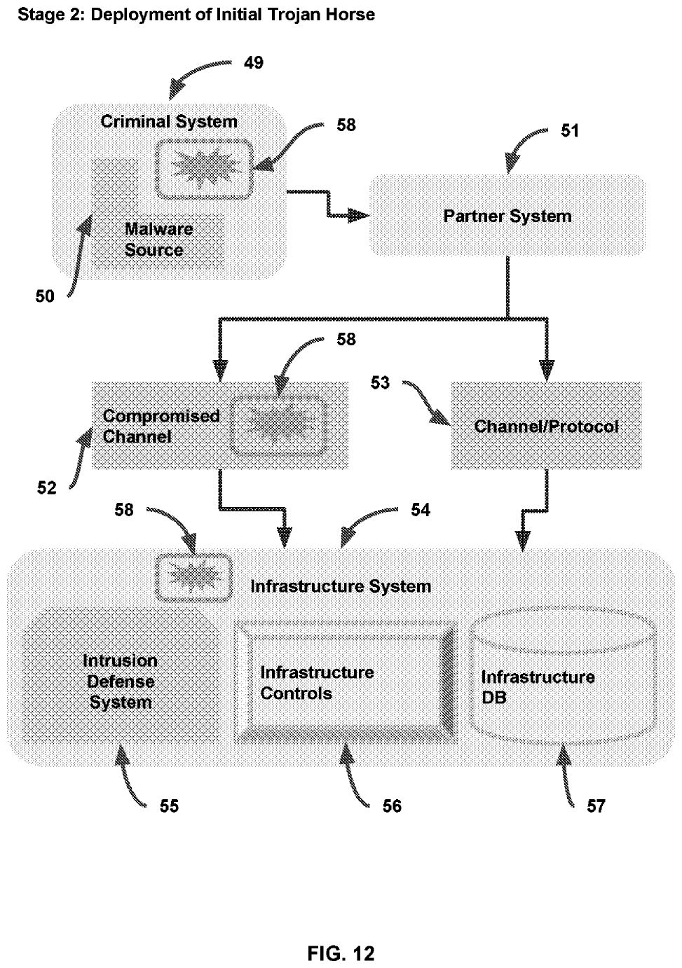

With FIG. 12 the Compromised Channel 52 offers a very narrow window of opportunity for exploitation, hence a very simple Trojan Horse is uploaded onto the target system to expand the exploitation opportunity. A Trojan Horse 58 originates from the Malware Source 50, travels through the Compromised Channel 52 and arrive at it's target the infrastructure system 54. It's purpose is to open up opportunities afforded by exploits so that the advanced executable malware payload (which is more complex and contains the actual malicious code that steals data etc.) can be installed on the target system.

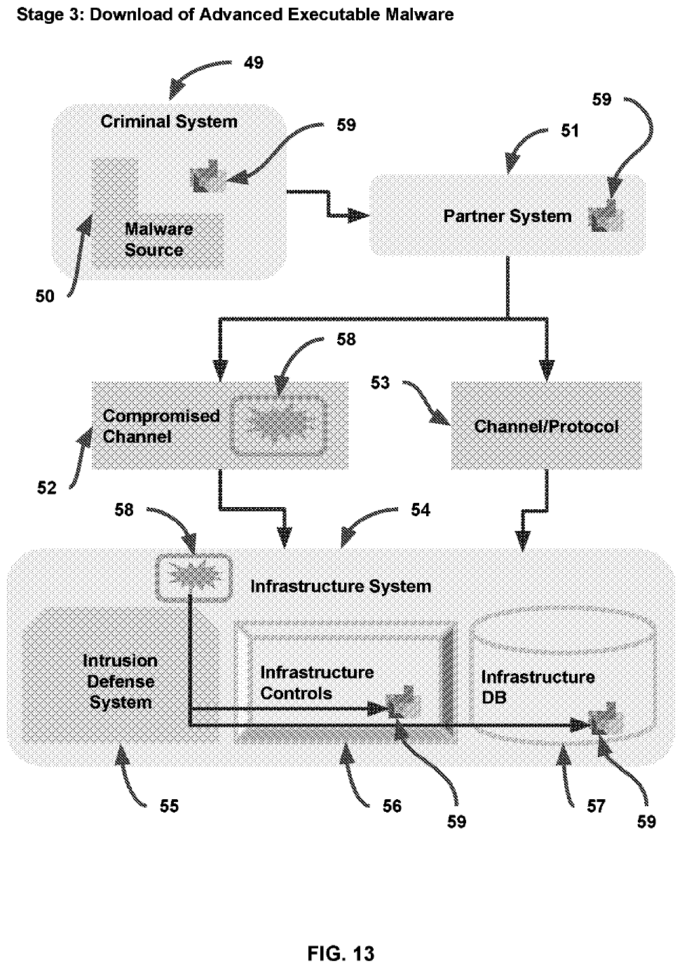

FIG. 13 shows how after the trojan horse further exploits the system, a large executable malware package is securely uploaded onto the system via the new open channel created by the Trojan Horse. The Advanced Executable Malware 59 is transferred to the Infrastructure System 54 and hence the sensitive database 57 and controls 56. The advanced executable malware uses the digital pathway paved by the previous exploits of the trojan horse to reach it's destination.

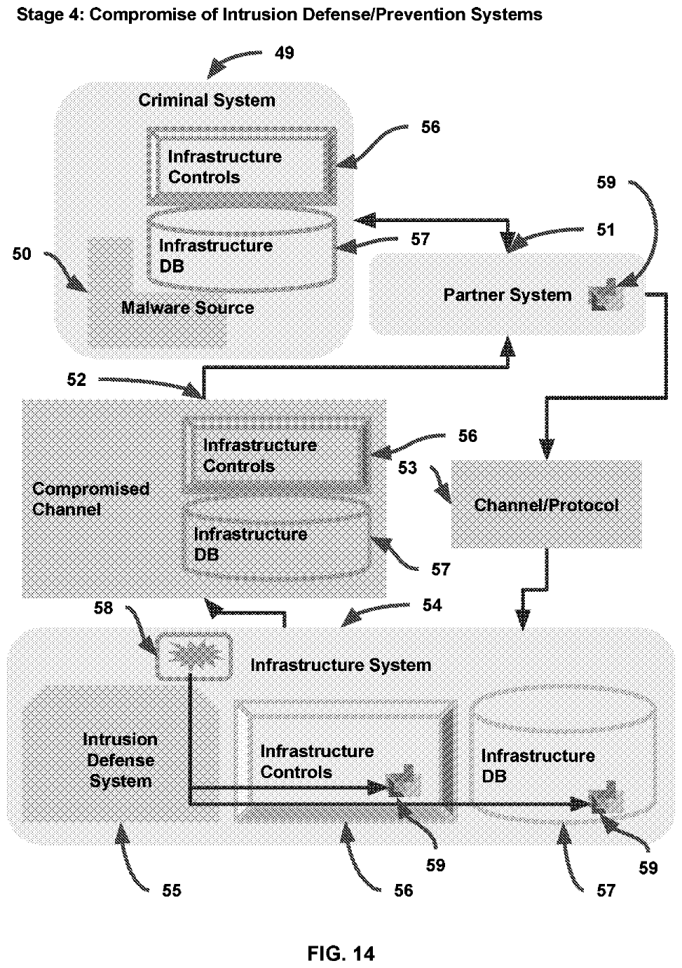

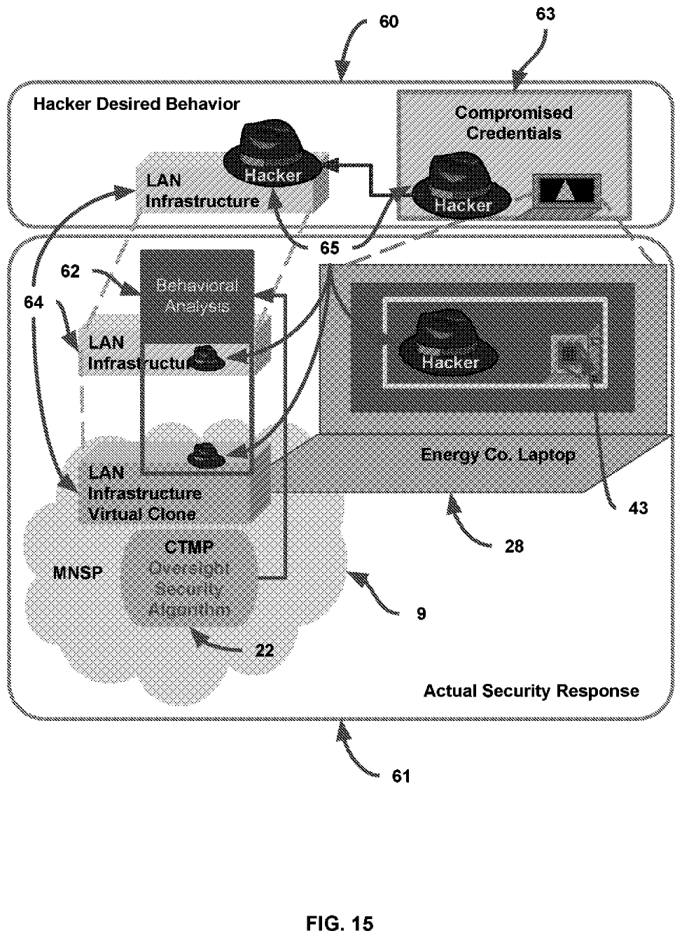

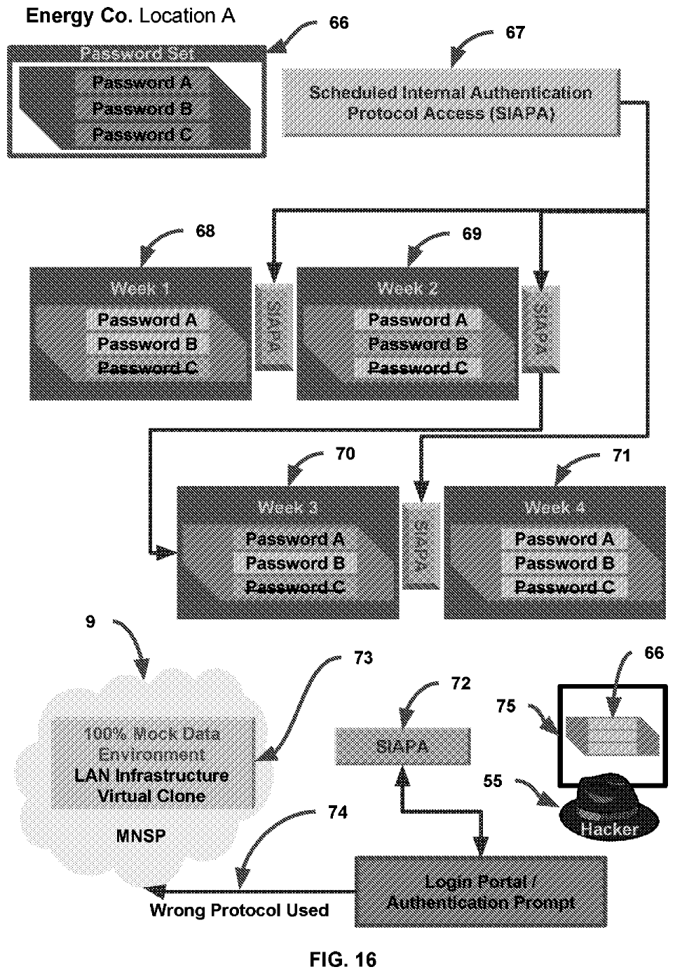

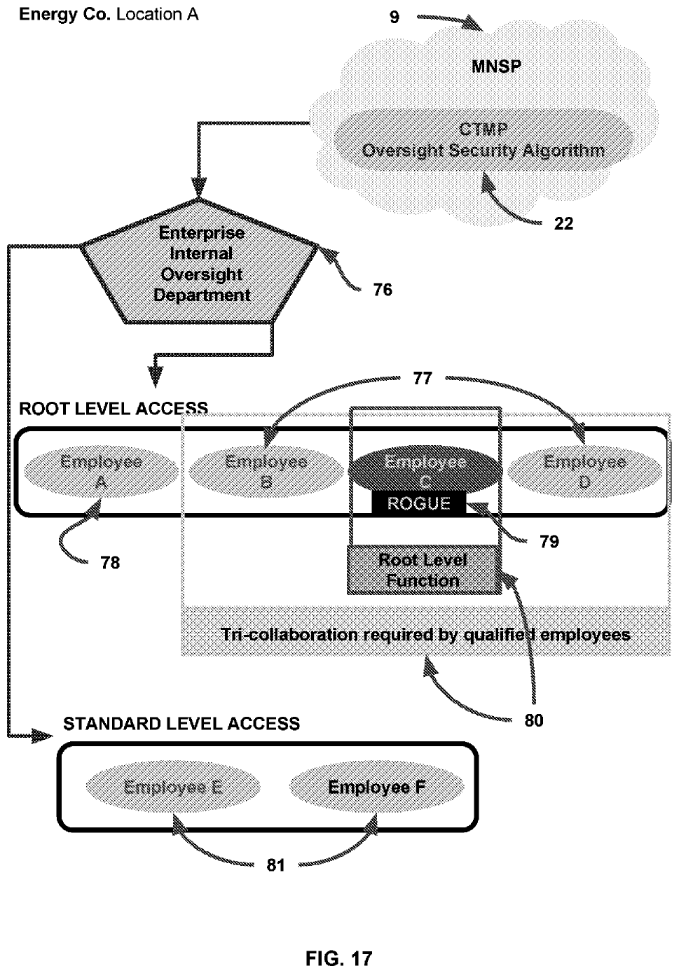

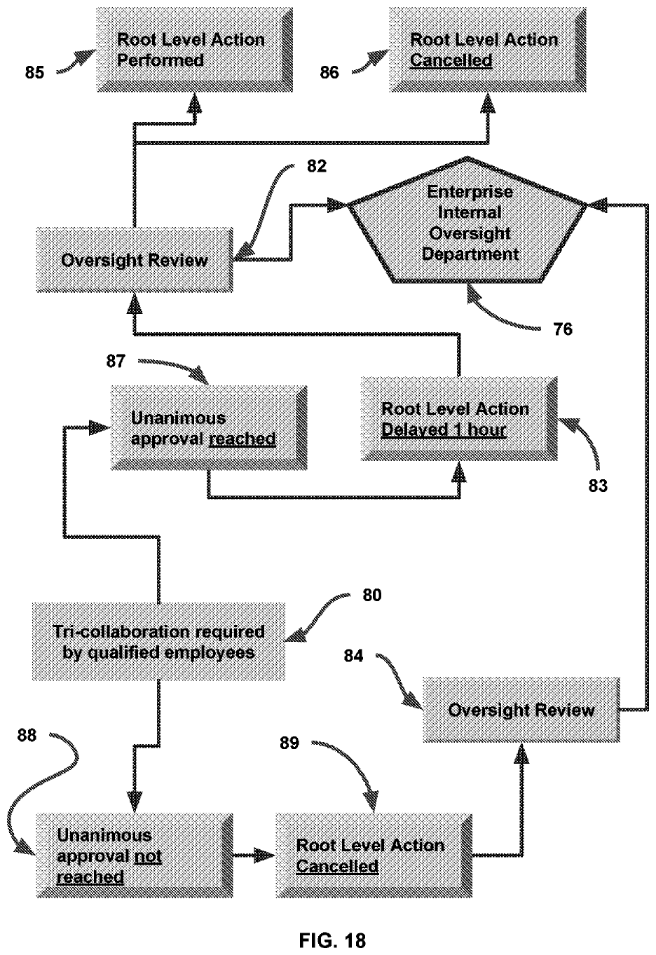

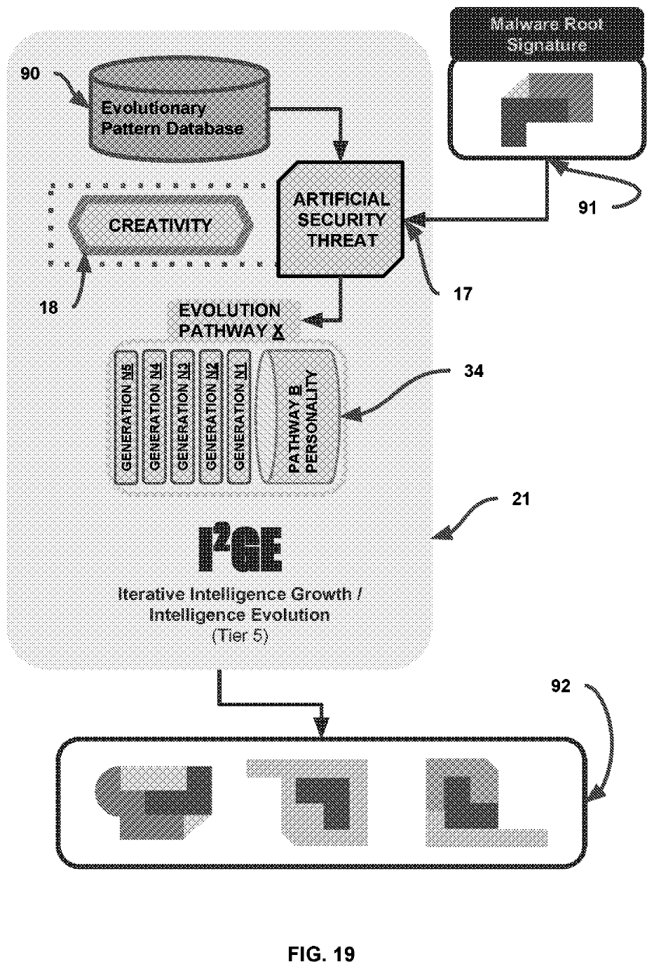

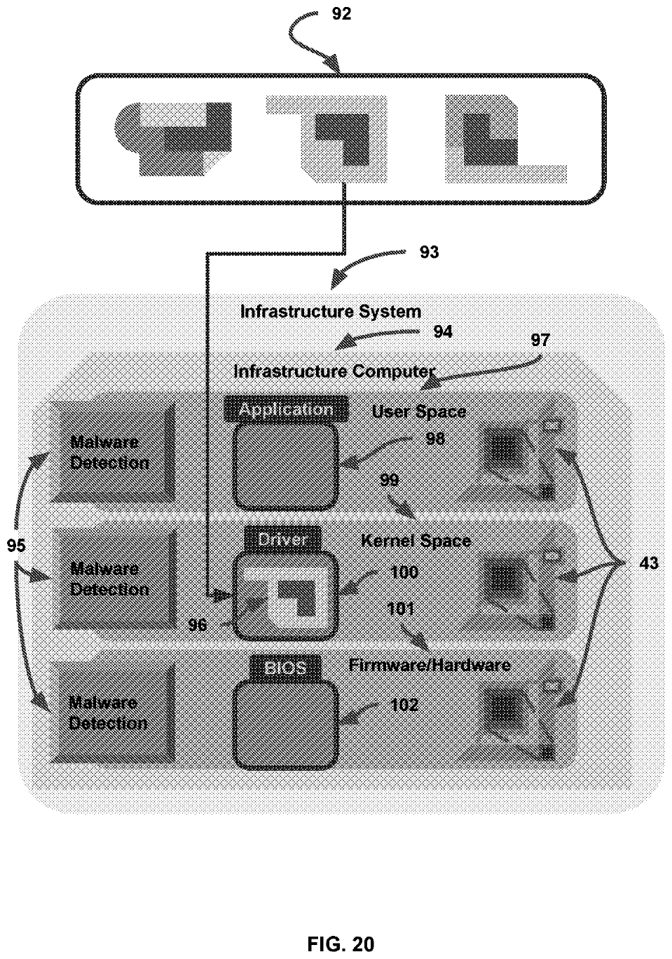

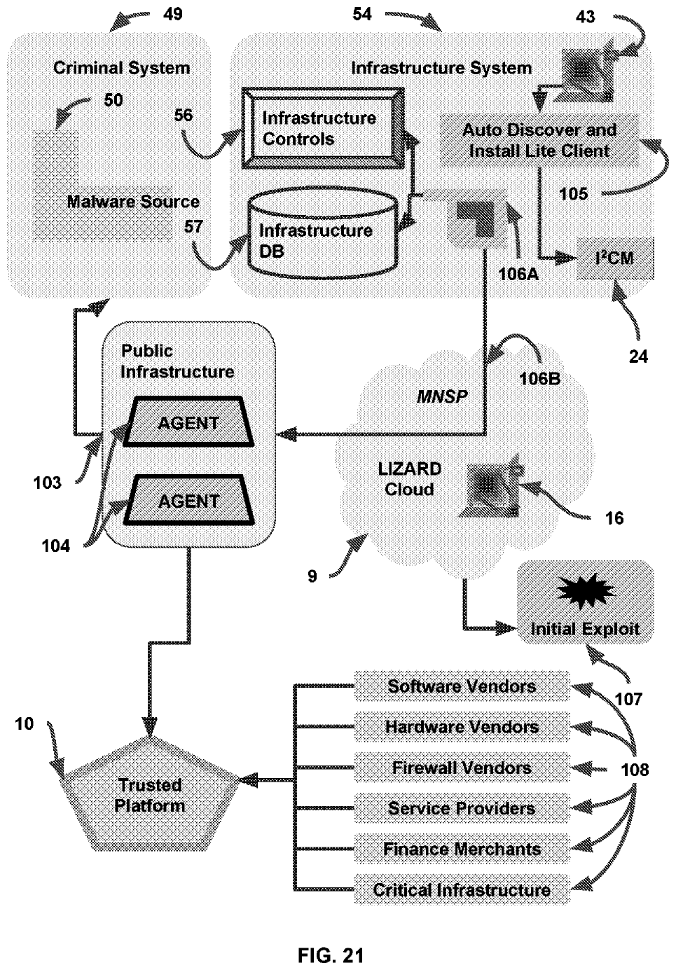

FIG. 14 shows how the Advanced Executable Malware 50 compromises the IDS so that sensitive infrastructure information and points of control can be discretely downloaded onto the Criminal System undetected. Hacker Desired Behavior 60, the Hacker 65 has managed to get ahold of trusted credentials of a company employee with legitimately authorized access credentials. The Hacker intends on using such credentials to gain discreet and inconspicuous access to the LAN that is intended for employee usage only. The Hacker intends on out-maneuvering a typical “too little, too late” security response. Even if the endpoint security client manages to relay data to a cloud security service, a retrospectively analytical security solution will only be able to manage damage control as opposed to eliminating and managing the threat from the initial intrusion in real-time. With Actual Security Response 61 the LIZARD Lite client (for endpoint usage) is unable to unequivocally prove the need, function and purpose of the credential login and system access usage. Since it is still unknown if this is truly the intended and legitimate user of the credentials or not, the user is placed in a partially virtualized/mock environment. Such an environment can dynamically alter the exposure to sensitive data in real-time as the user's behavior is analyzed. Behavioral Analysis 62 is performed on the Hacker 65 based on the elements he interacts with that exist both on the real and virtually cloned LAN infrastructure 64. With Compromised Credentials 63 the hacker has obtained access credentials that grant him admin access to the Energy Co. Laptop 28 and hence the LAN Infrastructure 64 which the laptop is configured to connect to. These credentials could have been compromised in the first place due to intercepting unencrypted emails, stealing an unencrypted enterprise device that has the credentials stored locally etc. LAN infrastructure 64 represents a series of enterprise devices that are connected via a local network (wired and/or wireless). This can include printers, servers, tablets, phones etc. The entire LAN infrastructure is reconstructed virtually (virtual router IP assignment, virtual printer, virtual server etc.) within the MNSP Cloud 9. The hacker is then exposed to elements of both the real LAN infrastructure and the virtual clone version as the system performs behavioral analysis 62. If the results of such analysis indicates risk, then the hacker's exposure to the fake infrastructure (as opposed to the real infrastructure) is increased to mitigate the risk of real data and/or devices becoming compromised. Hacker 65 is a malicious actor that intends on accessing and stealing sensitive information via an initial intrusion enabled by Compromised Credentials 63. With Password Set 66, authentication access is assigned with a set of three passwords. The passwords are never stored individually, and always come as a set. The employee must enter a combination of the three passwords according to the temporarily assigned protocol from SIAPA. With Scheduled Internal Authentication Protocol Access (SIAPA) 67, the authentication protocol for an individual employee's login portal is altered on a weekly/monthly basis. Such a protocol can be the selection of Passwords A and C from a set of passwords A, B, and C (which have been pre-assigned for authentication). By scheduling the authentication alteration on a consistent basis (every Monday or first day of the month), the employees will have gotten accustomed to switching authentication protocols which will minimize false positive events (when a legitimate employee uses the old protocol and gets stuck in a Mock Data Environment 394). To offset the risks of the new protocol being compromised by a hacker, the employee is only able to view their new protocol once before it is destroyed and unavailable for reviewing. The first and only viewing requires special multi-factor authentication such as biometric/retina/sms to phone etc. The employee is only required to memorize one or two letters, which represent which of the three passwords he is supposed to enter. Referring to Week 1 68, entering anything except only Passwords A and B will trigger a Mock Data Environment 394. Referring to Week 2 69, entering anything except only Passwords A and C will trigger a Mock Data Environment. Referring to Week 3 70, entering anything except only Password B will trigger a Mock Data Environment. Referring to Week 4 71, entering anything except all the passwords will trigger a Mock Data Environment. At SIAPA 72 the authentication protocol is kept secret, only anyone who was able to access the temporary announcement knows the correct protocol. In LAN Infrastructure Virtual Clone 73, because the Hacker 65 entered all three passwords instead of omitting the correct one, he is silently transferred into a duplicate environment in the MNSP Cloud 9 that contains no important data or functions. Forensic evidence and behavioral analysis is gathered whilst the hacker believes he has successfully infiltrated the real system. Referring to case scenario ‘Wrong Protocol Used’ 74, the hacker did not use the correct protocol because there was no way for him to know it, let alone the hacker did not even expect there to be a special protocol of omitting a specific password. At reference numeral 75, the hacker has managed to steal legitimate credentials and intends on logging into the company system to steal sensitive data. Enterprise Internal Oversight Department 76 comprises of an administrative committee as well as a technical command center. It is the top layer for monitoring and approving/blocking potentially malicious behavior. Employees B and D 77 are not rogue (they are exclusively loyal to the interests of the enterprise) and have been selected as qualified employees for a tri-collaboration of the approval of a Root Level Function 80. Employee A 78 has not been selected for the tri-collaboration process 80. This could be because he did not have sufficient work-experience with the company, technical experience, a criminal record, or he was too much of a close friend to the other employees which might have allowed for a conspiracy against the company etc. Employee C (Rogue) 79 attempts to access a root level function/action to be performed for malicious purposes. Such a Root Level Function 80 cannot be performed without the consent and approval of three employees with individual root level access. All three employees are equally liable for the results of such a root level function being performed, despite Employee C being the only one with malicious intentions. This induces a culture of caution and skepticism, and heavily deters employees from malicious behavior in the first place due to foreknowledge of the procedure. Employees E and F 81 have not been selected for the tri-collaboration process 80 as they do not have root level access to perform nor approve the requested root level function in the first place. Oversight Review 82 uses the time afforded by the artificial delay to review and criticize the requested action. The Root Level Action 83 is delayed by 1 hour to grant the Oversight department an opportunity to review the action and explicitly approve or block the action. Policy can define a default action (approve or decline) incase the Oversight department was unable or unavailable to make a decision. Oversight Review 84 determines what was the reasoning for why a unanimous decision was not achieved. Referring to Root Level Action Performed 85, upon passing the collaboration and oversight monitoring system, the root level action is performed whilst securely maintaining the records for who approved what. This way, a detailed investigation can be launched if the root level action turned out to be against the best interests of the company. At reference numeral 86 the root level action has been cancelled due to the tri-collaboration failing (unanimous decision not reached). At reference numeral 87, all three of the selected employees that have root level access have unanimously approved a root level action. If the root level action is in fact malicious, it would have needed all three employees to be part of the conspiracy against the company. Because of this unlikely yet still existing possibility, the root level action is delayed for 1 hour 83 and the oversight department is given the opportunity to review it (see reference numerals 76 and 82). At reference numeral 88, one or more of the qualified employees that have been selected for tri-collaboration has/have rejected the requested root level action. Hence the root level action itself is cancelled 89 and the Root Level Action 89 has been cancelled because a unanimous decision was not reached. The Evolutionary Pattern Database 90 contains previously discovered and processed patterns of security risks. These patterns enumerate the potential means of evolving a current malware state may transform into. The Malware Root Signature 91 is provided to the AST 17 so that iterations/variations of the Signature 91 can be formed. Polymorphic Variations 92 of malware are provided as output from I²GE and transferred to Malware Detection systems 95. The Infrastructure System 93 physically belongs within the infrastructure's premises. This system typically manages an infrastructural function like a hydroelectric plant, power grid etc. Infrastructure Computer 94 is the specific computer that performs a function or part of a function that enables the infrastructural function from System 93 to be performed. Malware Detection Software 95 is deployed on all three levels of the computer's composition. This includes User Space 97, Kernel Space 99 and Firmware/Hardware Space 101. This corresponds with the malware detection deployment performed on Lizard Lite agents which are deployed exclusively to each of the three levels. A form of Malware 96 which has been iterated via the Evolution Pathway 34 is found in a driver (which exists within the Kernel Space 99). User Space 97 is for mainstream developer applications. The easiest space to infiltrate with malware, yet also the easiest space to detect and quarantine malware. All User Space activity is efficiently monitored by LIZARD Lite. Applications 98 within the User Space can include programs like Microsoft Office, Skype, Quicken etc. Kernel Space 99 that is mostly maintained by Operating System vendors, like Apple, Microsoft, and the Linux Foundation. Harder to infiltrate than User Space, but the liability mostly belongs to the vendor unless the respective Infrastructure has undergone kernel modification. All Kernel Activity (including registry changes (Microsoft OS), memory management, network interface management etc) is efficiently monitored by LIZARD lite. Driver 100 that enable the Infrastructure Computer 94 to interact with peripherals and hardware (mouse, keyboard, fingerprint scanner etc. Firmware/Hardware Space 101 is entirely maintained by the Firmware/Hardware vendors. Extremely difficult for malware to infect without direct physical access to the hardware (i.e., removing the old BIOS chip from the motherboard and soldering on a new one). Some firmware activity is monitored by LIZARD Lite, depending on hardware configurations. The BIOS 102 (a type of firmware) is the first layer of software that the operating system builds off from. Public Infrastructure 103 refers to unknown and potentially compromised digital infrastructure (ISP routers, fiber cables etc.). The Agent 104 is planted on Public Infrastructure and monitors known Callback Channels by engaging with their known description (port, protocol type etc.) which are stored in the Trusted Platform Database. The agent checks for Heartbeat Signals and informs the Trusted Platform to gain leverage over the Malware Source. With Auto Discover and Install Lite Client 105, the LIZARD Cloud in MNSP 9 detects an endpoint system (i.e. a laptop) that isn't providing a signal response (handshake) to LIZARD. The endpoint will be synchronized upon discovery and classified through I²CM 24. Hence LIZARD Cloud detects (via an SSH remote root shell) that the Lizard Lite Client 43 is not installed/activated and by utilizing the root shell it forces the install of the Client 43 and ensures it is properly activated. The Malware 106A initially enters because the Lite Client 43 was not installed on the entry device. Lite Client 43 is installed in almost every instance possible on the system, let alone all incoming and outgoing traffic is routed through MNSP which contains LIZARD Cloud. With Initial Exploit 107 the initial entity of exploitation is detected and potentially blocked in it's entirety before it can establish a Covert Callback Channel 106B. The Channel 106B is an obscure pathway of communication for the Malware 106B to discretely communicate with its base. This can include masking the signal to look like legitimate http or https application traffic. A wide range of Vendors 108 provide valuable resources such as covert access to software, hardware, firewalls, services, finances and critical infrastructure to allow the planting of Agents 104 in Public Infrastructure 103. The Heartbeat signal is emitted via the Callback Channel 106B at regular intervals at a specific size and frequency by the Malware and directed to it's source of origin/loyalty via a Covert Callback Channel. The signal indicates its status/capabilities to enable the Malware Source 50 to decide on future exploits and coordinated attacks. Such a Malware Source represents an organization that has hacking capabilities with malicious intent; whether that be a black-hat hacking syndicate or a nation-state government. The Malware 106A and Heartbeat Signal (inside Channel 106B) is detected by LIZARD running in the MNSP Cloud 9 as all incoming and outgoing traffic is routed through MNSP cloud/Lizard via a VPN tunnel.

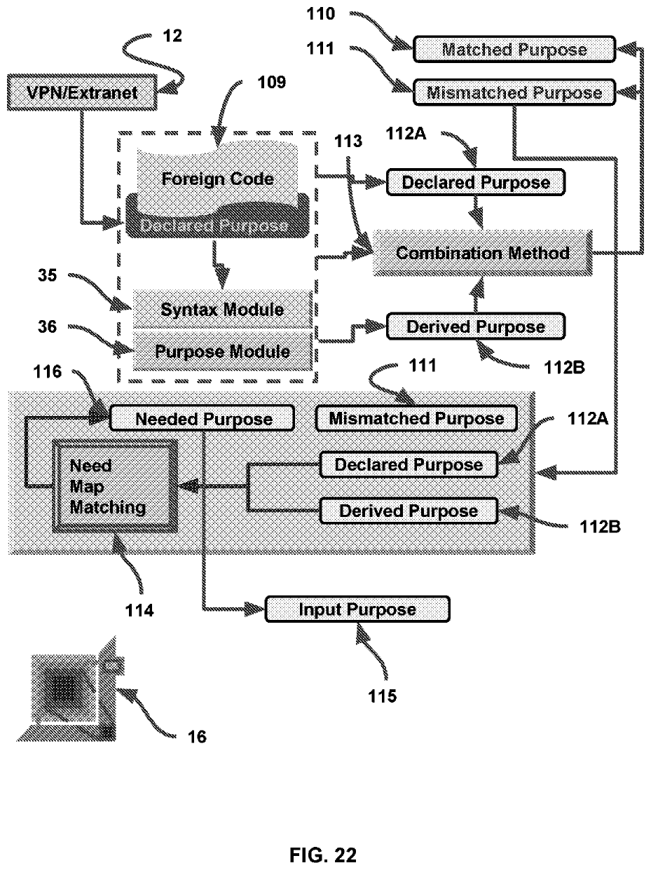

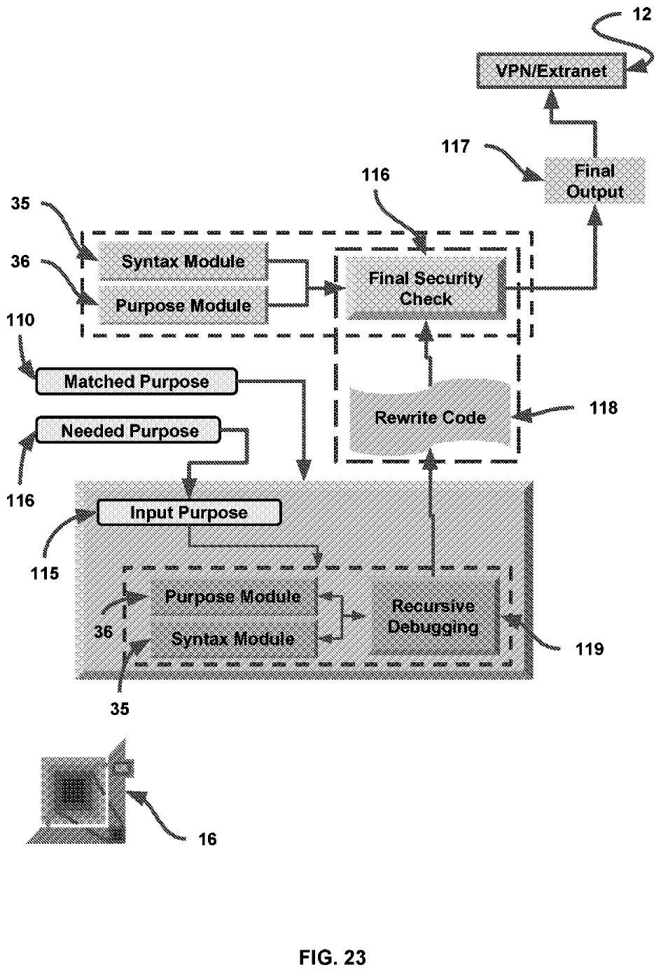

FIGS. 22-23 show how Foreign Code Rewrite syntactically reproduces foreign code from scratch to mitigate potentially undetected malicious exploits. Combination Method 113 compares and matches the Declared Purpose 112A (if available, might be optional according to Enterprise Policy 147) with Derived Purpose 112B. Uses Purpose Module 36 to manipulate Complex Purpose Format and achieves a resultant match or mismatch case scenario. With Derived Purpose 112B Need Map Matching keep's a hierarchical structure to maintain jurisdiction of all enterprises needs. Hence the purpose of a block of code can be defined and justified, depending on vacancies in the jurisdictionally orientated Need Map 114. Input Purpose 115 is the intake for the Recursive Debugging 119 process (which leverages Purpose & Syntax Module). Does not merge multiple intakes (i.e. purposes), a separate and parallel instance is initialized per purpose input. Final Security Check 116 leverages the Syntax 35 and Purpose 36 Modules to do a multi-purpose ‘sanity’ check to guard any points of exploitation in the programming and transfers the Final Output 117 to the VPN/Extranet 12.

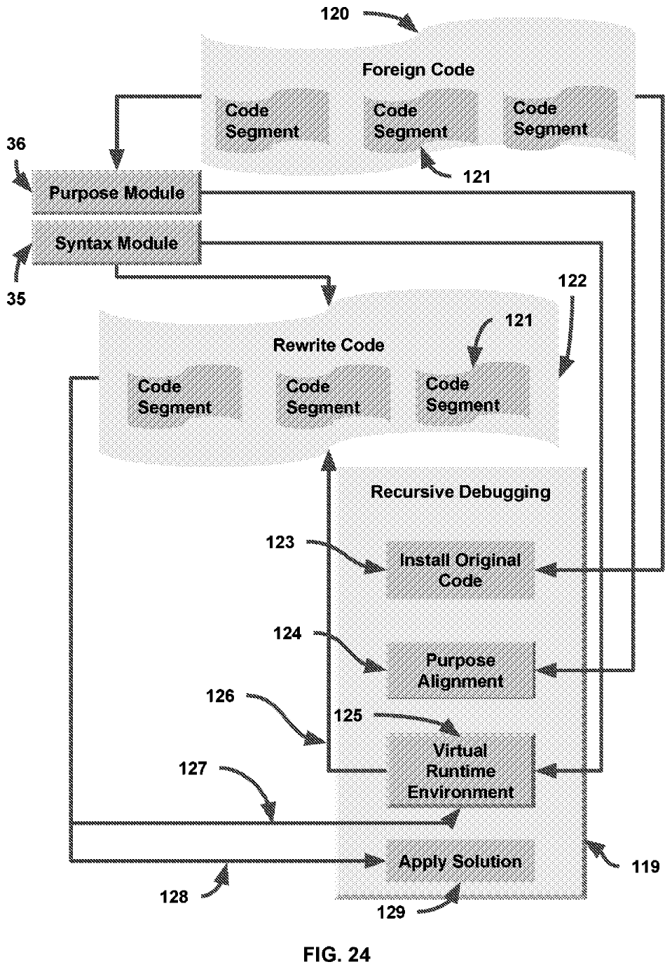

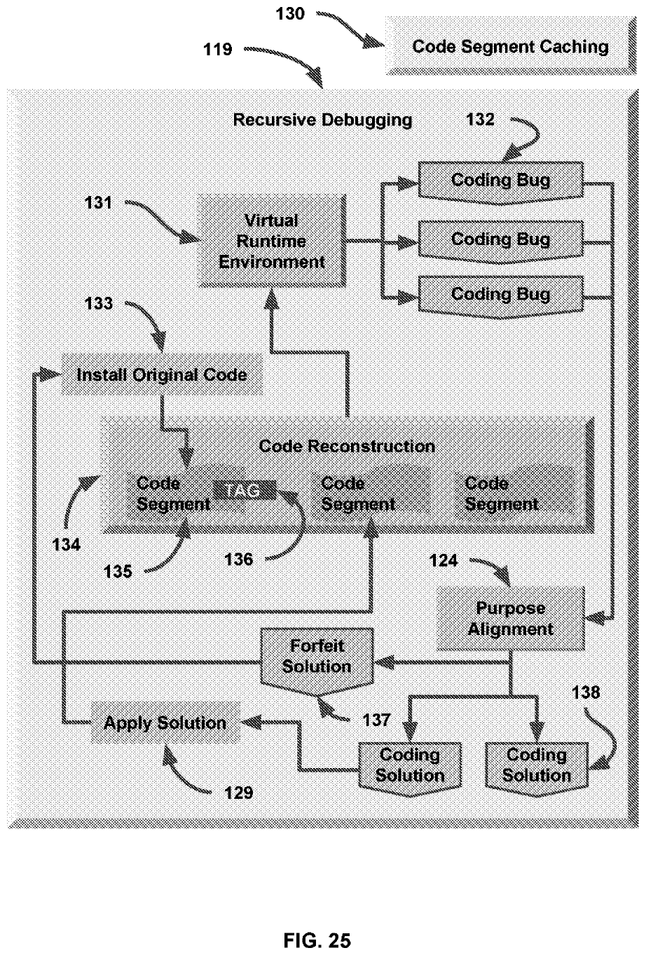

FIGS. 24-25 show how Recursive Debugging 119 loops through code segments to test for bugs and Applies bug fixes 129 (solutions) where possible. If a bug persists, the entire code segment is Replaced 123 with the original (foreign) Code Segment 121. The original code segment is subsequently tagged for facilitating additional security layers such as Virtual Obfuscation and Behavioral Analysis. With Foreign Code 120 the original state of the code is interpreted by the Purpose 36 and Syntax 35 Modules for a code rewrite. The Foreign Code 120 is directly referenced by the debugger in case an original (foreign) code segment needs to be installed because there was a permanent bug in the rewritten version. Rewritten Code 122 Segments 121 are tested by the Virtual Runtime Environment 131 to check for Coding Bugs 132. Such an Environment 131 executes Code Segments 121, like functions and classes, and checks for runtime errors (syntax errors, buffer overflow, wrong function call etc.). Any coding errors are processed for fixing. With Coding Bug 132, errors produced in the Virtual Runtime Environment are defined in scope and type. All relevant coding details are provided to facilitate a solution. With Purpose Alignment 124 a potential solution for the Coding Bug 132 is drafted by re-deriving code from the stated purpose of such functions and classes. The scope of the Coding Bug is rewritten in an alternate format to avoid such a bug. The potential solution is outputted, and if no solutions remain, the code rewrite for that Code Segment 121 is forfeited and the original Code Segment (directly from the Foreign Code) is used in the final codeset. Typically a Coding Bug 132 will receive a Coding Solution 138 multiple times in a loop. If all Coding Solutions have been exhausted with resolving the Bug 132; a solution is Forfeited 137 and the Original Foreign Code Segment 133 is used. A Code Segment 121 can be Tagged 136 as foreign to facilitate the decision of additional security measures such as Virtual Obfuscation and Behavioral Analysis. For example, if a Rewritten block of code contains a high degree of foreign code segments, it is more prone to being placed in a Mock Data Environment 394. With Code Segment Caching 130, Individual Code Segments (functions/classes) are cached and reused across multiple rewrite operations to increase LIZARD Cloud resource efficiency. This cache is highly leveraged since all traffic is centralized via VPN at the cloud. With Rewritten Code Segment Provider 128, a previously rewritten Code Segment 121 is provided so that a Coding Bug can have it's respective Solution Applied 129 to it.

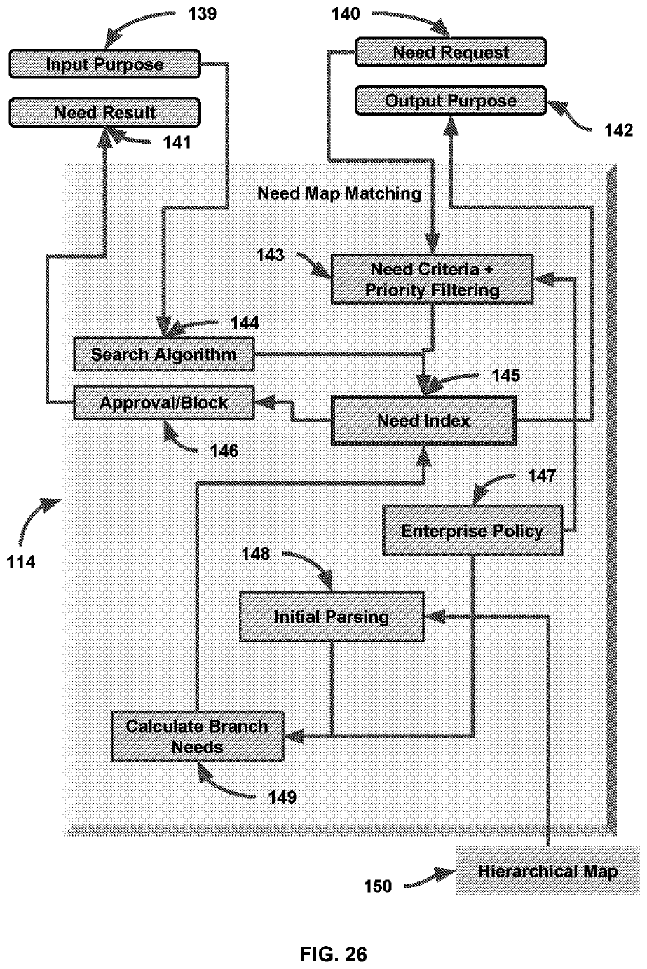

FIG. 26 shows the inner workings of Need Map Matching 114, which verifies purpose jurisdiction. LIZARD Cloud and Lite reference a Hierarchical Map 150 of enterprise jurisdiction branches. This is done to justify code/function purpose, and potentially block such code/function in the absence of valid justification. Whether the Input Purpose 139 is claimed or derived (via the Purpose Module 35), Need Map Matching 114 validates the justification for the code/function to perform within the Enterprise System. The master copy of the Hierarchical Map 150 is stored on LIZARD Cloud in the MNSP 9, on the account of the respective registered enterprise. The Need Index 145 within Need Map Matching 114 is calculated by referencing the master copy. Then the pre-optimized Need Index (and not the hierarchy itself) is distributed among all accessible endpoint clients. Need Map Matching receives a Need Request 140 for the most appropriate need of the system at large. The corresponding output is a Complex Purpose Format 325 that represents the appropriate need. With Need Criteria+Priority Filtering 143, and appropriate Need is searched for within the Enterprise Policy 147. Such a Policy 147 dictates the types and categories of needs each Jurisdiction can have. A need can range from email correspondence, software installation needs etc. Policy 147 determines what is a Need priority according to the enterprise. According to the definitions associated with each branch, needs are associated with their corresponding department. This way, permission checks can be performed. Example: Need Map matching approved the request for HR to download all the employee CVs, because it is time for an annual review of employee performance according to their capabilities. With Initial Parsing 148 each jurisdiction branch is downloaded for need referencing. With Calculate Branch Needs 149 Needs are associated with their corresponding department according to the definitions associated with each branch. This way, permission checks can be performed. Example: Need Map matching approved the request for HR to download all the employee CVs, because it is time for an annual review of employee performance according to jurisdictions defined in the Hierarchical Map 150.

### Machine Clandestine Intelligence (MACINT) & Retribution Through Covert Operations in Cyberspace

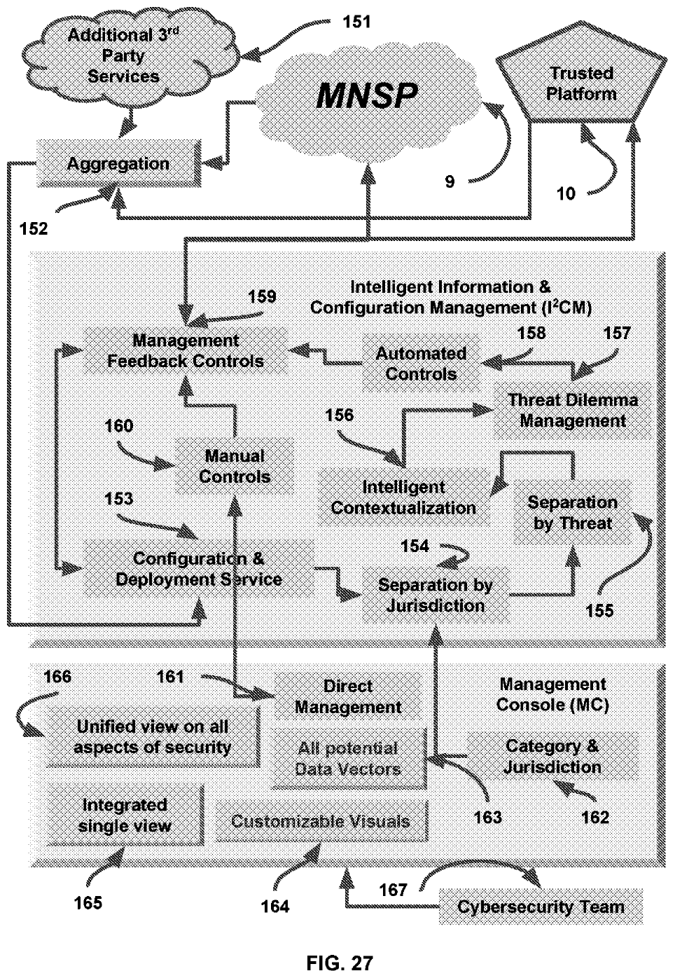

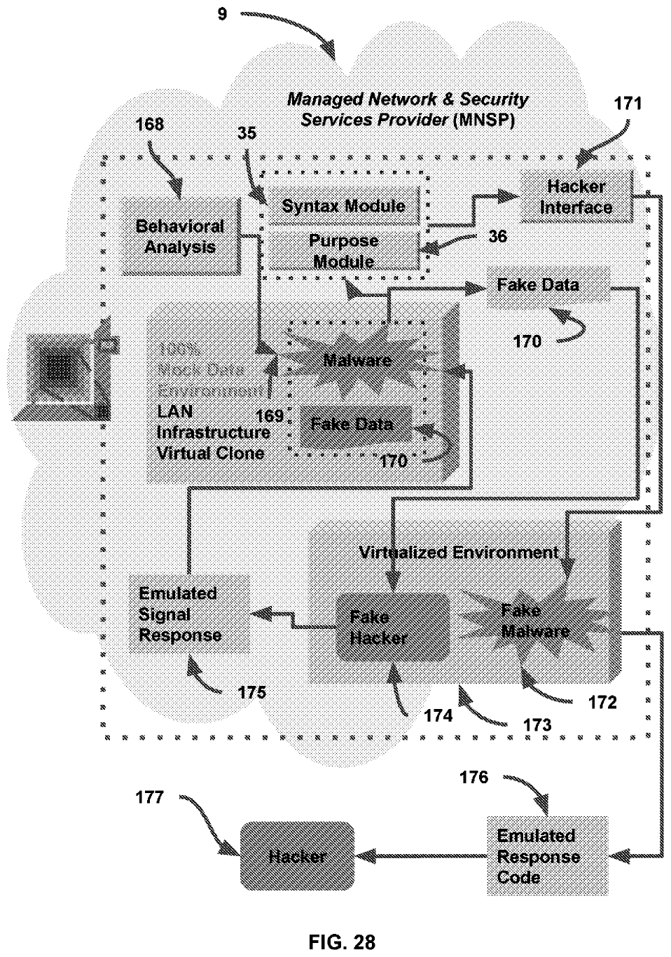

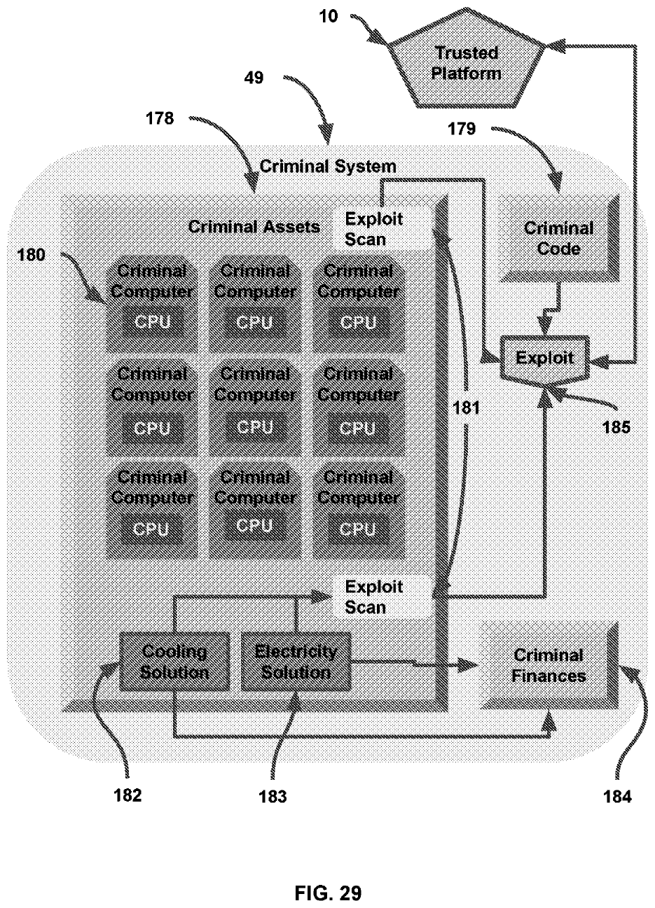

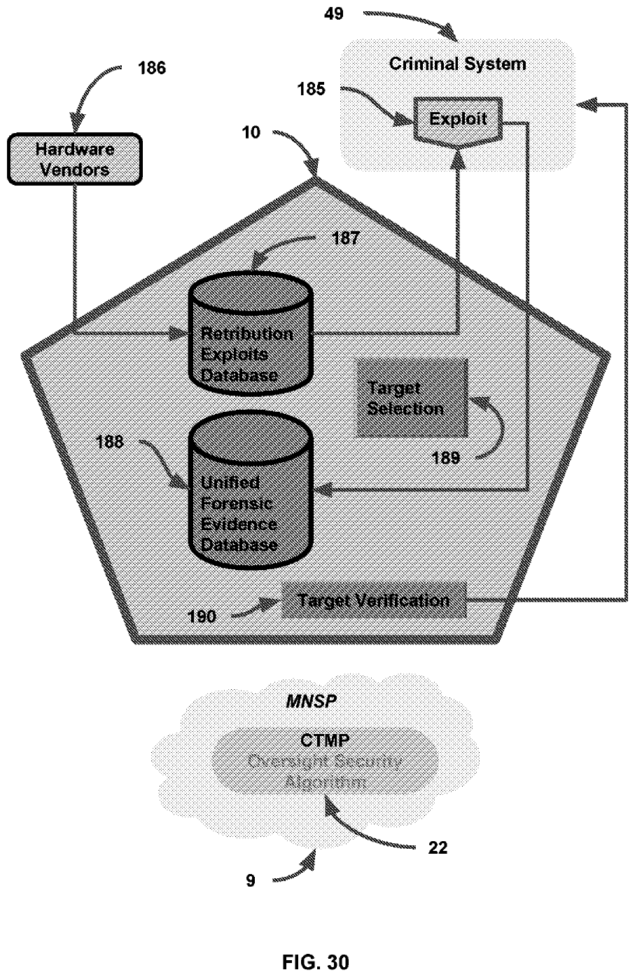

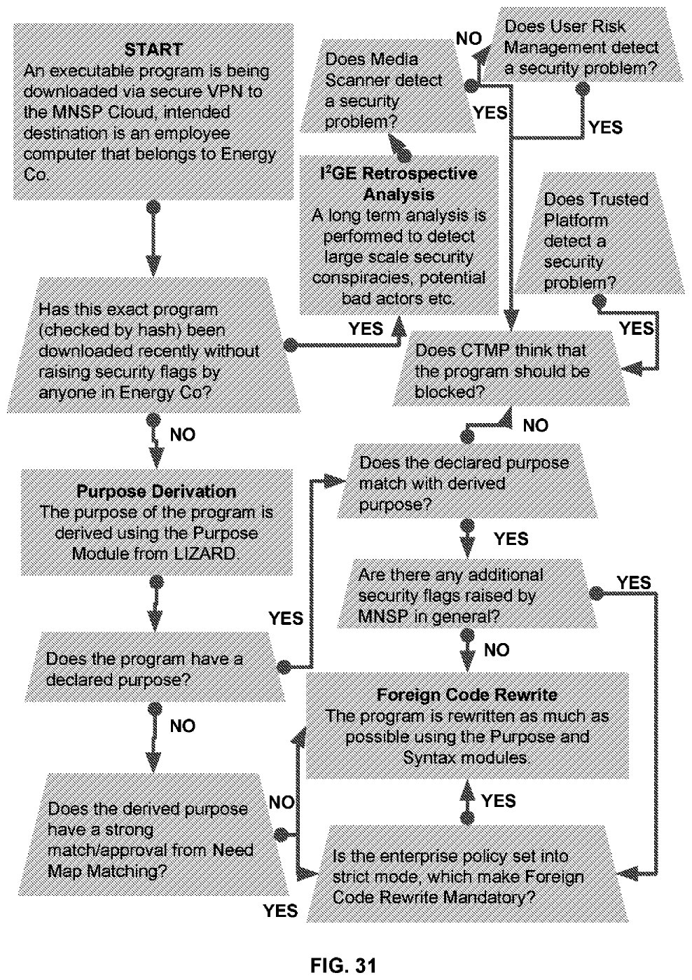

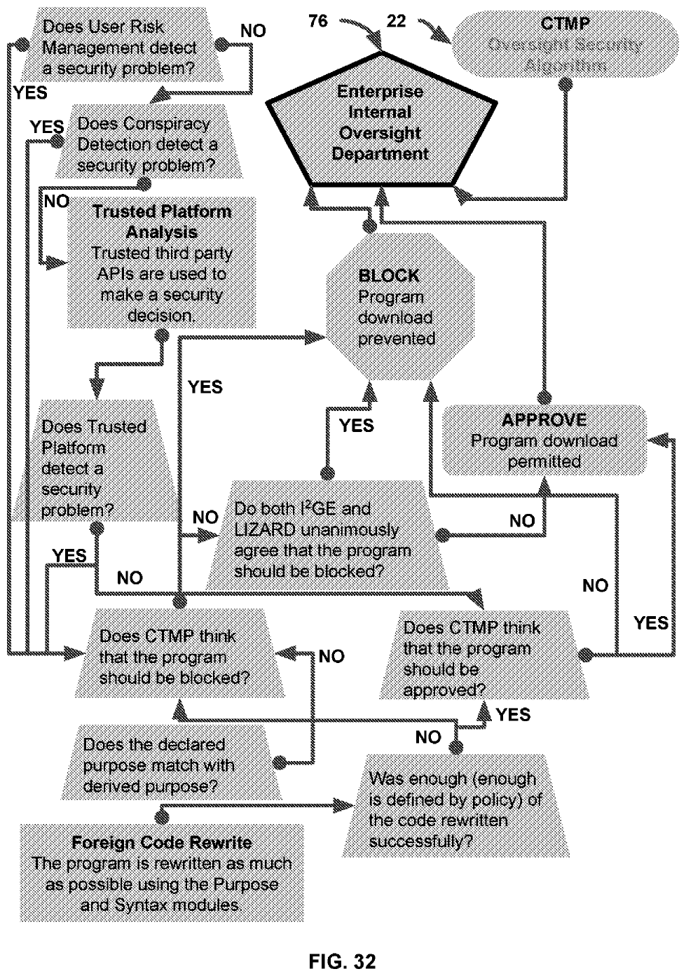

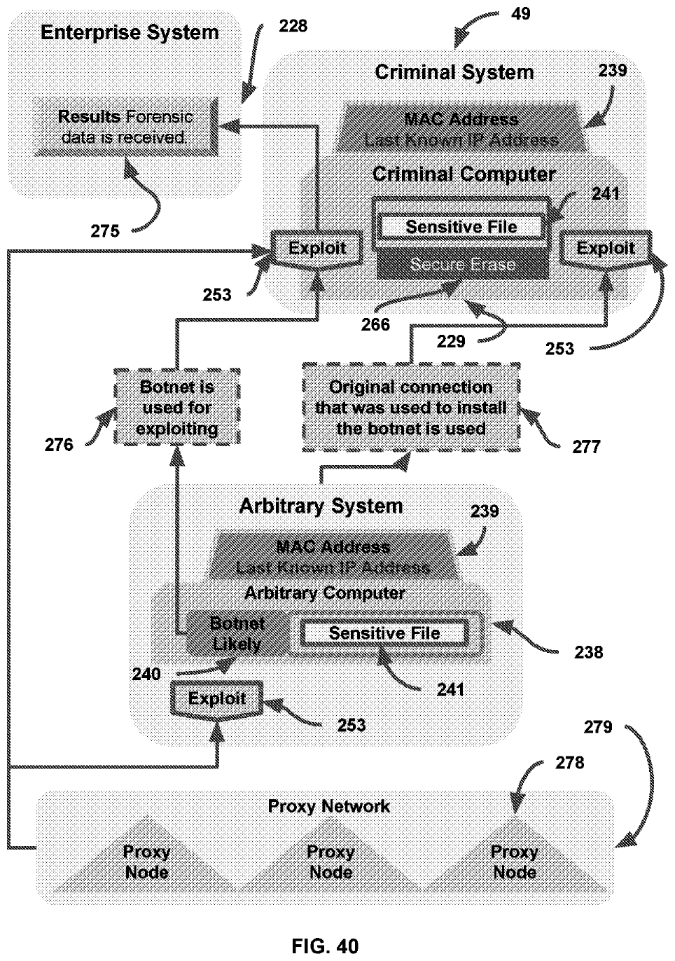

FIG. 27 shows intelligent information management, viewing and control. Aggregation 152 uses generic level criteria to filter out unimportant and redundant information, whilst merging and tagging streams of information from multiple platforms. Configuration & Deployment Service 153 is an interface for deploying new enterprise assets (computers, laptops, mobile phones) with the correct security configuration and connectivity setup. After a device is added and setup, they can be tweaked via the Management Console with the Management Feedback Controls as a middleman. This service also manages the deployment of new customer/client user accounts. Such a deployment may include the association of hardware with user accounts, customization of interface, listing of customer/client variables (i.e. business type, product type etc.). With Separation by Jurisdiction 154 the tagged pool of information are separated exclusively according to the relevant jurisdiction of the Management Console User. With Separation by Threat 155 the information is organized according to individual threats. Every type of data is either correlated to a threat (which adds verbosity) or is removed. At this stage of the process labelled Intelligent Contextualization 156 the remaining data now looks like a cluster of islands, each island being a cybersecurity threat. Correlations are made inter-platform to mature the security analysis. Historical data is accessed (from I²GE 21 as opposed to LIZARD 16) to understand threat patterns, and CTMP is used for critical thinking analysis. With Threat Dilemma Management 157 the cybersecurity threat is perceived from a bird's eye view (big picture). Such a threat is passed onto the management console for a graphical representation. Since calculated measurements pertaining to threat mechanics are finally merged from multiple platforms; a more informed threat management decision can be automatically performed. Automated Controls 158 represent algorithm access to controlling management related controls of MNSP 9, TP, 3PS. Management Feedback Controls 159 offers high level controls of all MNSP Cloud, Trusted Platform 10 additional Third Party Services (3PS) based services which can be used to facilitate policy making, forensics, threat investigations etc. Such management controls are eventually manifested on the Management Console (MC), with appropriate customizable visuals and presentation efficiency. This allows for efficient control and manipulation of entire systems (MNSP, TP, 3PI) direct from a single interface that can zoom into details as needed. Manual Controls 160 represent human access to controlling management related controls of MNSP 9, TP, 3PS. Direct Management 161 leverages manual controls to provide human interface. With Category and Jurisdiction 162 the user of the Management Console uses their login credentials which define their jurisdiction and scope of information category access. All Potential Data Vectors 163 are data in motion, data at rest & data in use. Customizable Visuals 164 is for use by various enterprise departments (accounting, finance, HR, IT, legal, Security/Inspector General, privacy/disclosure, union, etc.) and stakeholders (staff, managers, executives in each respective department) as well as third party partners, law enforcement, etc. Integrated Single View 165 is a single view of all the potential capabilities such as monitoring, logging, reporting, event correlation, alert processing, policy/rule set creation, corrective action, algorithm tuning, service provisioning (new customers/modifications), use of trusted platform as well as third party services (including receiving reports and alerts/logs, etc from third party services providers & vendors). Unified view on all aspects of security 165 is a collection of visuals that represent perimeter, enterprise, data center, cloud, removable media, mobile devices, etc. Cybersecurity Team 167 is a team of qualified professionals monitor the activity and status of multiple systems across the board. Because intelligent processing of information and AI decisions are being made, costs can be lowered by hiring less people with fewer years of experience. The Team's primary purpose is for being a fallback layer in verifying that the system is maturing and progressing according to desired criteria whilst performing large scale points of analysis. Behavioral Analysis 168 observes the malware's 169 state of being and actions performed whilst it is in the 100% Mock Data Environment 394. Whilst the malware is interacting with the Fake Data 170, Behavioral Analysis will record patterns observed in activation times (i.e. active only on Sunday's when the office is closed), file access requests, root admin functions requested etc. The Malware 169 has been planted by the hacker 177. Whilst the hacker believes that he has successfully planted malware into the target system, the malware has been silently transferred and isolated to a 100% Mock Data Environment 394. At Fake Data 170 the Malware (169 has taken digital possession of a copy of Fake Data. It does this whilst under the impression that the data is real, it and by extension the Hacker 177 are oblivious to whether the data is real or fake. When the Malware attempts to send the Fake Data to the Hacker, the outgoing signal is rerouted so that it is received by the Fake Hacker 174 as opposed to the Malware's expectation of the real Hacker. With Hacker Interface 171 the Syntax 35 and Purpose 36 Modules (which belong jurisdictionally to the LIZARD system) receive the code structure of the Malware 169. These modules reverse engineer the Malware's internal structure to output the Hacker Interface. This interface details the communication method used between the Malware and the Hacker, the expectations the Malware has of the Hacker (i.e. receiving commands etc.), and the expectations the Hacker has of the Malware (i.e. status reports etc.). Such information allows a Fake Hacker 174 and Fake Malware 172 to be emulated within a Virtualized Environment 173. Once Behavioral Analysis 168 has adequately studied the behavior of the Malware 169, the Signal Mimicry functionality of MNSP 9 can emulate a program that behaves like the Hacker 177. This includes the protocol of communication that exists between the Real Malware 169, the Fake Data 170, and the Fake Hacker 174. With Emulated Signal Response 175, the virtualized Fake Hacker 174 sends a response signal to the real Malware 169 to either give it the impression that it has succeeded or failed in its job. Such a signal could include commands for Malware behavior and/or requests for informational status updates. This is done to further behavioral analysis research, to observe the malware's next behavior pattern. When the research is concluded, the Mock Data Environment 394 with the malware in it can either be frozen or destroyed. With Emulated Response Code 176, the hacker is given a fake response code that is not correlated with the behavior/state of the real malware. Depending on the desired retribution tactic, either a fake error code or a fake success code can be sent. A fake error code would give the hacker the impression that the malware is not working (when in reality it does) and would waste the hacker's time on useless debugging tangents. A success error code would decrease the likelihood that the hacker would divert attention to making a new form of malware, but instead focus on the current one and any possible incremental improvements. Since such malware will have already been compromised and understood by LIZARD, the hacker is wasting energy on a compromised malware thinking it is succeeding. The Hacker 177 still believes that the malware he planted has successfully infiltrated the target system. In reality the malware has been isolated within a virtualized environment. That same virtualized environment has enacted Behavioral Analysis 168 on the malware to emulate the method and syntax of communication it has with the hacker (whether bi-directional or omni-directional). Criminal Assets 178 represents the investments made via Criminal Finances 184 to facilitate the hacking and malicious operations of Criminal System 49. Such Assets 178 are typically manifested as computing power and internet connectivity as having a strong investment in these two assets enables more advanced and elaborate hacking performances. With Criminal Code 179 an exploit scan is performed by the Trusted Platform's agent, to gather as much forensic evidence as possible. With Criminal Computer 180 a CPU exploit is performed which overflows the CPU with AVX instructions. This leads to increased heat, increased electricity consumption, more CPU degradation, and less available processing power for criminal processes. An Exploit Scan 181 of the Criminal Assets 178 are performed to identify their capabilities and characteristics. The resulting scan results are managed by the Exploit 185 and forwarded to the Trusted Platform 10. The Exploit 185 is a program sent by the Trusted Platform via the Retribution Exploits Database 187 that infiltrates the target Criminal System 49, as enumerated in MACINT FIGS. 27-44. Electric and Cooling expenditures increase significantly which puts a drain on Criminal Finances 184. Shutting down the computers will severely hamper the criminal operations. Purchasing new computers would put more strain on Criminal Finances, and such new computers are prone to being exploited like the old ones. Retribution Exploits Database 187 contains a means of exploiting criminal activities that are provided by Hardware Vendors 186 in the forms of established backdoors and known vulnerabilities. The Unified Forensic Evidence Database 188 contains compiled forensic evidence from multiple sources that spans multiple enterprises. This way the strongest possible legal case is built against the Criminal Enterprise, to be presented in a relevant court of law. With Target Selection 189 a target is only selected for retribution after adequate forensic evidence has been established against it. This may include a minimum time requirement for the forensic case to be pending for review by oversight (i.e. 6 months). Evidence must be highly self-corroborating, and isolated events cannot be used to enact retribution out of fear of attacking an innocent target and incurring legal repercussions. With Target Verification 190 suspected criminal systems are verified using multiple methods to surpass any potential methods of covertness (public cafe, TOR Network etc), including:
Physical location. GPS can be taken advantage of. Cloud services can aide in corroboration (i.e. Longterm precedent for Dropbox sign-in location)
Physical Device. MAC address, serial number (from manufacturer/vendor).
Personnel Verification. Use biometric data on security system, take photo from front-facing camera, corroboration of consistent log-in credentials over multiple platforms.

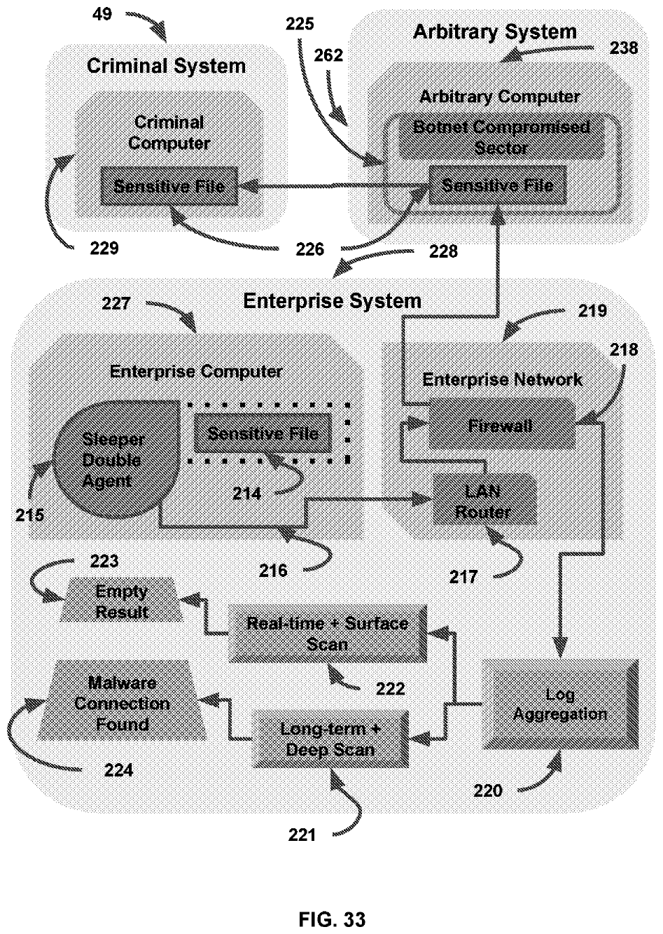

FIG. 33 shows MACINT covert operations overview, how criminals exploit an enterprise system. Enterprise System 228 defines the entire scope and jurisdiction of the enterprise's infrastructure and property. Enterprise Computer 227 is a crucial part of Enterprise System 228 as is contains Sensitive Information 214 and depends on Enterprise Network 219 for it's typically scheduled tasks. Sleeper Double Agent 215 is malicious software the stays dormant and ‘sleeps’ on the target Computer 227. Because of it's lack of activity it is very hard for programmers and cybersecurity analysts to detect it as no damage has occurred yet. When the hackers from Criminal System 49 find an opportunistic moment to use their Sleeper Agent 215, a copy of Sensitive File 214 is silently captured by Agent 215. At this stage the hackers have exposed themselves to being traced but it was at their discretion for when to use up the opportunity (i.e. if the File 214 was worth it) of having an Agent 215 installed without notice from administrators. At Stage 216 the Captured File 214 is pushed via encryption outside of the Enterprise Network to the rogue destination server. Such encryption (i.e. https) is allowed by policy, hence the transmission is not immediately blocked. The Captured File 214 is passed onto the network infrastructure of Enterprise Network 219 in an attempt to leave the Enterprise System 228 and enter the Arbitrary System 262 and eventually the Criminal System 49. Such a network infrastructure is represented as LAN Router 217 and Firewall 218, which are the last obstacles for the malware to pass through before being able to transport the Captured File 214 outside of the Enterprise System. The industry standard Firewall 218, which in this example is considered unable to thwart the stealing of the Captured File 214, generates logs which are forwarded to Log Aggregation 220. Such Aggregation then separates the data categorically for both a Long-Term/Deep Scan 221 and a Real-Time/Surface Scan 222. With the Empty Result 223 case scenario, Real-Time 222 is inadequately prepared to perform a near instant recognition of the malicious activity to stop it before execution. With the Malware Connection Found 224 case scenario, the Long-Term Scan 221 eventually recognizes the malicious behavior because of its advantage of having more time to analyze. The luxury of time allows Long-Term 221 to perform a more thorough search with more complex algorithms and points of data. With the Botnet Compromised Sector 225, a computer belonging to the system of an arbitrary third party is used to transfer the Sensitive File 226 to throw off the investigation and frame the arbitrary third party. Thieves receive Sensitive File 226 at Criminal Computer 229 whilst maintaining a hidden presence via their Botnet and proceed to use the File for illegal extortion and profit. Potential traces left of the identity (i.e. IP address) of Criminal Computer are may only be left at Arbitrary Computer 238, which the administrators and investigators of Enterprise System 228 do not have access to.

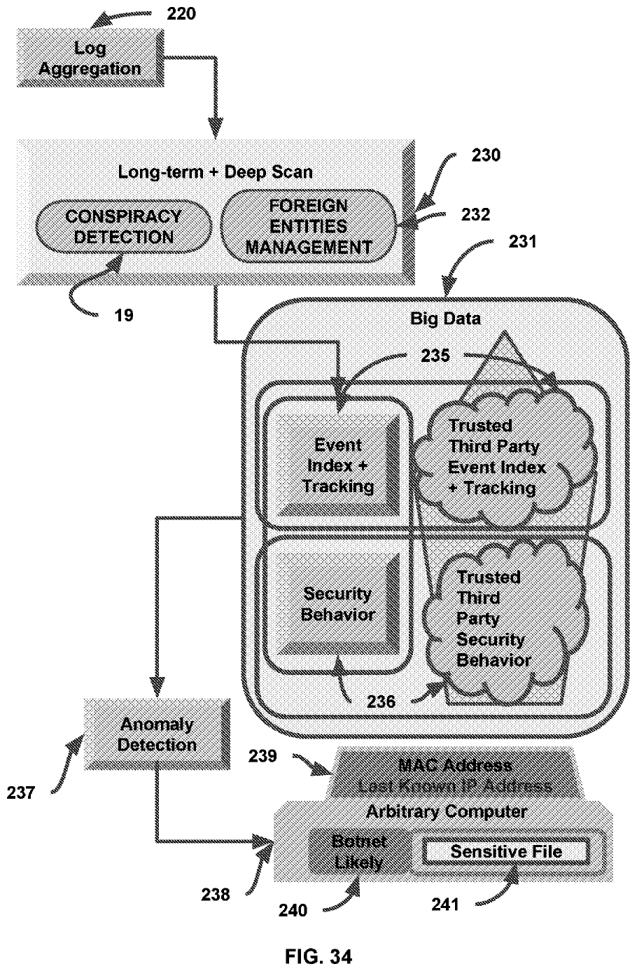

FIG. 34 shows more details to the Long-Term/Deep Scan 230 which uses Big Data 231. Deep Scan 230 contributes to and engages with Big Data 231 whilst leveraging two sub-algorithms, ‘Conspiracy Detection’ and ‘Foreign Entities Management’. The intermediate results are pushed to Anomaly Detection which are responsible for the final results. Standard logs from security checkpoints, like firewalls and central servers, are aggregated and selected with low restriction filters at Log Aggregation 220. With Event Index+Tracking 235 event details are stored, such as IP address, MAC address, Vendor ID, Serial Number, times, dates, DNS etc. Such details exist both as a local database and a shared cloud database (databases are not identical in data). Local storage of such entries is pushed (with policy restrictions according to the enterprise) to the cloud database for the benefit of other enterprises. In return, useful event information is received for the benefit of local analysis. An enterprise that is registered with the Trusted Third Party 235 may have already experienced the transgressions of a botnet, and is able to provide preventative details to mitigate such risks. With Security Behavior 236 security reactionary guidelines are stored in a local database and in a shared cloud database (these databases are not identical in data). Such reactionary guidelines define points of behavior to ensure a secure system. For example, if an IP address accessed the system, which the Event Index says has been associated 6 out of 10 times with a botnet, then ban the IP address for 30 days and put a priority flag on the log system to mark any attempts by the IP address to access the system during this time. Local storage of such guidelines is pushed (with policy restrictions according to the enterprise) to the cloud database for the benefit of other enterprises. In return, useful event information is received for the benefit of local analysis. With Anomaly Detection 237 the Event Index and Security Behavior are used in accordance with the intermediate data provided by the Deep Scan module to determine any potential risk events, like a Sensitive File being transferred by an unauthorized agent to an Arbitrary System outside of the Enterprise Network. Arbitrary Computer 238 is shown as the resultant Destination server involved in the breach is highlighted, defined by any known characteristics such as MAC Address/last known IP address 239, country and uptime patterns etc. Such an analysis primarily involves the Foreign Entities Management 232 module. The system is then able to determine the likelihood 240 of such a computer being involved in a botnet. Such an analysis primarily involves Conspiracy Detection 19.

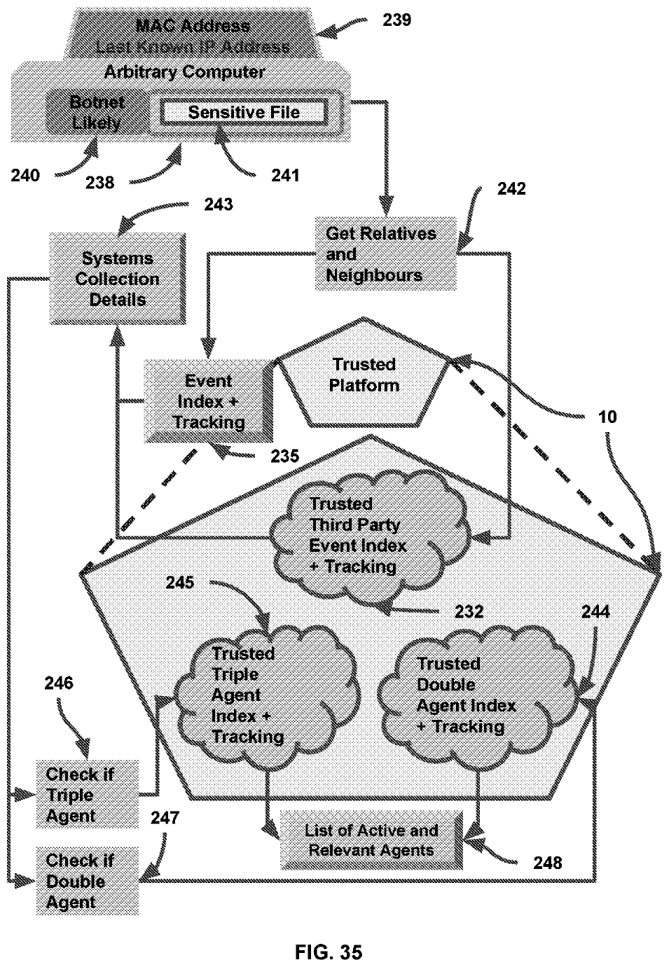

FIG. 35 shows how the Arbitrary Computer is looked up on the Trusted Platform 10 to check if it or its server relatives/neighbors (other servers it connects to) are previously established double or triple agents for the Trusted Platform 10. Stage 242 represents how known information of the Arbitrary Computer 238 such as MAC Address/IP Address 239 are sent for querying at Event Index+Tracking 235 and the cloud version 232. Such a cloud version that operates from the Trusted Platform 10 tracks event details to identify future threats and threat patterns. i.e. MAC address, IP address, timestamps for access etc. The results from such querying 242 are sent to Systems Collection Details 243. Such details include: the original Arbitrary Computer 238 details, computers/systems that receive and/or send packets regularly to Computer 238, and systems that are in physically close proximity to Computer 238. Such details are then forwarded to Stages 246 and 247 which checks if any of the mentioned computers/systems happen to Double Agents 247 or Triple Agents 246. Such an agent lookup check is performed at the Trusted Double Agent Index+Tracking Cloud 244 and the Trusted Triple Agent Index+Tracking Cloud 245. The Double Agent Index 244 contains a list of systems that have sleeper agents installed that are controlled by the Trusted Platform and it's affiliates. The Triple Agent Index 245 contains a list of systems that have been compromised by criminal syndicates (i.e. botnets), but have also been compromised by the Trusted Platform 10 in a discrete manner, as to monitor malicious activities and developments. These two clouds then output their results which are gathered at List of Active and Relevant Agents 248.

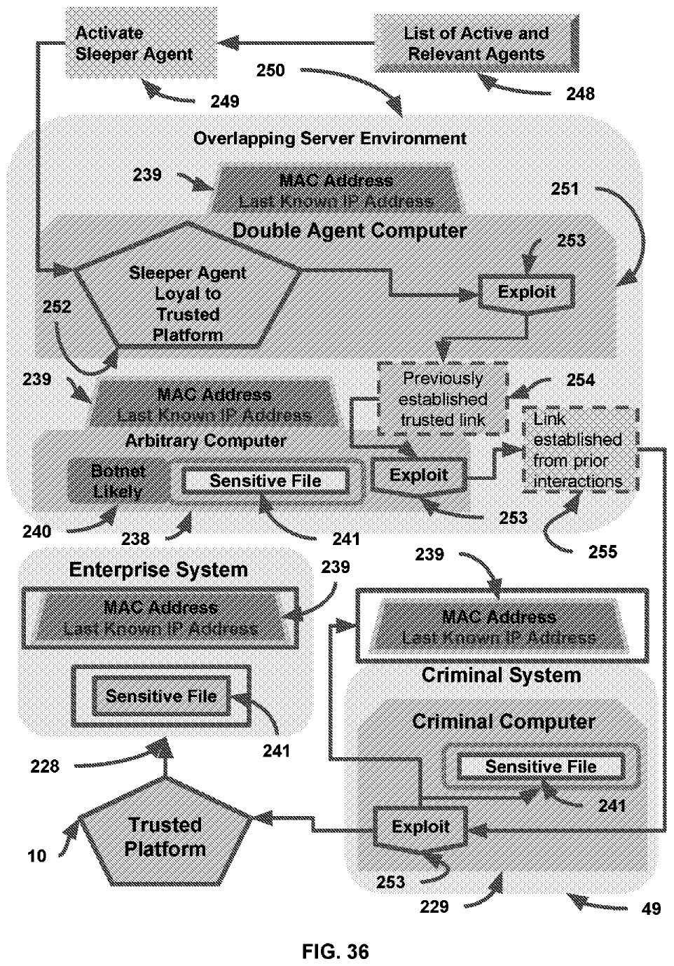

FIG. 36 shows how known double or triple agents from the Trusted Platform 10 are engaged to further the forensic investigation. Being transferred from the List of Agents 248; an appropriate Sleeper Agent 252 is activated 249. The Double Agent Computer 251, which is trusted by the Arbitrary Computer 238, pushes an Exploit 253 through its trusted channel 254. Upon being successfully deployed in the Arbitrary Computer 238 the Exploit 253 tracks the activity of the Sensitive File 241 and learns that it was sent to what is now known to be the Criminal Computer 229. It follows the same path that was used to transfer the File 241 the first time 216 at channel 255, and attempts to establish itself on the Criminal Computer 229. The Exploit 253 then attempts to find the Sensitive File 241, quarantines it, sends its exact state back to the Trusted Platform 10, and then attempts to secure erase it from the Criminal Computer 229. The Trusted Platform 10 then forwards the quarantined file back to the original Enterprise System 228 (who own the original file) for forensic purposes. It is not always guaranteed that the Exploit 253 was able to retrieve the Sensitive File 241, but at the least it is able to forward identifiable information 239 about the Criminal Computer 229 and System 49.

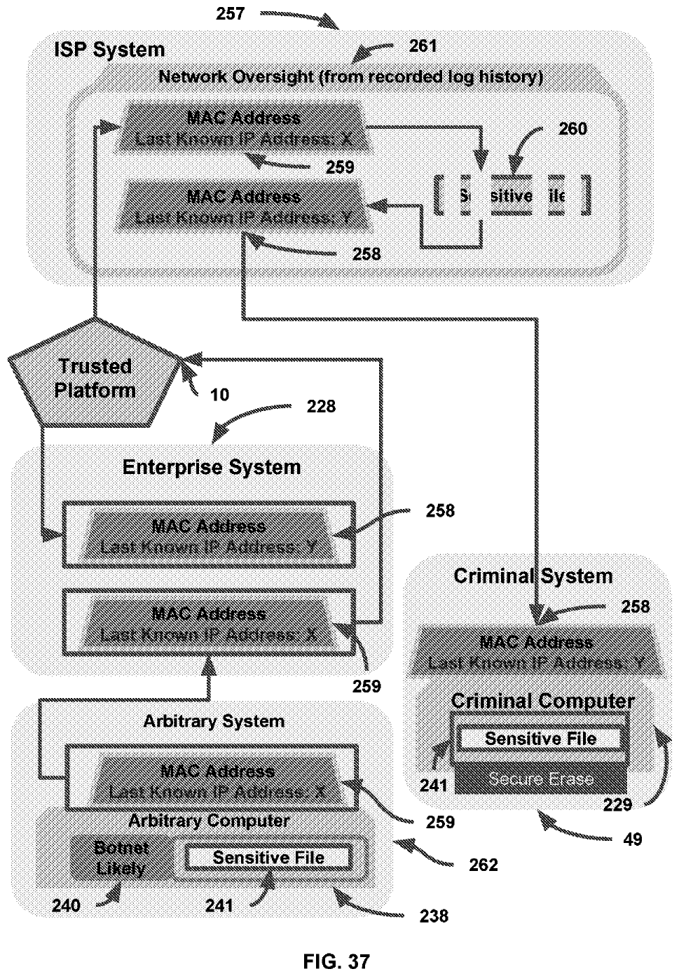

FIG. 37 shows how the Trusted Platform 10 is used to engage ISP (Internet Service Provider) 257 APIs concerning the Arbitrary Computer 238. Network Oversight 261 is used to try and compromise the Arbitrary System 262 to further the judicial investigation. The Enterprise System 228 only knows limited information 259 about the Arbitrary Computer 238, and is seeking information about the Criminal Computer 229 and System 49. An ISP 257 API request is made via the Trusted Platform 10. At the Network Oversight 261 system network logs for the Arbitrary System 262 are found, and a potential file transfer to (what is later recognised as) the Criminal Computer 229. The log history isn't detailed enough to have recorded the exact and entire composition of the Sensitive File 241, but is able to use metadata 260 to decide with significant confidence which computer the file was sent to. Network Oversight 261 discovers the network details 258 of Criminal Computer 229 and so reroutes such information to the Trusted Platform 10 which in turn informs the Enterprise System 228.

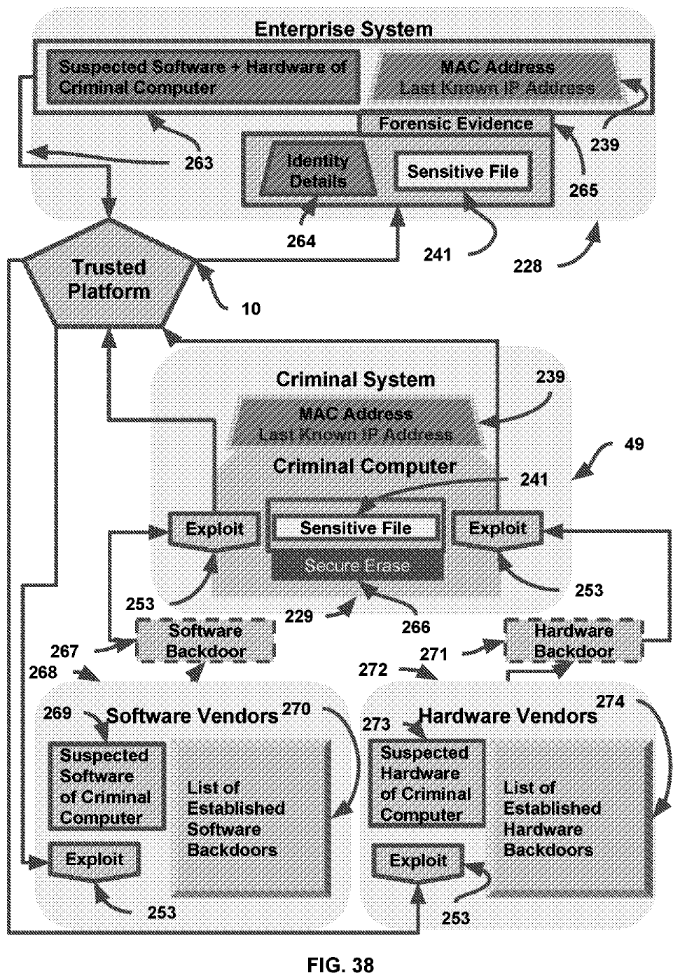

FIG. 38 shows how the Trusted Platform 10 is used to engage security APIs provided by Software 268 and Hardware 272 vendors to exploit any established backdoors that can aide the judicial investigation. At Stage 263 known identity details of Criminal Computer 229 are transferred to the Trusted Platform 10 to engage in backdoor APIs. Such details may include MAC address/IP address 239 and Suspected Software+Hardware of Criminal Computer. Then the Trusted Platform 10 delivers an Exploit 253 to the affiliated Software 268 and Hardware 272 Vendors in a dormant state (the exploitation code is transferred yet not executed). Also delivered to the vendors is the Suspected Software 269 and Hardware 273 of the Criminal Computer 229 as suspected by the Enterprise System 228 at Stage 263. The vendors maintain a List of Established Software 270 and Hardware 274 backdoors, including such information as to how to invoke them, what measures of authorizations need to be taken, and what are their capabilities and limitations. All such backdoors are internally isolated and confidential from within the vendor, hence Trusted Platform does not receive sensitive information dealing with such backdoors yet provides the Exploit 253 that would benefit from them. Upon a successful implementation of a Software 267 or Hardware 271 backdoor the Exploit 253 is discretely installed on the Criminal Computer 229. The Sensitive File 241 is quarantined and copied so that its metadata usage history can be later analyzed. Any remaining copies on the Criminal Computer 229 are then securely erased. Any other possible supplemental forensic evidences are gathered. All such forensic data is returned to the Exploit's 253 point of contact at the Trusted Platform 10. Thereafter the Forensic Evidence 265 is forward to the Enterprise System 228 which includes the Sensitive File 241 as found on the Criminal Computer 229, and Identity Details of those involved with the Criminal System that have evidence against them concerning the initial theft of the File 241. This way the Enterprise System 228 can restore the File 241 if it was deleted from their system during the initial theft, and the Identity Details 264 will enable them to seek retribution in terms of legal damages and disabling Criminal System 49 Botnet to mitigate the risk of future attacks.

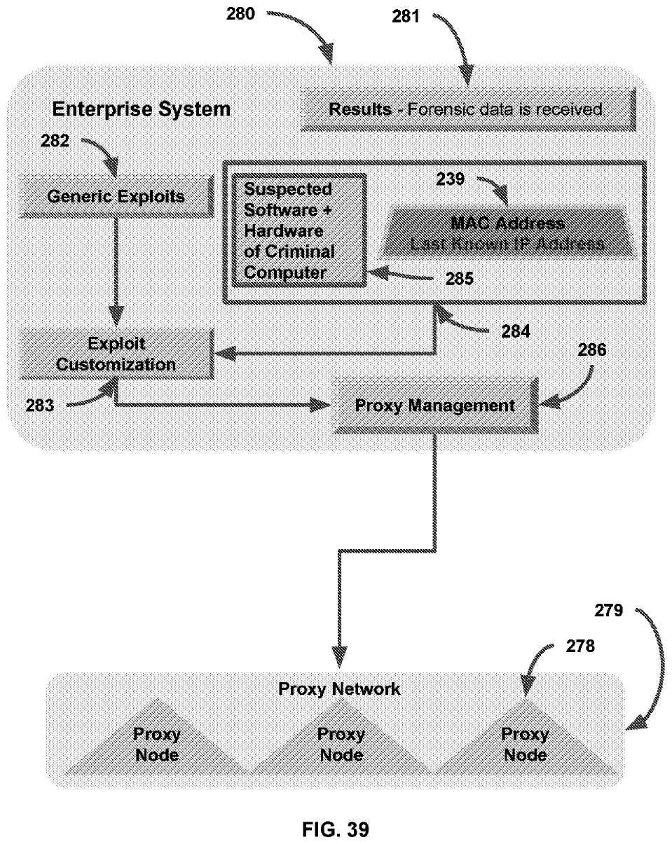

FIGS. 39-41 shows how Generic 282 and Customizable 283 Exploits are applied to the Arbitrary 238 and Criminal 229 Computers in the attempt to perform a direct compromise without the direct aide of the Trusted Platform 10. Generic Exploits 282 is a collection of software, firmware and hardware exploits organized and assembled by the Enterprise System 280 via independent cybersecurity research. With Exploit Customization 283 exploits are customized according to known information about the target. Exploits 253 are delivered with the most likely to succeed first, and with the least likely to succeed last. A collection of available information 284 concerning the Criminal Computer 229 is transferred to Customization 283. Such information includes any known computer information such as MAC Address/IP Address 239 and Suspected Software+Hardware 285 being used by the Criminal Computer 229. Proxy Management 286 is the combination of an algorithm and a database that intelligently selects proxies to be used for the exploitation attempt. Proxy Network 279 is a series of Proxy Nodes 278 which allow any separate system to mask their originating identity. The Node passes on such digital communication and becomes the apparent originator. Nodes are intelligently selected by Proxy Management 286 according to overall performance of a Node, availability of a Node, and current workload of a Node. Three potential points of exploitation of the Criminal Computer 229 and/or Arbitrary Computer 238 are tried. If exploiting the Criminal Computer 229 fails then an attempt to exploit the Arbitrary Computer 238 is made regardless as it may still facilitate the overall forensic investigation. One method is direct exploitation, second is via the Arbitrary Computer's Botnet Tunnel 276, and third is the original means of exploitation that the Criminal System used to install the botnet 277 (as well as other unused points of exploitation). The Botnet Tunnel 276 is the established means of communication used between the Criminal Computer 229 and the active part of the Botnet 240. Any forensic data that is generated by the Exploit 253 is sent to the Enterprise System 228 at Stage 275.

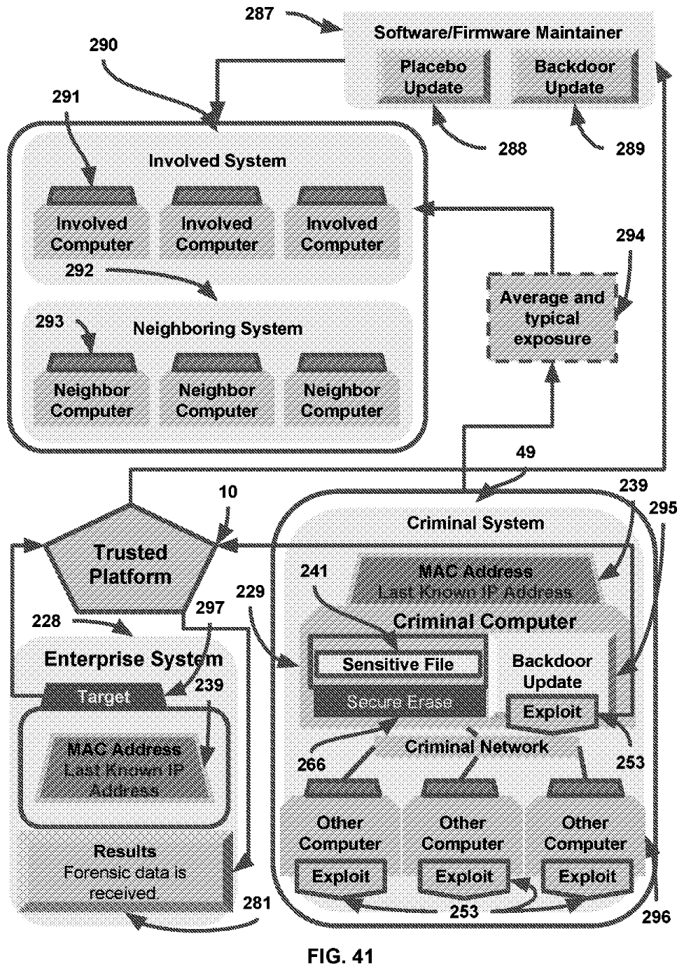

FIG. 41 shows how a special API with the Trusted Platform 10 is used to push a software or firmware Update 289 to the Criminal Computer 229 to establish a new backdoor. A Placebo Update 288 is pushed to nearby similar machines to maintain stealth. The Enterprise System 228 sends the Target Identity Details 297 to the Trusted Platform 10. Such details include MAC Address/IP Address 239. Trusted Platform 10 communicates with a Software/Firmware Maintainer 287 to push Placebo Updates 288 and Backdoor Updates 289 to the relevant computers. A Backdoor Update introduces a new backdoor into the Criminal Computer's 229 system by the using the pre-established software update system installed on the Computer. Such an update could be for the operating system, the BIOS (firmware), a specific software like a word processor. The Placebo Update 288 omits the backdoor so that no security compromises are made, yet shows the same details and identification (i.e. update number/code) as the Backdoor Update 289 to evoke an environment that maintains stealth of the Backdoor. Maintainer 287 transfers the Backdoor 295 to the target, as well as to computers which have an above average amount of exposure to the target. Such additional Computers 296 can be those belonging to the Criminal System 49 infrastructure or those that are on the same local network as the Criminal Computer 229. Exploiting such additional Computers 296 increases the chances of gaining a path of entry to the Criminal Computer 229 in case a direct attack was not possible (i.e. they turn off updates for the operating system etc.). The Exploit 253 would then be able to consider different points of entry to the target if it is able to establish itself on nearby Computers 296. For Involved Computers 291 that have an average amount of exposure to the target a Placebo Update 228 is submitted. Exposure can be understood as sharing a common network (i.e. Virtual Private Network etc.) or a common service platform (i.e. file sharing etc.). Involved System 290 may also be strategically tied to Criminal System 49, such as being owned by the same company legal structure etc. Neighbor Computers 293 belonging to a Neighboring System 292 are given the placebo update because of their nearby physical location (same district etc.) to the target Criminal Computer 229. Both Systems Involved 290 and Neighboring 292 are given Placebo Updates 288 to facilitate a time sensitive forensic investigation whilst there are no regular updates the Maintainer 287 has planned to deliver in the near future (or whatever is suitable and viable for the investigation). In the case scenario that there is a regular update intended on improving the software/firmware, then Involved 290 and Neighboring 292 Systems do not need to be given a placebo update as to validate the perceived legitimacy of the Backdoor 289 Update. Instead the Backdoor 289 can be planted on some of the legitimate updates targeting the Criminal Computer 229 and Other Computer 296. Upon successful implementation of the Exploit 253 via the Backdoor Update 295 the Sensitive File 241 is quarantined and copied so that its metadata usage history can be later analyzed. Any remaining copies on Criminal Computer 229 are then securely erased. Any supplemental forensic evidence is gathered. Thereafter forensic data is sent to the exploit's point of contact at the Trusted Platform 10. Upon the data being verified at the Platform 10 it is then forwarded to the Enterprise System 228 at Results 281.

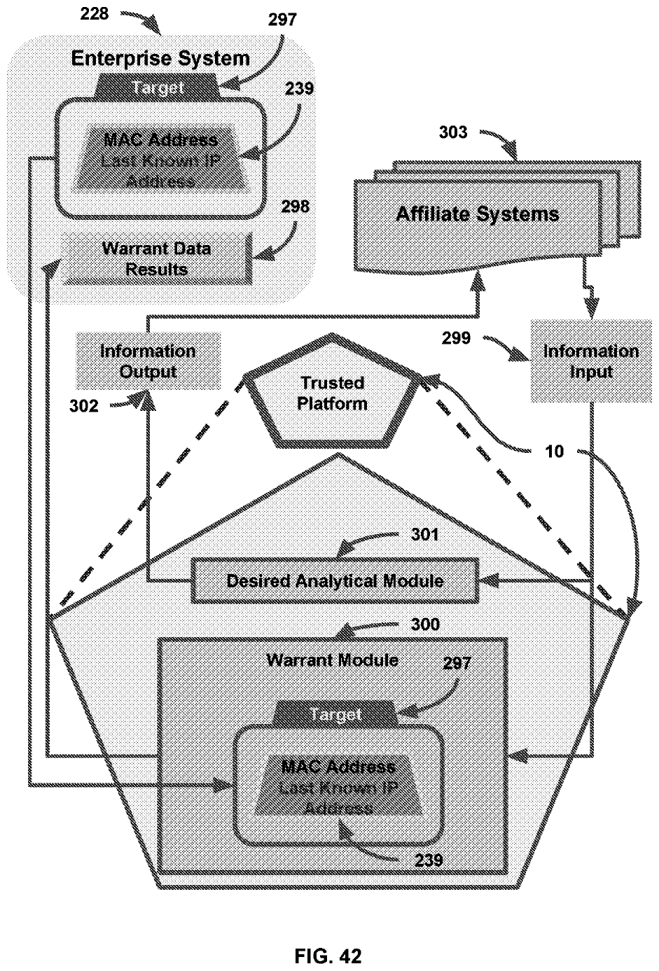

FIG. 42 shows how a long-term priority flag is pushed onto the Trusted Platform 10 to monitor the Criminal System 229 for any and all changes/updates. New developments are monitored with priority over the long-term to facilitate the investigation. Firstly the Enterprise System 228 submits a Target 297 (which includes identifiable details 239) to the Warrant Module 300 which is a subset of the Trusted Platform 10. The Warrant Module scans all Affiliate Systems 303 Input 299 for any associations of the defined Target 297. If there are any matches, the information is passed onto the Enterprise System 228, who defined the warrant and are seeking to infiltrate the Target 297. Information Input 299 is information that Affiliates Systems of the Trusted Platform 10 report, usually to receive some desired analysis. Input might also be submitted for the sole purpose of gaining accreditation and reputation with the Trusted Platform 10. Affiliate Systems 303 submit their input to the Trusted Platform 10; which is to the advantage of the Enterprise System 228 seeking to monitor Target 297. This increases the chances that one of these Affiliate Systems 303 have encountered Target or a relative of Target, whether that be a positive, neutral, or negative interaction. Such Input 299 is transferred to the Desired Analytical Module 301, which represents the majority function of the Trusted Platform 10 to synchronize mutually beneficial security information. The Affiliate Systems 303 post security requests and exchange security information. If information pertaining to Target 297 or any Target relatives are found, the information is also forwarded to the Warrant Module 300 in parallel. The Information Output 302 of the Module 301 is forwarded to the Affiliate System 303 to complete their requested task or function. Any useful information learnt by the Warrant Module 300 concerning the Target 297 is forwarded to the Results 298 as part of the Enterprise System's 228 forensic investigation.

### Logically Inferred Zero-Database A-Priori Realtime Defense (LIZARD)

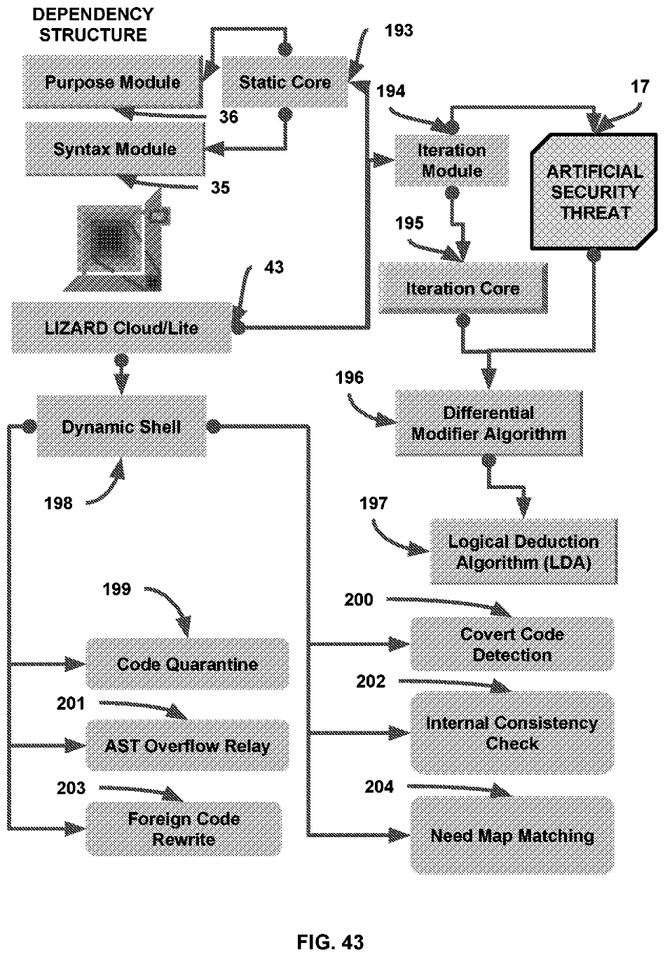

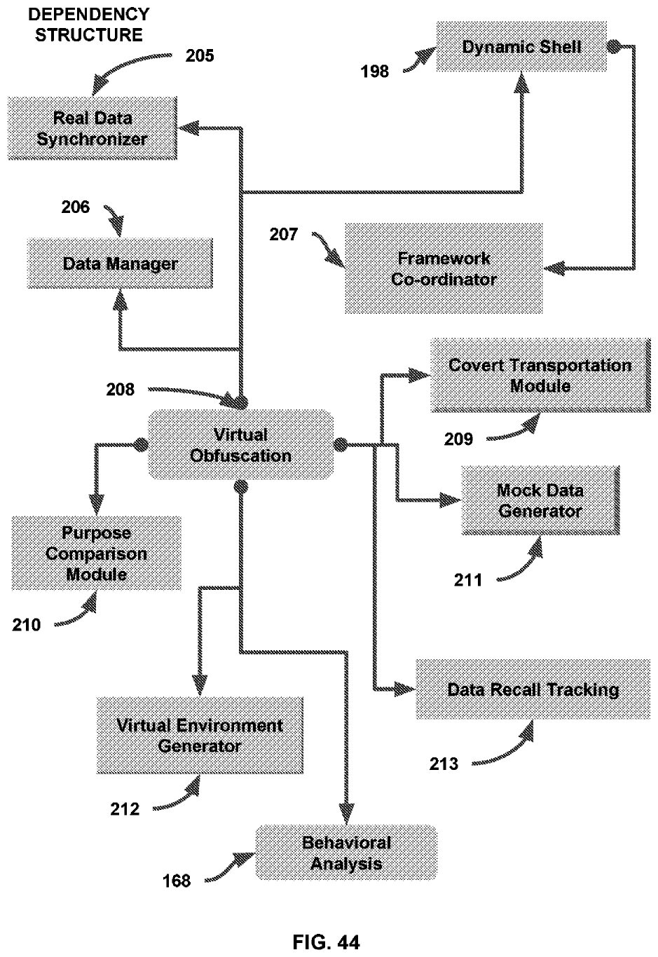

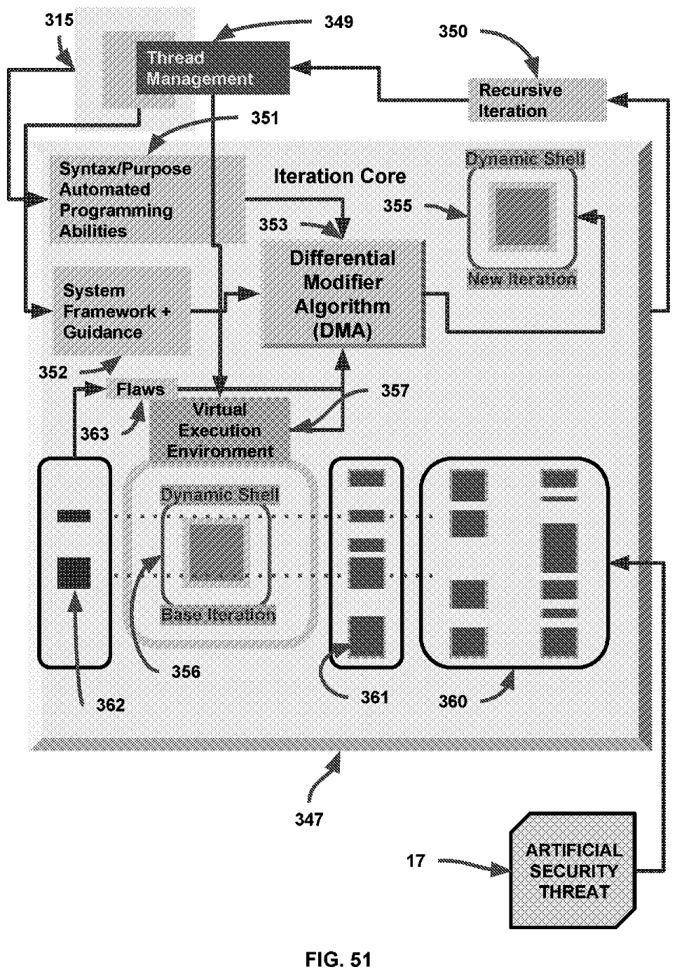

FIGS. 43 and 44 show the dependency structure of LIZARD (Logically Inferred Zero-database A-priori Realtime Defense). The Static Core 193 is where predominantly fixed program modules have been hard coded by human programmers. The Iteration Module 194 intelligently modifies, creates and destroys modules on the Dynamic Shell 198. Uses Artificial Security Threat (AST) for a reference of security performance and uses Iteration Core to process the automatic code writing methodology. The Iteration Core 195 is the main logic for Iterating the Dynamic Shell 198 for security improvements as illustrated at FIG. 51. The Differential Modifier Algorithm 196 modifies the Base Iteration according to the flaws the AST found. After the differential logic is applied, a new iteration is proposed, upon which the Iteration Core is recursively called & undergoes the same process of being tested by AST. The Logic Deduction Algorithm (LDA) 197 receives known security responses of the Dynamic Shell Iteration in it's Current State from the Artificial Security Threat (AST). LDA also deduces what codeset makeup will achieve the known Correct Response to a security scenario (provided by AST). The Dynamic Shell 198 contains predominantly dynamic program modules that have been automatically programmed by the Iteration Module. Code Quarantine 199 isolates foreign code into a restricted virtual environment (i.e. a petri dish). Covert Code Detection 200 detects code covertly embedded in data & transmission packets. AST Overflow Relay 201 data is relayed to the AST 17 for future iteration improvement when the system can only perform a low confidence decision. Internal Consistency Check 202 checks if all the internal functions of a block of foreign code make sense. Makes sure there isn't a piece of code that is internally inconsistent with the purpose of the foreign code as a whole. Foreign Code Rewrite 203, after deriving foreign code purpose, rewrites either parts or the whole code itself and allows only the rewrite to be executed. Mirror test checks to make sure the input/output dynamic of the rewrite is the same as the original. This way, any hidden exploits in the original code are made redundant and are never executed. Need Map Matching 204 is a mapped hierarchy of need & purpose is referenced to decide if foreign code fits in the overall objective of the system (i.e. a puzzle). The Real Data Synchronizer 205 is one of two layers (the other being Data Manager) that intelligently selects data to be given to mixed environments and in what priority. This way highly sensitive information is inaccessible to suspected malware, & only available to code that is well known and established to be trustworthy. The Data manager 206 is the middleman interface between entity & data coming from outside of the virtual environment. The Framework Co-ordinator 207 manages all the input, output, thread spawning and diagnostics of the semi-artificial or artificial algorithms. Virtual Obfuscation 208 confuses and restricts code (therefore potential malware) by gradually and partially submerging them into a virtualized fake environment. Covert Transportation Module 209 transfers malware silently and discretely to a Mock Data Environment 394. With Purpose Comparison Module 210 four different types of Purpose are compared to ensure that the entity's existence and behavior are merited and understood by LIZARD in being productive towards the system's overall objectives. A potentially wide divergence in purpose indicates malicious behavior. Mock Data Generator 211, creates fake data that is designed to be indistinguishable from the real data. i.e. a batch of SSNs. Virtual Environment Manager 212, manages the building of the virtual environment, which includes variables such as ratio of mock data, system functions available, network communication options, storage options etc. Data Recall Tracking 213 keeps track of all information uploaded from and downloaded to the Suspicious Entity 415. This is done to mitigate the security risk of sensitive information being potentially transferred to malware. This security check also mitigates the logistical problems of a legitimate enterprise process receiving mock (fake) data. In the case that mock data had been sent to a (now known to be) legitimate enterprise entity, a “callback” is performed which calls back all of the mock data, and the real data (that was originally requested) is sent.

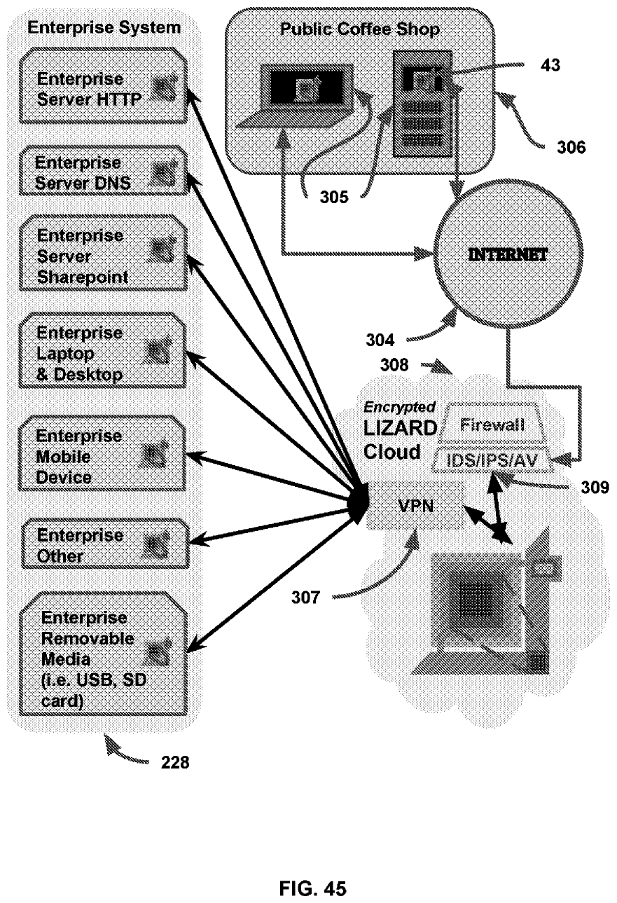

FIG. 45 shows an overview of LIZARD (Logically Inferred Zero-database A-priori Realtime Defense) which is a central oversight algorithm that is able to block all potential cybersecurity threats in realtime, without the direct aid of a dynamic growing database. Determining whether data/access into the system is permitted is based on a need-to-know, need-to-function, purpose-driven-basis. If a block of code or data cannot provide a function/purpose towards achieving the hardcoded goal of the system, then it will be rejected in a covert way that includes virtual isolation and obfuscation. LIZARD is equipped with a syntactical interpreter that can read and write computer code. Combined with it's purpose derivation capabilities, it is able to derive goal-orientated behavior from blocks of code, even those that are covertly embedded in seemingly benign data. All enterprise devices, even those outside of the enterprise premises like a company phone in a public coffee shop, are routed through LIZARD. All software and firmware that runs enterprise assets is hardcoded to perform any sort of download/upload via LIZARD like a permanent proxy. Non-compliance with the permanent proxy policy is mitigated by a snitching policy on loyal assets. A digital transfer to occur within the enterprise system is bound to pass through a piece of hardware that is hardcoded to relay via LIZARD, hence malicious code can find no place of safety nor can any collaborating compromised computers that ignore the permanent proxy policy. LIZARD has a symbiotic relationship with the Iteration Module (IM). IM clones the hardcoded goal-oriented tasks and syntactical comprehension capabilities of LIZARD. It then uses those syntactical capabilities to modify LIZARD to suit the hardcoded goals. The Artificial Security Threat (AST) module is engaged in a parallel virtual environment to stress test differing variations of LIZARD. The variation that scores the best is selected as the next official iteration. LIZARD provides an innovative model that deviates from the status quo of cyber security solutions. With it's advanced logic deduction capabilities it is able to perform instantaneous and accurate security decisions without the “too little too late” paradigm of contemporary cyber security defense. LIZARD interacts with three types of data: data in motion, data in use, and data at rest. LIZARD interacts with 6 types of data mediums (known as vectors): Files, Email, Web, Mobile, Cloud and Removable Media (USB). Enterprise System 228 shows the types of Servers that are running within their infrastructure such as HTTP and DNS etc. Mobile Devices 305 are shown operating within a Public Coffee Shop 306 whilst being connected to the Enterprise System's 228 digital infrastructure via the LIZARD Lite Client 43. Such a Client 43 acts as the gateway to the Internet 304 which thereafter connects to the Encrypted LIZARD Cloud 308.

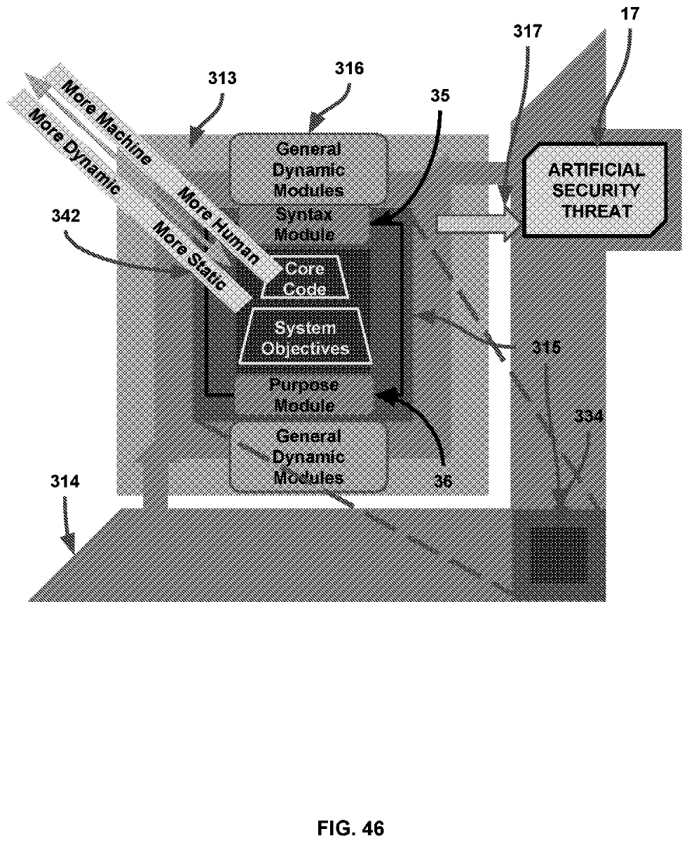

FIG. 46 shows an overview of the major algorithm functions concerning LIZARD. The Outer Dynamic Shell (DS) 313 of LIZARD is a section of functionality that is more prone to changing via iteration. Modules that require a high degree of complexity to achieve their purpose usually belong at this Shell 313; as they will have surpassed the complexity levels a team of programmers can handle directly. The Iteration Module 314 uses the Static Core (SC) 315 to syntactically modify the code base of DS 313 according to the defined purpose in ‘Fixed Goals’ & data from the Data Return Relay (DRR) 317. This modified version of LIZARD is then stress tested (in parallel) with multiple and varying security scenarios by the Artificial Security Threat (AST) 17. The most successful iteration is adopted as the live functioning version. The SC 315 of LIZARD is the least prone to changing via automated iteration, and is instead changed directly by human programmers. Especially the innermost square which is known as Inner Core 334, which is not influenced by automated iterations at all. This innermost layer 334 is like the root of the tree that guides the direction & overall capacity of LIZARD. General Dynamic Modules (GDM) 316 is the zone of modules which are the most heavily malleable to the automated self-programming and hence belong to the jurisdiction of the Dynamic Shell 313. As such programs running in the GDM 316 are in a constant ‘beta’ state (not necessarily stable and a work in progress). When LIZARD performs a low confidence decision it relays relevant data to the AST 17 via the Data Return Relay (DRR) 317 to improve future iterations of LIZARD. LIZARD itself does not directly rely on data for performing decisions, but data on evolving threats can indirectly benefit the a-priori decision making that a future iteration of LIZARD might perform. Label 342 shows how the more human work is involved in the design of the code, the more static the code is (changes very gradually). The more the Iteration Module (IM) 314 programs the code, the more dynamic and fluid the code is. The Syntax 35 and Purpose 36 modules are shown functioning from within SC 315.

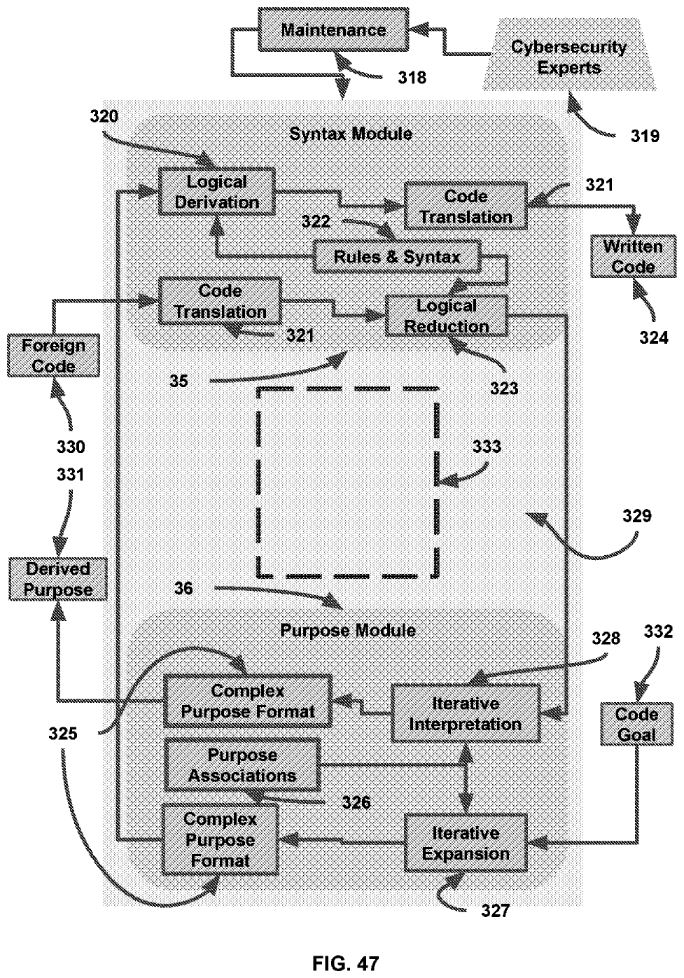

FIG. 47 shows the inner workings of the Static Core (SC) 315. Logic Derivation 320 derives logically necessary functions from initially simpler functions. The end result is that an entire tree of function dependencies are built from a stated complex purpose. Code Translation 321 converts arbitrary (generic) code which is understood directly by Syntax Module functions to any chosen known computer language. The inverse of translating known computer languages to arbitrary code is also performed. Rules and Syntax 322 contains static definitions that aid the interpretation and production of syntactical structures. For example, the rule and syntax for the C++ programming language can be stored in 322. Logic Reduction 323 reduces logic written in code to simpler forms to produce a map of interconnected functions. Written Code 324 is the final output, an executable program, whilst Code Goal 332 is the input. Complex Purpose Format 325 is a storage format for storing interconnected sub-purposes that represent an overall purpose. Purpose Associations 326 is a hardcoded reference for what functions & types of behavior refer to what kind of purpose. Iterative Expansion 327 adds detail and complexity to evolve a simple goal into a complex purpose by referring to Purpose Associations. Iterative Interpretation 328 loops through all interconnected functions & produces an interpreted purpose by referring to Purpose Associations 326. The Outer Core 329 is primarily formed by the Syntax and Purpose modules which work together to derive a logical purpose to unknown foreign code, & to produce executable code from a stated function code goal. Foreign Code 330 is code that is unknown to LIZARD and the functionality and intended purpose is unknown. Whilst Foreign Code 330 is the input to the inner core, Derived Purpose 331 is the output. Purpose 331 is the intention of the given Code 330 as estimated by the Purpose Module 36. It is returned in the Complex Purpose Format 325.

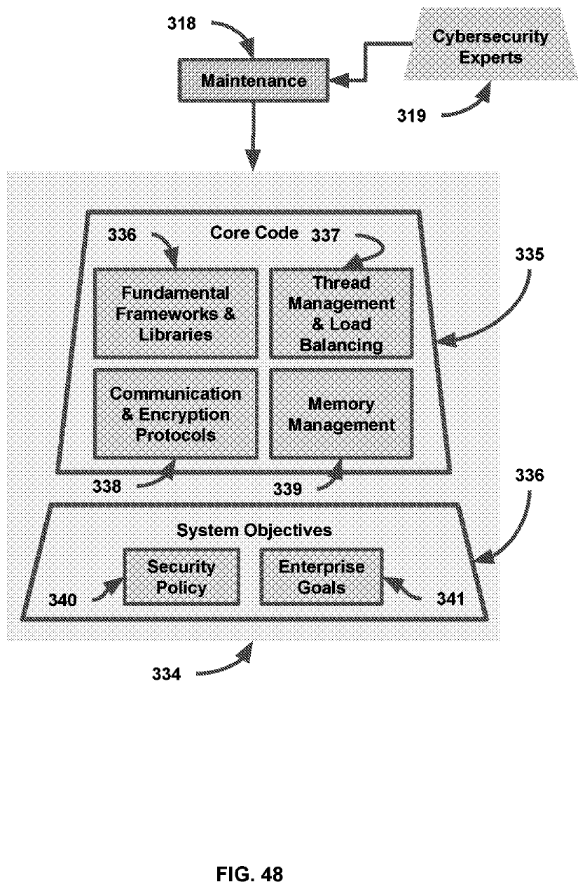

FIG. 48 shows how Inner Core 334 houses the essential core functions of the system, which are directly and exclusively programmed by relevant Cybersecurity Experts 319 via a Maintenance 318 platform. The Core Code 335 is rudimentary groundwork needed to run LIZARD. Within Core 336 Fundamental Frameworks and Libraries 336 holds all the needed function to operate LIZARD such as compression and comparison functions. Within Core 336 Thread Management and Load Balancing 337 enables LIZARD to scale over a cluster of servers efficiently whilst Communication and encryption Protocols defines the types of encryption sued (i.e. AES, RSA etc.). Within Core 336 Memory Management 339 allows the data that is interpreted and processed by LIZARD is efficiently managed within the server's Random Access Memory (RAM). System Objectives 336 contains Security Policy 340 and Enterprise Goals 341. Policy 340 is manually designed by a cyber security analyst (or many) as a guide that may be referenced for LIZARD to operate according to custom variables. Hence LIZARD has a standard of which to justify what is considered an insecure and prohibited action and what is permissible. For example, it might be within the enterprise's Security Policy 340 to prohibit sending emails to recipients outside of the organization, or to lock an account after the third failed password entry attempt. Enterprise Goals 341 defines more broad characteristics of what kind of general infrastructure the enterprise wants to achieve. Goals 341 is mostly used to guide the self-programming of the Dynamic Shell 313 as to what functionalities LIZARD must have and what capabilities it must perform in regards to the enterprise's infrastructure context.

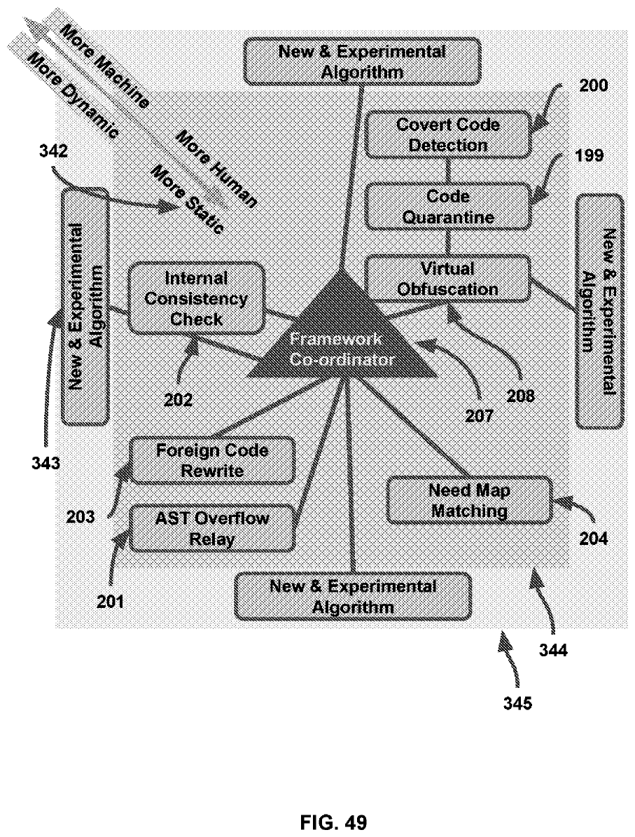

FIG. 49 shows the inner workings of the Dynamic Shell (DS) 313. This section of LIZARD is primarily manipulated by an artificially intelligent programming module (Iteration Module). Modules in the Outer Shell 345 are new & experimental modules that possess a light amount of influence on the overall system's decision making. The Inner Shell 344 is the main body of LIZARD; where most of it's intelligent capabilities operate. New and Experimental Algorithm 343 ‘beta’ allocated software space, where a functional need for a new module can be programmed and tested by humans, artificial intelligence, or both.

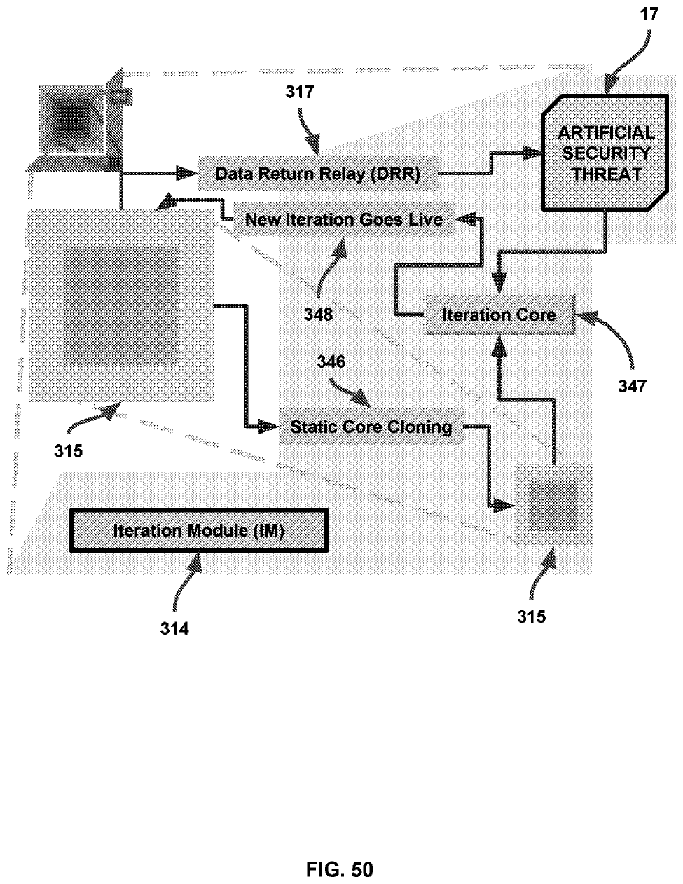

FIG. 50 shows the Iteration Module (IM) which intelligently modifies, creates and destroys modules on the Dynamic Shell 313. It uses Artificial Security Threat (AST) 17 for a reference of security performance and uses the Iteration Core 347 to process the automatic code writing methodology. At the Data Return Relay (DRR) 317 data on malicious attacks & bad actors is relayed to the AST 17 when LIZARD had to resort to making a decision with low confidence. The AST 17 creates a virtual testing environment with simulated security threats to enable the iteration process. The artificial evolution of the AST 17 is engaged sufficiently to keep ahead of the organic evolution of criminal malicious cyber activity. With Static Core Cloning 346 the Static Core 315, including the semi-dynamic Outer Core 329, is used as a criterion for iteration guidance. Since this iteration, in part, modifies the Outer Core 329; self-programming has come full cycle in an artificially intelligent loop. The Iteration Core 347 receives artificial security scenarios & System Objective guidance to alter the Dynamic Shell 313. The Iteration Core 347 produces many iterations. The iteration that performs the best in the artificial security tests is uploaded to become the live functioning iteration of the Dynamic Shell at Stage 348.

FIG. 51 shows Iteration Core 347 which is the main logic for iterating code for security improvements. With Recursive Iteration 350 a new instance of the Iteration Core 347 is called, with the New Iteration 355 replacing the Base Iteration 356. Such a transition is managed by Thread Management 349 which is derived from Thread Management and Load Balancing 337 which is a subset of the Core Code 335. The Differential Modifier Algorithm (DMA) 353 receives Syntax/Purpose Programming Abilities 351 and System Objective Guidance 352 from the Inner Core 334. These two inputs correlate with Fundamental Frameworks and Libraries 336 and Security Policy 340/Enterprise Goals 341. It then uses such a codeset to modify the Base Iteration 356 according to the flaws the AST 17 found. After the differential logic is applied, a New Iteration 355 is proposed, upon which the Iteration Core 347 is recursively called and undergoes the same process of being tested by AST 17. With Queued Security Scenarios 360 multiple scenarios that collectively perform a comprehensive test of the Dynamic Shell 313 at all known points of security. With Active Security Scenarios 361 the currently active security scenario is testing the Dynamic Shell 313 in an isolated Virtual Execution Environment 357. Such an Environment 357 is a virtual instance that is completely separate from the live system. It perform artificially generation malicious attacks and intrusions. Security Result Flaws 362 are presented visually as to indicate the security threats that ‘passed through’ the Base Iteration 356 whilst running the Virtual Execution Environment 357. Thereafter any Flaws 363 that have been discovered are forwarded to the DMA 353 to facilitation the generating of a New Iteration 355 which seeks to omit such Flaws.

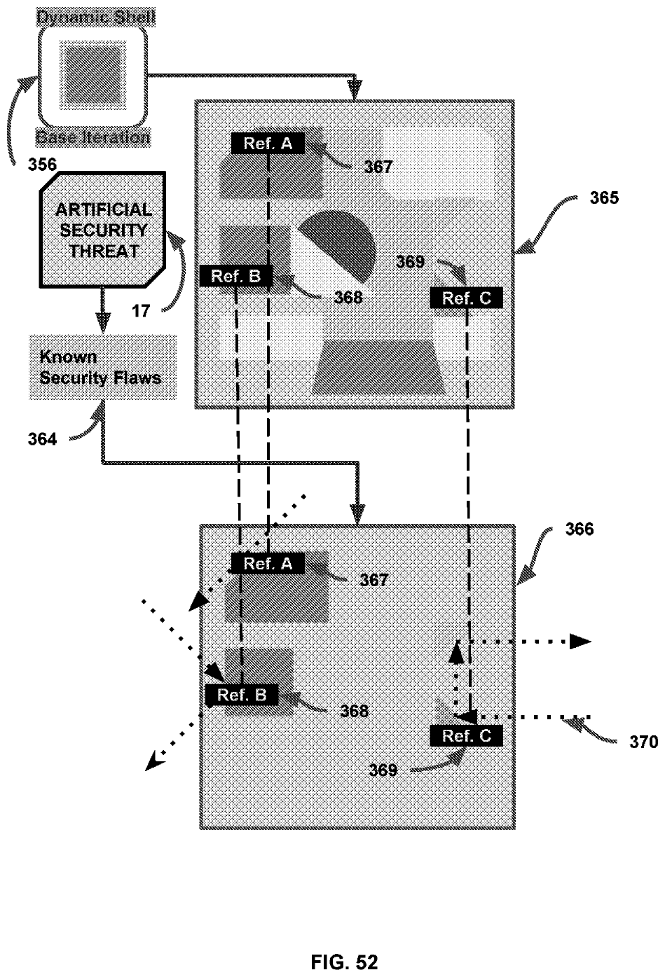

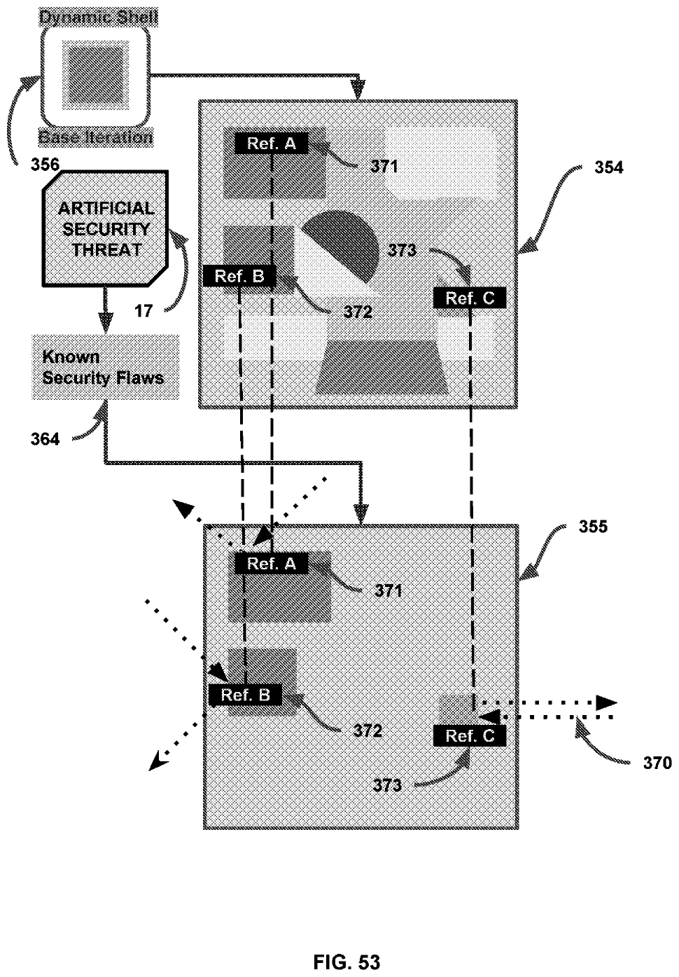

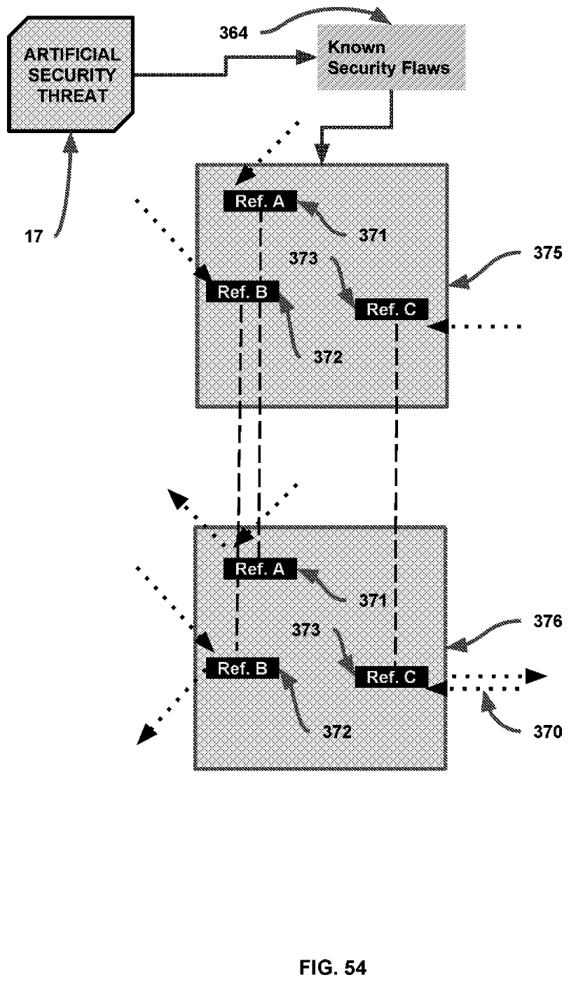

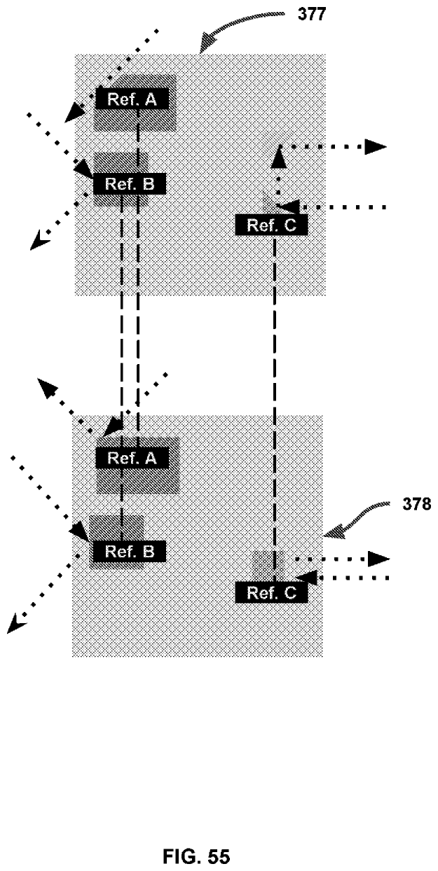

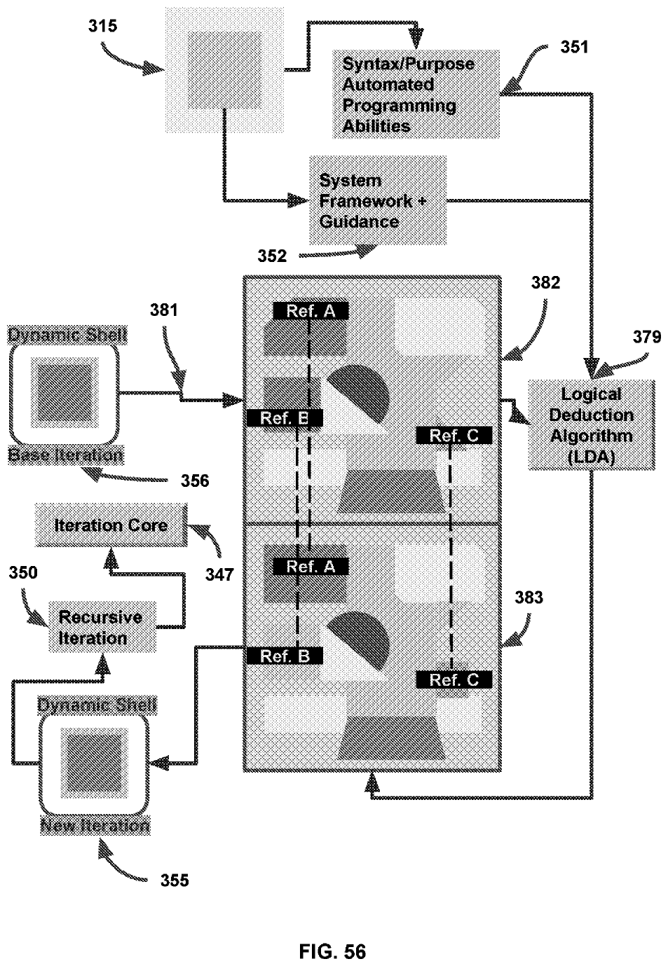

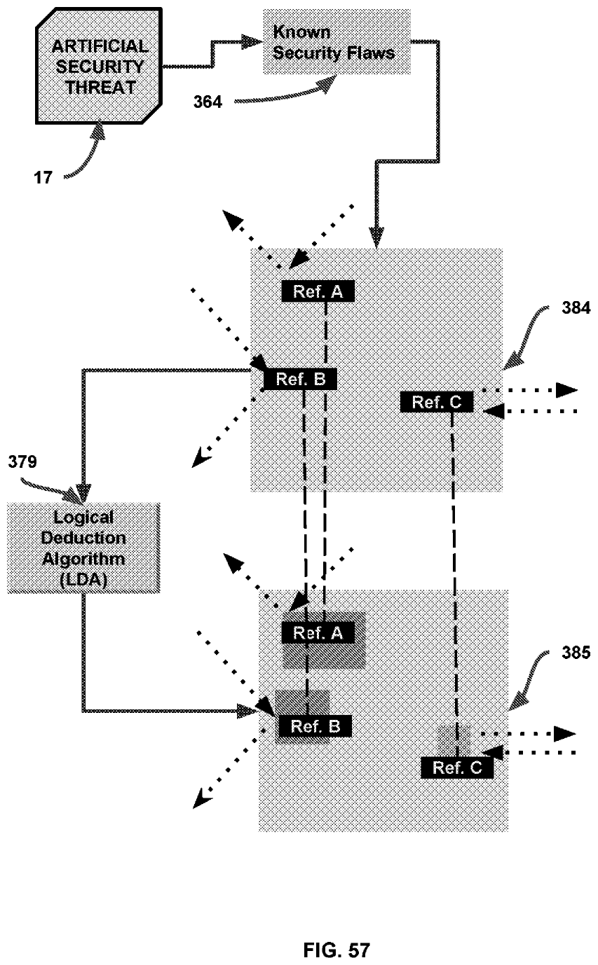

FIGS. 52-57 show the logical process of the Differential Modifier Algorithm (DMA) 353. Current State 365 represents the Dynamic Shell 313 codeset with symbolically correlated shapes, sizes and positions. Different configurations of these shapes indicate different configurations of security intelligence and reactions. AST 17 provides any potential responses of the Current State 365 that happened to be incorrect and what the correct response is (i.e. quarantine this file because it is a virus). Attack Vector 370 (all dotted arrows) acts as a symbolic demonstration for a cybersecurity threat. Direction, size, & color all correlate to hypothetical security properties like attack vector, size of malware, and type of malware. The Attack Vector symbolically ‘bounces’ off of the codeset to represent the security response of the codeset. Ref. A 367 shows a specific security configuration that allows an Attack Vector to pass through, which may or may not be the correct security response. Ref. B 368 shows an Attack Vector bouncing off a security configuration which illustrates an alternate response type to Ref. A whilst potentially being correct or incorrect. Ref. C 369 shows a security response which sends the Attack Vector back to it's place of origin, which may or may not be the correct security response. On FIG. 53 Correct State 354 represents the final result of the Differential Modifier Algorithm's 353 process for yielding the desired security response from a block of code of the Dynamic Shell 313. Correct State 354 is produced by recursively iterating 350 new iterations 355 of the Dynamic Shell 313. Even though there are subtle differences between the Current 365 and Correct 354 States, these differences can result in entirely different Attack Vector 370 responses. Whilst Ref. A 367 allows the Attack Vector to pass straight through, Ref. A 371 (the correct security response) bounces the Attack Vector at a right degree angle. The Attack Vector response for Ref. B in both the Current 365 and Correct 354 States remains unchanged. With Ref. C 373, the Attack Vector is also sent back to its originating source albeit at a different position than Ref. C 369. All these Attack Vector presentations illustrate and correspond to logistical management of security threats. FIG. 54 shows AST Security Attack Vector 375 which is the sequence of attacks provided by the AST 17. Correct Security Response 376 shows the desired security response concerning the Attack Vectors 370. The codeset (shapes) to produce such correct security responses are not shown as at this stage they are not known yet. FIG. 55 shows the Current Dynamic Shell Response Attack 377 which exhibits on inferior security response to the Correct Dynamic Shell Response Attack 378. Such a Correct Response 378 is produced by the Logic Deduction Algorithm (LDA) 197. FIG. 56 shows how LDA 197 infers the correct security setup to match the Correct Attack Response 378. The Static Core 315 provides System Framework/Guidance 352 and Syntax/Purpose Automated Programming Abilities 351 to LDA 379 as to enable it to construct a security program that produces the Correct Attack Response 378. The Base Iteration 356 of the Dynamic Shell 313 is provided to the LDA 379 at Stage 381. Such an iteration is represented as a Security Response Program 382 that produces substandard and ineffective security responses. Such a Program 382 is provided as input for the LDA 379. LDA uses the Syntax/Purpose Capabilities 351 from the Static Core 315 to build off from the Incorrect Security Response Program 382 so that it conforms with the Correct Response Attack 378. Hence the Correct Security Response Program 383 is produced and is considered the New Iteration 355 of the Dynamic Shell 313. The process continues via Recursive Iteration 350 of the Iteration Core 347 will continually upgrade the security capabilities of the Dynamic Shell 313 until it is saturated with all the security information made available by the AST 17. FIG. 57 shows a simplified overview of this process as the AST 17 provides Known Security Flaws 364 along with the Correct Security Response 384. Whilst the AST 17 is able to provide the Known Security Flaws 364 and Responses 384, it is unable to construct a valid and running program that will produce such Correct Responses 384. Hence LDA 379 uses prior (base) Iterations 356 of the Dynamic Shell 313 to produce a superior and better equipped Iteration 355 of the Dynamic Shell known as Correct Security Response Program 385. The usage of the word ‘program’ represents the overall functionality of many different function and submodules that operate within the Dynamic Shell 313.

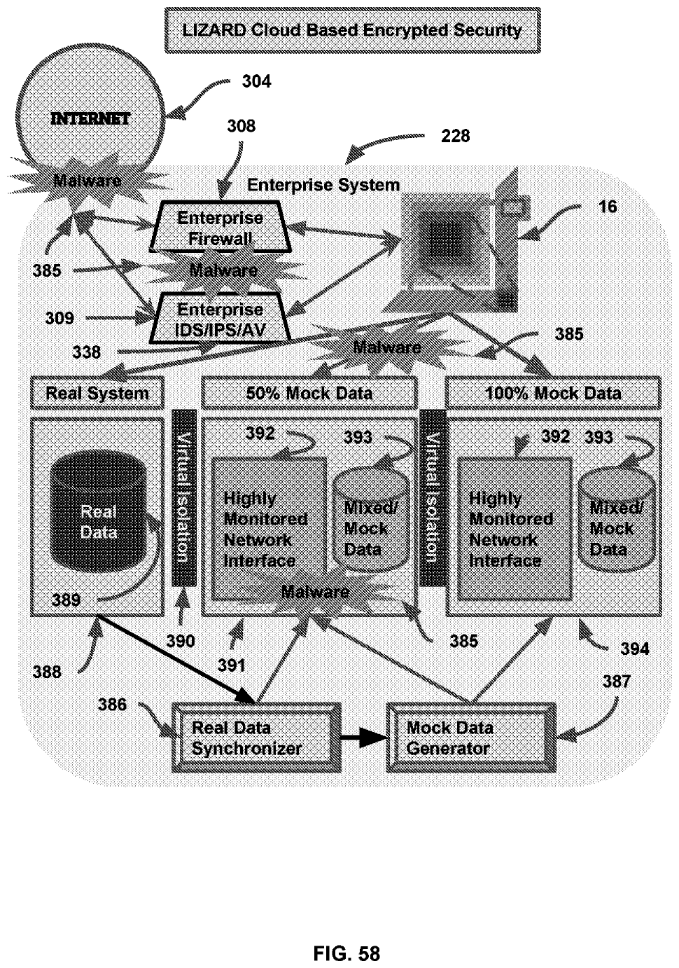

FIG. 58 shows an overview of Virtual Obfuscation. The following capabilities of Virtual Obfuscation & Mock Data Generation are deployed on an encrypted cloud platform, to be used by small/medium businesses with little to no cybersecurity employees. The security system can also be installed directly in datacenters for large corporations. In this case scenario Malware 385 comes form the Internet 304 and bypasses the industry standard Firewall/Intrusion Detection System/Anti-Virus etc. At it's current state of security iteration, LIZARD 16 has a low confidence assessment of the intent/purpose of the incoming block of Code 385. These conditions are assumed as a worst case scenario. So as to mitigate the risk of having an innocent process deprived of entitled crucial data, and to also avoid the risk of allowing malicious code to have sensitive data, the questionable Code 385 is covertly allocated to an environment in which half of the data is intelligently mixed with mock (fake) data. Real System 388 represents unrestricted to Real Data 389 except for typical administrative access requirements. Any subjects operating within the Real System 388 can be easily and covertly transferred to a Partially 391 or Fully 394 Mock Data Environment due to Virtual Isolation 390. The Real Data Synchronizer 386 is one of two layers (the other being Data Manager 401) that intelligently selects data to be given to mixed environments and in what priority. This way highly sensitive information is inaccessible to suspected malware and only available to code that is well known and established to be trustworthy. The Mock Data Generator 387 uses the Real Data Synchronizer 386 as a template for creating counterfeit & useless data. Attributes such as data type, data format, data density, data detail etc. are mimicked from the Real Data 389 to produce a database with realistic looking data that appears to be well integrated into the System at large (no irrelevant and odd data). The perceived risk of confidence in perception of the incoming Foreign Code will influence the level of Obfuscation that LIZARD 16 chooses. High confidence in the code being malicious will invoke allocation to an environment that contains large amounts of Mock Data 394. Low confidence in the code being malicious can invoke either allocation to a Real System 388 (considered a benefit of a doubt) or the 100% Mock Data Environment 394 (considered non-trusting by default). Such customization options in security behavior are defined in Security Policy 340, which is a subset of System Objectives 336 which is a subset of Inner Core 334. A Highly Monitored Network Interface 392 is used in environments containing Mock Data 393. Such a secure Interface is used to protect the environment from leaking into restricted environments like Real System 388 in conjunction with Virtual Isolation 390. Such Isolation 390 uses virtualization technology to completely separate and protect Random Access Memory (RAM) and CPU Threads from mixing as to isolate each environment to itself.

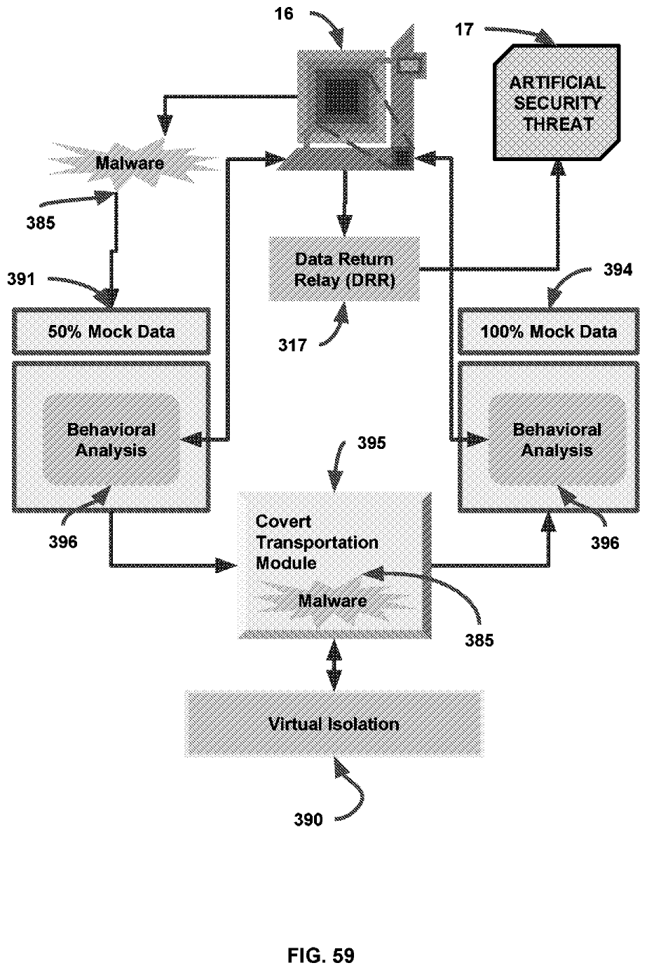

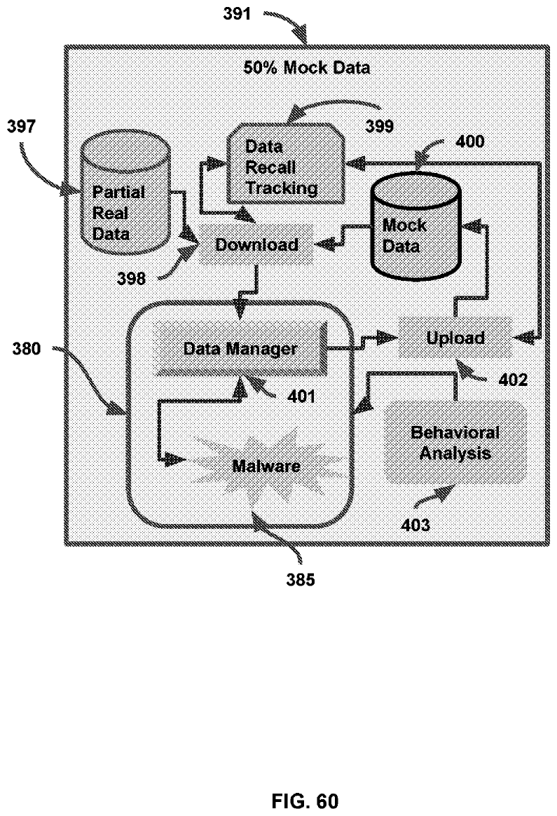

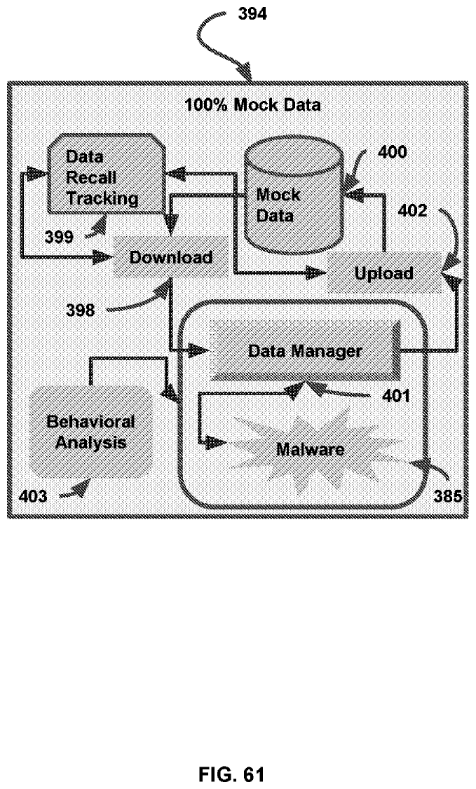

FIGS. 59-61 shows the Monitoring and Responding aspect of Virtual Obfuscation. Such a system monitors and manages malware 385 according to malware behavior. Initially LIZARD perceives, at it's current iteration level of sophistication, a block of code that might or might not be malware. In case it is not malware, LIZARD pushes it into a virtual clone of the real system that is comprised of 50% Mock Data 391. This is done so that if it turns out to not be malware, system and enterprise functionality is not severely hampered (i.e. wrong SSN is provided etc). In the illustrated example, the block of code is actually Malware 385, but at this stage LIZARD is still unsure because of the new and unknown nature of this threat and exploitation method. FIG. 60 specifically shows how Malware 385 is submerged into a Virtually Isolated 380 Mock Data Environment 391 since LIZARD is still not yet sure if it is or is not malware. The Data Manager 401 intelligently mixes real data with mock data so that highly sensitive data has no exposure. The Manager 401 Uploads 402 information generated by the Malware 385 to Mock Data Storage 400 and Downloads 398 previously stored mock data to blend with the Real Data 397. This way the Malware does not have write access to the Real Data Storage 397 and cannot override sensitive information. The Malware 385 is Virtually Isolated 380 so that it is only exposed to the Data Manager 401. This Virtual Isolation prohibits the Malware from being able to access all of the Real Data 397 by bypassing Data Manager 401. Behavioral Analysis 403 tracks the Download 398 and Upload 402 behavior of the suspicious block of code to determine potential corrective action. The Analysis 403 monitors how the Malware 385 behaves in it's candid form, to help confirm or deny LIZARD's original suspicion. Having monitored the Malware's Behavior in it's candid form LIZARD has confirmed the initial suspicion that the foreign code is indeed malware. The Malware 385 is silently and discreetly transferred to the 100% Mock Data Virtual Environment 394 via the Covert Transportation Module 395. Just incase the Malware had already multiplied and performed infections in the 50% Mock Data environment 391, the entire virtual environment is securely destroyed (including the Malware) as a precaution. At this stage the Malware 385 is now fully submerged into a Mock Environment 394 with no exposure to any sensitive information. Potential communication of the Malware to its homebase (i.e. heartbeat signals) via covert communication channels are monitored for potentially improving future Dynamic Shell 313 iterations. Such Malware behavior information is transferred via the Data Return Relay (DRR) 317 to the AST 17 to benefit future iterations. This way the DS 313 can make a more confident decision about similar Malware 385 rather than having to resort to placing it in a 50% Mock Data Environment 391 again (which still contains some risk concerning legitimate data being stolen).

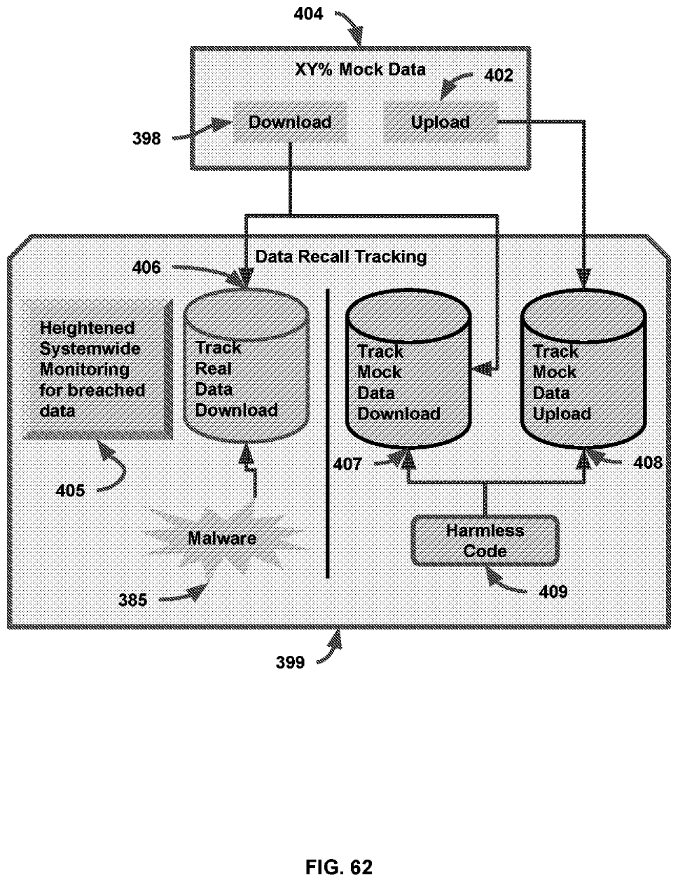

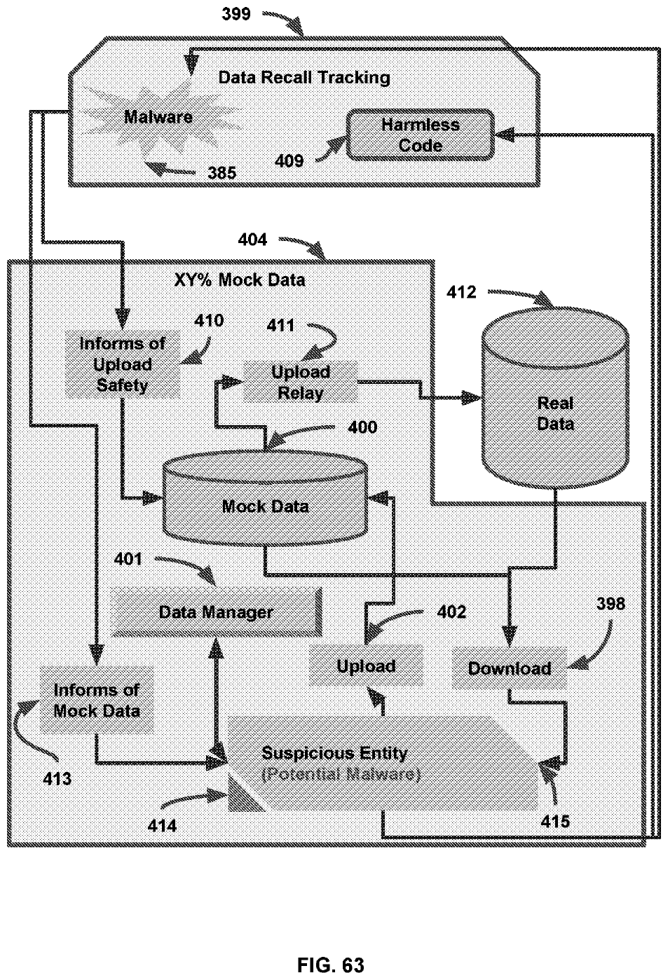

FIGS. 62 and 63 shows Data Recall Tracking 399 keeps track of all information uploaded from and downloaded to the Suspicious Entity 415. This is done to mitigate the security risk of sensitive information being potentially transferred to Malware. This security check also mitigates the logistical problems of a legitimate enterprise process receiving Mock Data 400. In the case that Mock Data had been sent to a (now known to be) legitimate enterprise entity, a “callback” is performed which calls back all of the Mock Data, and the Real Data (that was originally requested) is sent as a replacement. A callback trigger is implemented so that a legitimate enterprise entity will hold back on acting on certain information until there is a confirmation that the data is not fake. If real data had been transferred to the malware inside a virtual mixed environment, the entire environment container is securely destroyed with the Malware 385 inside. An alert is placed systemwide for any unusual activity concerning the data that was known to be in the malware's possession before it was destroyed. This concept is manifested at Systemwide Monitoring 405. If the entity that received partial real data turns out to be malware (upon analyzing behavior patterns), then the virtual environment (including the malware) is securely destroyed, & the enterprise-wide network is monitored for unusual activity of the tagged real data. This way any potential information leaks are contained. With Track Mock data Download 407 and Upload 408; Mock data that was sent to and from a Suspicious Entity 415 in a virtual container is tracked. With Informs of Upload Safety 410, Data that has been written in the Mock Data Collection 400 initially as a safeguard is later considered safe and hence is prepared to be written to Real Data 412 to fulfill the Upload 402 request of the Suspicious Entity 415. Thereafter the Upload Relay 411 passes on such marked safe information to Real Data 412. In the case that a legitimate enterprise entity (not malware) received Mock Data 400, it is Informed 413 of the extent of the mock data presence. The Real Data 412 is uploaded to precisely replace the Mock Data. The Data Recall Trigger 414 is an installation of software performed on legitimate entities (and inadvertently; malicious entities attempting to appear legitimate) that checks for hidden signals which indicate that a Mixed Data Environment has potentially been activated. Data Manager 401 is the middleman interface between the Entity 415 and data that calculates the proportions of Real Data 412 (if any) that should be mixed with Mock Data 400 (if any). In the Upload 402 and Download 398 streams of information, individual packets/files are marked (if required) for the Data Recall Trigger 414 to consider a reversal of data.

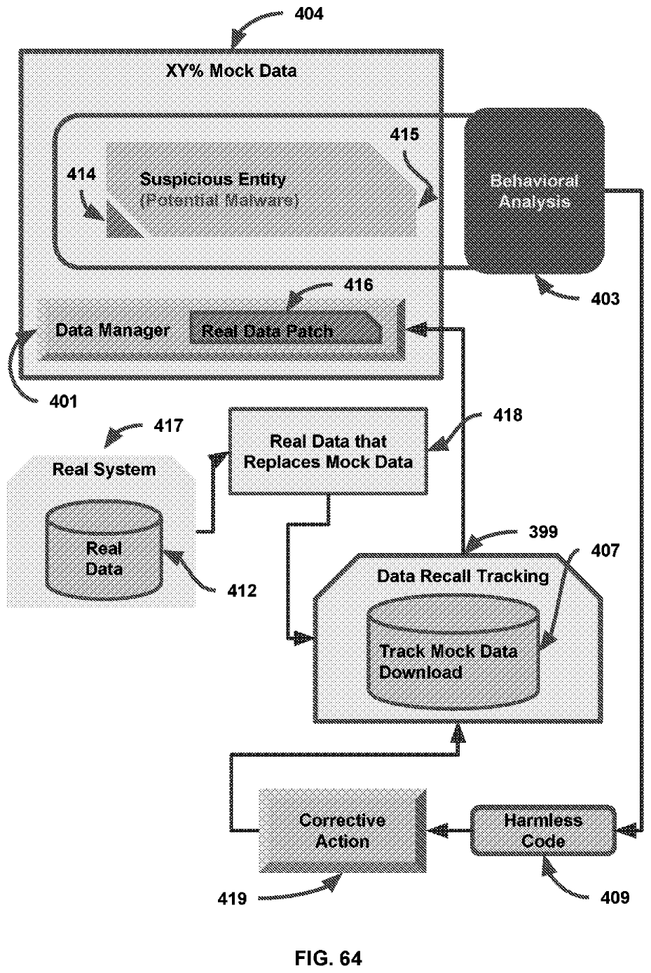

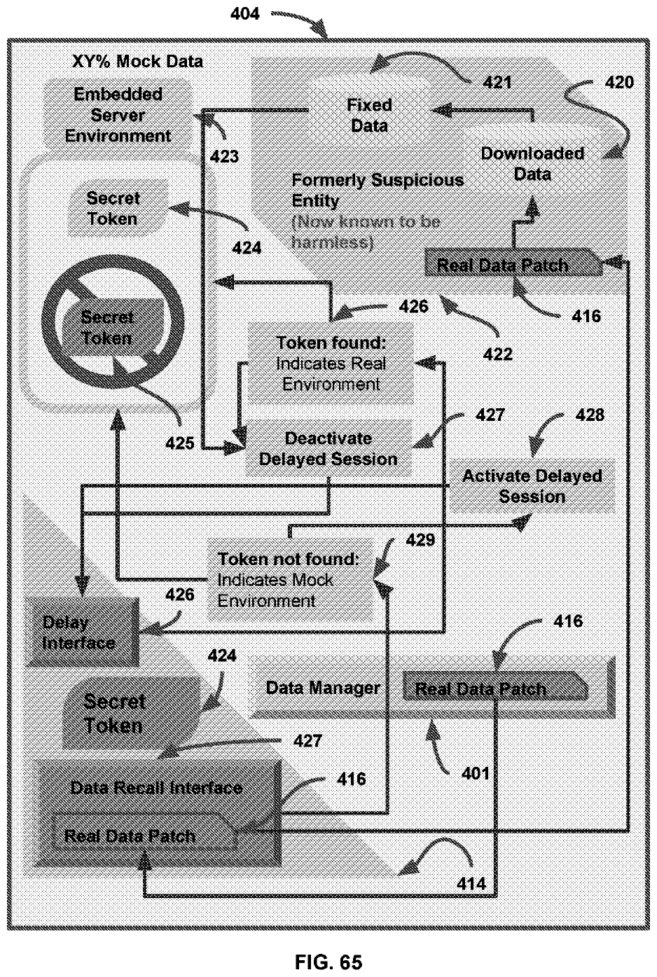

FIGS. 64 and 65 show the inner workings of the Data Recall Trigger 414. Behavioral Analysis 403 tracks the download and upload behavior of the Suspicious Entity 415 to determine potential Corrective Action 419. Real System 417 contains the original Real Data 412 that exists entirely outside of the virtualized environment and contains all possible sensitive data. Real Data that Replaces Mock Data 418 is where Real data is provided unfiltered (before even the Real Data Synchronizer 386) to the Data Recall Tracking 399. This way a Real Data Patch 416 can be made to replace the mock data with real data on the Formerly Suspicious Entity 422. The Data Manager 401, which is submerged in the Virtually Isolated Environment 404, receives a Real Data Patch 416 from Data Recall Tracking 399. This Patch 416 includes the replacement instructions to convert the Formerly Suspicious Entity 422 (which is now known to be harmless) to a correct, real and accurate information state. Such a Patch 416 is transferred to the Data Recall Interface 427 which is subsequently transferred to the Formerly Suspicious Entity 422. Downloaded Data 420 is the data that the enterprise had downloaded within a Mock Data Environment 404 (hence the data is partially or fully fake). Fixed Data 421 is where the Mock data has been replaced with it's counterpart Real Data after the Real Data Patch 416 has been applied. When Harmless Code 409 has been cleared by Behavioral Analysis 403 to being malicious, Corrective Action 419 is performed. Such Action 419 is to replace the Mock Data in the Formerly Suspicious Entity 422 with the Real Data 412 that it represents. Secret Token 424 is a security string that is generated and assigned by LIZARD. The Secret Token 424 does not prove to the Virtual Obfuscation System that the Suspicious Entity 415 is legitimate and harmless. Instead it allows the Entity that is indeed harmless to not proceed with it's job since it knows it has been subject to a Partially 391 or Fully 394 Mock Data Environment. As long as an Entity is legitimate there should be no logistical problems of an employee/software etc. acting upon fake information and leading to real life issues (wrong address sent, wrong employee fired etc.) The Data Recall Trigger 414 only exists on legitimate enterprise functions and entities. By default, a legitimate entity will check an agreed upon location in the Embedded Server Environment 404 for the Token's 424 presence. If the Token is Missing 429 and 425, this indicates the likely scenario that this legitimate entity has been accidentally placed in a partially Mock Data Environment (because of the risk assessment of it being malware). Thereafter A Delayed Session 428 with the Delay Interface 426 is activated. If the Token is found 426 and 424, this indicates that the server environment is real and hence any delayed sessions are Deactivated 427. The Delay Interface 426 is a Module that is pre-installed directly on the entity. Upon indication of being in a Mock Environment 404, a delayed session will be activated. A delayed session means the processes of the entity are made artificially slow to grant Behavioral Analysis 403 time to make a decision about whether this entity is harmless or malicious. Practically such a delay is expected to take several seconds per action. It is extremely difficult for actual malware to ever gain a copy of the Secret Token (which itself can be changed and regenerated routinely), because it is only secretly embedded on a 100% Real Data system, which malware is almost never likely to ever be on. In the case scenario that the Secret Token is not found, the Delay Interface 426 is engaged which implies the entity acts patient until it is regranted Real Data Access by Behavioral Analysis 403.

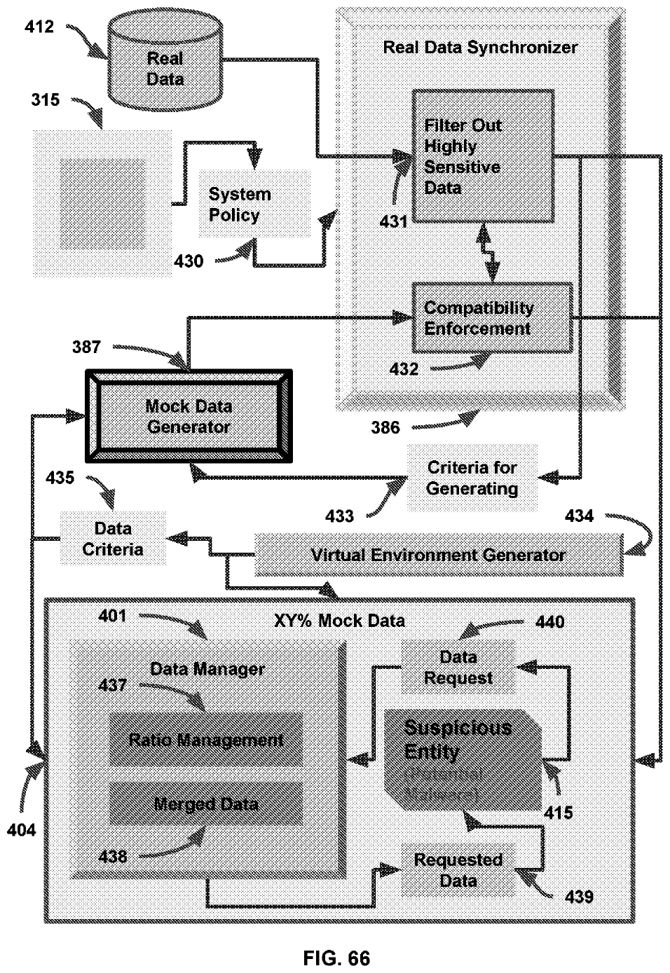

FIG. 66 shows Data Selection, which filters out highly sensitive data and mixes Real Data with Mock Data. Real Data 412 is provided to the Real Data Synchronizer 386 which Filters Out Highly Sensitive Data 431. The Filter range varies according to System Policy 430 which is defined in the Static Core 315. This Module 431 ensures that sensitive information never even reaches the same virtual environment that the Suspicious Entity 415 exists in. The data is filtered once, upon the Generating 434 of the Virtual Environment 404. With Criteria for Generating 433, the filtered real data is used as criteria for what kind and amount of Mock Data should be generated. The Mock Data Generator 387 creates fake data that is designed to be indistinguishable from the real data. I.e. a batch of SSNs. With Compatibility Enforcement 432 the generated Mock Data is verified to be compatible with the Real Data, ensuring there isn't too much overlap and there aren't pockets of missing data types. The collection of both real and fake data are made to seamlessly merge without raising any suspicion. i.e. Fake SSNs and real SSNs don't overlap (avoid duplicates). The Virtual Environment Generator 434 manages the building of the Virtual Environment 404, which includes variables such as ratio of mock data, system functions available, network communication options, storage options etc. Data Criteria 435 is the variable for tuning the ratio of Real data to Mock (fake) Data. With Merged Data 438, data is merged according to the Data Criteria 435. During the merging process, Real Data that is marked as less sensitive is merged with Mock Data that gives the impression of being more sensitive. Ratio Management 437 constantly adjusts the amount of Real and Mock Data being merge, as do conform with the desired Mock Data Ratio. The data is merged in realtime according to the Data Request 440 of the Suspicious Entity 415. The data is returned with the appropriate Mock Data ratio at Requested Data 439.

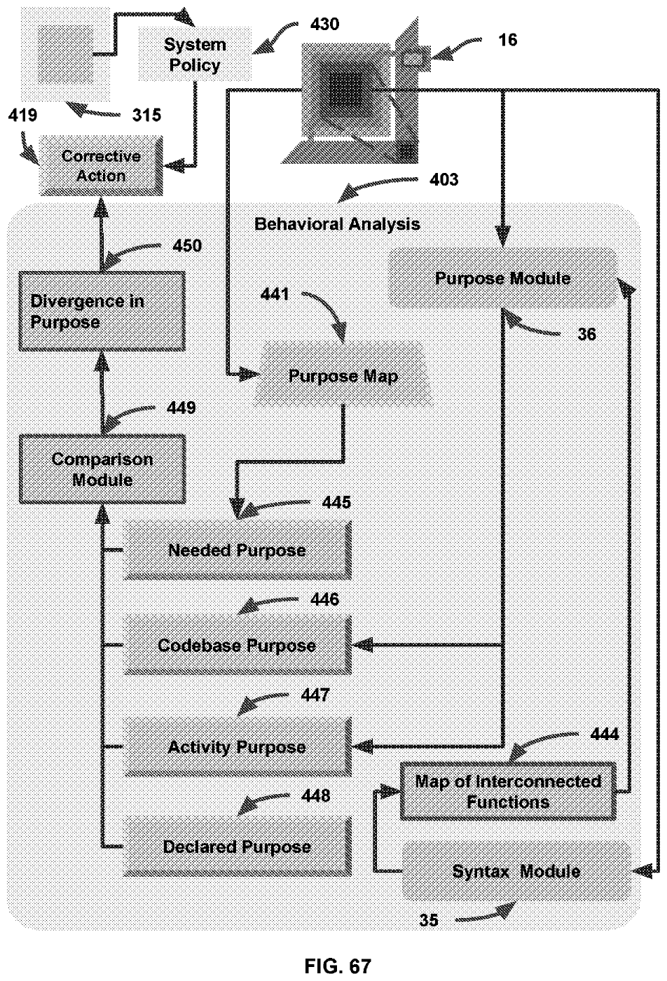

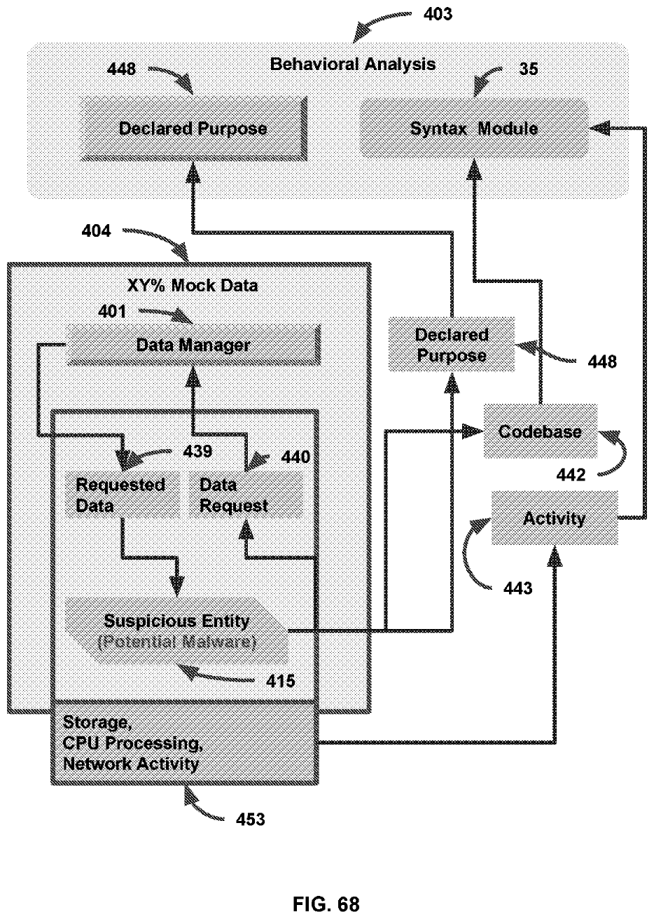

FIGS. 67 and 68 show the inner workings of Behavioral Analysis 403. Purpose Map 441 is a hierarchy of System Objectives which grants purpose to the entire Enterprise System. Such purpose is assigned for even the granularity of small-scale networks, CPU processing, and storage events. The Declared, Activity and Codebase Purposes are compared to the innate system need for whatever the Suspicious Entity 415 is allegedly doing. With Activity Monitoring 453 the suspicious entity's Storage, CPU Processing, and Network Activity are monitored. The Syntax Module 35 interprets such Activity 443 in terms of desired function. Such functions are then translated to an intended purpose in behavior by the Purpose Module 36. For example, the Codebase Purpose 446 might be to file annual earning reports, yet the Activity Purpose 447 might be “to gather all the SSNs of the top paid employees”. This methodology is analogous to the customs division of an airport where someone has to declare certain items to customs, whilst customs does a search of their bags anyways. Codebase 442 is the source code/programming structure of the Suspicious Entity 415. Entities that do not disclose their source code because of being a compiled closed source program can be blocked from accessing the system by System Policy 430. Such a Codebase 442 is forwarded to the Syntax Module 35 as a subset of Behavioral Analysis 403. The Syntax Module 35 understands coding syntax and is able to reduce programming code and code activity to an intermediate Map of Interconnected Functions 444. Such Functions 444 represents the functionality of Codebase 442 and Activity 443 and is transferred to the Purpose Module 36 which produces the perceived ‘intentions’ of the Suspicious Entity 415. The Purpose Module 36 produces the outputs Codebase Purpose 446 and Activity Purpose 447. Codebase Purpose 446 contains the known purpose, function, jurisdiction and authority of Entity 415 as derived by LIZARD's syntactical programming capabilities. Activity Purpose 447 contains the known purpose, function, jurisdiction and authority of Entity 415 as understood by LIZARD's understanding of its storage, processing and network Activity 453. Declared Purpose is the assumed purpose, function, jurisdiction, and authority of Entity 415 as declared by the Entity itself. Needed Purpose 445 contains the expected purpose, function, jurisdiction and authority the Enterprise System requires. This is similar to hiring an employee to fulfill a need of the company. This enables LIZARD to block a Suspicious Entity 415 incase it's capabilities and/or services are not absolutely needed by the system. All four of theses purposes 445-448 are compared in the Comparison Module 449 to ensure that the Entity's 415 existence and behavior within the Enterprise System is merited and understood by LIZARD in being productive towards the System's Objectives 336. Any inconsistencies between the four purposes 445-448 will invoke a Divergence in Purpose 450 scenario which leads to Corrective Action 419. Corrective Action can potentially mark the Suspicious Entity 415 as Malware 385 or as Harmless 409. An ensuing action may be to securely destroy the virtual container, or to discreetly move the Malware 385 to a new virtual environment with zero access to Real Data (Mock Data only) and real enterprise network access.

### Critical Thinking Memory & Perception (CTMP)

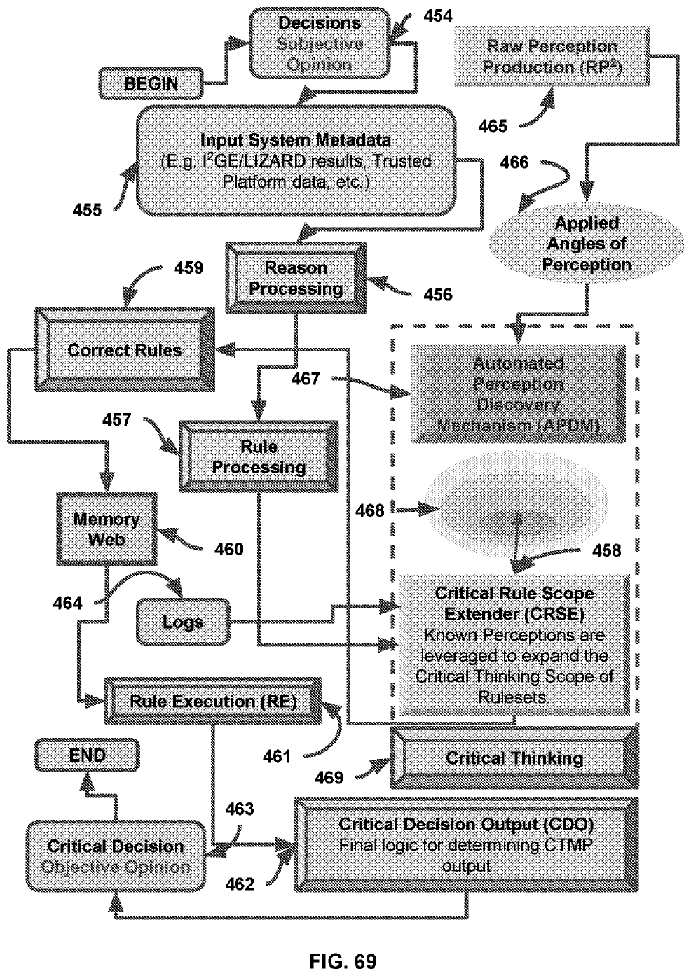

FIG. 69 illustrates the main logic of CTMP 22. CTMP's primary goal is to criticize decisions made by a third party. CTMP 22 cross-references intelligence from multiple sources (i.e. I²GE, LIZARD, Trusted Platform, etc.) and learns about expectations of perceptions and reality. CTMP estimates it's own capacity of forming an objective decision on a matter, and will refrain from asserting a decision made with low internal confidence. Incoming streams of data, such as an army of globally deployed agents as well as information from the Trusted Platform, are all converted into actionable data. Subjective opinion decisions 454 indicates the original subjective decision provided by the input algorithm which is known as the Selected Pattern Matching Algorithm (SPMA) 526. The SPMA is typically a security related protection system, yet without limiting other types of systems such as Lexical Objectivity Mining (LOM) (reasoning algorithm) and Method for Perpetual Giving (MPG) (tax interpretation algorithm). Input system Metadata 455 indicates raw metadata from the SPMA 526 which describes the mechanical process of the algorithm and how it reached such decisions. Reason Processing 456 will logically understand the assertions being made by comparing attributes of properties. In Rule Processing 457, a subset of Reason Processing, the resultant rules that have been derived are used as a reference point to determine the scope of the problem at hand. Critical Rule Scope Extender (CRSE) 458 will take the known scope of perceptions and upgrade them to include critical thinking scopes of perceptions. Correct rules 459 indicates correct rules that have been derived by using the critical thinking scope of perception. In Memory Web 460, the market variables (Market Performance 30 and Profit History 31) logs are scanned for fulfillable rules. Any applicable and fulfillable rules are executed to produce investment allocation override decisions. In Rule Execution (RE) 461, rules that have been confirmed as present and fulfilled as per the memory's scan of the Chaotic Field 613 are executed to produce desired and relevant critical thinking decisions. Such execution of rules leads to the inevitably unambiguous results. Whilst a chaotically complex process can lead to inconsistent yet productive results, the logically complex process of RE 461 always leads to the same deduced results contingent on the ruleset being consistent. In Critical Decision Output 462, final logic for determining the overall output of CTMP by comparing the conclusions reached by both Perception Observer Emulator (POE) 475 and Rule Execution (RE) 461. Critical Decision 463 is the final output which is an opinion on the matter which attempts to be as objective as possible. Logs 464 are the raw information that is used to independently make a critical decision without any influence or bias from the subjective opinion of the input algorithm (MPG). Raw Perception Production (RP2) 465 is a module that receives metadata logs from the SPMA 526. Such logs are parsed and a perception is formed that represents the perception of such algorithm. The perception is stored in a Perception Complex Format (PCF), and is emulated by the Perception Observer Emulator (POE) 475. Applied Angles of Perception 466 indicates angles of perception that have already been applied and utilized by the SPMA 526. Automated Perception Discovery Mechanism (APDM) 467 indicates a module that leverages the Creativity Module 18 which produces hybridized perceptions (that are formed according to the input provided by Applied Angles of Perception 466) so that the perception's scope can be increased. 468 indicates the entire scope of perceptions available to the computer system. Critical Thinking 469 indicates the outer shell jurisdiction of rule based thinking. This results in Rule Execution (RE) 461 manifesting the rules that are well established according to the SPMA 526 but also the new Correct Rules 459 that have been derived from within CTMP.

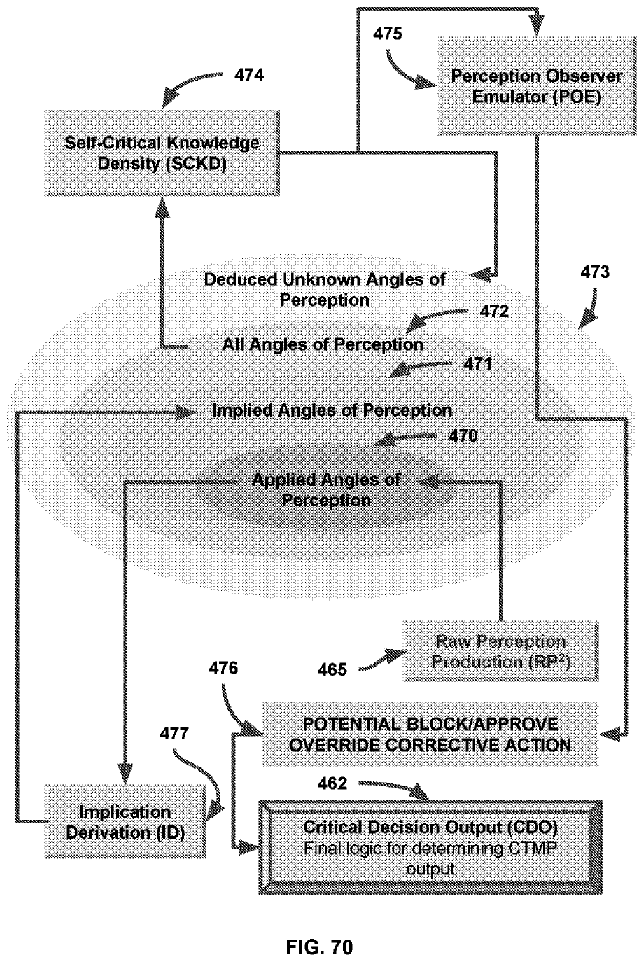

Referring to Self-Critical Knowledge Density 474 of FIG. 70, Incoming raw logs represent technical knowledge known by the SPMA 526. This module 474 estimates the scope and type of potential unknown knowledge that is beyond the reach of the reportable logs. This way the subsequent critical thinking features of CTMP can leverage the potential scope of all involved knowledge, known and unknown directly by the system. Perception Observer Emulator (POE) 475 produces an emulation of the observer and tests/compares all potential points of perception with such variations of observer emulations. The input is all of the potential points of perception in addition to the enhanced data logs. The output is the resultant security decision produced by such enhanced logs according to the best, most relevant, and most cautious observer with such a mixture of selected perceptions. Referring to Implication Derivation (ID) 477, this module derives angles of perception data that can be implicated from the current Applied Angles of Perception 470. Referring to Override Corrective Action 476, the final corrective action/assertion criticism produced by Perception Observer Emulator (POE) 475.

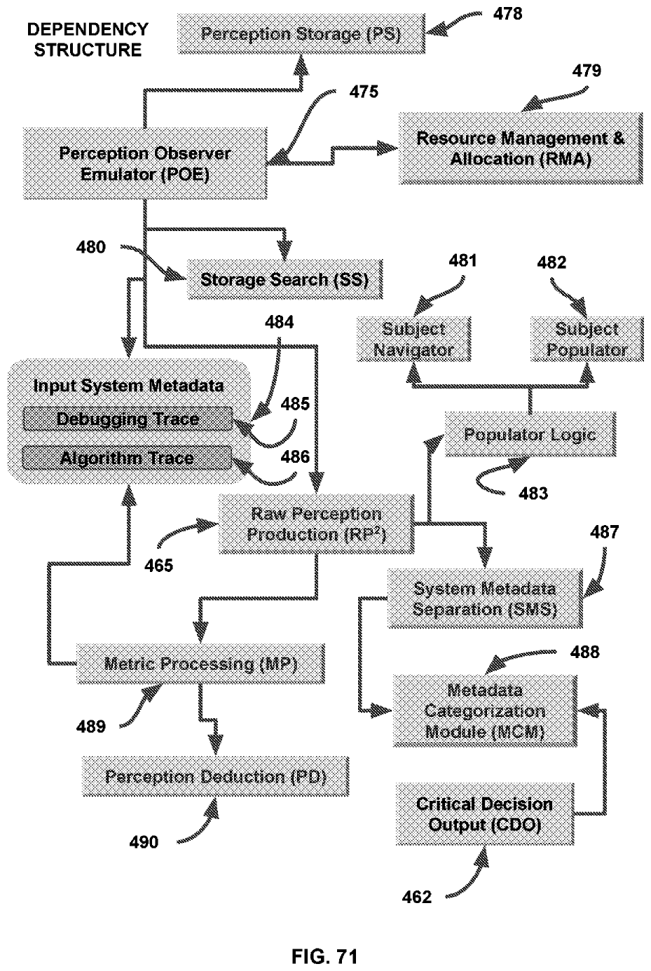

FIG. 71 shows the dependency structure of CTMP. Referring to Resource Management & Allocation (RMA) 479, adjustable policy dictates the amount of perceptions that are leveraged to perform an observer emulation. The priority of perceptions chosen are selected according to weight in descending order. The policy can then dictate the manner of selecting a cut off, whether than be a percentage, fixed number, or a more complex algorithm of selection. Referring to Storage Search (SS) 480, The CVF derived from the data enhanced logs is used as criteria in a database lookup of the Perception Storage (PS) 478. Metric Processing (MP) 489 reverse engineers the variables from the Selected Pattern Matching Algorithm (SPMA) 526 investment allocation to ‘salvage’ perceptions from such algorithm's intelligence. Perception Deduction (PD) 490 uses a part of the investment allocation response and its corresponding system metadata to replicate the original perception of the investment allocation response. Critical Decision Output (CDO) 462 indicates the final logic for determining CTMP output. Referring to Metadata Categorization Module (MCM) 488, the debugging and algorithm traces are separated into distinct categories using traditional syntax based information categorization. Such categories can then be used to organize and produce distinct investment allocation responses with a correlation to market/tax risks and opportunities. Referring to System Metadata Separation (SMS) 487, Input System Metadata 455 is separated into meaningful investment allocation cause-effect relationships. Referring to Populator Logic 483, comprehensively assorts all the investment allocations with relevant market/tax risks, opportunities, and their respective responses. Subject Navigator 481 scrolls through all applicable subjects. Subject Populator 482 retrieves the appropriate investment risk and allocation correlated with the subject. Perception Storage (PS) 478 perceptions, in addition to their relevant weight, are stored with the comparable variable format (CVF) as their index. This means the database is optimized to receive a CVF as the input query lookup, and the result will be an assortment of perceptions.

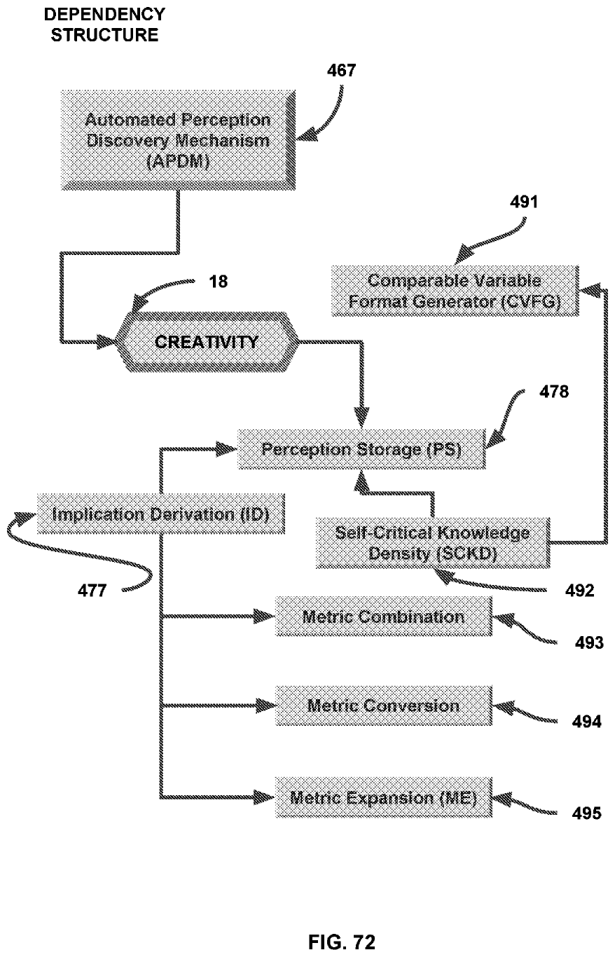

Referring to FIG. 72, Implication Derivation (ID) 477 derives angles of perception of data that can be implicated from the current known angles of perceptions. Referring to Self-Critical Knowledge Density (SCKD) 492, incoming raw logs represent known knowledge. This module estimates the scope and type of potential unknown knowledge that is beyond the reach of the reportable logs. This way the subsequent critical thinking features of the CTMP can leverage the potential scope of all involved knowledge, known and unknown directly by the system. In Metric Combination 493, angles of perception are separated into categories of metrics. In Metric Conversion 494, individual metrics are reversed back into whole angles of perception. In Metric Expansion (ME) 495, the metrics of multiple and varying angles of perception are stored categorically in individual databases. The upper bound is represented by the peak knowledge of each individual Metric DB. Upon enhancement and complexity enrichment, the metrics are returned to be converted back into Angles of Perception and to be leveraged for critical thinking. With Comparable Variable Format Generator (CVFG) 491, a stream of information is converted into Comparable Variable Format (CVF).

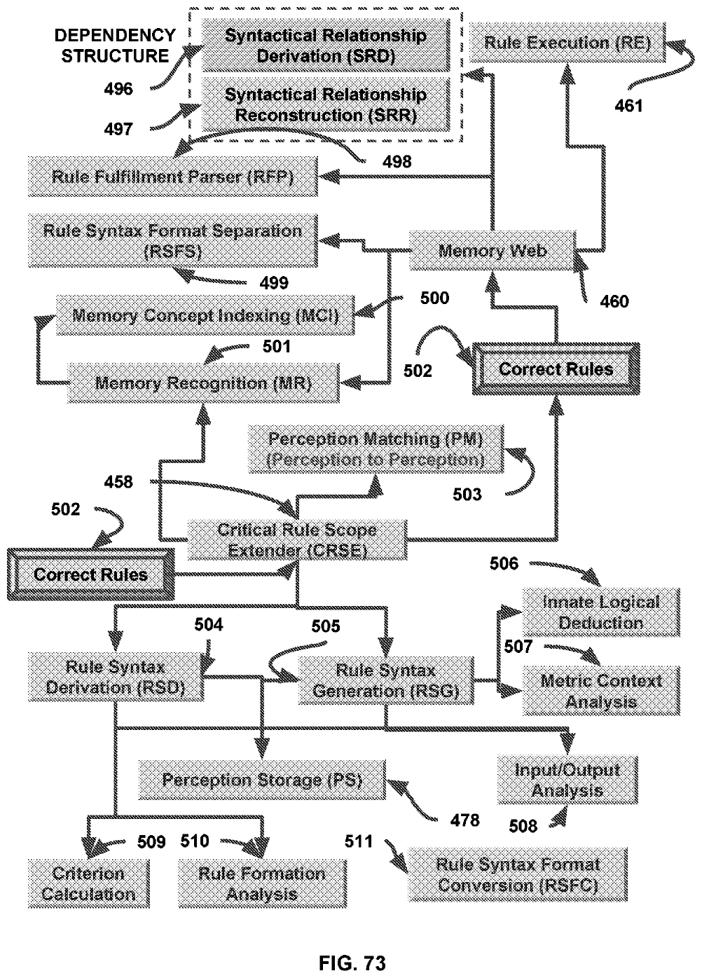

FIG. 73 shows the dependency structure of CTMP. In Critical Rule Scope Extender (CRSE) 458, known perceptions are leveraged to expand the Critical Thinking Scope of Rulesets. In Perception Matching 503, a Comparable Variable Format (CVF) is formed from the perception received from Rule Syntax Derivation (RSD) 504. The newly formed CVF is used to lookup relevant Perceptions in the Perception Storage (PS) 479 with similar indexes. The potential matches are returned to Rule Syntax Generation (RSG) 505. In Memory Recognition (MR) 501, a Chaotic Field 613 is formed from input data. Field scanning is performed to recognize known concepts. In Memory Concept Indexing 500, the whole concepts are individually optimized into separate parts known as indexes. These indexes are used by the letter scanners to interact with the Chaotic Field 613. The Rule Fulfillment Parser (RFP) 498 receives the individual parts of the rule with a tag of recognition. Each part is marked as either having been found, or not found in the Chaotic Field 613 by Memory Recognition 501. The RFP can then logically deduce which whole rules, the combination of all of their parts, have been sufficiently recognized in the Chaotic Field 613 to merit Rule Execution (RE) 461. In Rule Syntax Format Separation (RSFS) 499, Correct Rules are separated and organized by type. Hence all the actions, properties, conditions, and objects are stacked separately. This enables the system to discern what parts have been found in the Chaotic Field 613, and what parts have not. In Rule Syntax Derivation 504, logical ‘black and white’ rules are converted to metric based perceptions. The complex arrangement of multiple rules are converted into a single uniform perception that is expressed via multiple metrics of varying gradients. Rule Syntax Generation (RSG) 505 receives previously confirmed perceptions which are stored in Perception Format and engages with the perception's internal metric makeup. Such gradient-based measures of metrics are converted to binary and logical rulesets that emulates the input/output information flow of the original perception. Rule Syntax Format Separation (RSFS) 499 Correct rules represent the accurate manifestation of rulesets that conform to the reality of the object being observed. Correct rules are separated and organized by type. Hence all the actions, properties, conditions, and objects are stacked separately. This enables the system to discern what parts have been found in the Chaotic Field 613, and what parts have not. Innate Logical Deduction 506 uses logical principles, hence avoiding fallacies, to deduce what kind of rule will accurately represent the many gradients of metrics within the perception. To illustrate an example, it is like taking an analog sine wave (of a radio frequency etc.) and converting it into digital steps. The overall trend, position, and result is the same. However, the analog signal has been converted to digital. Metric Context Analysis 507 analyzes the interconnected relationships within the perceptions of metrics. Certain metrics can depend on others with varying degrees of magnitude. This contextualization is used to supplement the mirrored interconnected relationship that rules have within the ‘digital’ ruleset format. Input/Output Analysis 508 performs a differential analysis of the input and output of each perception (grey) or rule (black and white). The goal of this module is to ensure that the input and output remains as similar or identical as possible after transformation (from grey to black/white and vice versa). Criterion Calculation 509, Calculates the criteria and task of the input rules. This can be translated to the ‘motivation’ behind the ruleset. Rules are implemented for reasons, which can be understood by implication or by an explicit definition. Hence by calculating the implied reason for a why a ‘digital’ rule has been implemented, that same reason can be used to justify the makeup of metrics within a perception that seeks the same input/output capabilities. Rule Formation Analysis 510 analyzes the overall composition/makeup of rules and how they interact with each other. Used to supplement the mirrored interconnected relationship that metrics have within an ‘analog’ perception. With Rule Syntax Format Conversion (RSFC) 511 rules are assorted and separated to conform to the syntax of the Rule Syntax Format (RSF) 538.

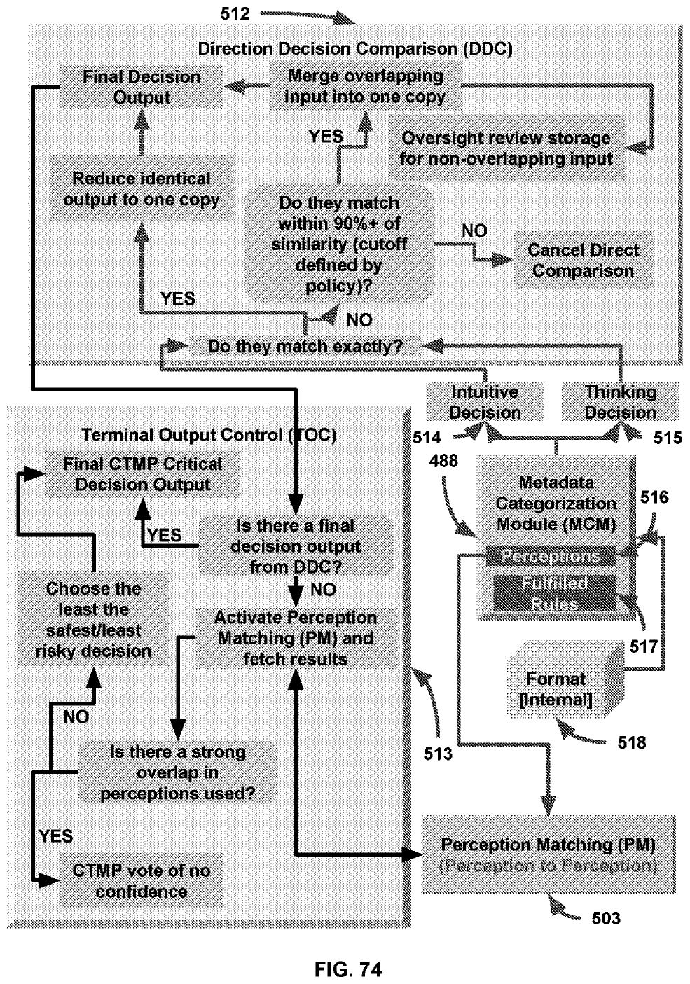

FIG. 74 shows the final logic for processing intelligent information in CTMP. The final logic receives intelligent information from both Intuitive/Perceptive and Thinking/Logical modes (Perception Observer Emulator (POE) 475 and Rule Execution (RE) 461 respectively). In Direct Decision Comparison (DDC) 512, both decisions from Intuition and Thinking are compared to check for corroboration. The key difference is that no Meta-metadata is being compared yet, because if they agree identically anyways then it is redundant to understand why. Terminal Output Control (TOC) 513 is the last logic for determining CTMP output between both modes Intuitive 514 and Thinking 515. Intuitive Decision 514 is one of two major sections of CTMP which engages in critical thinking via leveraging perceptions. See Perception Observer Emulator (POE) 475. Thinking Decision 515 is the other one of two major sections of CTMP which engages in critical thinking via leveraging rules. See Rule Execution (RE) 461. Perceptions 516 is data received from Intuitive Decision 158 according to a format syntax defined in Internal Format 518. Fulfilled Rules 517 is data received from Thinking Decision 515 which is a collection of applicable (fulfillable) rulesets from Rule Execution (RE) 461. Such data is passed on in accordance with the format syntax defined in Internal Format 518. By using Internal Format 518 the Metadata Categorization Module (MCM) 488 is able to recognize the syntax of both inputs as they have been standardized with a known and consistent format that is used internally within CTMP.

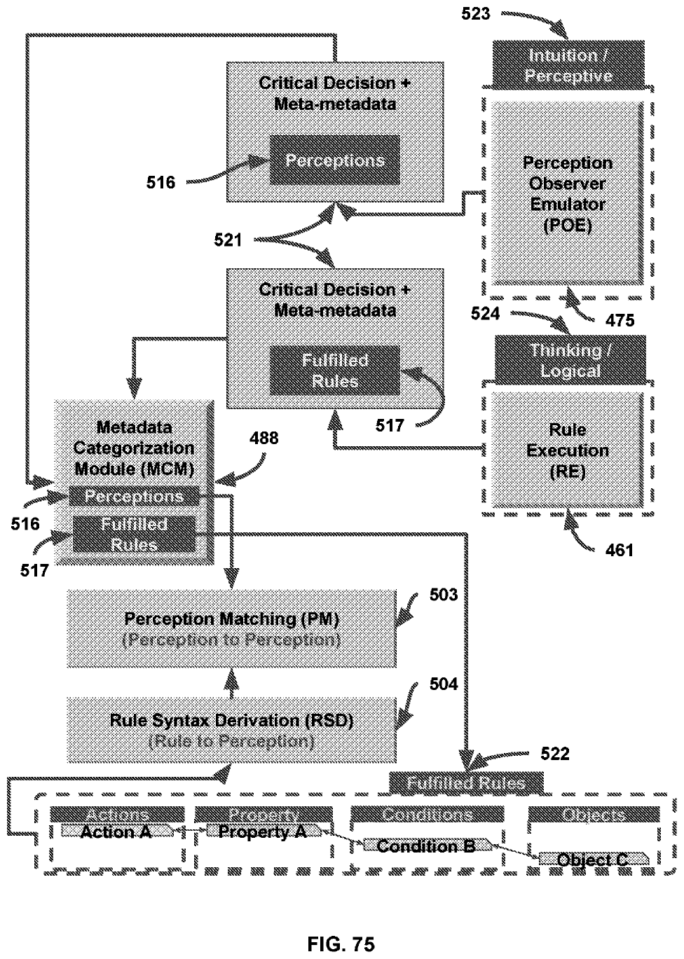

FIG. 75 shows the two main inputs of Intuitive/Perceptive and Thinking/Logical assimilating into a single terminal output which is representative of CTMP as a whole. Critical Decision+Meta-metadata 521 is a digital carrier transporting either Perceptions 516 or Fulfilled Rules 517 according to the syntax defined in Internal Format 518.

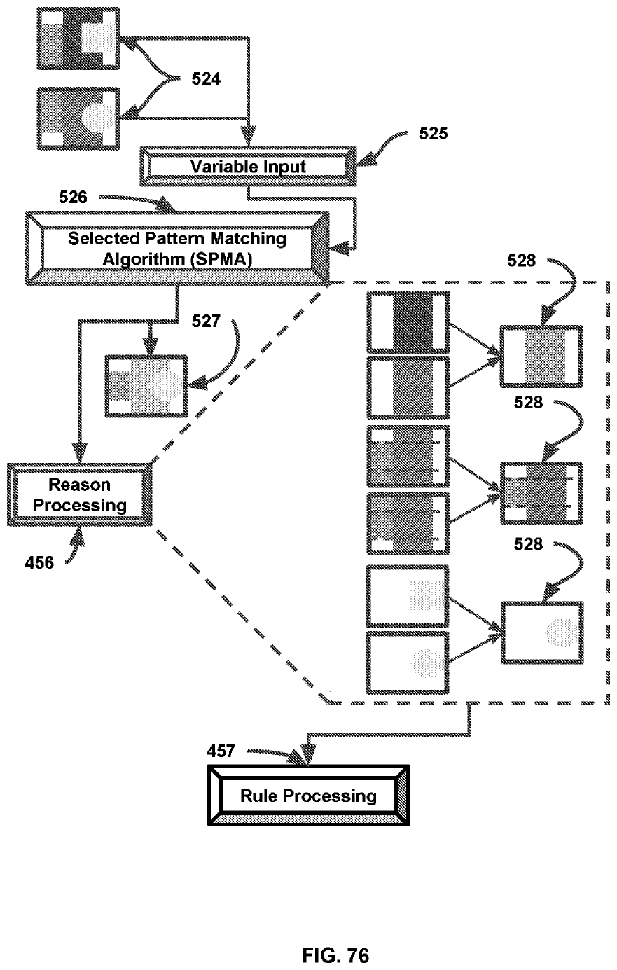

FIG. 76 shows the scope of intelligent thinking which occurs in the original Select Pattern Matching Algorithm (SPMA) 526. Input Variables 524 are the initial financial/tax allocation variables that are being considered for Reason and Rule processing. CTMP intends on criticizing them and becoming an artificially intelligent second opinion. Variable Input 525 receives input variables that define a security decision. Such variables offer criteria for the CTMP to discern what is a reasonable corrective action. If there is an addition, subtraction, or change in variable; then the appropriate change must be reflected in the resultant corrective action. The crucial objective of CTMP is to discern the correct, critical change of corrective action that correctly and accurately reflects a change in input variables. Selected Pattern Matching Algorithm (SPMA) 526, the selected pattern matching algorithm attempts to discern the most appropriate action according to its own criteria. Resultant Output Form 527 is the result produced by the SPMA 526 with initial input variables 168. The rules derived by the SPMA 526 decision making are considered ‘current rules’ but are not necessarily ‘correct rules’. With Attributes Merging 528 according to the log information provided by SPMA 526 Reason Processing 456 proceeds with the current scope of knowledge in accordance with the SPMA 526.

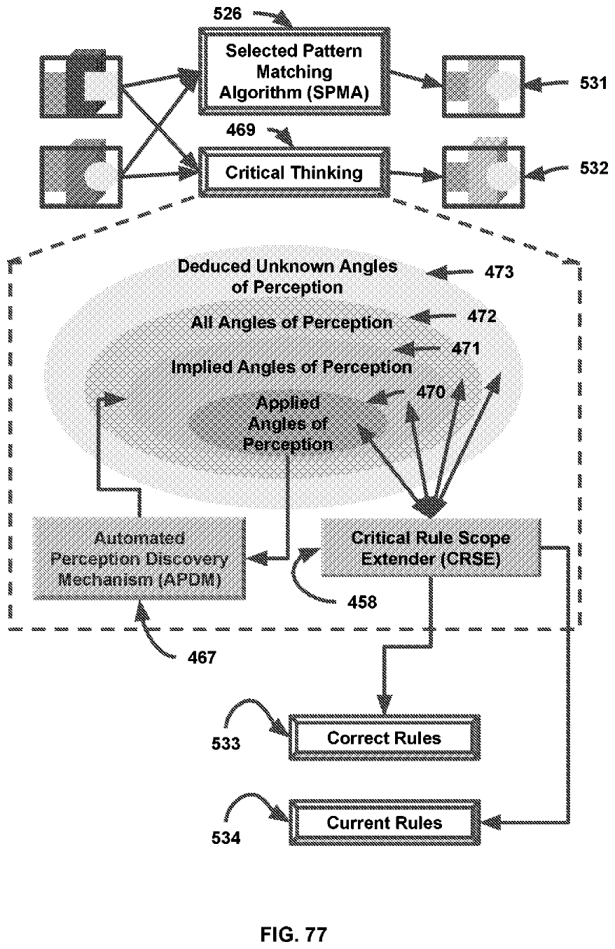

FIG. 77 shows the conventional SPMA 526 being juxtaposed against the Critical Thinking performed by CTMP via perceptions and rules. Misunderstood Action 531, the Selected Pattern Matching Algorithm (SPMA) 526 was unable to provide an entirely accurate corrective action. This is because of some fundamental underlying assumption that was not checked for in the original programming or data of the SPMA 526. In this example, the use of a 3D object as the input variable and the correct appropriate action illustrate that there was a dimension/vector that the SPMA 526 did not account for. Appropriate Action 532, Critical Thinking considered the 3^{rd} dimension, which the SPMA 526 omitted as a vector for checking. The 3^{rd} dimension was considered by Critical Thinking 469 because of all the extra angles of perception checks that were performed. Referring to Correct Rules 533, the Critical Rule Scope Extender (CRSE) extends the scope of comprehension of the rulesets by leveraging previously unconsidered angles of perception (i.e., the third dimension). Referring to Current Rules 534, the derived rules of the current corrective action decision reflect the understanding, or lack thereof (as compared to the correct rules), of the SPMA 526. Input rules have been derived from the Selected Pattern Matching Algorithm (SPMA) 526 which describe the default scope of comprehension afforded by the SPMA. This is illustrated by the SPMA 526 comprehending only 2 dimensions in a flat plane concept of financial allocations.

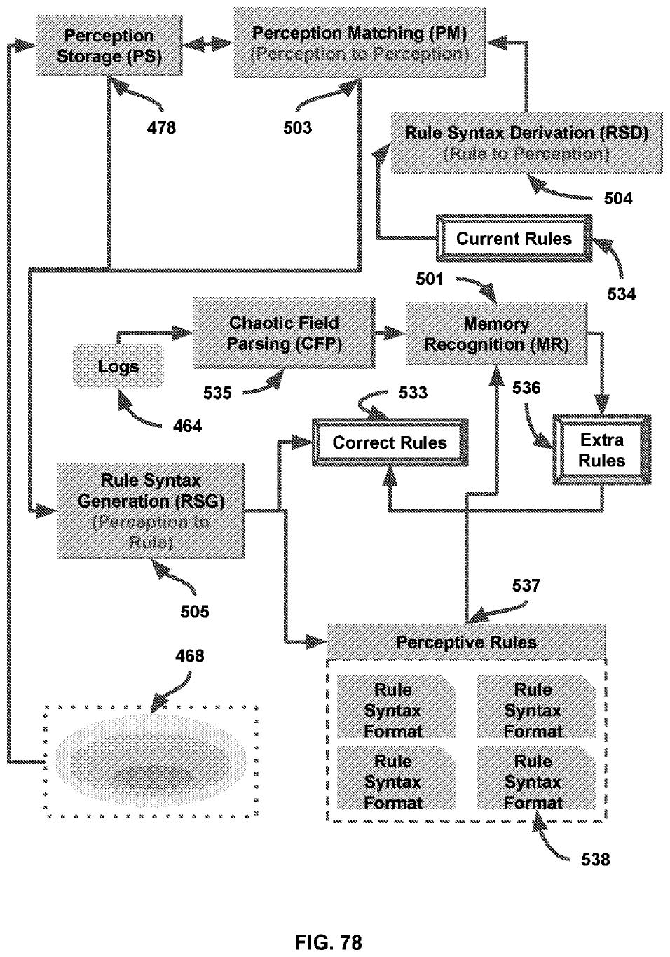

FIG. 78 shows how Correct Rules 533 are produced in contrast with the conventional Current Rules 534 which may have omitted a significant insight and/or variable. With Chaotic Field Parsing (CFP) 535 the format of the logs are combined into a single scannable unit known as the Chaotic Field 613. Extra Rules 536 are produced from Memory Recognition (MR) 501 to supplement the already established Correct Rules 533. Referring to Perceptive Rules 537, perceptions that are considered relevant and popular have been converted into logical rules. If a perception (in it's original perception format) had many complex metric relationships that defined many ‘grey areas’, the ‘black and white’ logical rules encompass such ‘grey’ areas by n^{th} degree expansion of complexity. Rule Syntax Format 538 is a storage format that has been optimized for efficient storage and querying of variables.

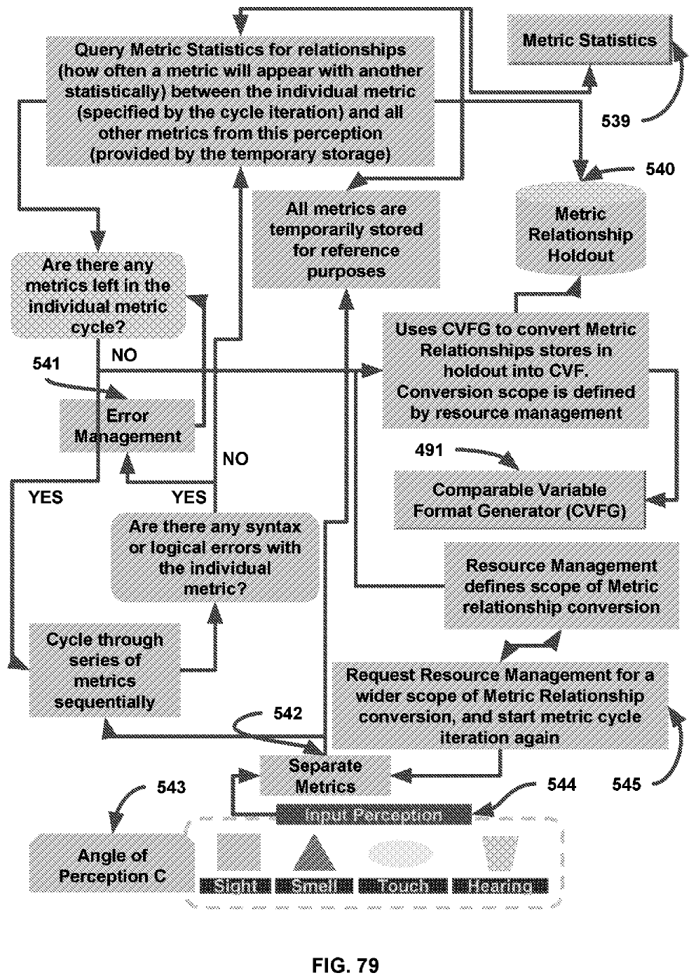

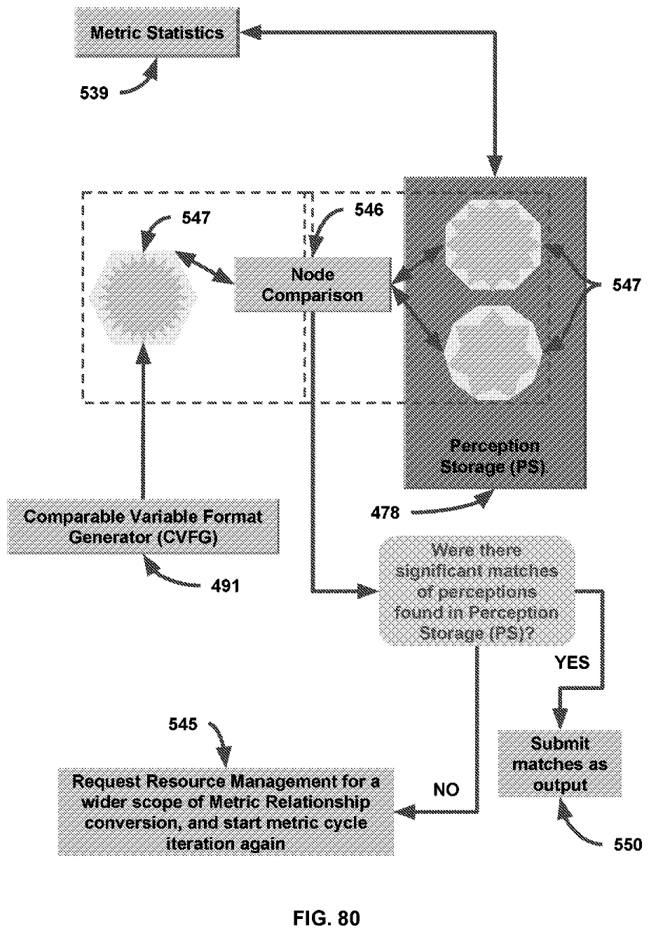

FIGS. 79-80 describes the Perception Matching (PM) 503 module. Concerning Metric Statistics 539, statistical information is provided from Perception Storage (PS) 479. Such statistics define the popularity trends of metrics, internal metric relationships, and metric growth rate etc. Some general statistic queries (like overall Metric popularity ranking) are automatically executed and stored. Other more specific queries (how related are Metrics X and Y) are requested from PS 479 on a real-time basis. Metric Relationship Holdout 540 holds Metric Relationship data so that it can be pushed in a unified output. Error Management 541 parses syntax and/or logical errors stemming from any of the individual metrics. Separate Metrics 542 isolates each individual metric since they used to be combined in a single unit which was the Input Perception 544. Input Perception 544 is an example composition of a perception which is made up of the metrics Sight, Smell, Touch and Hearing. Node Comparison Algorithm (NCA) 546 receives the node makeup of two or more CVFs. Each node of a CVF represents the degree of magnitude of a property. A similarity comparison is performed on an individual node basis, and the aggregate variance is calculated. This ensures an efficiently calculated accurate comparison. A smaller variance number, whether it be node-specific or the aggregate weight, represents a closer match. Comparable Variable Formats (CVFs) 547 are visual representations to illustrate the various makeups a CVF. Submit matches as output 550 is the terminal output for Perception Matching (PM) 503. Whatever nodes overlap in Node Comparison Algorithm (NCA) 546 are retained as a matching result, and hence the overall result is submitted at Stage 550.

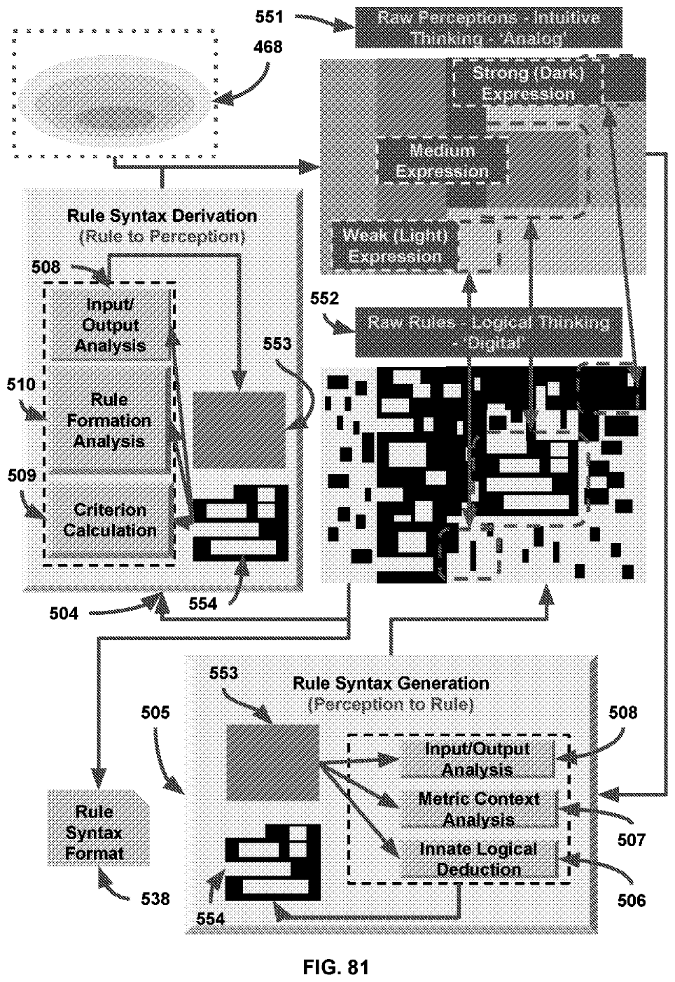

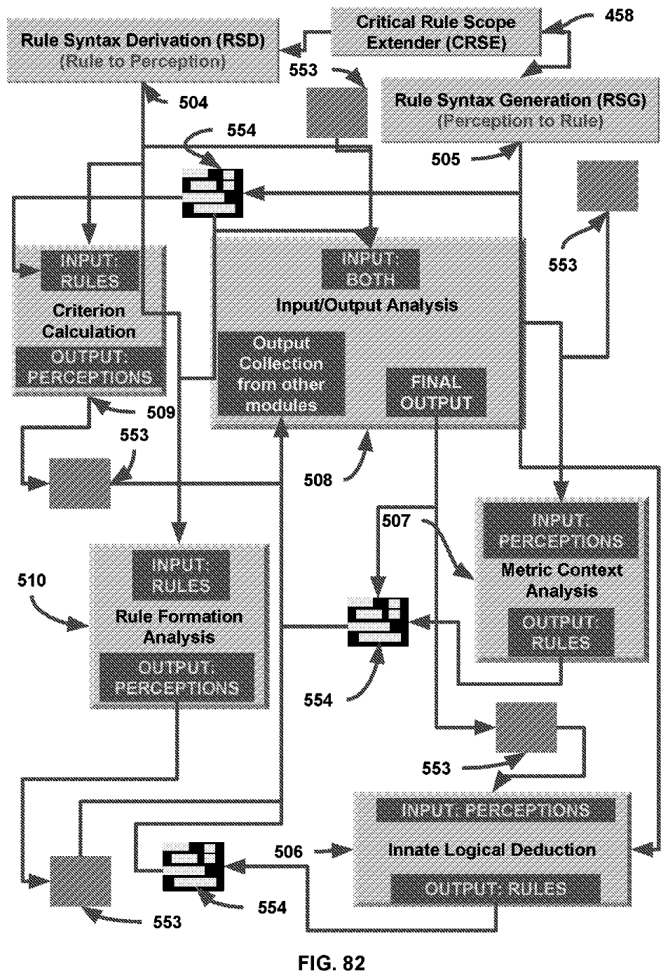

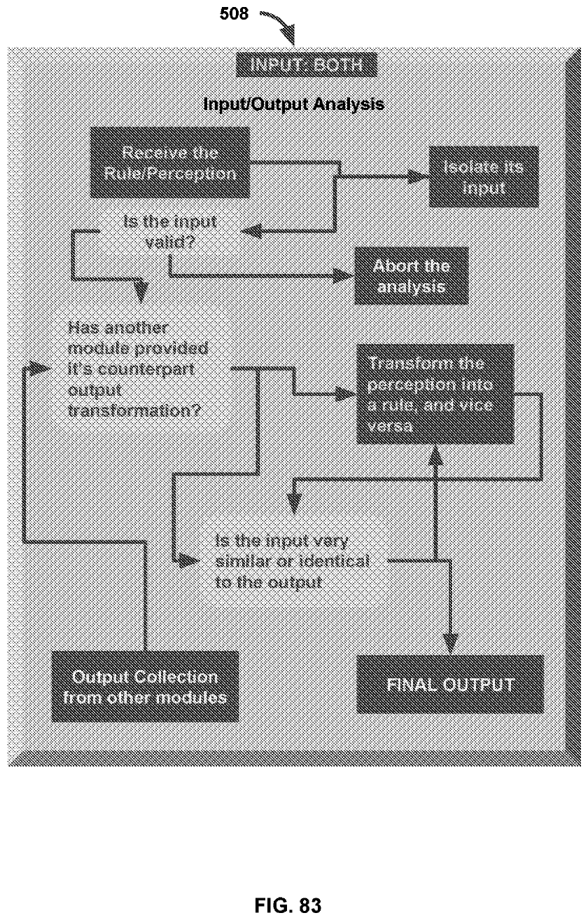

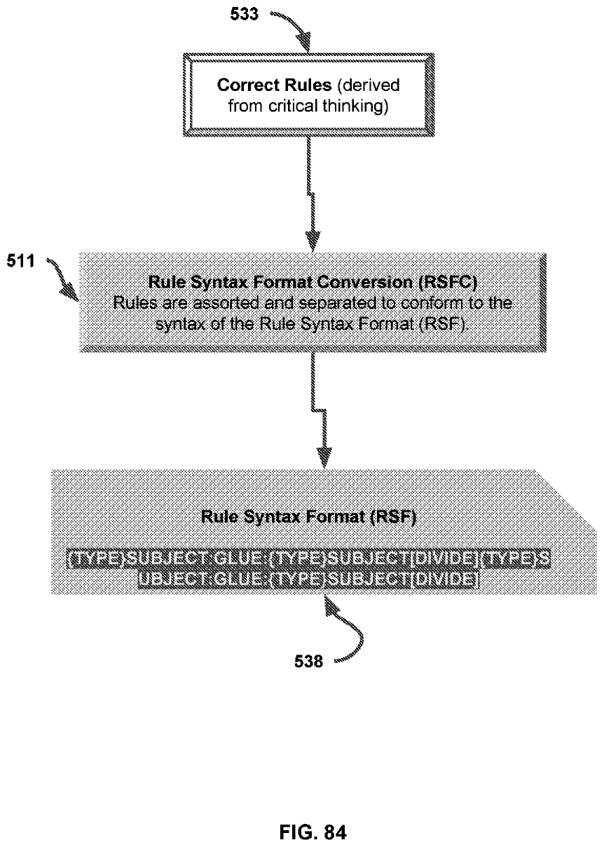

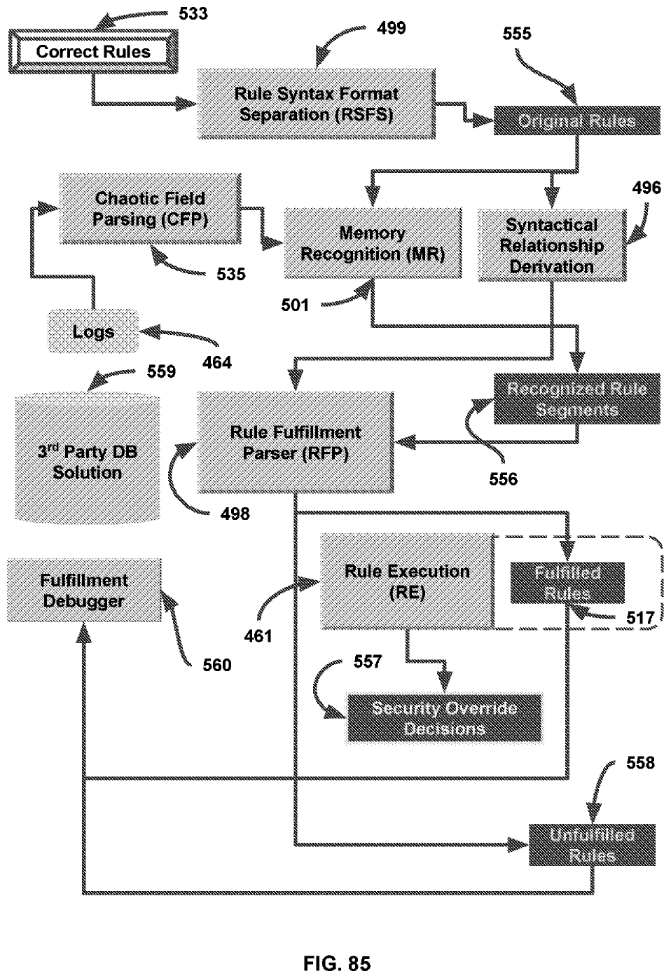

FIGS. 81-85 shows Rule Syntax Derivation/Generation. Raw Perceptions—Intuitive Thinking (Analog) 551 is where the perceptions are processed according to an ‘analog’ format. Raw Rules—Logical Thinking (Digital) 552 is where rules are processed according to a digital format. Analog Format 553 perceptions pertaining to the financial allocation decision are stored in gradients on a smooth curve without steps. Digital Format 554 raw rules pertaining to the financial allocation decision are stored in steps with little to no ‘grey area’. Original Rules 555 is the same as Correct Rules 533 in terms of data content. What differs is that the Original Rules 555 have been converted by Rule Syntax Format Separation (RSFS) 499 into a more dynamic format which allows for cross-referencing with the Chaotic Field 613 via Memory Recognition 501. Recognized Rule Segments 556 are the rules from Original Rules 555 which have been recognized by Memory Recognition 501. This indicates which of the individual segments that constitute of the original Correct Rule 533 (such as Actions, Properties, Conditions, and Objects) have been recognized in the Chaotic Field 613, and hence are applicable for potentially becoming logically fulfilled rules. Security Override Decisions 557 are the final results produced by Rule Execution (RE) 461 which allow for corrective actions to be performed. Such corrective actions are further channeled to the Terminal Output Control (TOC) 513 which is a subset of the greater corrective action logic performed in Critical Decision Output (CDO) 462. Unfulfilled Rules 558 are rulesets that have not been sufficiently recognized (according to the Rule Fulfillment Parser 498) in the Chaotic Field 613 according to their logical dependencies. Likewise, Fulfilled Rules 517 have been recognized as sufficiently available in the Chaotic Field 613 according to logical dependencies analyzed by CDO 462. The Third Party Database Solution 559 is the hardware interface software which manages buffer, cache, disk storage, thread management, memory management, and other typical mechanical database functions. Fulfillment Debugger 560 seeks to find the reason for unfulfilled rules. It is either that the Chaotic Field 613 was not rich enough, or that the ruleset was inherently illogical. It can be instantaneously checked, within a certain degree of accuracy, if the ruleset is illogical. However, to establish the potential spareness of the Chaotic Field 613, multiple surveys must be taken so as to not fall into the fallacy of performing an insufficient survey.

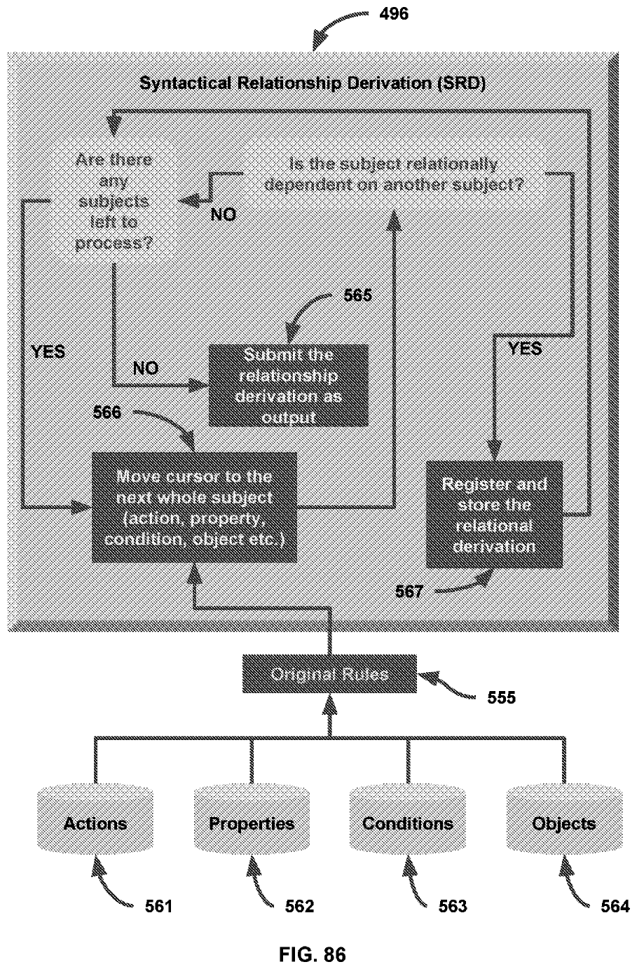

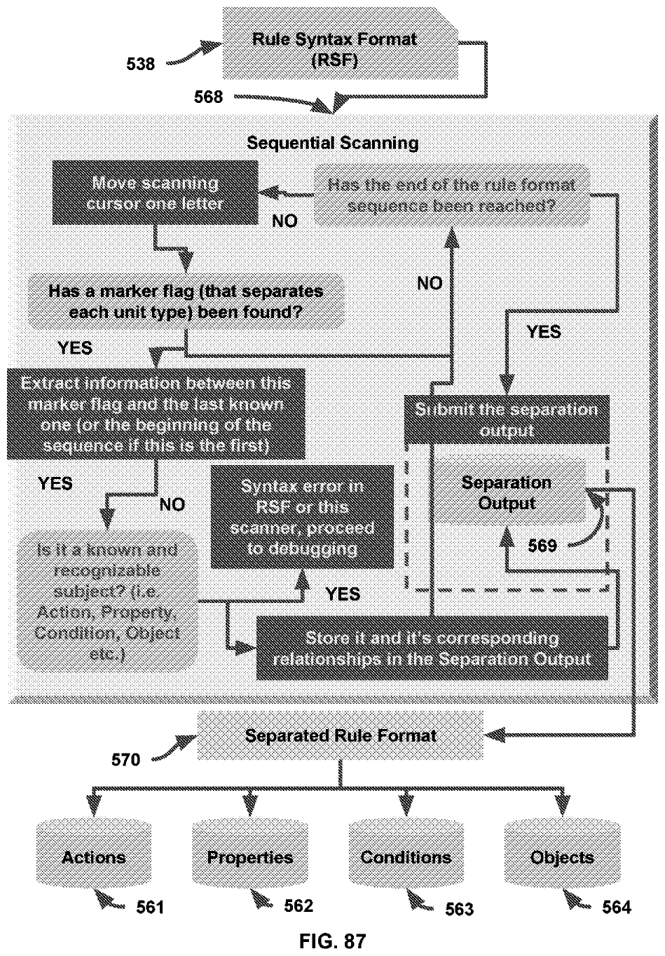

FIGS. 86-87 shows the workings of the Rule Syntax Format Separation (RSFS) 499 module. In this module Correct Rules 502 are separated and organized by type. Hence all the actions, properties, conditions, and objects are stacked separately. This enables the system to discern what parts have been found in the Chaotic Field 613, and what parts have not. Regarding Actions 561, one of four rule segment data types that indicates an action that may have already been performed, will be performed, is being considered for activation etc. Regarding Properties 562, one of four rule segment data types that indicates some property-like attribute which describes something else, be it an Action, Condition or Object. Regarding Conditions 563, one of four rule segment data types that indicates a logical operation or operator (i.e. if x and y then z, if x or z then y etc.). Regarding Objects 564, one of four rule segment data types that indicates a target which can have attributes applied to it such as Actions 561 and Properties 562. At processing stage 565 the relationship derivation results that have been gathered thus far are submitted as output and the program terminates thereafter. Processing stage 566 iterates through the rule segments one item at a time. Processing stage 567 interprets and records each individual relationship between rule segments (i.e. Actions 561, Objects 564 etc.). Each individual relationship is thus collected and prepared for output at stage 565. Sequential Scanning 568 splits up each unit of the RSF 538 at the ‘[DIVIDE]’ marker. The Subjects and Glue from RSF 538 are also separated and parsed. Separation Output 569 is where individual subjects and internal subject relationships are held by the scanner. They are sent for output all at once when the entire RSF 538 has been sequentially scanned. Separated Rule Format 570 is a delivery mechanism for containing the individual rule segments (i.e. Actions 561, Objects 564 etc.) from Separation Output 569. The Separated Rule Format 570 use is highlighted in two major points of information transfer: first as output from the Rule Syntax Format Separation (RSFS) 499 (which is considered the pre-Memory Recognition phase) and as output from Memory Recognition (MR) 501 (post-Memory Recognition phase).

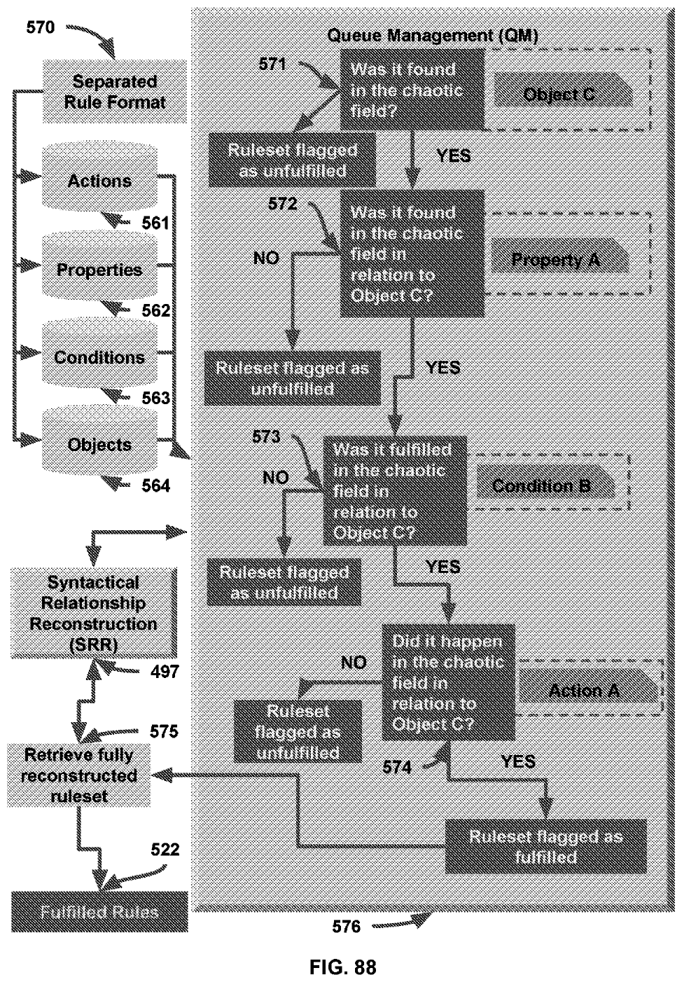

FIG. 88 shows the workings of the Rule Fulfillment Parser (RFP) 498. This module receives the individual segments of the rule with a tag of recognition. Each segment is marked as either having been found, or not found in the Chaotic Field 613 by Memory Recognition (MR) 501. The RFP 498 can then logically deduce which whole rules, the combination of all of their parts, have been sufficiently recognized in the Chaotic Field 613 to merit Rule Execution (RE) 461. Queue Management (QM) 561 leverages the Syntactical Relationship Reconstruction (SRR) 497 module to analyse each individual part in the most logical order. QM 561 has access to the Memory Recognition (MR) 501 results so that the binary yes/no flow questions can be answered and appropriate action can be taken. QM checks every rule segment in stages, if a single segment is missing from the Chaotic Field 613 and not in proper relation with the other segments, the ruleset is flagged as unfulfilled. If all the check stages pass then the ruleset is flagged as fulfilled 522. QM stage 571 checks if rule segment ‘Object C’ was found in the Chaotic Field 613. QM stage 572 checks if the next appropriate segment is related to the original ‘Object C’, whilst also being found in the Chaotic Field 613 according to Memory Recognition (MR) 501. The same logic is applied to QM stages 573 and 574 for Condition B and Action A respectively. These segment denotations (A, B, C etc.) are not part of the core logic of the program but are reference to a consistent example used for displaying expected and typical usage. The receiving of the fully reconstructed ruleset 575 requires the fulfilled ruleset output of Queue Management 576, assuming that the ruleset was found to be fulfillable, and the associations of the rule segments as given by the Syntactical Relationship Reconstruction (SRR) module 497.

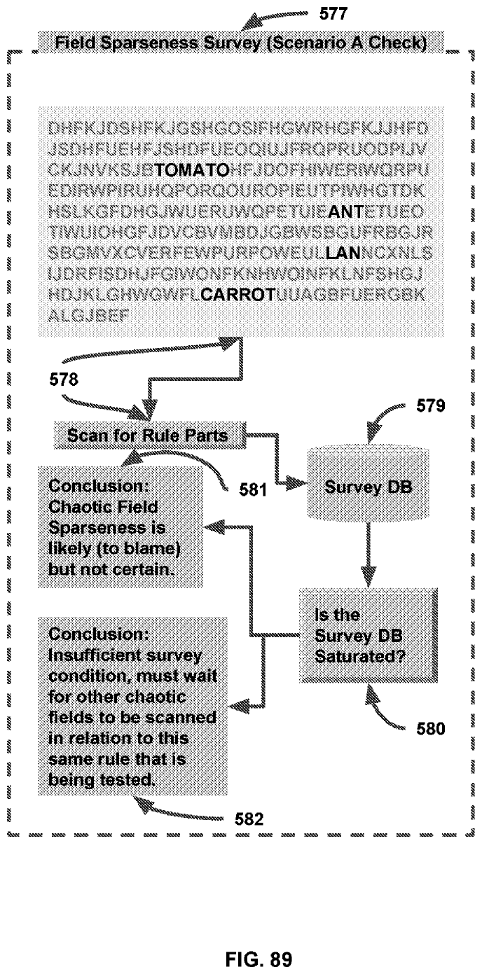

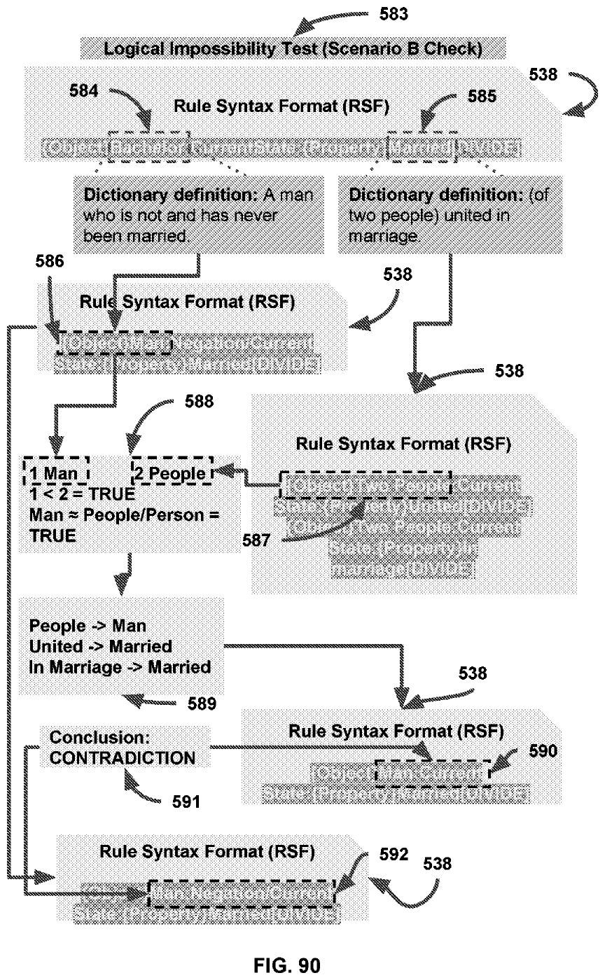

FIGS. 89-90 display the Fulfillment Debugger 560 which seeks to find the reason for unfulfilled rules. It is either that the Chaotic Field 613 was not rich enough, or that the ruleset was inherently illogical. It can be instantaneously checked, within a certain degree of accuracy, if the ruleset is illogical. However, to establish the potential spareness of the Chaotic Field 613, multiple surveys must be taken in order to avoid the insufficient survey fallacy. Field Spareness Survey 577 specifically checks if the Chaotic Field 613 is rich enough or not to trigger the variable makeup of the ruleset. Scan 578 checks for relevant rule parts' presence inside the Chaotic Field 613. Survey DB 579 stores the survey results for near future reference. Conditional 580 checks if the Survey DB 579 has become saturated/filled up. This means that any possible scans for Rule Parts have been performed, despite the scans yielding positive or negative results. If all possible scans have been performed, then Conclusion 581 is implicated: that sparseness in the entire Chaotic Field 613 is the reason for why the ruleset was classified as unfulfilled. If all possible scans have not been performed, then Conclusion 582 is implicated: that the survey is incomplete and more sectors of the Chaotic Field 613 need to be scanned in order to reliably tell if Chaotic Field 613 sparseness is the cause for a rule becoming unfulfilled. Logical Impossibility Test 583 checks to see if there is an inherently impossible logical dependency within the ruleset which is causing it to become classified as unfulfilled. For example the Object 584 ‘Bachelor’ has been assigned the Property 585 ‘Married’, which leads to an inherent contradiction. The Test 583 determines the dictionary definitions of terms 584 and 585. Internal Rule Consistency Check 588 will check if all properties are consistent and relevant with their object counterparts. The ‘Bachelor’ 584 definition in RSF 538 format contributes the partial definition of Object 586 ‘Man’ whilst the ‘Married’ 585 definition (also in RSF 538 format) contributes to the partial definition of Object 587 ‘Two People’. The conclusion of Check 588 is that both definitions 586 and 587 are compatible insofar as Object 586 ‘Man’ is potentially inclusive of Object 587 ‘Two People’. With Rule Relevancy Conversion 589 equitable terms are converted to perform a comparison test. Such a conversion allows the second definition (‘married’) to be understood within the context of the first definition (‘bachelor’). Thereby Conclusion 591 is drawn that the rule contains an inherent contradiction that the same man cannot be currently 590 and not currently 592 married at the same time.

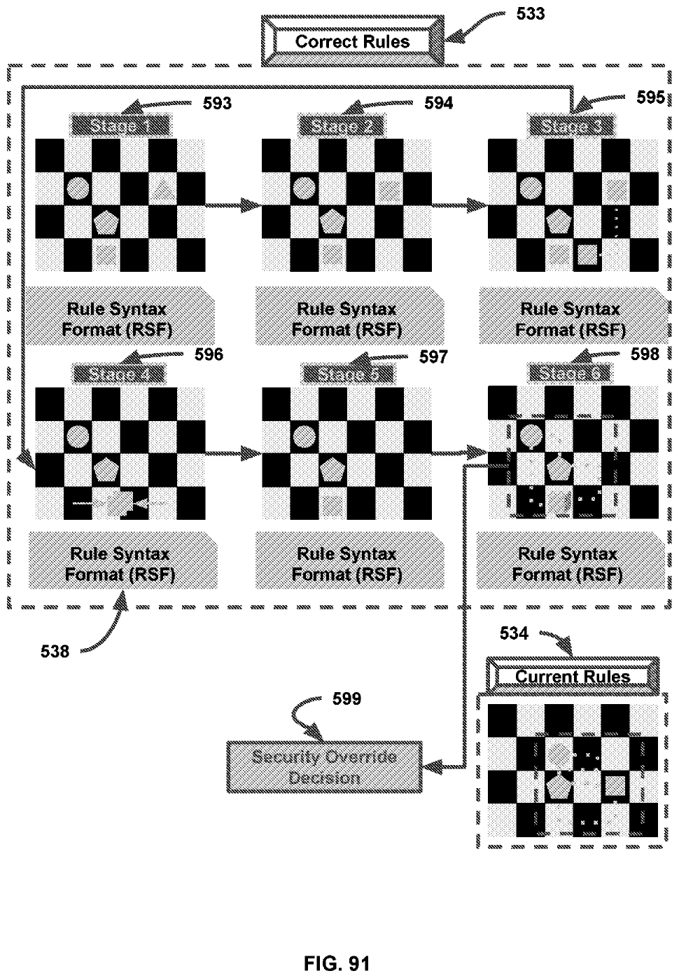

FIG. 91 shows Rule Execution (RE) 461; Rules that have been confirmed as present and fulfilled as per the memory's scan of the Chaotic Field 613 are executed to produce desired and relevant critical thinking decisions. There is a checkerboard plane which is used to track the transformations of rulesets. The objects on the board represents the complexity of any given security situation, whilst the movement of such objects across the ‘security checkerboard’ indicates the evolution of the security situation which is managed by the responses of the security rulesets. Stage 1 593 the RSF 538 information defines the initial starting positions of all the relevant objects on the checkerboard plane, hence defining the start of the dynamically cascading security situation. This is symbolically used to illustrate the logical ‘positions’ of rules that deal with a dynamic security policy. Stage 2 594 and Stage 6 598 indicate an object transformation which is illustrative of security rules being applied which modifies the position and scope of certain security situations. For example, the transformation of an object in Stages 2 and 6 can represent the encryption critically files. Stage 3 595 illustrates the movement of an object on the checkerboard, which can correspond to the actual movement of a sensitive file to an offsite location as part of a security response strategy. Stage 4 596 and Stage 5 597 show the process of two objects merging into a common third object. An example application of this rule is two separate and isolated local area networks being merged to facilitate the efficiently and securely managed transfer of information. Upon completion of Rule Execution (RE) 461, the results of the Correct Rules 533 and the Current Rules 534 are different. This illustrates the critical thinking advantage that CTMP has performed, as opposed to the less critical results produced from the Selected Pattern Matching Algorithm (SPMA) 526. All of the shapes, colors, and positions are symbolically representing security variables, incidences, and responses (because of the simplicity to explain rather than actual security objects). The SPMA has produced final shape positions that differ from CTMP, as well as a similar yet different (orange vs yellow) color difference for the pentagon. This occurs because of the complex conditional statement-ruleset makeup that all of the input logs go through for processing. This is similar to how starting a billiard ball match with varying player variables (height, force etc.) can lead to entirely different resultant ball positions. CTMP also transformed the purple square into a cube, which symbolically represents (throughout CTMP's description) it's ability to consider dimensions and perceptions that the SPMA 526 or even a human would have never expected nor considered. The final Security Override Decision 599 is performed in accordance with the Correct Rules 533.

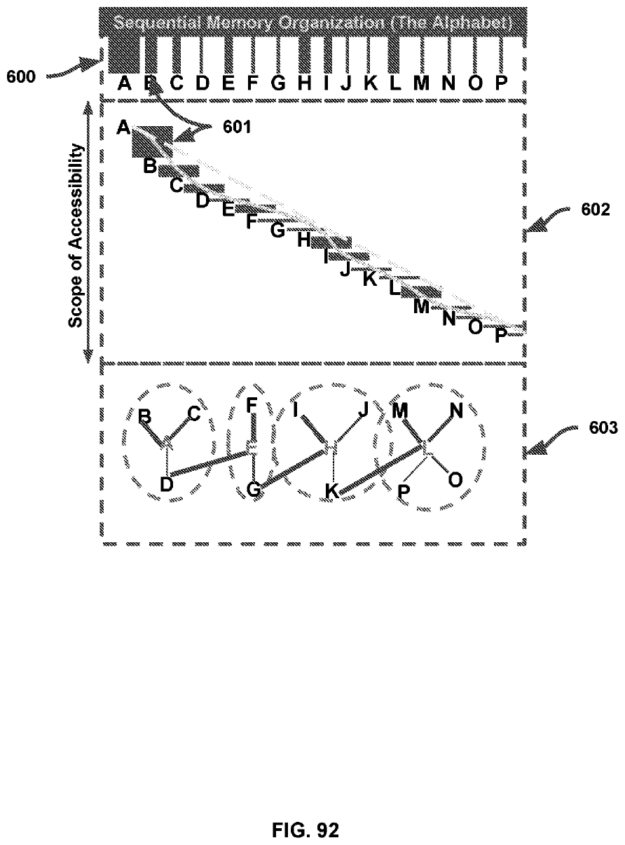

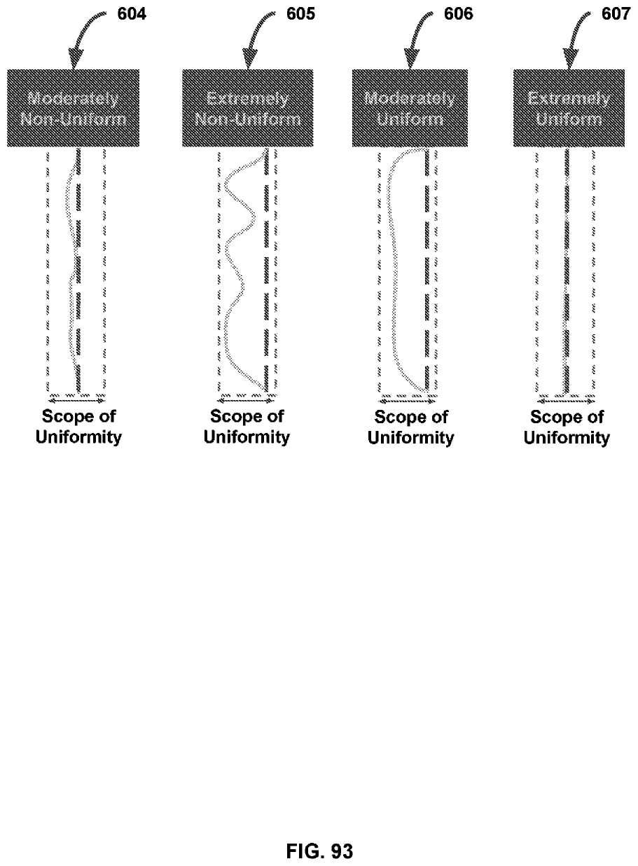

FIGS. 92 and 93 demonstrate Sequential Memory Organization, which is an optimized information storage method that yields greater efficiency in reading and writing for ‘chains’ of sequenced information such as the alphabet. In Points of Memory Access 600, the width of each of the Nodes 601 (blocks) represent the direct accessibility of the observer to the memorized object (node). In the sequentially memorized order of the alphabet, ‘A’ is the most accessible point of memory as it is the first node of the sequence. Letter's E, H and L also have easier direct access as they are the ‘leader’ for their own sub-sequences ‘EFG’, ‘HIJK’, and ‘LMNOP’. With Scope of Accessibility 602 each letter represents its point of direct memory access to the observer. A wider scope of accessibility indicates that there are more points of accessibility per sequence node, and the inverse is true. The more a sequence would be referenced only ‘in order’ and not from any randomly selected node, the more narrow the scope of accessibility (relative to sequence size). This allows for more efficient memory recollection according the magnitude of sequentiality. With Nested Sub-Sequence Layers 603, a sequence that exhibits strong non-uniformity is made up of a series of smaller sub-sequences that interconnect. The alphabet is highly indicative of this behavior as the individual sub-sequences ‘ABCD’, ‘EFG’, ‘HIJK’, ‘LMNOP’ all exist independently as a memorized sequence, yet they interconnect and form the alphabet as a whole. This type of memory storage and referencing can be much more efficient if there is occasional or frequent access to certain nodes of the master sequence. This way scanning from the start of the entire sequence can be avoided to gain efficiency in time and resources. This is similar to a book being scanned according to chapter, rather than scanning the book from the first page in every search. With an Extremely Non-Uniform 605 scope, there is an inconsistent point of access throughout all of the nodes. This means that it has a heavy composition of nested sub-sequences that interconnect like a chain. An extremely non-uniform sequence means it is moderately sequential, yet should have multiple points of memory access (nested sub-sequence layers). An example of Extremely Non-Uniform 605 is the alphabet, which is varies in difficult to recite depending on which letter one starts with. With an Extremely Uniform 607 scope, there is a consistent point of access throughout all of the nodes. This means that it is not made up of nested sub-sequences that interconnect like a chain. An Extremely Uniform sequence means it is either extremely sequential (consistently little to no points of access throughout the nodes) or extremely non-sequential (consistently large points of access throughout the nodes). An example of Extremely Uniform 607 is a collection of fruit, there is barely any specified nor emphasised sequence in reciting them nor are there any interconnected sub-sequences. The Moderately Uniform 606 scope has an initial large access node, which means it is most efficient to recite the contents starting from the beginning. However the main contents is moreover linear, which indicates the absence of nested sub-sequence layers and the presence of a singular large sequence. The Moderately Non-Uniform 604 scope does not deviate very much from a linear and hence consistent point of access throughout. This indicates that there are more subtle and less defined nested sub sequence layers whilst at the same time conforming to a consistent and reversible collection. An example of information exhibiting the behavior of Moderately Non-Uniform 604 can be the catalogue for a car manufacturer. There can be defined categories such as sport cars, hybrids and SUVs yet there is no strong bias for how the list should be recited nor remembered, as a potential customer might still be comparing an SUV with a sports car despite the separate category designation.

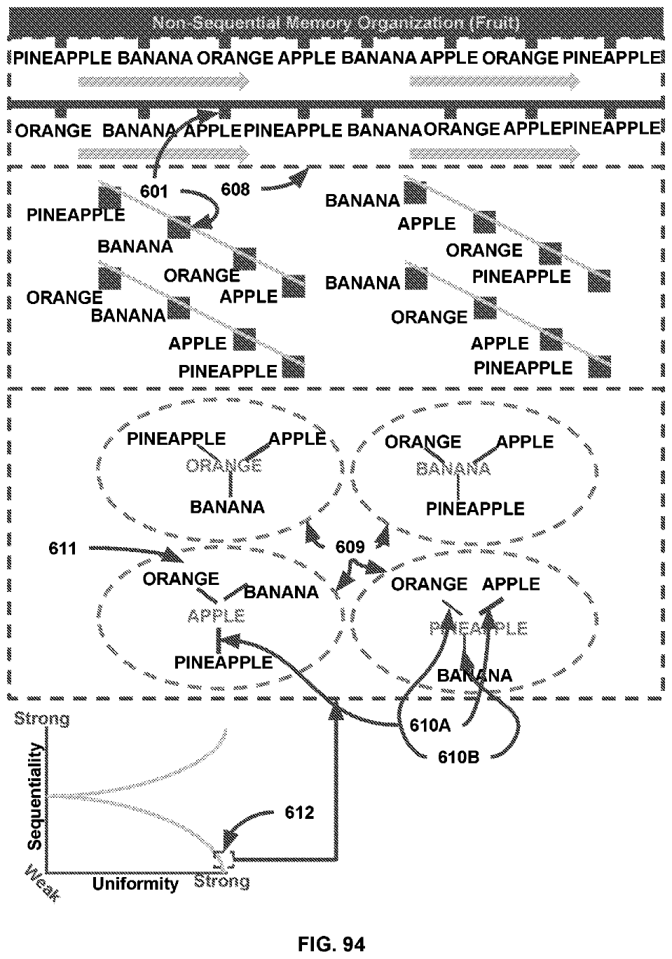

FIG. 94 shows Non-Sequential Memory Organization, which deals with the information storage of non-sequentially related items such as fruit. With a collection of fruit there is no highly specified order in which they should be read, as opposed to the alphabet which has a strong sequential order for how the information should be read. Memory Organization 608 shows the consistently uniform nodes of access for all of the fruit, indicating a non-sequential organization. The organization in 608 illustrates how reversibility indicates a non-sequential arrangement and a uniform scope. In this instance it indicates the memory of fruit is non-sequential, as indicated by the relatively wide point of access per node. The same uniformity exists when the order of the fruit is shuffled, which indicated the reversible order of the fruit. In contrast, a sequential series like the alphabet is much harder to recite backwards as opposed to the regular recitation. A list of common fruit does not exhibit this phenomenon, which indicates that it is referenced outside of a sequential list more often than within a sequential list. In Nucleus Topic and Associations 609, since there is no sequentiality in this list of fruit the same series of fruit are repeated but with a different nucleus (the center object). The nucleus represents the primary topic, to which the remaining fruit act as memory neighbours to which they can be accessed easier as opposed to if there were no nucleus topic defined. In Strong Neighbours 610A, despite an apple being a common fruit, it has a stronger association with pineapple than other common fruit because of the overlap in spelling. Hence the are considered to be more associated memory-wise. In Weak Neighbours 610B, because pineapple is a tropical fruit, it has less associations with oranges and bananas (Common Fruit). A pineapple is more likely to be referenced with a mango because of the tropical overlap. Graph Point 612 demonstrates how the extremely weak sequentiality of the fruit series leads to extremely strong uniformity in Node 601 access.

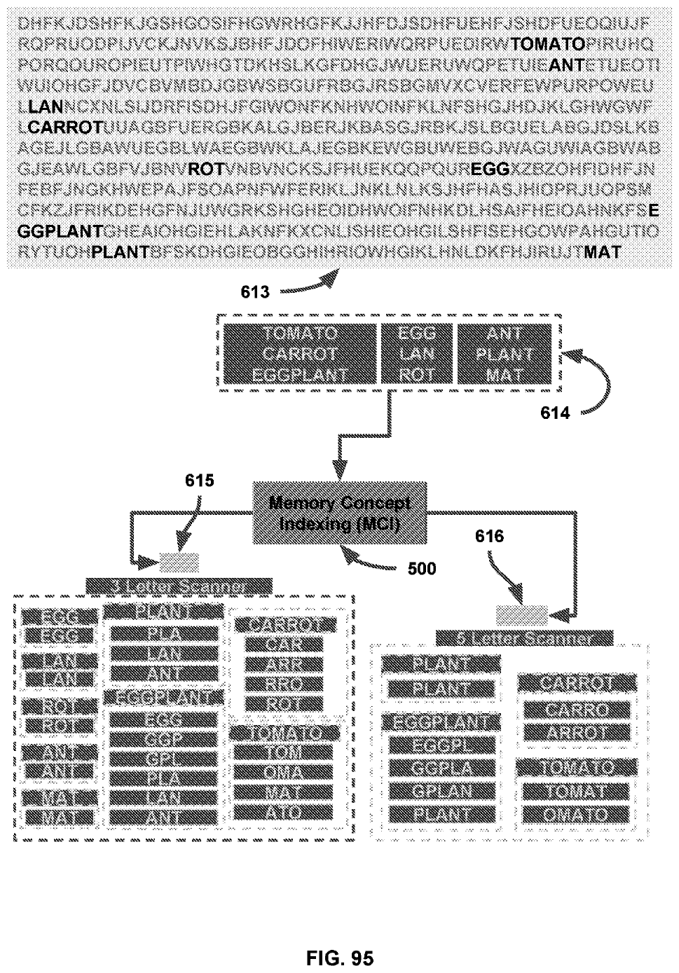

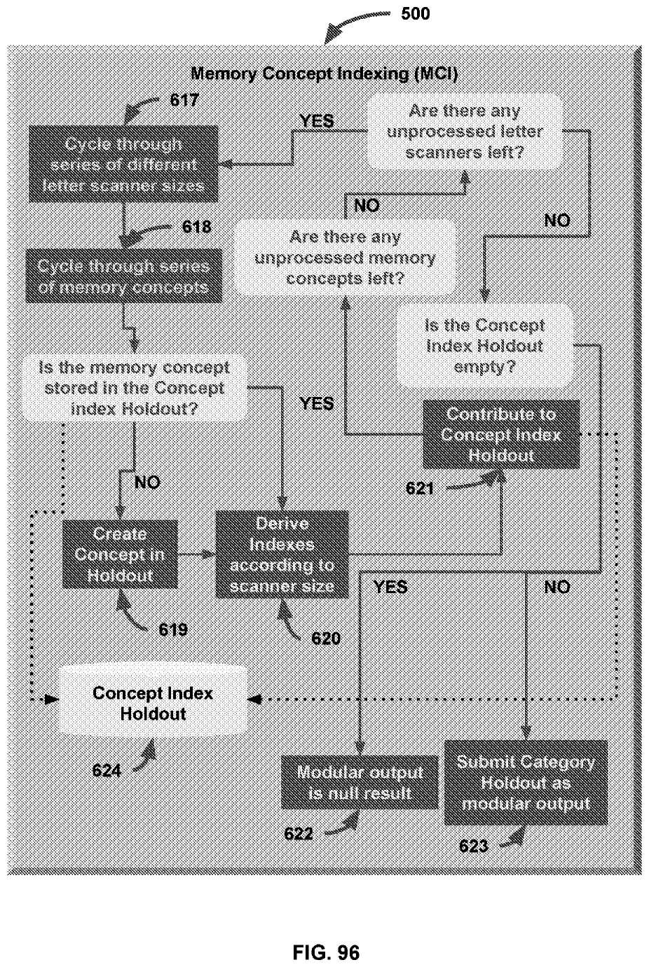

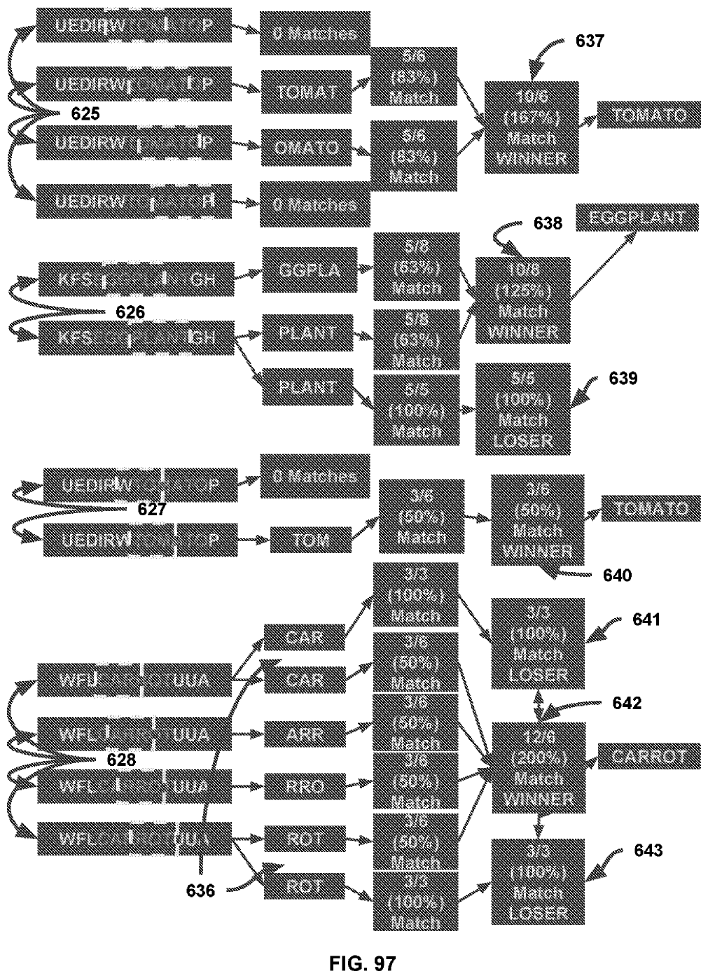

FIG. 95-97 shows Memory Recognition (MR) 501, where Chaotic Field 613 scanning is performed to recognize known concepts. Chaotic Field 613 is a ‘field’ of concepts arbitrarily submersed in ‘white noise’ information. It is being made known to the CTMP system on a spontaneous basis, and is considered ‘in the wild’ and unpredictable. The objective of Memory Recognition is to scan the field efficiently to recognize known concepts. With Memory Concept Retention 614, recognizable concepts are stored and ready to be indexed and referenced for field examination. The illustration uses the simplified example of vegetable name spelling to facilitate easy comprehension of the system. However, this example can be used as an analogy for much more complex scenarios. For a real life security example, this can include recognizing and distinguishing between citizens and military personnel in a camera feed. For a cybersecurity example, this can include recognizing known and memorized trojans, backdoors, and detecting them in a sea of security white noise (logs). With 3 Letter Scanner 615, the Chaotic Field 613 is scanned and checked against 3 letter segments that correspond to a target. For example, ‘PLANT’ is a target, and the scanner moves along the field incrementally every 3 characters. With every advancement of the scanner, the segments ‘PLA’, ‘LAN’, and ‘ANT’ are checked for since they are subsets of the word ‘PLANT’. Despite this, the words ‘LAN’ and ‘ANT’ are independent words which also happen to be targets. Hence when one of these 3 letter segments are found in the field, it can imply the full target of ‘LAN’ or ‘ANT’ has been found or that a subset of ‘PLANT’ might have been found. The same concept is applied for the 5 Letter Scanner 616, but this time the segment that is checked with every advancement throughout the field is the entire word ‘PLANT’. Targets such as ‘LAN’ and ‘ANT’ are omitted since a minimum of 5 letter targets are required to function with the 5 letter scanner. The Chaotic field 613 is segmented for scanning in different proportions (3, 5 or more letter scanning) as such proportions offer various levels of scanning efficiency and efficacy. As the scope of the scanning decreases (smaller amount of letters), the accuracy increases (and vice-versa). As the field territory of the scanner increases, a larger letter scanner is more efficient for performing recognitions, at the expense of accuracy (it depends on how small the target is). With the Memory Concept Indexing (MCI) 500, Stage 617 alternates the size of the scanner (3, 5 or more) in response to their being unprocessed memory concepts left. MCI 500 starts with the largest available scanner and decreases gradually with Stage 617 so that more computing resources can be found to check for the potential existence of smaller memory concept targets. Stage 618 cycles the available memory concepts so that their indexes (smaller segments suited to the appropriate length such as 3 or 5) can be derived at Stage 620. Incase the memory concept did not already exist in the Concept Index Holdout 624 then stage 619 will create it as per the logistical flow of actions. Stage 621 then assigned the derived indexes from Stage 620 into the Holdout 624. As the programmed full circle of MCI 500 continues, if MCI runs out of unprocessed letter scanners then it will reach a fork where it either submits an empty (null) result 622 if the Holdout 624 is empty, or submit the non-empty Holdout 624 as modular output 623. Sections of the Chaotic Field 613 range from numerals 625 through 628. Sections 625 and 626 represent a scan performed by a 5 letter scanner, whilst sections 627 and 628 represent a 3 letter scan. Scan 625 has a 5 letter width whilst checking for a 6 letter target ‘TOMATO’. Two 5 letter segments were matched at ‘TOMAT’ and ‘OMATO’, which had previously been indexed at MCI 500. Each one of these corresponds to a 5 letter match out of a 6 letter word, which further corresponds to 83%. This fraction/percentage is added cumulatively in favor of the memory concept ‘TOMATO’ at 167% 637, hence the concept ‘TOMATO’ was successfully discovered in the Chaotic Field 613. Scan 626 has a memory concept target of ‘EGGPLANT’, with two significant segments being ‘GGPLA’ and ‘PLANT’. Whilst ‘GGPLA’ exclusively refers to the true match of ‘EGGPLANT’, the segment ‘PLANT’ introduces the potential of a false positive as ‘PLANT’ is in and of itself a memory concept target. For the system to recognize ‘PLANT’ as existing in the Chaotic Field 613 whilst ‘EGGPLANT’ is the only real recognizable memory concept in the Field would be classed as a false positive. However the system's programming is able to circumvent the false positive case scenario, as ‘GGPLANT’ contributes a 63% match, ‘PLANT’ in context of ‘EGGPLANT’ also contributes 63% whilst ‘PLANT’ in context of the target ‘PLANT’ contributes 100%. As the matches are added in aggregate, that target ‘EGGPLANT’ receives an aggregate score of 125% (63%+63%) 638 whilst the target ‘PLANT’ gets 100% 639. Hence the scanner has successfully maintained the correct interpretation of the Chaotic Field 613. Scan 627 has a width of 3 letters, and recognizes the segment ‘TOM’, which leads to an aggregate match of 50% 640. This is the same target as existing in the Field of Scan 625, yet because of the difference in scan width (3 instead of 5), a match of weaker confidence (50% vs 167%) was found. Hence the design of MCI 500 includes multiple layers of scan widths to strike the correct balance between accuracy and computing resources spent. Scan 628 also incorporates a width of 3 letters, this time with two potential false positive tangents 636. Whilst the actual concept in the Field is ‘CARROT’, the concepts ‘CAR’ and ‘ROT’ are considered for existing in and of themselves in the Field. The scanner must now discern which is the correct concept that is located in the Chaotic Field 613. This is checked with subsequent scans done on nearby letters. Eventually, the scanner recognizes the concept as ‘CARROT’ and not ‘CAR’ or ‘ROT’, because of the corroboration of other located indexes. The 100% composite match of ‘CAR’ 641 and the 100% composite match of ‘ROT’ 643 both lose out to the 200% composite match of ‘CARROT’ 642.

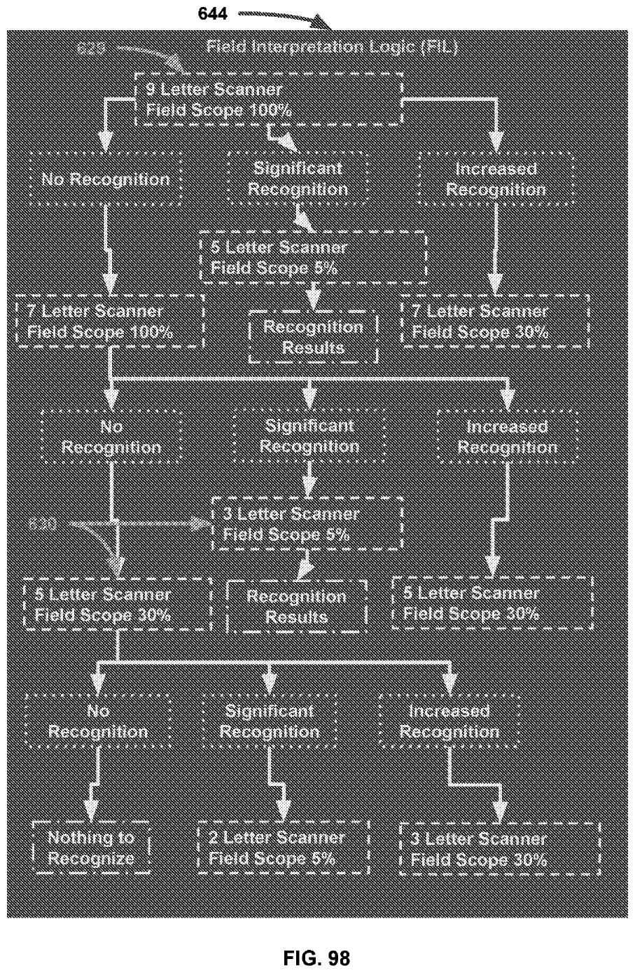

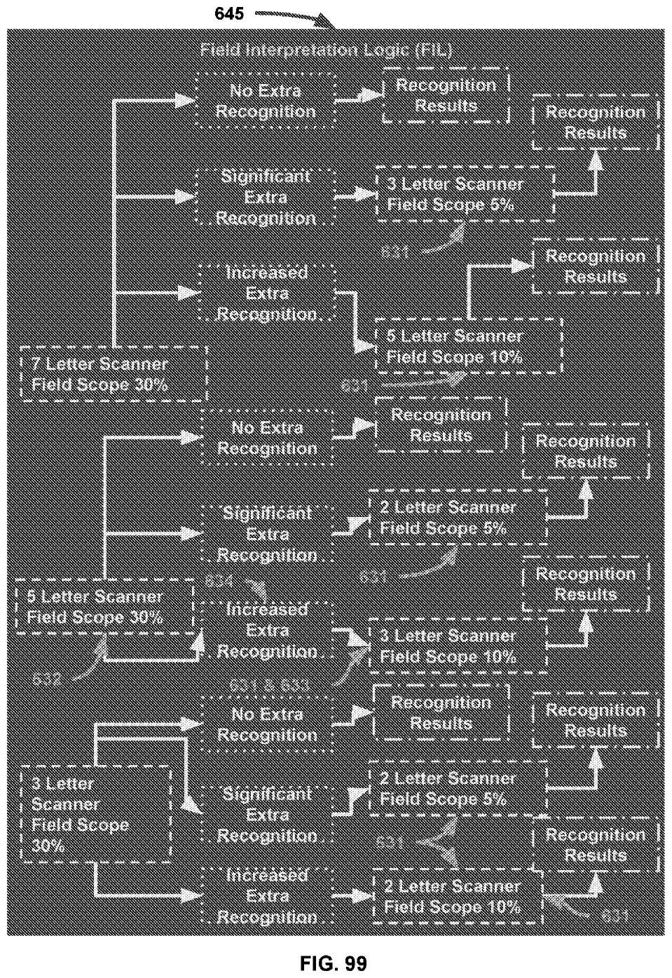

FIGS. 98-99 shows Field Interpretation Logic (FIL) 644 and 645, which operates the logistics for managing scanners of differing widths with the appropriate results. The General Scope Scan 629 begins with a large letter scan. This type of scan can sift through a large scope of field with fewer resources, at the expense of small scale accuracy. Hence the smaller letter scanners are delegated for more specific scopes of field, to improve accuracy where needed. The Specific Scope Scan 630 is used when an area of significance has been located, and needs to be ‘zoomed in’ on. The general correlation is that the smaller the field scope selected for scanning, the smaller type of scanner (less letters). This ensures that an expensively accurate scan isn't performed in a redundant and unyielding location. Section 645 of FIL displays the reactionary logistics to scanner results. If a particular scanner receives additional recognition of memory concepts in the Chaotic Field 613, this indicates that that Field Scope 631 (section of 613) contains a dense saturation of memory concepts and it is worth ‘zooming in’ on that particular scope with smaller width scans. Hence a 5 letter scanner with a field scope of 30% 632 will activate a 3 letter scanner with a field scope of 10% 633 contingent on their being an initial result returned considered as “Increased ‘Extra’ Recognition” 634. The ‘extra’ in 634 indicates the recognition being supplemental to the initial recognition performed in FIL Section 644.

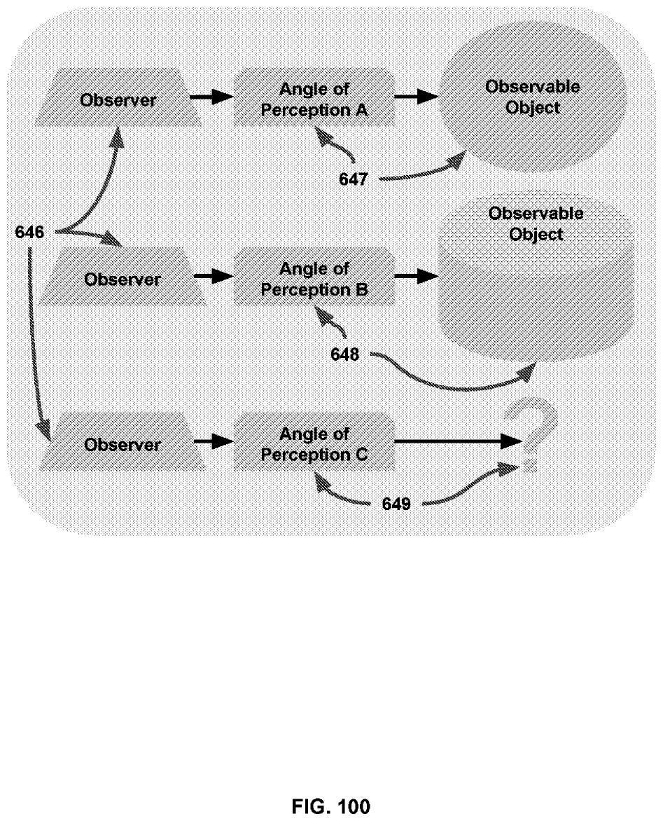

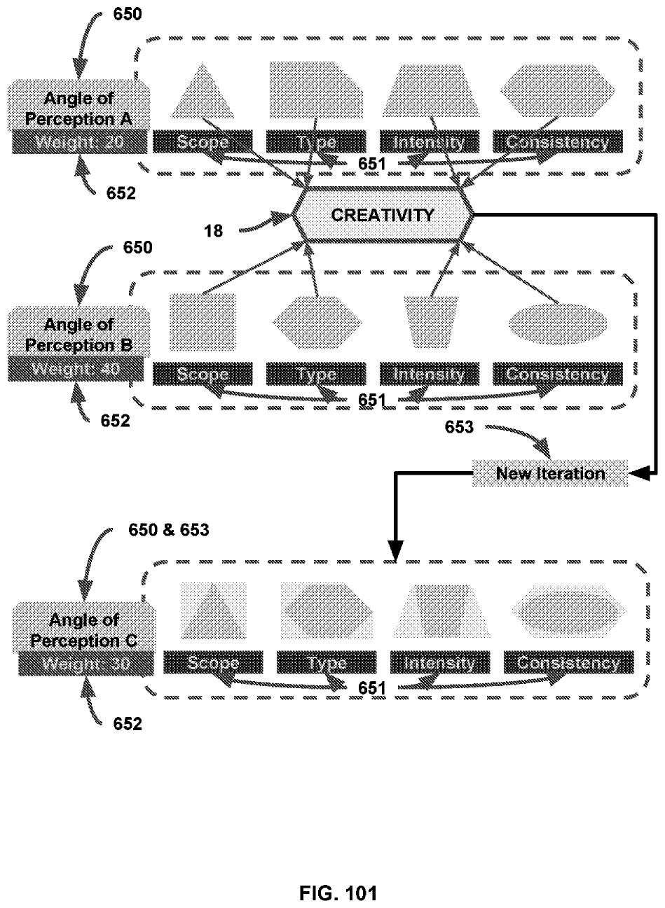

FIGS. 100-101 shows the Automated Perception Discovery Mechanism (APDM) 467. The Observer 646, whilst representing a digital or human observer, can perceive the same Object via multiple perceptions. The Observable Object is used to illustrate a potential cybersecurity case scenario. Angle of Perception A 647 yields a limited scope of information about the Observable Object as it is rendered in two dimensions. Angle of Perception B 648 yields a more informed scope as it includes the third dimension. The result of Angle of Perception C 649 is unknown to our limited thinking capabilities as the creative hybridization process Creativity 18 is being leveraged by modern parallel processing power. The Critical Thinking algorithm, by hybridizing the metrics of Angles A and B and hence forming a New Iteration 653, has the potential to produce more forms of Perception that can be beyond human comprehension ear or exponential (not plateauing) relationship between iteration complexity+efficacy and CPU time and power. Angle of Perceptions 650 are defined in composition by multiple metrics including yet not limited to Scope, Type, Intensity and Consistency 651. These Metrics define multiple aspects of perception that compose the overall perception. These can become more complex in scope than the example given above, hence there can be many complex variations of Perception produced by the Creativity Module. The Perception Weight 652 defines how much relative influence a Perception has whilst emulated by the Perception Observer Emulator (POE) 475. This weights of both input Perceptions are considering whilst defining the weight of the Newly Iterated Perception 653. This New Iterated Perception 653 contains hybridized metrics that are influenced from the previous generation of Perceptions: A+B. Such a new Angle of Perception might potentially offer a productive new vantage point for security software to detect covert exploits. Generations of perceptions are chosen for hybridization via a combination of trial/error and intelligent selection. If a perception, especially a newly iterated one, proves to be useless in providing insights in security problems, then it can be deemphasized for usage but it is seldom deleted as it is never fully known if it will ever provide a useful insight. Hence the trade off of computing power resources and security intelligence is experienced.

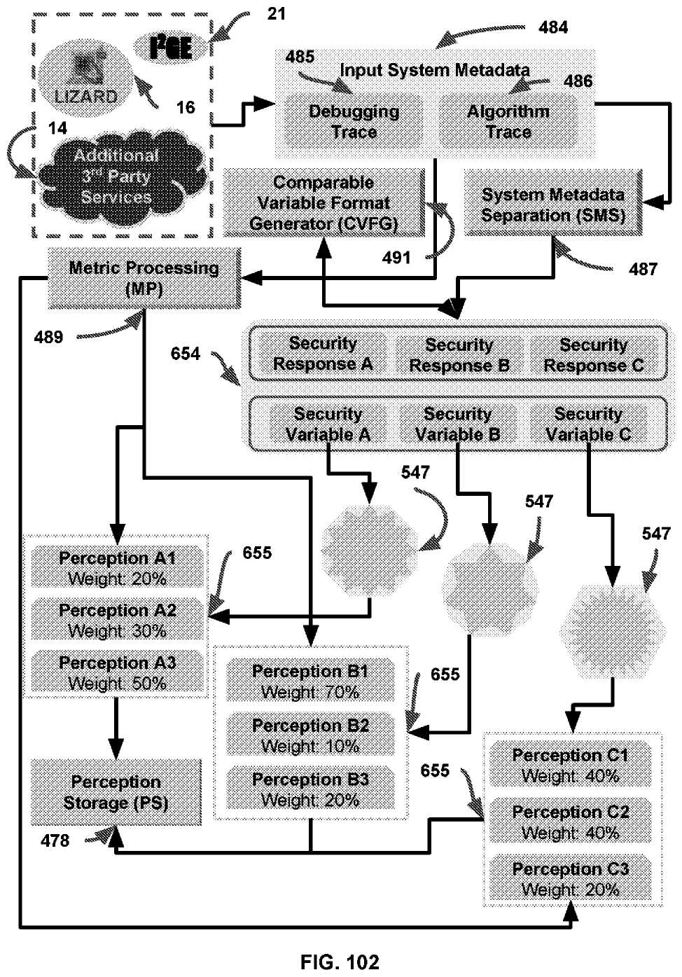

FIG. 102 shows Raw Perception Production (RP2) 465 which is a Module that receives metadata logs from the Selected Pattern Matching Algorithm (SPMA) 526. Such logs are parsed and a perception is formed that represents the perception of such algorithm. The perception is stored in a Perception Complex Format (PCF), and is emulated by the Perception Observer Emulator (POE). System Metadata Separation (SMS) 487 provides output of Security Response/Variable pairs 654, which establishes security cause-effect relationships as appropriate corrective action is coupled with trigger variables (such as subject, location, behavioral analysis etc.). The Comparable Variable Formats 547 are represented in non-graphical terms 655. Each one of these perception collections has a varying assortment of perceptions with a specific weighted influence to form the CVF 547.

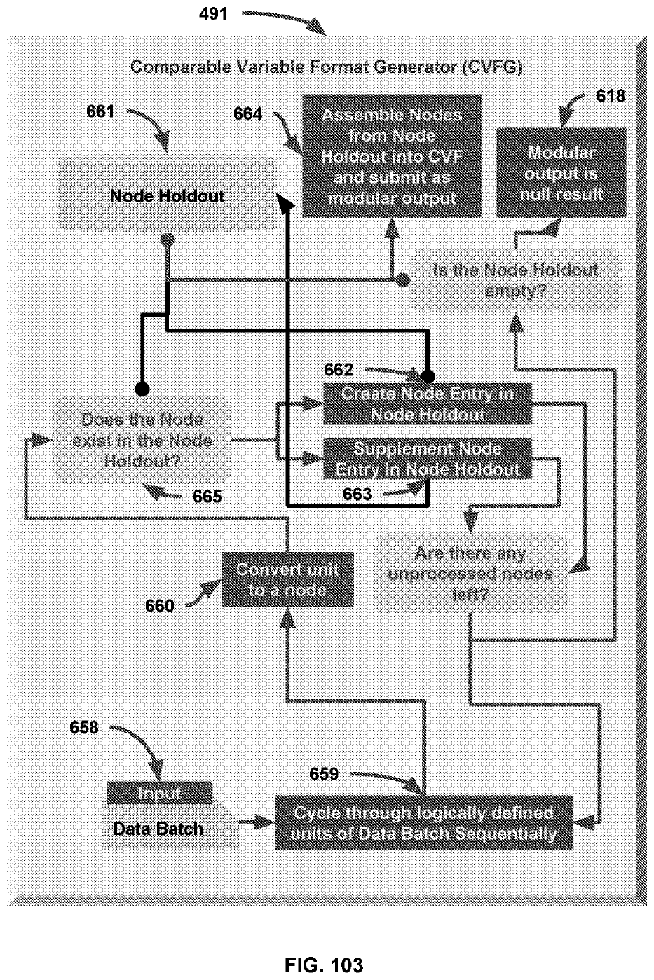

FIG. 103 shows the logic flow of the Comparable Variable Format Generator (CVFG) 491. The input for the CVFG is Data Batch 658, which is an Arbitrary Collection of data that represents the data that must be represented by the node makeup of the generated CVF 547. Stage 659 performs a sequential advancement through each of the individual units defined by Data Batch 658. The data unit is converted to a Node format at Stage 660, which has the same composition of information as referenced by the final CVF 547. Nodes are the building blocks of CVFs, and allow for efficient and accurate comparison evaluations to be performed against other CVFs. A CVF is like an irreversible MD5 hash-sum, except that it has comparison optimized characteristics (nodes). Such converted Nodes are then temporarily stored in the Node Holdout 661 upon checking for their existence at Stage 665. If they are not found then they are created at Stage 662 and updated with statistical information such as occurrence and usage at Stage 663. At Stage 664 all the Nodes with the Holdout 661 are assembled and pushed as modular output as a CVF 547. If after the Generator has run the Holdout 661 is empty then a null result is returned 618.

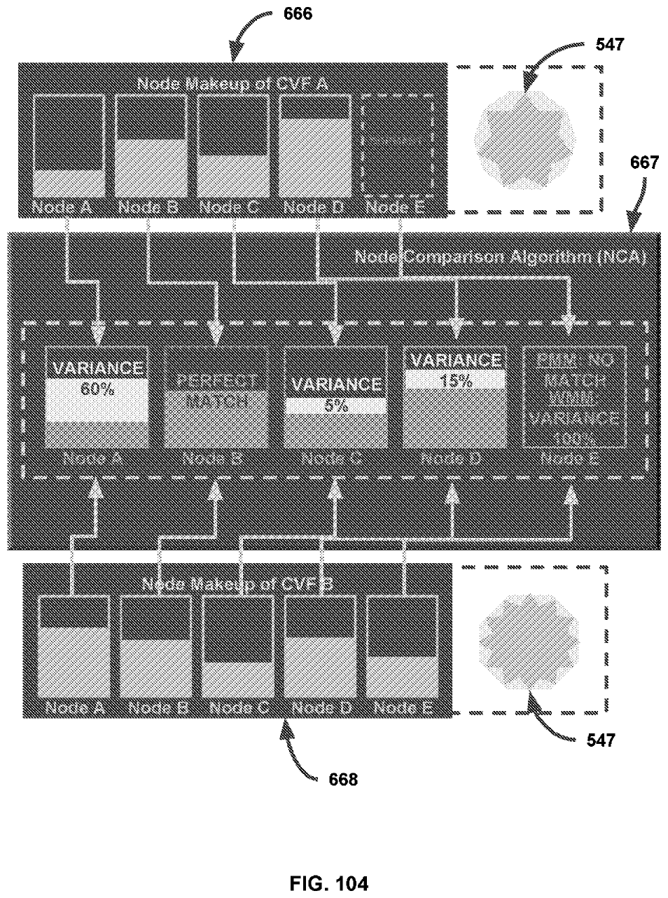

In FIG. 104, the Node Comparison Algorithm (NCA) 667 is comparing two Node Makeups 666 and 668, which have been read from the raw CVF 547. Each node of a CVF represents the degree of magnitude of a property. A similarity comparison is performed on an individual node basis, and the aggregate variance is calculated. This ensures an efficiently calculated accurate comparison. A smaller variance number, whether it be node-specific or the aggregate weight, represents a closer match. There are two modes of comparison that can take place: Partial Match Mode (PMM) and Whole Match Mode (WMM). With PMM if there is an active node in one CVF and it is not found in its comparison candidate (the node is dormant), then the comparison is not penalized. Mode Applicability Example: when comparing Tree A with Forest A, Tree A will find its closest match Tree B which exists within Forest A. With WMM If there is an active node in one CVF and it is not found in its comparison candidate (the node is dormant), then the comparison is penalized. Mode Applicability Example: when comparing Tree A with Forest A, no match will be found because Tree A and Forest A are being compared directly and have a large variance in overlap and structural similarity.

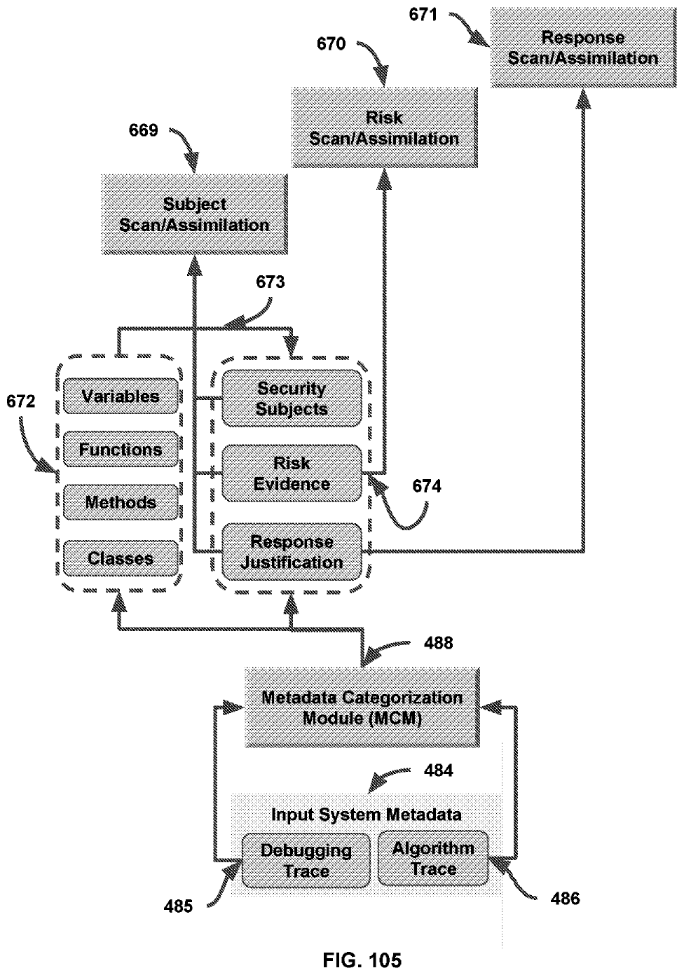

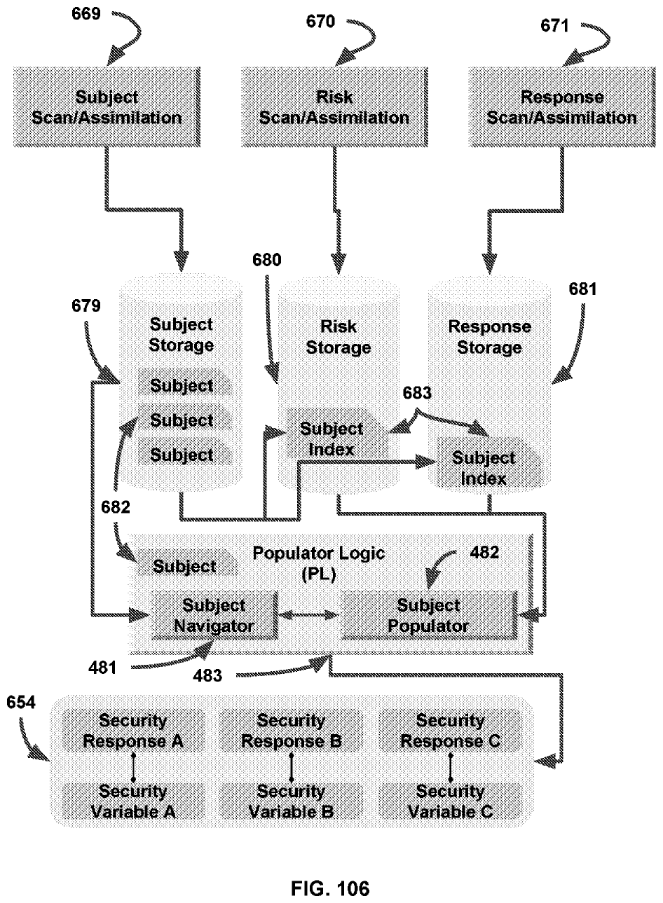

FIGS. 105 to 106 show System Metadata Separation (SMS) 487 which separates Input System Metadata 484 into meaningful security cause-effect relationships. As output from MCM 488, programming elements of the logs are retrieved individually at Stage 672. At Stage 673 individual categories from the MCM are used to get a more detailed composition of the relationships between security responses and security variables (security logs). Such categorizations 674 are then assimilated in Stages 669, 670, and 671. With Subject Scan/Assimilation 669 the subject/suspect of a security situation is extracted from the system metadata using premade category containers and raw analysis from the Categorization Module. The subject is used as the main reference point for deriving a security response/variable relationship. A subject can range from a person, a computer, an executable piece of code, a network, or even an enterprise. Such parsed Subjects 682 are stored in Subject Storage 679. With Risk Scan/Assimilation 670 the risk factors of a security situation are extracted from the system metadata using premade category containers and raw analysis from the Categorization Module. The risk is associated with the target subject which exhibits or is exposed to such risk. A risk can be defined as potential point of attack, type of attack vulnerability etc. Such Risks are stored in Risk Storage 680 with associations to their related Subjects at Subject Index 683. With Response Scan/Assimilation 671 the response of a security situation made by the input algorithm is extracted from the system metadata using premade category containers and raw analysis from the Categorization Module. The response is associated with the security subject which allegedly deserves such a response. Responses can range from approve/block/flag/quarantine/obfuscate/signal mimicry/retribution etc. Such Responses are stored in Response Storage 681 with associations to their related Subjects at Subject Index 683. Such stored information is then processed by the Populator Logic (PL) 483 which comprehensively assorts all the security subjects with relevant risks and responses.

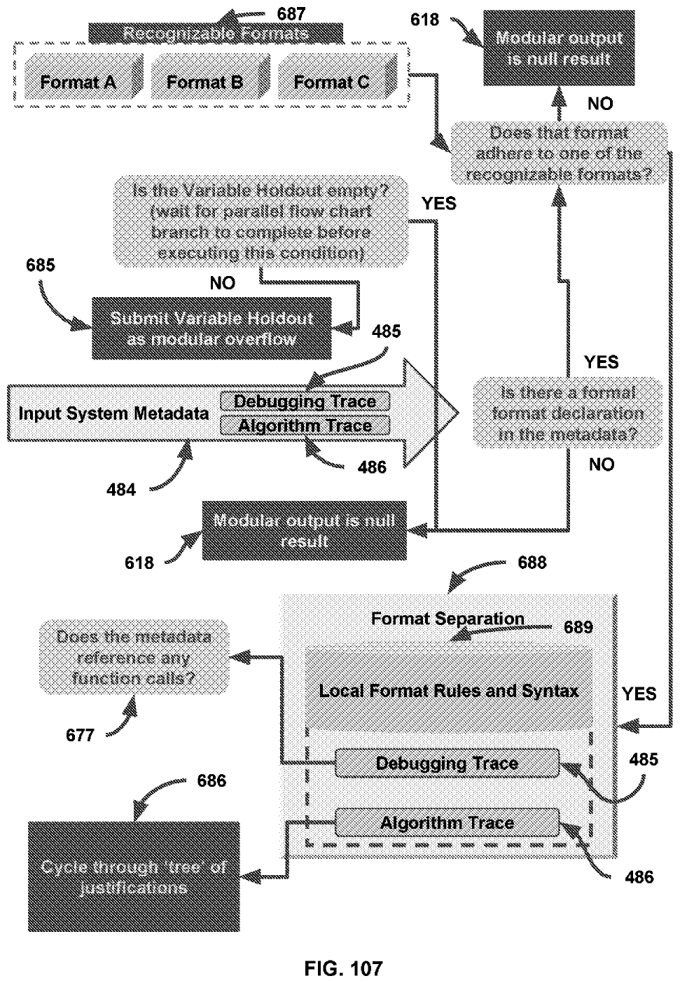

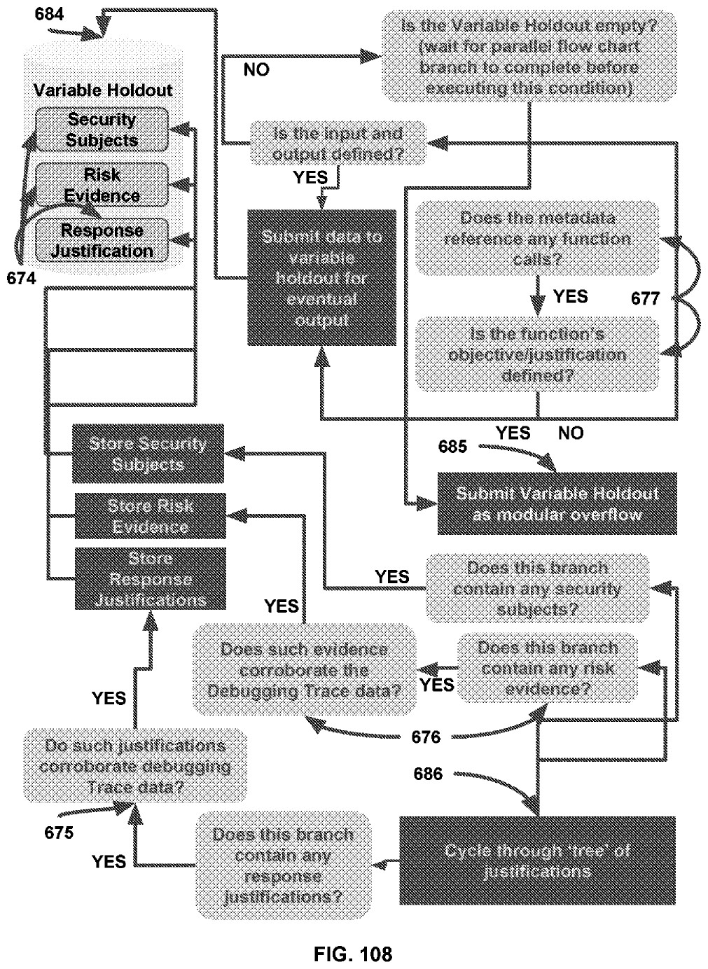

FIGS. 107 to 108 shows the Metadata Categorization Module (MCM) 488. In Format Separation 688 the metadata is separated and categorized according to the rules and syntax of a recognized format. Such metadata must have been assembled in accordance with a recognizable format, or else the metadata is rejected for processing. Local Format Rules and Syntax 689 contains the definitions that enable the MCM module to recognize pre-formatted streams of metadata. Local implies ‘of a format’ that has been previously selected due to relevancy and presence in the metadata. Debugging Trace 485 is a coding level trace that provides variables, functions, methods and classes that are used and their respective input and output variable type/content. The full function call chain (functions calling other functions) is provided. Algorithm Trace 486 is a Software level trace that provides security data coupled with algorithm analysis. The resultant security decision (approve/block) is provided along with a trail of how it reached that decision (justification), and the appropriate weight that each factor contributed into making that security decision. Such Algorithm trace 486 leads to the MCM's mode of cycling through each one of these security decision justifications at Stage 686. Such justifications define how and why a certain security response was made in computer log syntax (as opposed to written directly by humans). Recognizable Formats 687 are pre-ordained and standardized syntax formats that are compatible with CMTP. Hence if the format declarations from the Input System Metadata 484 are not recognized then a modular null result is returned 618. It is the obligation of the programmers of the SPMA 526 to code the Metadata 484 in a standardized format that is recognizable by CTMP. Such formats do not need to be proprietary and exclusive to CTMP, such as JSON and XML etc. Variable Holdout 684 is where processing variables are held categorically 674 so that they can be submitted as a final and unified output all at once 685. Stage 675 does a comparison check between the two main branches of input information which are Debugging Trace 485 and Algorithm Trace 486. Such a comparison tracks the occurrence of the justification at the coding level to better understand why such a security justification occurred and if it is worth becoming output for MCM. This step is precautionary to guarantee the reasoning behind every security justification and decision is well understood at even the coding level to further validate CTMP's potential criticism as a whole. Similarly Risk Evidence is checked for corroboration with the Debugging Trace Data at Stage 676. At Stage 677 the metadata is checked for any functions that were called by the SPMA, and thereafter such applicable functions are checked to see if their functional purpose and justification for being used is defined as per the specifications of Recognizable Formats 687.

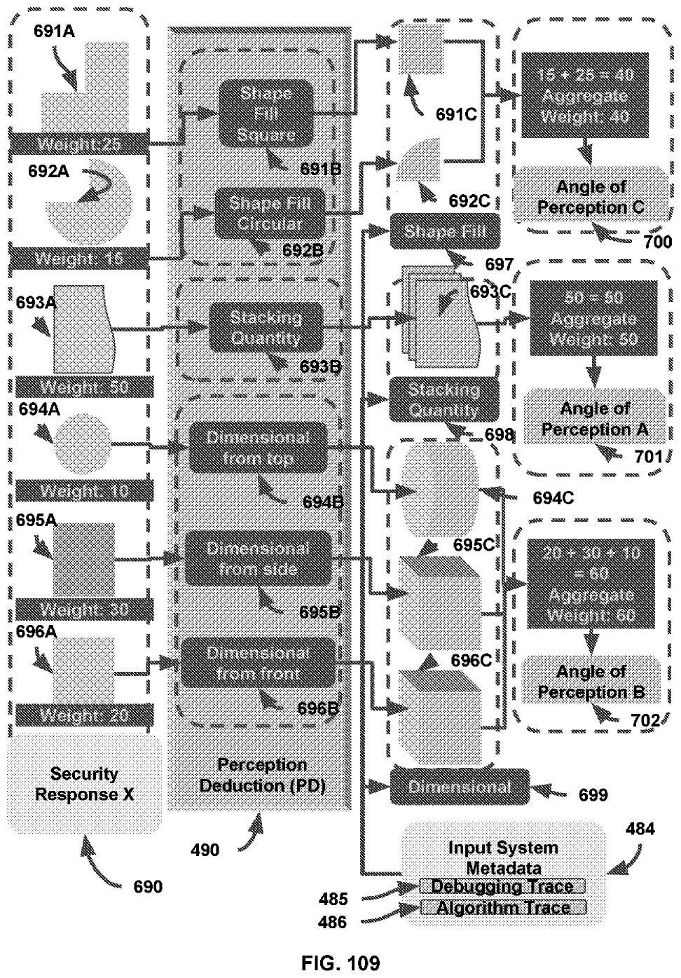

FIG. 109 shows Metric Processing (MP) 489, which reverse engineers the variables from the Selected Pattern Matching Algorithm (SPMA) 526 security response to ‘salvage’ perceptions from such algorithm's intelligence. Security Response X 690 represents a series of factors that contribute to the resultant security response chosen by the SPMA (i.e. Approve/Block/Obfuscate etc.). Each one of the shapes represents a security response from the Selected Pattern Matching Algorithm (SPMA). The initial weight is determined by the SPMA, hence it's intelligence is being leveraged. Such decisions are then referenced in bulk to model perceptions. Perception Deduction (PD) 490 uses a part of the security response and its corresponding system metadata to replicate the original perception of the security response. Perception Interpretations of the Dimensional Series 699 display how PD will take the Security Response of the SPMA and associate the relevant Input System Metadata 484 to recreate the full scope of the intelligent ‘digital perception’ as used originally by the SPMA. This gives CTMP a deep understanding of input algorithm and can then reuse and cross-reference the intelligence of multiple and varying algorithms, hence a significant milestone of Artificial Intelligence is being implemented. Such shapes are symbolic of complex rules, behaviors and correlations implemented by the SPMA. Shape Fill 697, Stacking Quantity 698, and Dimensional 699 are digital perceptions that capture the ‘perspective’ of an intelligent algorithm. The Dimensional 699 type of perception represents a three-dimensional shape, which can be a symbolic representation for a language learning algorithm that interprets company employee's internal emails and attempts to detect and/or predict a security breach of company sensitive information. Whilst the Dimensional type may be a single intelligent algorithm with slight variations (i.e. variation 694C is circular whilst 695C/696C is rectangular, representing subtle differences in the intelligent algorithm), there can be multiple initial security responses that at face value might not appear to have been made by such an algorithm. At face value 694A appears to have more in common with 692A than 696A. Despite this counter intuition, 692A is a security response that was performed by an algorithm Shape Fill 697 which is entirely different than Dimensional 699. Whilst perceptions 695C and 696C are identical, their Security Response counterparts 695A and 696A have subtle differences. Security Response 695A is darker and represents the Dimensional Perception from the side 695B whilst 696A represents the exact same perception albeit from the front 696B. These differences illustrate how different security responses which respond to different security threats/suspicious can be reverse engineered and found to be the same intelligent algorithm. All three instances of the Dimensional 699 perception (two of which are identical) are combined into a single unit thereafter referenced internally within CTMP as Angle of Perception B 702. The weight of influence this Angle of Perception has within CTMP is calculated according to the initial weight of influence the security responses 694A, 695A, and 696A carried. With the Stacking Quantity Perception 698, instead of receiving third dimensional depth as per Dimensional 699, the security response 693A is found to be a part of a set of multiple quantity. This can be a symbolic representation for a profiling algorithm that builds security profiles on new company employees to avoid external infiltration. Whilst CTMP initially receives only a single security profile, which is represented as Security Response 693A, it is in fact part of a collection of inter-referencing profiles known (after MP 489 performs reverse engineering) as Perception Stacking Quantity 698. Such a perception can be referenced within CTMP as Angle of Perception A 701 For Security Responses 691A and 692A a Security Response is provided to MP 489 that is symbolically represented as an incomplete shape. PD 490 leverages the Input System Metadata to find out that intelligent algorithm of which this Security Response originated is looking for the absence of an expected security variable. For example, this can be an algorithm that notices the absence of regular/expected behavior as opposed to noticing the presence of suspicious behavior. This can be a company employee that does not sign his emails in the way he usually does. This could either mean a sudden change of habit or an indication that this employee's email account has been compromised by a malicious actor who is not accustomed to signing emails like the real employee. Such an algorithm is reverse engineered to be the digital perception Shape Fill 697 which can be referenced within CTMP as Angle of Perception C 700 with the appropriate weight of influence.

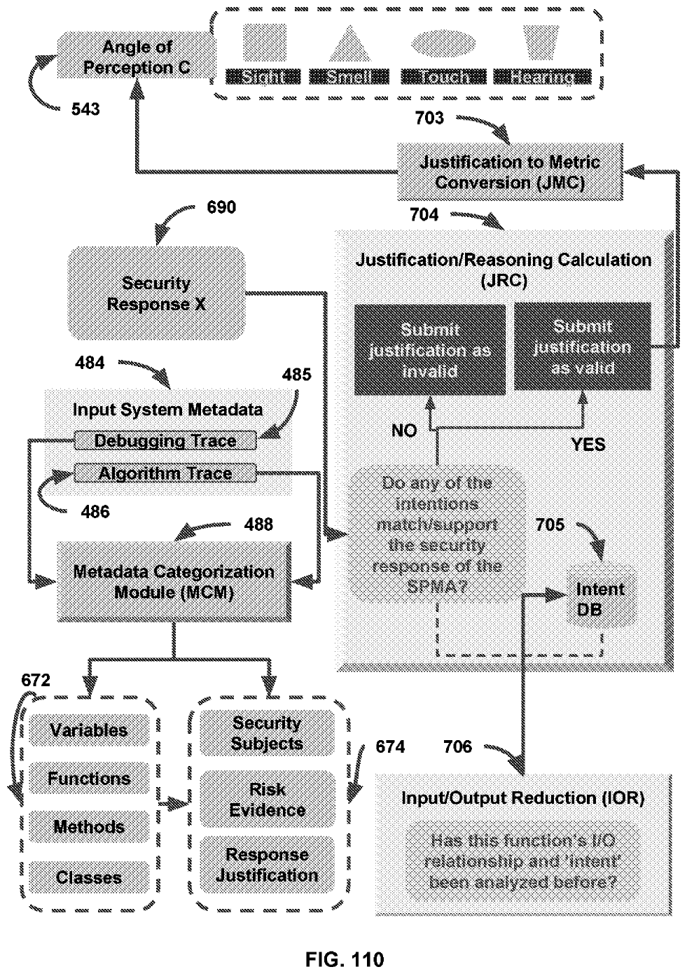

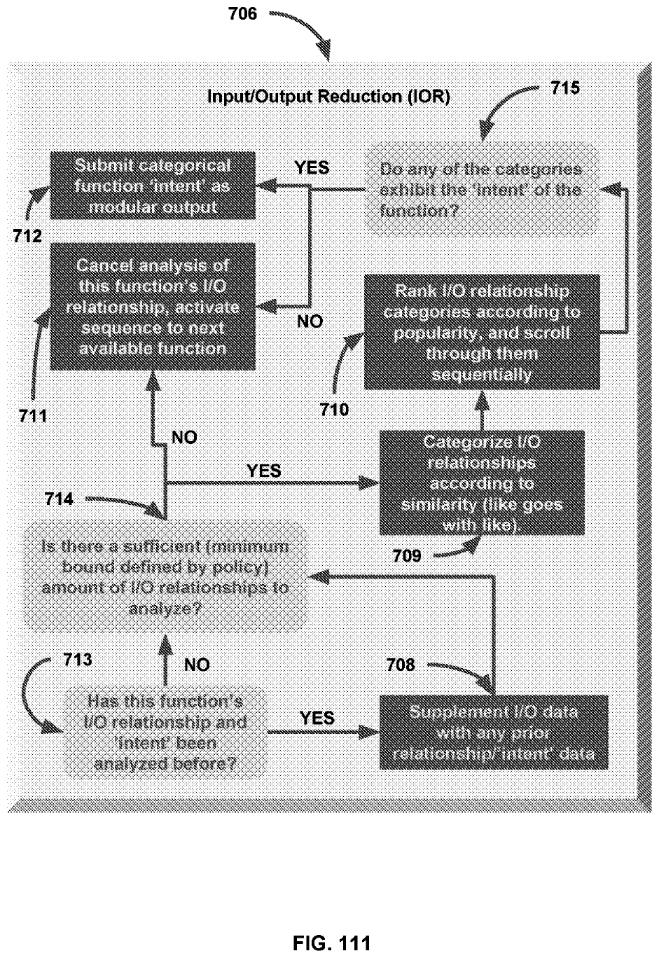

FIGS. 110 and 111 shows the internal design of Perception Deduction (PD) 490, which is primary used by Metric Processing (MP) 489. Security Response X is forwarded as input into Justification/Reasoning Calculation 704. This module determines the justification of the security response of the SPMA 526 by leveraging the intent supply of the Input/Output Reduction (IOR) module 706 as stored in the Intend DB 705. Such module IOR interprets the input/output relationship of a function to determine the justification and intent of the function's purpose. The IOR module uses the separated input and output of the various function calls listed in the metadata. Such a metadata separation is performed by the Metadata Categorization Module (MCM) 488, with the output categories occurring as collections 672 and 674. In JRC 704 the function intentions stored in the Intent DB 705 are checked against the Security Responses provided as input 690. If the function intentions corroborate the security decisions of the SPMA then they are submitted as a valid justification to Justification to Metric Conversion JMC 703. In the JMC module, the validated security response justification is converted into a metric which defines the characteristic of the perception. Metrics are analogous to human senses, and the security response justification represents the justification for using this sense. When a person crosses the road their senses (or metrics) for sight and sound are heightened, and their senses for smell and touch are dormant. This collection of senses, with their respective magnitudes of intensity, represent the ‘road-crossing’ perception. Justifications to this analogy would be ‘vehicles on roads can be dangerous, and you can see and hear them’. Hence the perception makeup is rationally justified, and an example Angle of Perception C 543 is formed. An I/O (input/output) relationship is defined as a single set of function input and the corresponding output that was provided by such function. IOR 706 first checks if a function's I/O relationships and function ‘intent’ have been previously analyzed by referencing an internal database. If information is found in the database, it is used as a supplement the current I/O data at stage 708. The supplemented (if applicable) I/O data is then checked if saturated enough to be able to attain a sufficient level of meaningful analysis at Stage 714. The amount is quantified in technical terms and the minimum level is defined by pre-existing CTMP policy. If there is an insufficient amount of I/O information to analyze, then that specific function analysis is cancelled at stage 711 and the IOR module 706 advances to the next available function. Upon their being a sufficient amount of information to analyze, I/O relationships are categorized according to similarity 709. For example, one I/O relationship is found to convert one currency to another (i.e. USD to EUR) whilst another I/O relationships is found to convert one unit of weight to another (i.e. pounds to kilograms). Both I/O relationships are categorized as belonging to data conversion due to trigger concepts being correlated with a categorization index. For example, such an index can have referenced to USD, EUR and pounds, kilograms make reference to the data conversion category. Hence once those units are found in an I/O relationship then IOR 706 is able to properly categorize them. Hence the function's intent is being suspected of being a currency and units conversion function. Upon categorizing all the available I/O relationships the categories are ranked according to the amount of I/O relationships weight that they contain at Stage 710, with the most popular appearing first. At Stage 715 the categories of I/O data are checked if they are able to confidently display a pattern of the function's intent. This is done by checking for consistency in the input to output transformation that the function performs. If a certain category of information is persistent and distinct (such as converting currency as one category and converting units as a second category), then these category become described ‘intents’ of the function. Hence the function will be described as having the intention of converting currencies and units. By IOR 706 reducing the function to it's intended purpose, this has major security analysis implications as CTMP can verify the real purpose for a function existing in code and is able to intelligently scan for malicious behavior pre-emptively before any damage has been done via execution of such code. If the ‘intent’ has been well understood with a sufficient degree of confidence by IOR 706 then is submitted as modular output 712. If ‘intent’ categories did not strongly corroborate each other and the ‘intent’ of the function was not confidently established, then the function's ‘intent’ is declared unknown and IOR 706 advances to the next available function for analysis at Stage 711.

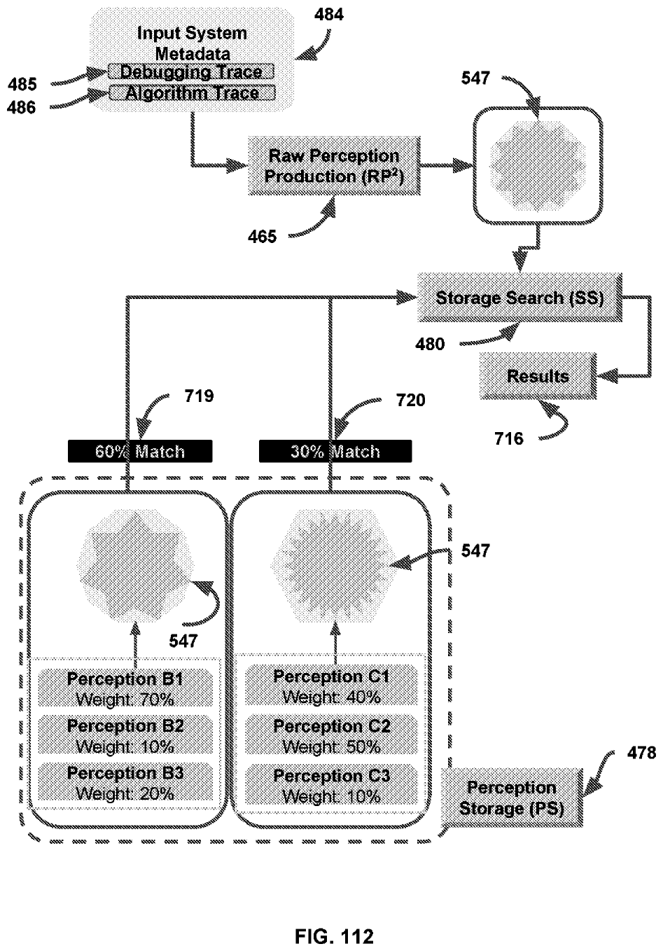

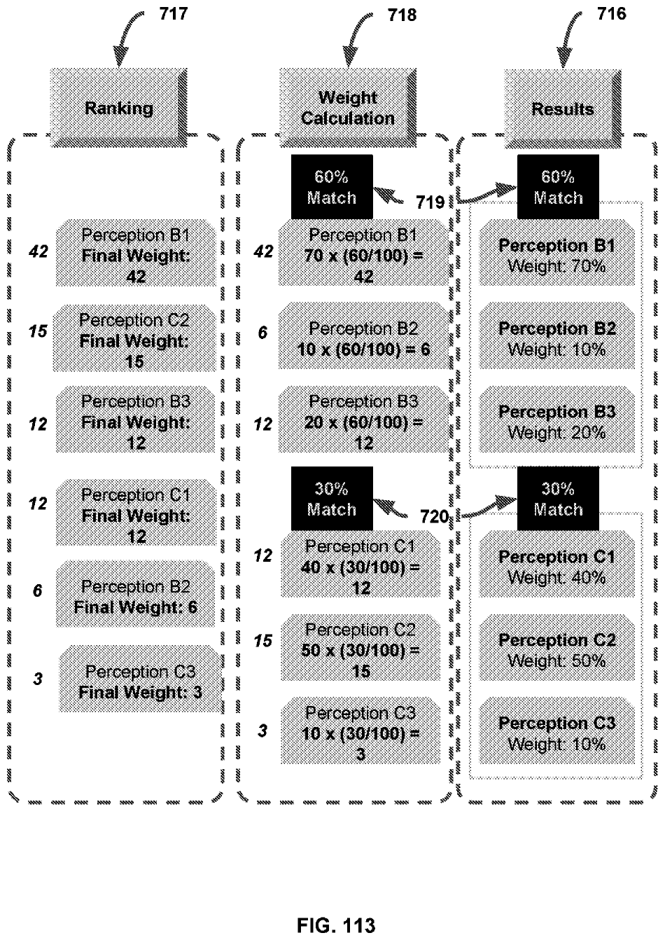

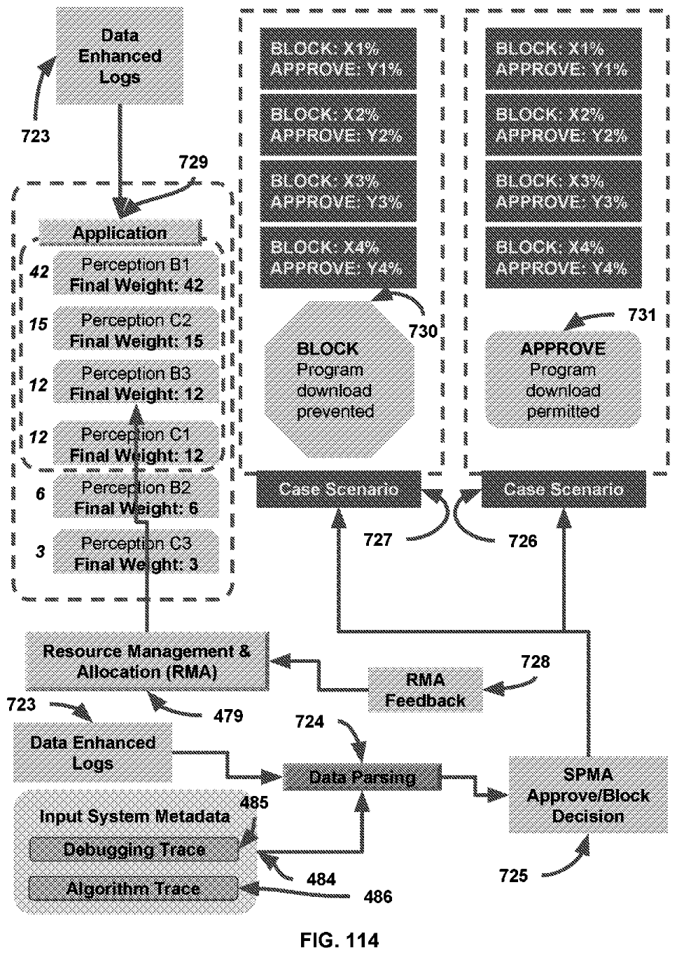

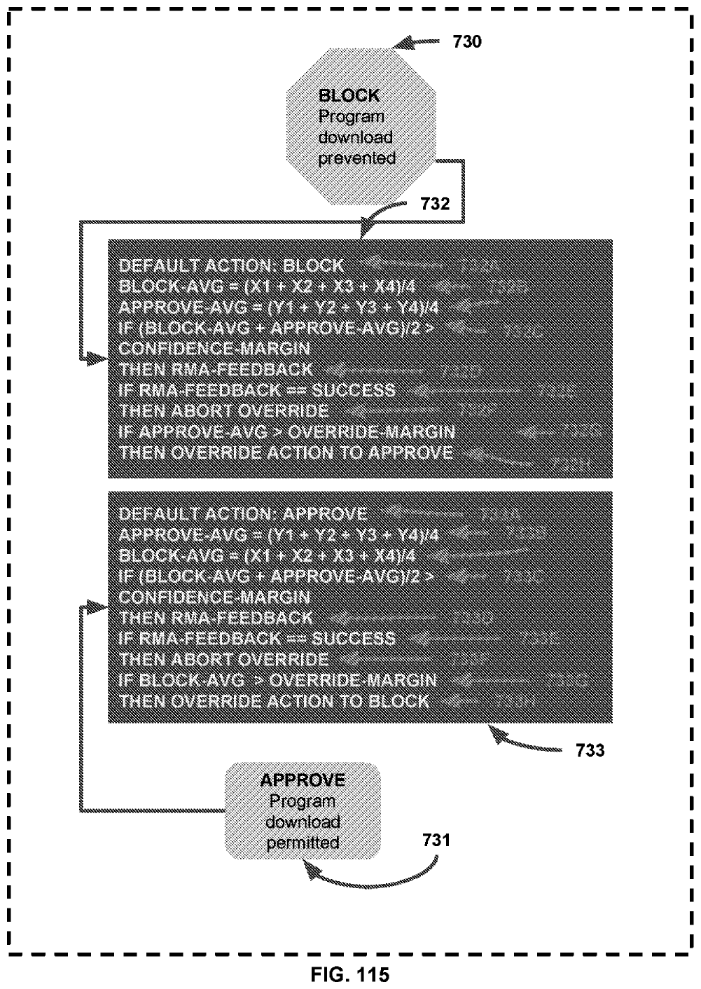

FIGS. 112-115 display the Perception Observer Emular (POE) 475. This module produces an emulation of the observer, and tests/compares all potential points of perception with such variations of observer emulations. Whilst the input are all the potential points of perception plus the enhanced data logs; the output is the resultant security decision produced of such enhanced logs according to the best, most relevant, and most cautious observer with such mixture of selected perceptions. Input System Metadata 484 is the initial input that is used by Raw Perception Production (RP2) 465 to produce perceptions in the Comparable Variable Format CVF 547. With Storage Search (SS) 480 the CVF derived from the data enhanced logs is used as criteria in a database lookup of the Perception Storage (PS) 478. PS provides all the available CVFs 547 from the database with the highest matching CVFs. Their associated Perception makeup and weight is referenced and to be used upon a successful matching event in Results 716. The similarity overlap is mentioned as 60% Match 719 and 30% Match 720. Such results are calculated by Storage Search 480. With Results 716 the Matches 719 and 720 are stored and then calculated for individual perception ranking at Weight Calculation 718. Such a calculation takes the overall similarity (or match) value of the database CVFs compared with the input CVF and multiplies that value with each individual perception weight. Such a weight has already been stored and associated with the CVF as initially determined by Metric Processing (MP) 489. In Ranking 717, the perceptions are ordered according to their final weight. Such ranking is part of the selection process to use the most relevant (as weighed in Weight Calculation 718) perceptions to understand the security situation and hence pass an eventual Block 730 or Approve 731 command output. Once the perceptions have been ranked they are forwarded to Application 729 where the Data Enhanced Logs 723 are applied to the perceptions to produce block/approve recommendations. Logs 723 are the input logs of the system with the original security incident. The Self-Critical Knowledge Density (SCKD) 492 tags the logs to define the expected upper scope of unknown knowledge. This means that the perceptions are able to consider data that is tagged with unknown data scopes. This means that the perceptions can perform a more accurate assessment of the security incident, considering it has an estimation of how much it knows, as well as how much it doesn't know. Data Parsing 724 does a basic interpretation of the Data Enhanced Logs 723 and the Input System Metadata 484 to output the original Approve or Block Decision 725 as decided by the original Selected Pattern Matching Algorithm (SPMA) 526. Thus two potential case scenarios exist, the SPMA has either chosen to block 730 the security related incident (i.e. prevent a program download) in Scenario 727 or has chosen to Approve 731 such incident in Scenario 726. At this point CTMP 22 has progressed thus far that it is ready to perform its most core and crucial task which is to criticize decisions (including but not limited to cybersecurity). This criticism occurs twice within CTMP in two different ways, once here in Perception Observer Emulator (POE) according to perceptions, and once in Rule Execution (RE) according to logically defined rules. Within POE, upon receiving the block command from the SPMA, the override logic of 732 is engaged. Upon receiving the approve command from the SPMA, the override logic of 733 is engaged. At Stage 732A the default action of Block 730 is assumed and the BLOCK-AVG and APPROVE-AVG values 732B are calculated by finding the average of the Block/Approve confidence values stored in Case Scenario 727. Stage 732C checks if the average confidence of Case Scenario 727 is greater than a pre-defined (by policy) confidence margin. If the confidence of the scenario is low this indicates that CTMP is withholding criticism due to insufficient information/understanding. Upon such a low confidence situation arising the RMA Feedback module 728 is engaged at Stage 732D to attempt to reevaluate the security situation with more perceptions included. Such additionally considered perceptions may increase the confidence margin. Hence the RMA feedback will communicate with Resource Management and Allocation (RMA) 479 itself to check if a revaluation is permissible according to resource management policy. If such revaluation is denied, then the algorithm has reached it's peak confidence potential and overriding the initial approval/block decision is permanently aborted for this POE session. Stage 732E indicates a condition of the RMA Feedback module 728 receiving permission from RMA 479 to reallocate more resources and hence more perceptions into the calculation. Upon such a condition the override attempt (CTMP criticism) is aborted at Stage 732F as to allow for the new evaluation of Case Scenario 727 to take place with the addition perceptions (and hence computer resource load increase). Stage 732G indicates the Approve average is confident enough (according to policy) to override the Default Block action 730/732A to an Approve action 731 at Stage 732H. The same logic applies to the Approve logic 733 which occurs at Case Scenario 726. At Stage 733A the default action is set to Approve as requested by the SPMA 526. The BLOCK-AVG and APPROVE-AVG values 733B are calculated by finding the average of the Block/Approve confidence values stored in Case Scenario 726. Stage 733C checks if the average confidence of Case Scenario 726 is greater than a pre-defined (by policy) confidence margin. Upon such a low confidence situation arising the RMA Feedback module 728 is engaged at Stage 733D to attempt to reevaluate the security situation with more perceptions included. Stage 733E indicates a condition of the RMA Feedback module 728 receiving permission from RMA 479 to reallocate more resources and hence more perceptions into the calculation. Upon such a condition the override attempt (CTMP criticism) is aborted at Stage 733F as to allow for the new evaluation of Case Scenario 726 to take place with the addition perceptions (and hence computer resource load increase). Stage 733G indicates the Approve average is confident enough (according to policy) to override the Default Approve action 731/733A to a Block action 730 at Stage 733H.

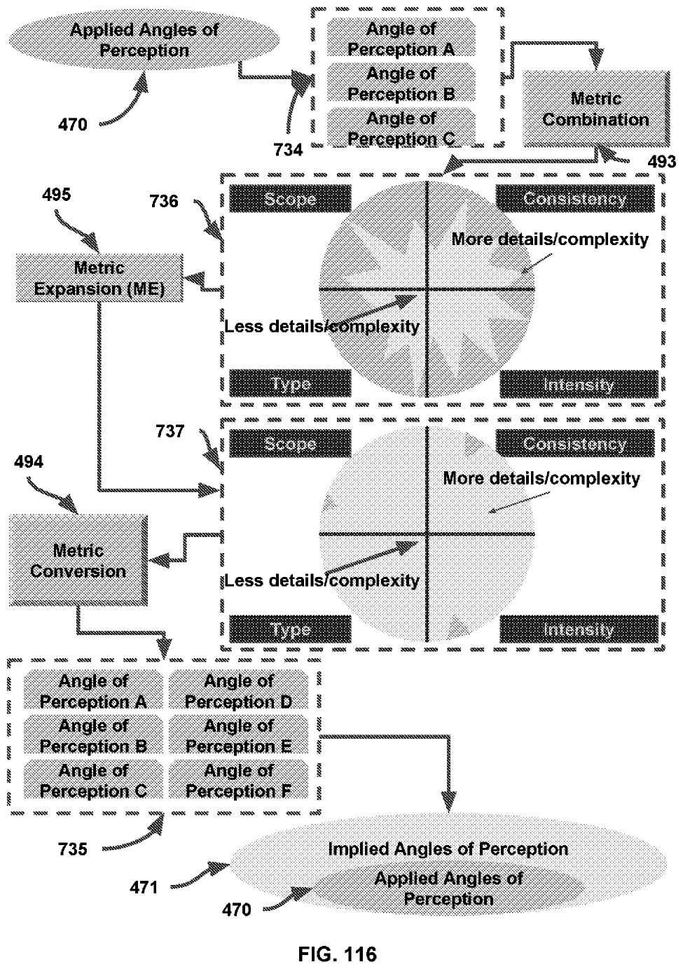

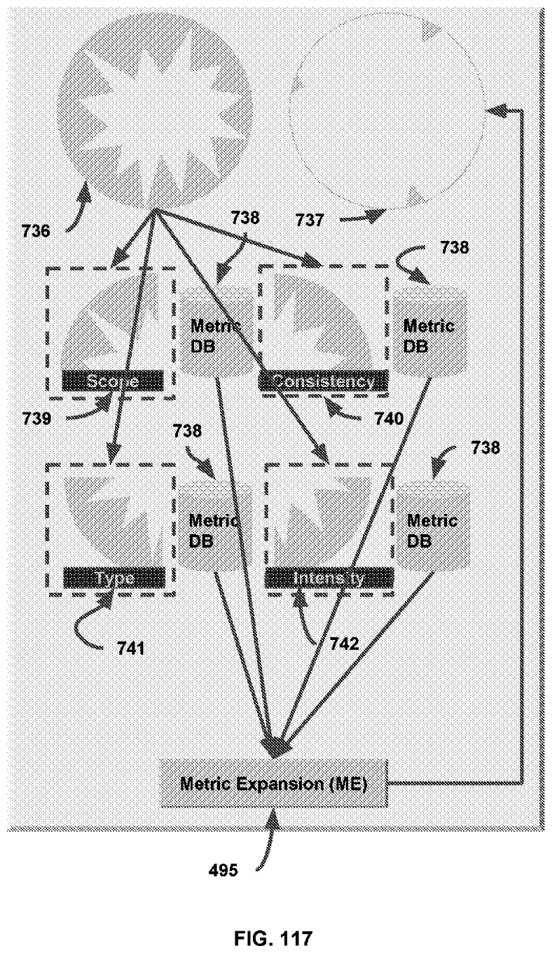

FIGS. 116 to 117 shows Implication Derivation (ID) 477 which derives angles of perception data that can be implicated from the current known angles of perceptions. Applied Angles of Perception 470 is a scope of known perceptions which are stored in a CTMP storage system. Such perceptions 470 have been applied and used by the SPMA 526, and are gathered as a collection of perceptions 734 and forwarded to Metric Combination 493. This module 493 converts the Angle of Perceptions 734 format into categories of metrics which is the format recognized by Implication Derivation (ID) 477. With Metric Complexity 736 the outer bound of the circle represents the peak of known knowledge concerning the individual metric. Hence towards the outer edge of the circle represents more metric complexity, whilst the center represents less metric complexity. The center light grey represents the metric combination of the current batch of Applied Angles of Perception, and the outer dark grey represents metric complexity that is stored and known by the system in general. The goal of ID 477 is to increase the complexity of relevant metrics, so that Angles of Perception can be multiplied in complexity and quantity. Known metric complexity from the current batch is added to the relevant Metric DB 738 incase it does not already contain such detail/complexity. This way the system has come full circle and that newly stored metric complexity can be used in a potential future batch of Angles of Perception Implication Derivation. Such Complex Metric Makeup 736 is passed as input to Metric Expansion (ME) 495, where the metrics of multiple and varying angles of perception are stored categorically in individual databases 738. The dark grey surface area represents the total scope of the current batch of Applied Angles of Perception, and the amount of scope left over according to the known upper bound. The upper bound is represented by the peak knowledge of each individual Metric DB. Hence the current batch of metrics (which have been derived by the current batch of Angles of Perception) are enhanced with previously known details/complexity of those metrics. Upon enhancement and complexity enrichment the metrics are returned as Metric Complexity 737. As viewed in the diagram 737 the light grey area has become larger in all four sectors of metrics Scope 739, Consistency 740, Type 741 and Intensity 742. This indicates that the perception has become more detailed and complex in all four metric sectors. This enhanced Metric Complexity 737 is then passed as input of Metric Conversion 494, which reverses individual to whole Angles of Perception 735. Thus the final output is assembled as Implied Angles of Perception 471, which is an extended version of the original input Applied Angles of Perception 470.

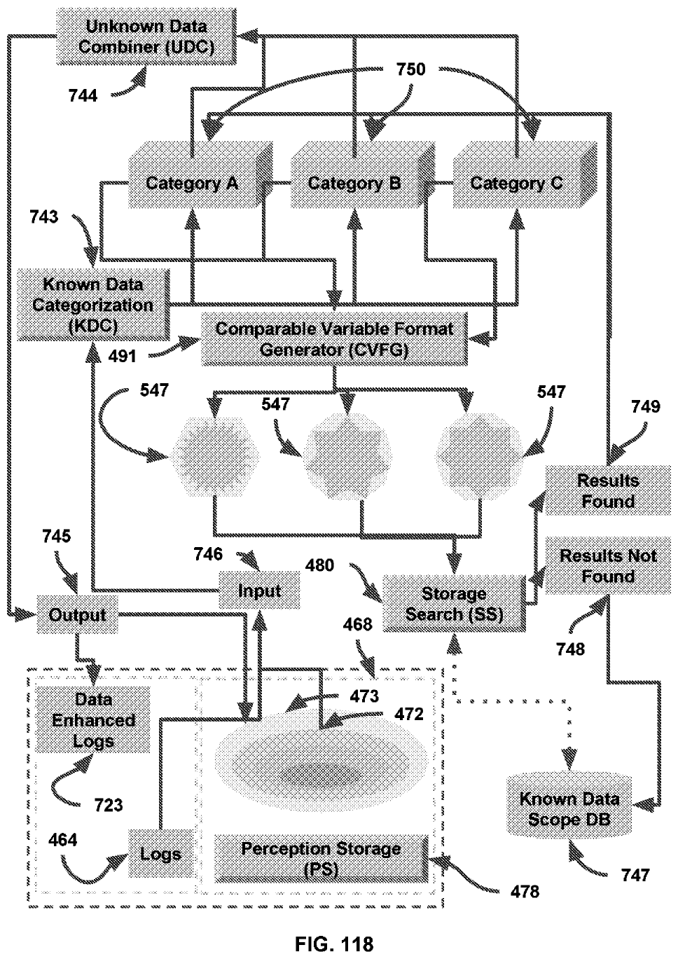

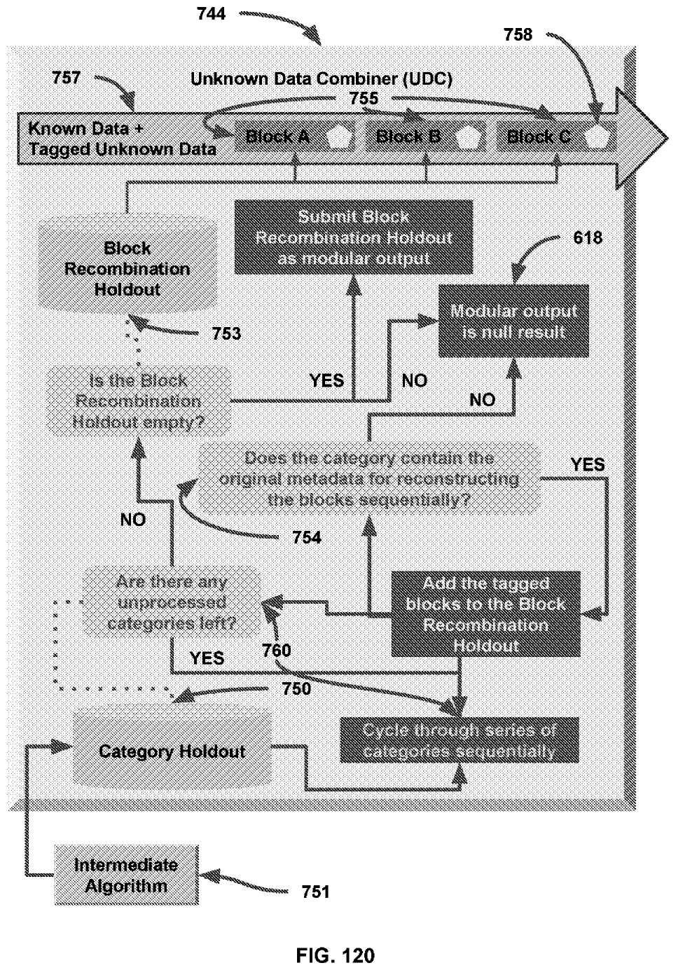

FIGS. 118-120 show Self-Critical Knowledge Density (SCKD) 492, which estimates the scope and type of potential unknown knowledge that is beyond the reach of the reportable logs. This way the subsequent critical thinking features of the CTMP 22 can leverage the potential scope of all involved knowledge, known and unknown directly by the system. The following is an example use case to demonstrate the intended functionality and capabilities of SCKD 492:
1) The system has built a strong scope of reference for Nuclear Physics.
2) The system has performed an analogy that Nuclear Physics and Quantum Physics are categorically and systematically similar in complexity and type.
3) However, the system has much less referenceable knowledge on Quantum Physics than Nuclear Physics.
4) Hence the system defines the upper bound of potentially attainable Quantum Physics knowledge via analogy of Nuclear Physics.
5) The system determines that the scope of unknown knowledge in terms of Quantum physics is large.

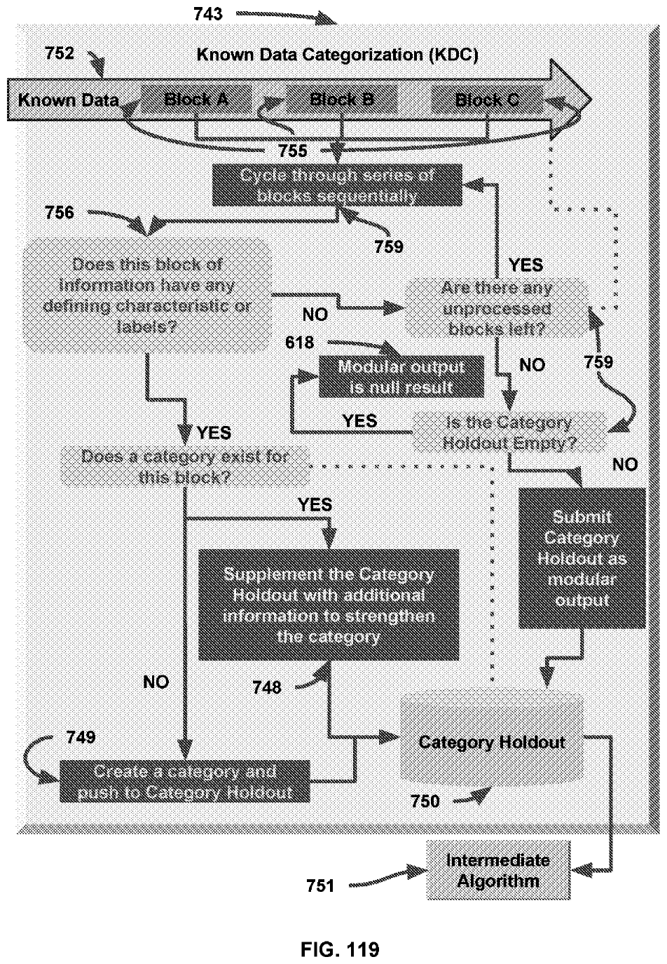

Known Data Categorization (KDC) 743 categorically separates confirmed (known) information from Input 746 so that an appropriate DB analogy query can be performed. Such information is separated into categories A, B, and C 750, after which the separate categories individually provide input to the Comparable Variable Format Generator (CVFG) 491. The CVFG then outputs the categorical information in CVF 547 format, which is used by Storage Search (SS) 480 to check for similarities in the Known Data Scope DB 747. With DB 747 the upper bound of known data is defined according to data category. A comparison is made between similar types and structures of data to estimate the confidence of the knowledge scope. If SS 480 was unable to find any results to make a knowledge analogy at Scenario 748 then the current data is stored so that a future analogy can be made. According the Use Case example, this would be the incident which allows the scope of Nuclear Physics to be defined. Then when Quantum Physics is referenced in the future, it can make an analogy of it's knowledge scope with the current storing of the Nuclear Physics knowledge scope. Scenario 749 describes a results found situation, upon which each category is tagged with it's relevant scope of known data according to the SS 480 results. Thereafter the tagged scopes of unknown information per category are reassembled back into the same stream of original data (Input 746) at the Unknown Data Combiner (UDC) 744. At Output 745 the original input data is being returned and coupled with the unknown data scope definitions. At FIG. 119 the Known Data Categorization (KDC) module 743 is illustrated in greater detail. Known Data 752 is the primary input and contains Blocks of information 755 that represent defined scopes of data such as individual entries from an error log. Stage 756 checks for recognizable definitions within the block which would show, as per the Use Case, that it is labelled as Nuclear Physics information. If a Category exists suiting the information label of the block in the Category Holdout 750, then the pre-existing Category is strengthened with details at Stage 748 by supplementing it with the processed block of information 755. If no such category exists then it is created at Stage 749 so that the block of information 755 can be stored accordingly and correctly. The Rudimentary Logic 759 cycles through the blocks sequentially until all of them have been processed. After all of them having been processed, if not the minimum amount (defined by policy) was submitted to the Category Holdout 750, then KDC 743 submits modular output as null result 618. If there is a sufficient amount of processed blocks then the Category Holdout 750 is submitted to the Intermediate Algorithm 751 (which is primarily SCKD 492). Unknown Data Combiner (UDC) 744 receives known data which has been tagged with unknown data point 757 from the Intermediate Algorithm 751. Such data is initially stored in the Category Holdout 750 and from there Rudimentary Logic 760 cycles through that all units of data sequentially. Stage 754 checks if the defined categories from Holdout 750 contain the original metadata which describes how to reconstruct the separate categories into a congruent stream of information. Such metadata was originally found in the input Known Data 752 from KDC 743, since at that stage the data had yet to be separated into categories and there was an initial single congruent structure that held all the data. After Stage 754 reassociates the metadata with their counterpart data the tagged blocks are transferred to the Block Recombination Holdout 753. In no metadata was found that matched the data at Stage 754, then the Holdout 753 will inevitably remain empty and a modular null result 618 will be returned. Upon a successful metadata match, the Holdout 753 is filled and the modular output for UDC 744 is Known Data+Tagged Unknown Data 757. Blocks 755 in the modular output represents the original blocks of information as found in Known Data 752 from KDC 743. Pentagon 758 represents the Unknown Data scope definition which is coupled with every block of Known Data 755.

### Lexical Objectivity Mining (LOM)

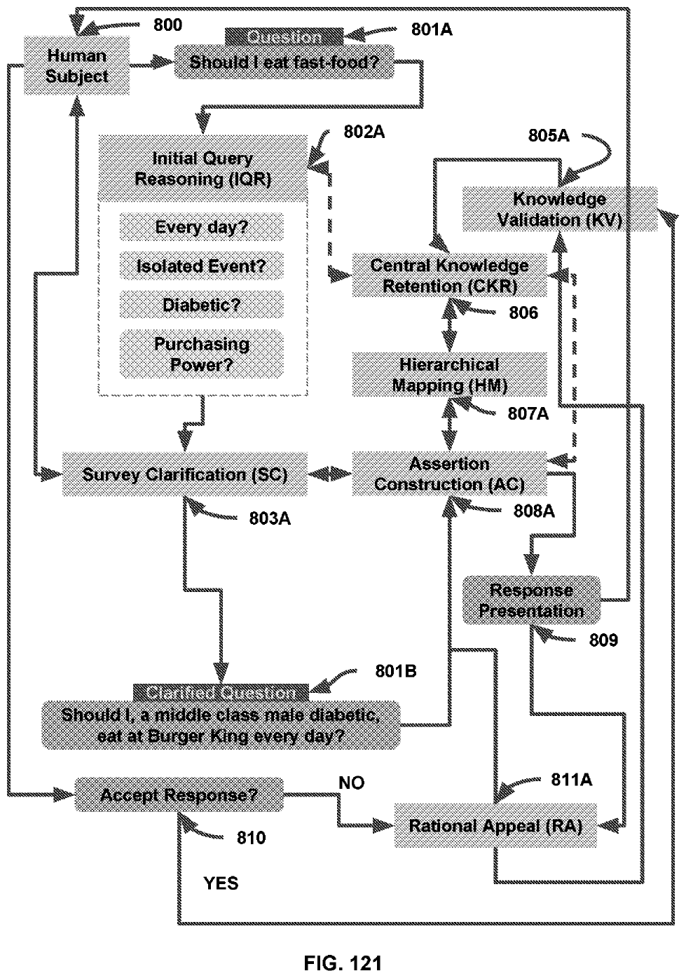

FIG. 121 shows the main logic for Lexical Objectivity Mining (LOM). LOM attempts to reach as close as possible to the objective answer to a wide range of questions and/or assertions. It engages with the Human Subject 800 to allow them to concede or improve their argument against the stance of LOM. Conceding or improving an argument is the core philosophy of LOM as it must be able to admit when it has been wrong so that it can learn from the knowledge of the human, which is where it gets knowledge from in the first place. LOM is extremely database heavy (and hence CPU, RAM and Disk are all crucial players), and would benefit from Central Knowledge Retention (CKR) 806 being centralized in a single (yet duplicated for redundancy and backups) master instance. Third party apps can be facilitated via a paid or free API that connects to such a central master instance. LOM's activity begins with Human Subject 800, who posits a question or assertion 801 into the main LOM visual interface. Such a question/assertion 801A is transferred for processing to Initial Query reasoning (IQR) 802 which leverages Central Knowledge Retention (CKR) 806 to decipher missing details that are crucial in understanding and answering/responding to the Question/Assertion. [ . . . ] Thereafter the Question/Assertion 801 along with the supplemental query data is transferred to Survey Clarification (SC) 803A which engages with the Human Subject 800 to achieve supplemental information so that the Question/Assertion 801A can be analyzed objectively and with all the necessary context. Hence Clarified Question/Assertion 801B is formed, which takes the original raw Question/Assertion 801 as posed by Human Subject 800 yet supplements details learnt from 800 via SC 803A. Assertion Construction (AC) 808A receives a proposition in the form of an assertion or question (like 801B) and provides output of the concepts related to such proposition. Response Presentation 809 is an interface for presenting a conclusion drawn by LOM (specifically AC 808) to both Human Subject 800 and Rational Appeal (RA) 811. Such an interface is presented visually for the Human 800 to understand and in a purely digital syntax format to RA 811. Hierarchical Mapping (HM) 807A maps associated concepts to find corroboration or conflict in Question/Assertion consistency. It then calculates the benefits and risks of having a certain stance on the topic. Central Knowledge Retention 806 is the main database for referencing knowledge for LOM. Optimized for query efficiency and logical categorization and separation of concepts so that strong arguments can be built, and defeated in response to Human Subject 800 criticism. Knowledge Validation (KV) 805A receives high confidence and pre-criticised knowledge which needs to be logically separated for query capability and assimilation into the CKR 806. Accept Response 810 is choice given to the Human Subject 800 to either accept the response of LOM or to appeal it with a criticism. If the response is accepted, then it is processed by KV 805A so that it can be stored in CKR 806 as confirmed (high confidence) knowledge. Should the Human Subject 800 not accept the response, they are forwarded to Rational Appeal (RA) 811A which checks and criticises the reasons of appeal given by Human 800. RA 811A can criticise assertions whether it be self-criticism or criticism of human responses (from a ‘NO’ response at Accept Response 810).

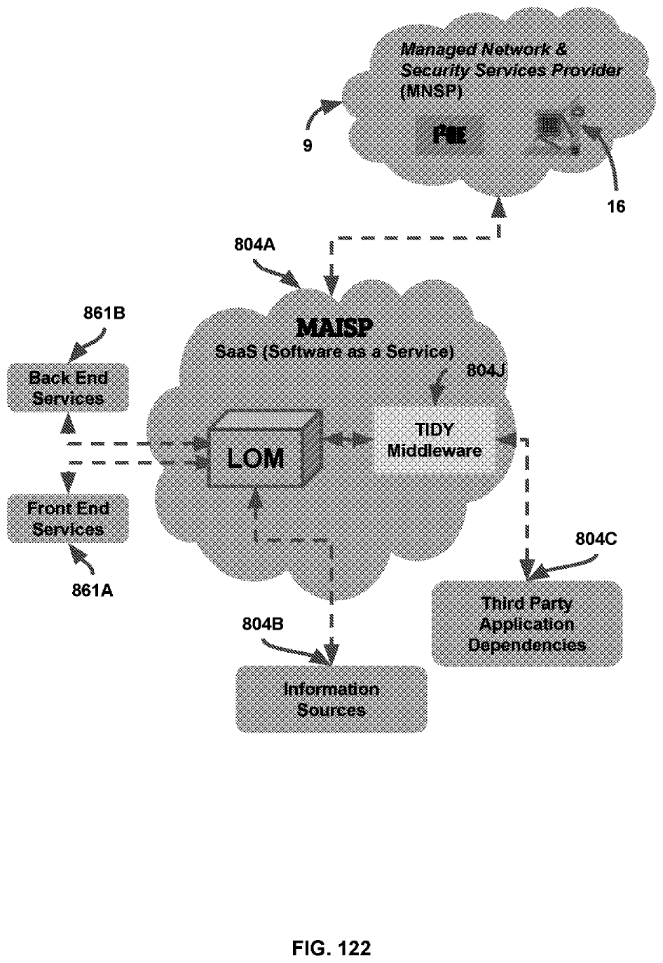

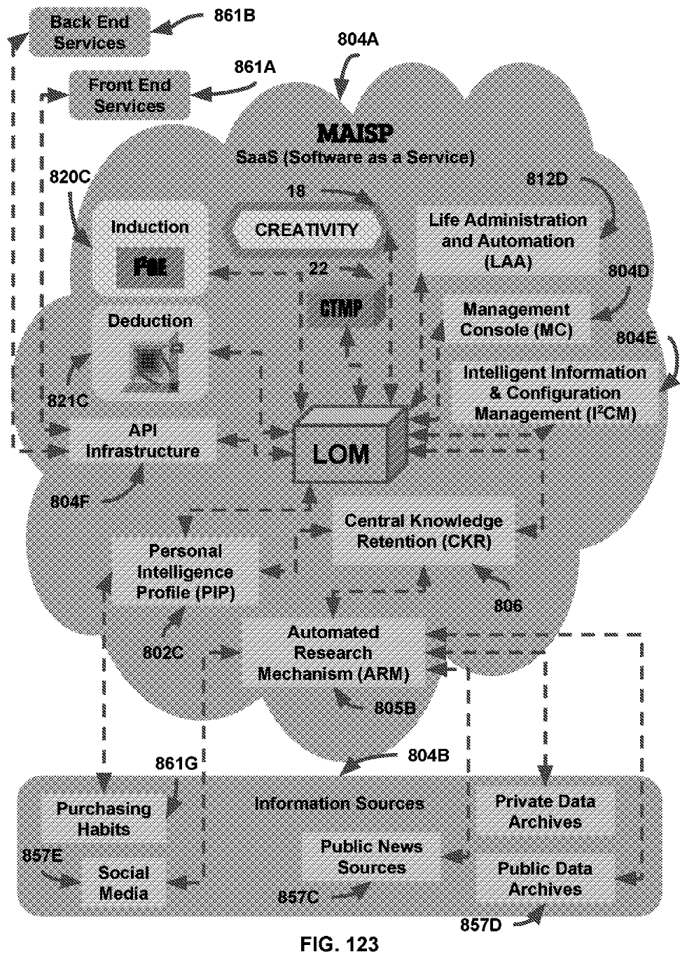

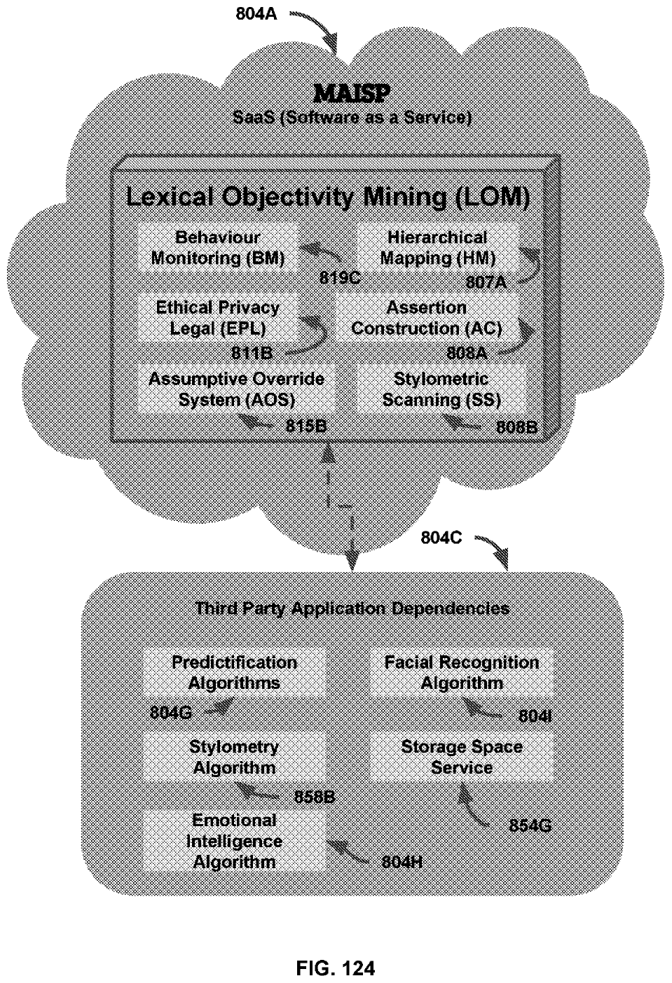

FIGS. 122-124 shows Managed Artificially Intelligent Services Provider (MAISP) 804A. MAISP runs an internet cloud instance of LOM with a master instance of Central Knowledge Retention (CKR) 806. MAISP 804A connects LOM to Front End Services 861A, Back End Services 861B, Third Party Application Dependencies 804C, Information Sources 804B, and the MNSP 9 Cloud. Front End Services 861A include Artificially Intelligent Personal Assistants (i.e. Apple's Siri, Microsoft's Cortana, Amazon's Alexa, Google's Assistant), Communication Applications and Protocols (i.e. Skype, WhatsApp), Home Automation (i.e. Refrigerators, Garages, Doors, Thermostats) and Medical Applications (i.e. Doctor Second Opinion, Medical History). Back End Services 861B include online shopping (i.e. Amazon.com), online transportation (i.e. Uber), Medical Prescription ordering (i.e. CVS) etc. Such Front End 861A and Back End 861B Services interact with LOM via a documented API infrastructure 804F which enables standardization of information transfers and protocols. LOM retrieves knowledge from external Information Sources 804B via the Automated Research Mechanism (ARM) 805B.

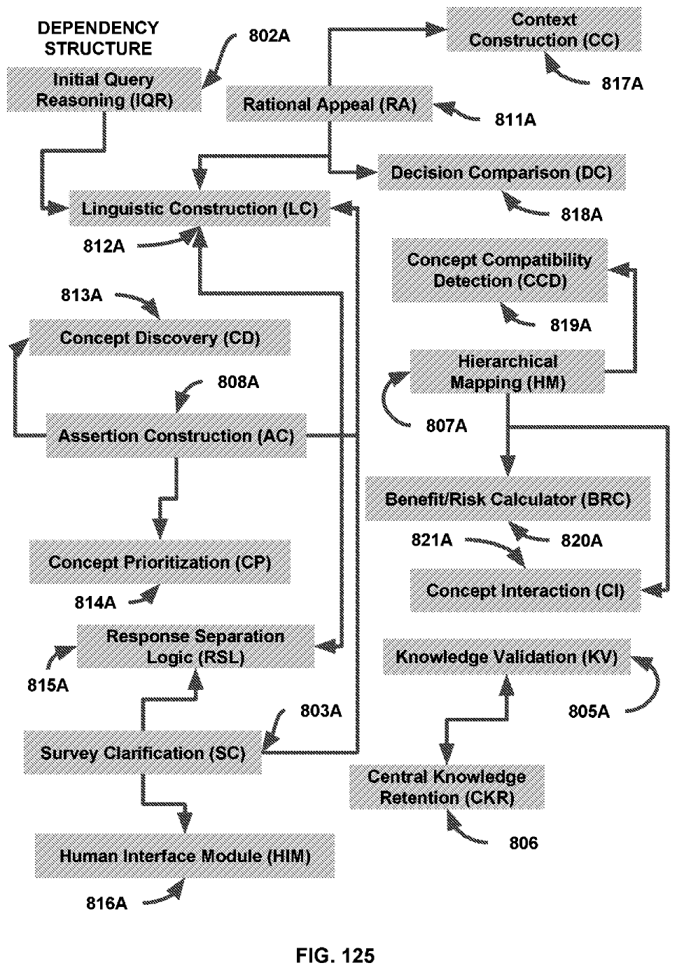

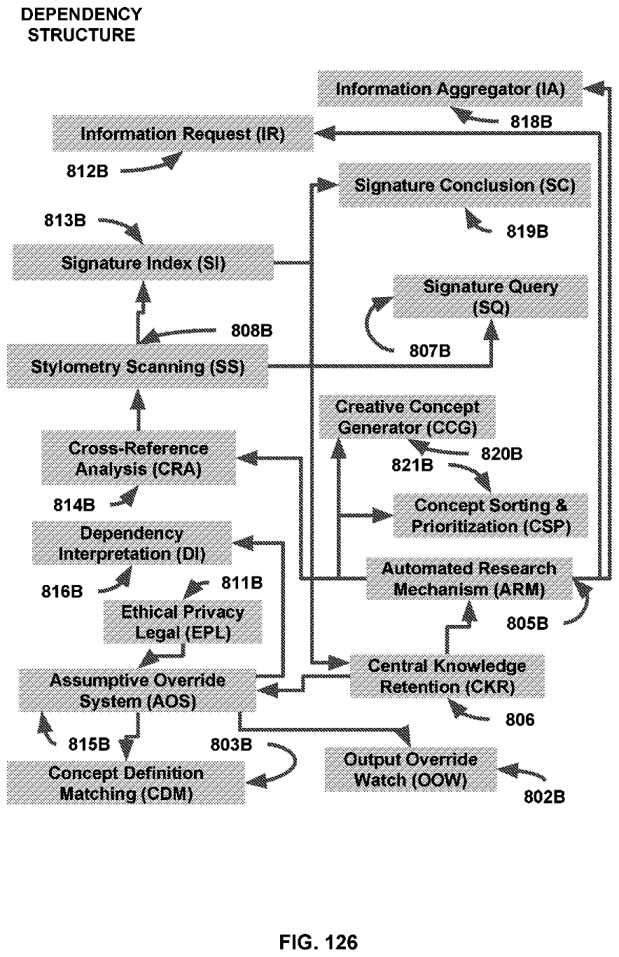

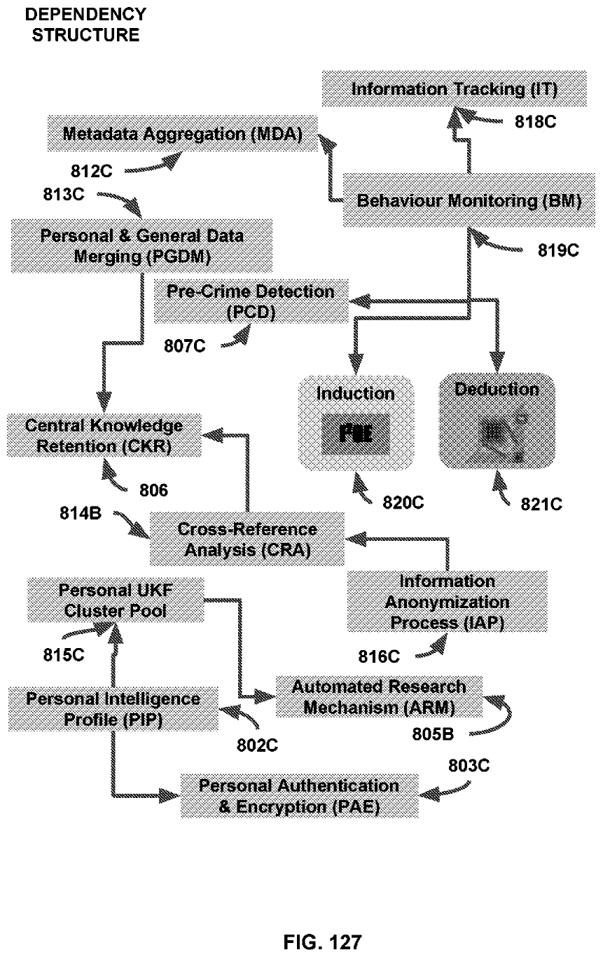

FIGS. 125-128 show the Dependency Structure of LOM, which indicates how modules inter-depend on each other. Linguistic Construction (LC) 812A interprets raw question/assertion input from the Human Subject 800 and parallel modules to produce a logical separation of linguistic syntax that can be understood by the LOM system as a whole. Concept Discovery (CD) 813A receives points of interest within the Clarified Question/Assertion 804 and derives associated concepts by leveraging CKR 806. Concept Prioritization (CP) 814A receives relevant concepts and orders them in logical tiers that represent specificity and generality. The top tier is assigned the most general concepts, whilst the lower tiers are allocated increasingly specific concepts. Response Separation Logic (RSL) 815A leverages LC 812A to understand the Human Response and associate a relevant and valid response with the initial clarification request, hence accomplishing the objective of SC 803A. LC 812A is then re-leveraged during the output phase to amend the original Question/Assertion 801 to include the supplemental information received by SC 803. Human Interface Module (HIM) 816A provides clear and logically separated prompts to the Human Subject 800 to address the gaps of knowledge specified by Initial Query Reasoning (IQR) 802A. Context Construction (CC) 817A uses metadata from Assertion Construction (AC) 808A and potential evidence from the Human subject 800 to give raw facts to CTMP for critical thinking. Decision Comparison (DC) 818A determines the overlap between the pre-criticized and post-criticized decisions. Concept Compatibility Detection (CCD) 819A compares conceptual derivatives from the original Question/Assertion 801 to ascertain the logical compatibility result. Such concepts can represent circumstances, states of being, liabilities etc. Benefit/Risk Calculator (BRC) 820A receives the compatibility results from CCD 819A and weighs the benefits and risks to form a uniform decision that encompasses the gradients of variables implicit in the concept makeup. Concept Interaction (CI) 821A assigns attributes that pertain to AC 808A concepts to parts of the information collected from the Human Subject 800 via Survey Clarification (SC) 803A.

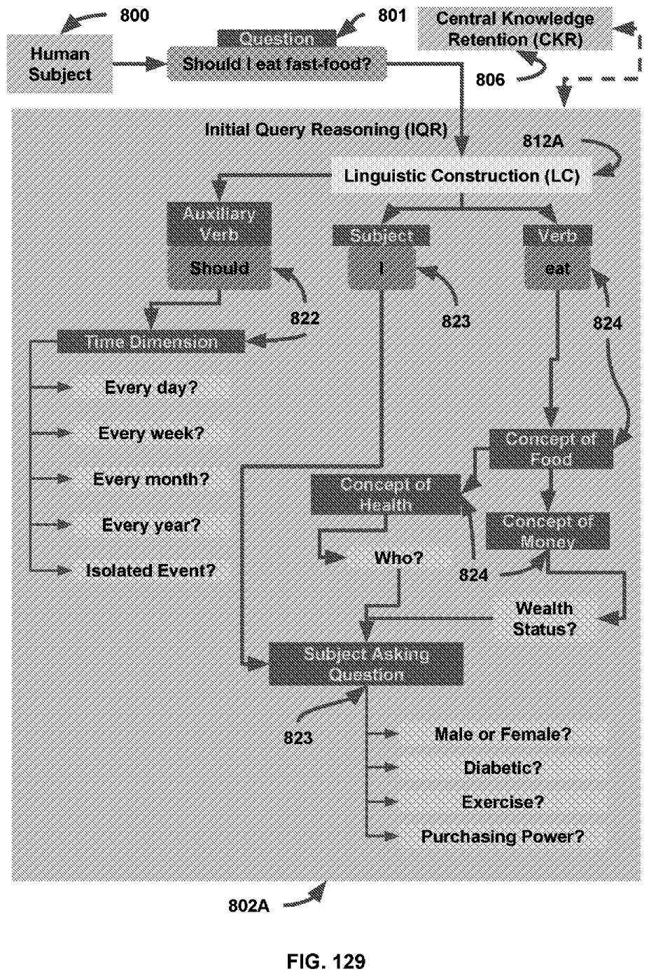

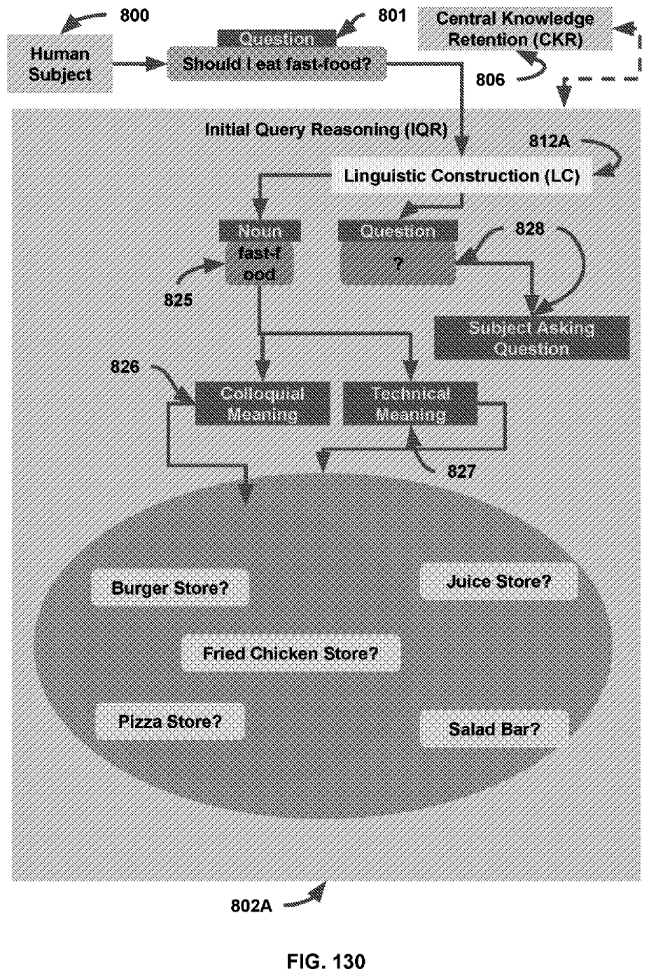

FIGS. 129 and 130 shows the inner logic of Initial Query Reasoning (IQR) 802A. Linguistic Construction (LC) 812A, acting as a subset of IQR 802, receives the original Question/Assertion 801 from the Human Subject 800. 801 is linguistically separated so that IQR 802A processes each individual word/phrase at a time. The Auxiliary Verb ‘Should’ 822 evokes a lack of clarity concerning the Time Dimension 822. Hence counter questions are formed to reach clarity such as ‘Every day?’, ‘Every week?’ etc. The Subject ‘I’ 823 evokes a lack of clarity concerning who is the subject, hence follow up questions are formed to be presented to the Human Subject 800. The Verb ‘eat’ 824 is not necessarily unclear yet is able to supplement the other points of analysis that lack clarity. IQR 802 connects the concept of food with concepts of health and money at Stages 824 by leveraging the CKR 806 DB. This informs the query ‘Subject Asking Question’ 823 so that more appropriate and relevant follow up questions are asked such as ‘Male or Female?’, ‘Diabetic?’, ‘Exercise?’, ‘Purchasing Power?’. The Noun ‘fast-food’ 825 evokes a lack of clarity in terms of how the word should be interpreted. It can either be interpreted in it's rawest form of ‘food that is served very fast’ at Technical Meaning 827, or it's more colloquial understanding 826 of ‘fried-salty-like foods that are cheap and are made very quickly at the place of ordering’. A salad bar is technically a fast means of getting food as it is pre-made and instantly available. However this technical definition does comply with the more commonly understood colloquial understanding of ‘fast-food’. By referencing CKR 806, IQR 802 considers the potential options that are possible considering the ambiguity of the term ‘fast-food’. Such ambiguous options such as ‘Burger Store?’ and ‘Salad Bar?’ can be forwarded to the Human Subject 800 via the Human Interface Module (HIM) 816. However, there may be sufficient information at CKR 806 to understand that the general context of the Question 801 indicates a reference to the Colloquial Meaning 826. CKR 806 is able to represent such a general context after gradually learning that there is a level of controversy involved with fast-food and health. Hence there is a high likelihood that Question 801 is referring to that controversy, hence HIM 816 does not need to be invoked to further clarify with Human Subject 800. Therefore IQR 802 seeks to decipher obvious and subtle nuances in definition meanings. Question 828 indicates to LOM as a whole that the Human Subject 800 is asking a question rather than asserting a statement.

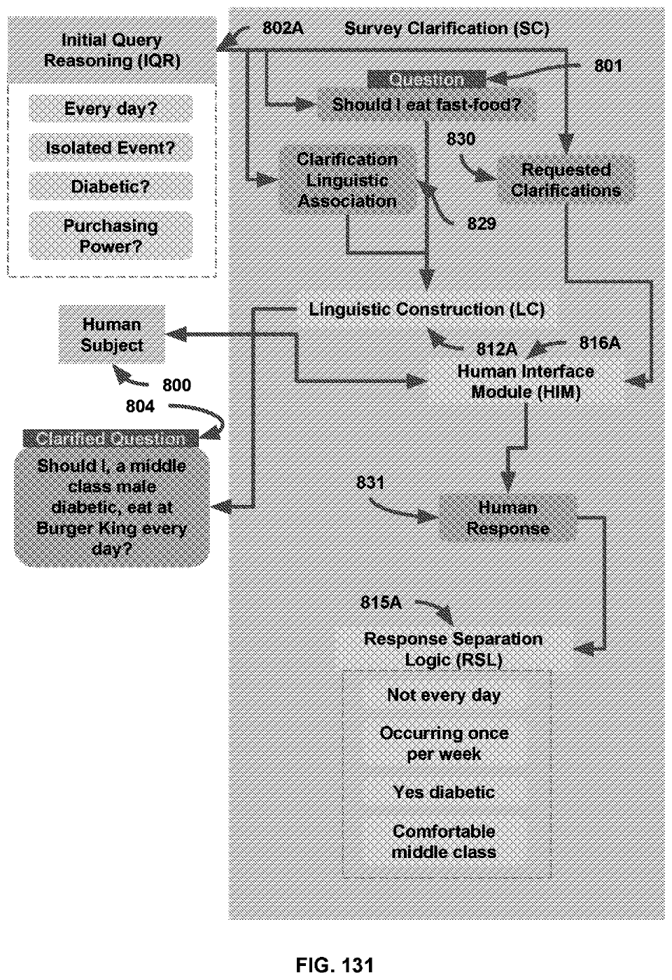

FIG. 131 shows Survey Clarification (SC) 803, which receives input from IQR 802. Such input contains series of Requested Clarifications 830 that must be answered by Human Subject 800 for an objective answer to the original Question/Assertion 801 to be reached. Therefore Requested Clarifications 830 is forwarded to the Human Interface Module (HIM) 816B. Any provided response to such clarifications are forwarded to Response Separation Logic (RSL) 815A which thereafter correlates the responses with the clarification requests. In parallel to the Requested Clarifications 830 being processed, Clarification Linguistic Association 829 is provided to Linguistic Construction (LC) 812A. Such Association 829 contains the internal relationship between Requested Clarifications 830 and the language structure. This in turn enables the RSL 815A to amend the original Question/Assertion 801 so that LC 812A can output the Clarified Question 804, which has incorporated the information learnt via HIM 816.

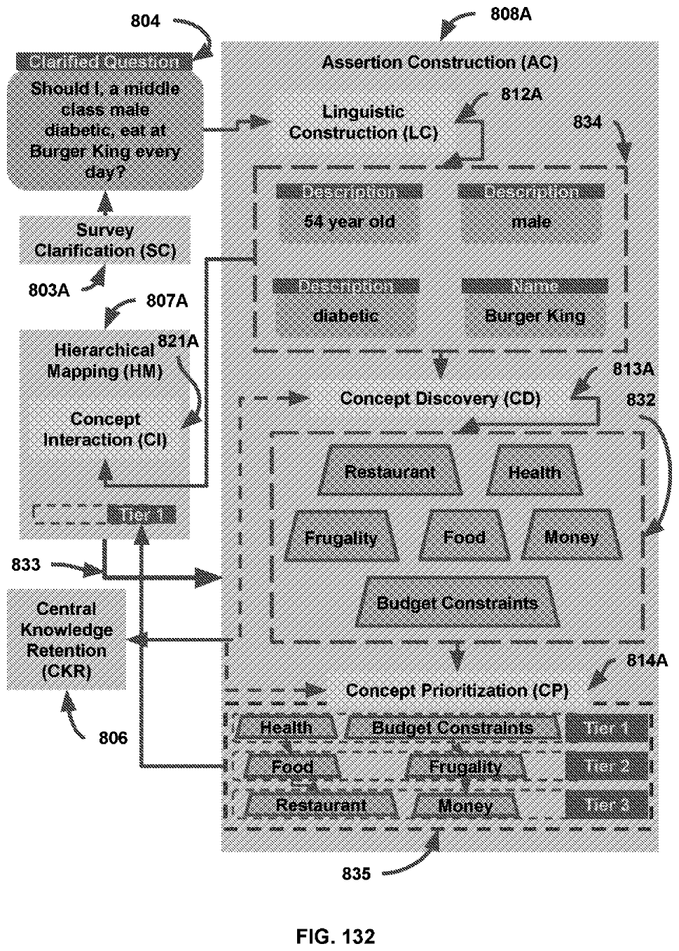

FIG. 132 shows Assertion Construction (AC) 808, which received the Clarified Question/Assertion 804 produced by Survey Clarification (SC) 803. LC 812A then breaks the question down into Points of Interest 834 (key concepts) which are passed onto Concept Discovery (CD) 813. CD then derives associates concepts 832 by leveraging CKR 806. Concept Prioritization (CP) 814A is then able to order concepts 832 into logical tiers that represent specificity and generality. The top tier is assigned the most general concepts, whilst the lower tiers are allocated increasingly specific concepts. Such ordering was facilitated with the data provided by CKR 806. The top tier is transferred to Hierarchical Mapping (HM) 807 as modular input. In a parallel transfer of information HM 807 receives the Points of Interest 834, which are processed by its dependency module Concept Interaction (CI) 821. CI assigns attributes to such Points of Interest 834 by accessing the indexed information available at CKR 806. Upon HM 807 completing its internal process, its final output is returned to AC 808 after the derived concepts have been tested for compatibility and the benefits/risks of a stance are weighed and returned. This is known as the Modular Output Feedback Loop 833 since AC 808 and HM 807 have reached full circle and will keep on sending to each other modular output until the analysis has fully saturated the concept complexity and until CKR 806 becomes a bottleneck due to limitations of knowledge (whichever comes first).

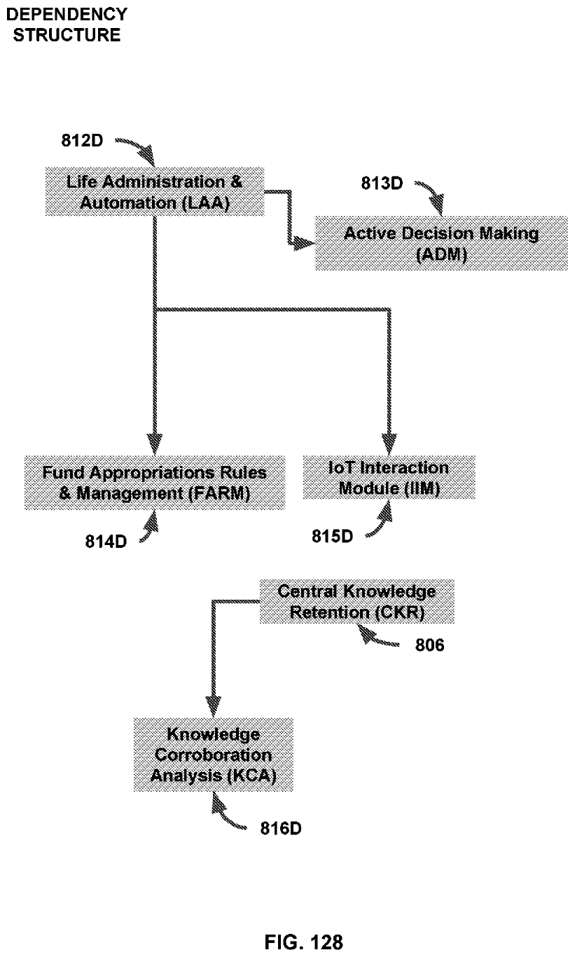

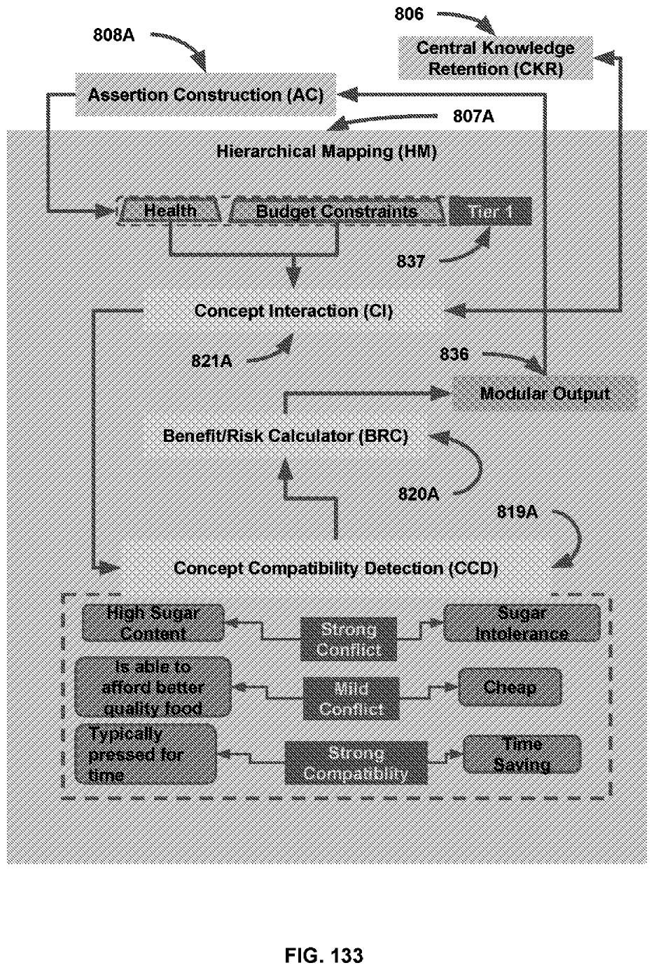

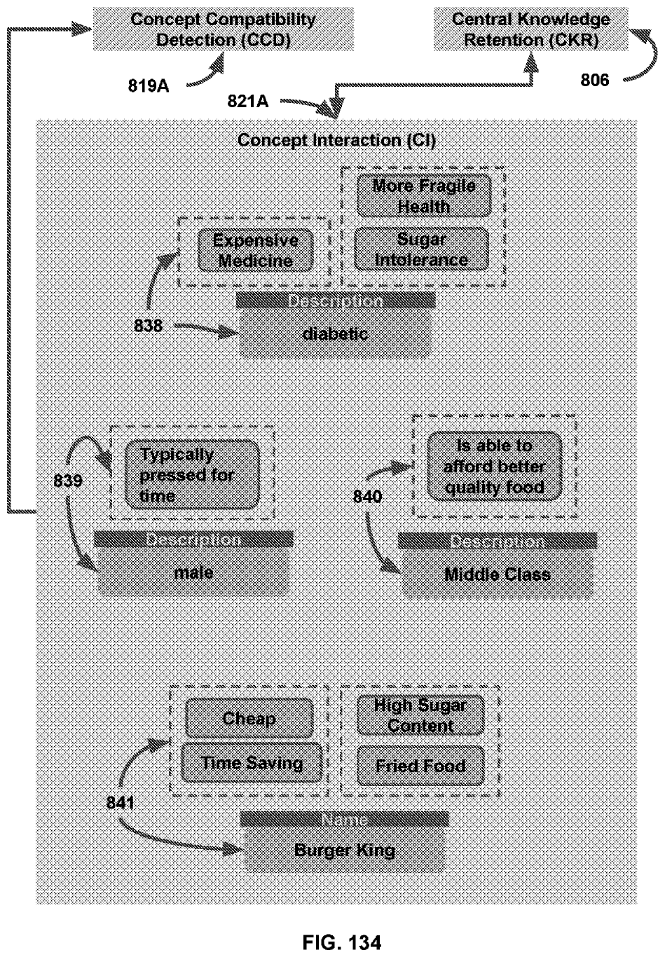

FIGS. 133 and 134 show the inner details of how Hierarchical Mapping (HM) 807 works. AC 808 provides two types input to HM 807 in parallel. One is known as Conceptual Points of Interest 834, and the other is the top tier of prioritized concepts 837 (the most general). Concept Interaction (CI) 821 uses both inputs to associate contextualized conclusions with Points of Interest 834, as seen in FIG. 128. CI 821 then provides input to Concept Compatibility Detection (CCD) 819 which discerns the compatibility/conflict level between two concepts. This grants HM 807 the general understanding of agreement versus disagreement between the assertions and/or propositions of the Human Subject 800 and the high-confidence knowledge indexed in Central Knowledge Retention (CKR) 806. Such compatibility/conflict data is forwarded to Benefit/Risk Calculator (BRC) 820, a module that translates these compatibilities and conflicts into benefits and risks concerning taking a holistic uniform stance on the issue. For example, three main stances will emerge as per the use case (according to criteria set by Human Subject 800): fast-food is overall not recommended, fast-food is permissible yet not emphasised, or fast-food is overall recommended. Such stances, along with their risk/benefit factors, are forwarded to AC 808 as Modular Output 836. This is one of several points within LOM that the flow of information has come full circle, as AC 808 will attempt to facilitate the expansion of the assertions put forward by HM 807. The system containing loops of information flow indicates gradients of intelligence being gradually supplemented as the subjective nature of the question/assertion a gradually built objective response. An analogy is how a honey bee will seek the nectar of a flower, inadvertently collecting it's pollen which spreads to other flowers. This fertilization of flowers produce yet more flowers which attracts yet more honey bees in the long run. This is analogous to the interconnected information ecosystem that occurs within LOM to gradually ‘pollinate’ assertions and mature concepts until the system achieves a strong confidence on a stance of a topic. The inner workings of Concept Interaction (CI), as a subset of HM 807, are displayed on FIG. 128. CI 821 receives Points of Interest 834 and interprets each one according to the top tier of prioritized concepts 837. Two of the prioritized concepts of the top tier in this example are ‘Health’ and ‘Budget Constraints’ 837. Hence when CI attempts to interpret the Points of Interest 834 it will be through the lens of these topics. Point of Interest ‘diabetic’ 838 leads to the assertion of ‘Expensive Medicine’ concerning ‘Budget Constraints’ 837 and ‘More fragile Health’/‘Sugar Intolerance’ concerning ‘Health’ 837. Point of interest ‘male’ 839 asserts ‘typically pressed for time’ despite with a low confidence, as the system is discovering that more specificity is needed such as for ‘workaholics’ etc. The issue of time is inversely tied to ‘budget constraints’ as the system has noticed the correlation between time and money. Point of Interest ‘Middle Class’ 840 asserts ‘Is able to afford better quality food’ concerning ‘Budget Constraints’ 837. Point of Interest ‘Burger King’ 841 asserts ‘Cheap’ and ‘Saving’ concerning ‘Budget Constraints’ 837, and ‘High Sugar Content’ plus ‘Fried Food’ concerning ‘Health’ 837. Such assertions are made via referencing established and confident knowledge stored in CKR 806.

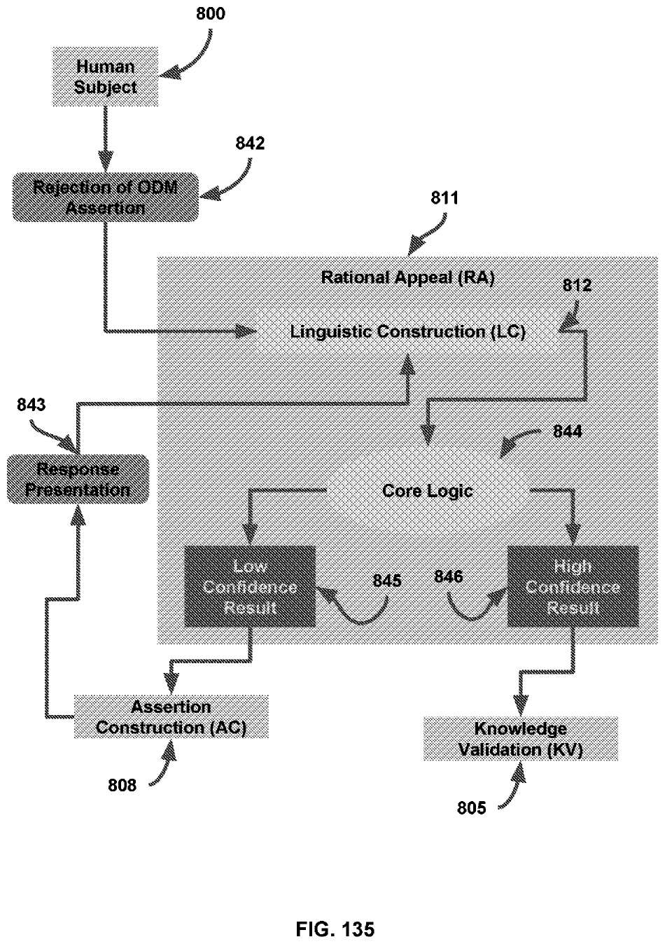

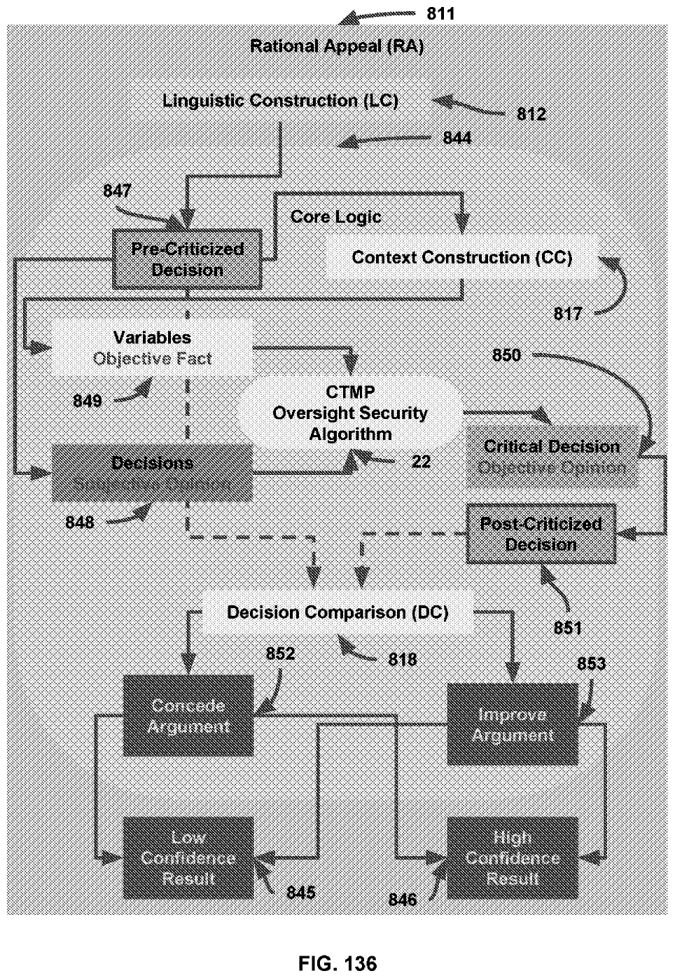

FIGS. 135 and 136 show the inner details of Rational Appeal (RA) 811, which criticized assertions whether it be self-criticism or criticism of human responses. LC 812A acts as a core sub-component of RA 811, and receives input from two potential sources. One source is if the Human Subject 800 rejects an opinion asserted by LOM at Stage 842. The other source is Response Presentation 843, which will digitally transmit an assertion constructed by AC 808 for LOM internal self-criticism. After LC 812A has converted the linguistic text into a syntax understandable to the rest of the system, it is processed by RA's Core Logic 844. Upon such Core Logic returning a Result of High Confidence 846, the result is passed onto Knowledge Validation (KV) 805 for proper assimilation into CKR 806. Upon the Core Logic returning a Result of Low Confidence 845, the result is passed onto AC 808 to continue the cycle of self-criticism (another element of LOM that has reached full circle). Core Logic 844 received input from LC 812A in the form of a Pre-Criticized Decision 847 without linguistic elements (using instead a syntax which is optimal for Artificial Intelligence usage). Such a Decision 847 is forwarded directly to CTMP 22 as the ‘Subjective Opinion’ 848 sector of it's input. Decision 847 is also forwarded to Context Construction (CC) 817 which uses metadata from AC 808 and potential evidence from the Human Subject 800 to give raw facts (i.e. system logs) to CTMP 22 as input ‘Objective Fact’. With CTMP 22 having received it's two mandatory inputs, such information is processed to output it's best attempt of reaching ‘Objective Opinion’ 850. Such opinion 850 is treated internally within RA 811 as the Post-Criticized Decision 851. Both Pre-Criticized 847 and Post-Criticized 851 decisions are forwarded to Decision Comparison (DC) 818, which determines the scope of overlap between both decisions 847 and 851. The appeal argument is then either conceded as true 852 or the counter-point is improved 853 to explain why the appeal is invalid. Such an assessment is performed without consideration nor bias of if the appeal originated from Artificial Intelligence or Humans. Indifferent to a Concede 852 or Improve 852 scenario, a result of high confidence 846 is passed onto KV 805 and a result of low confidence 845 is passed onto AC 808 for further analysis.

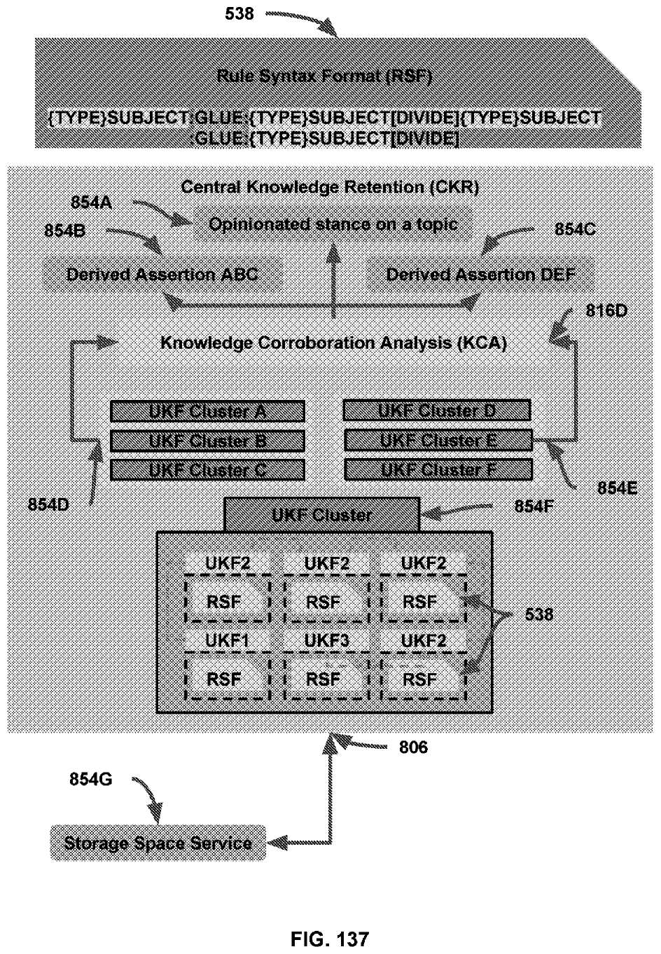

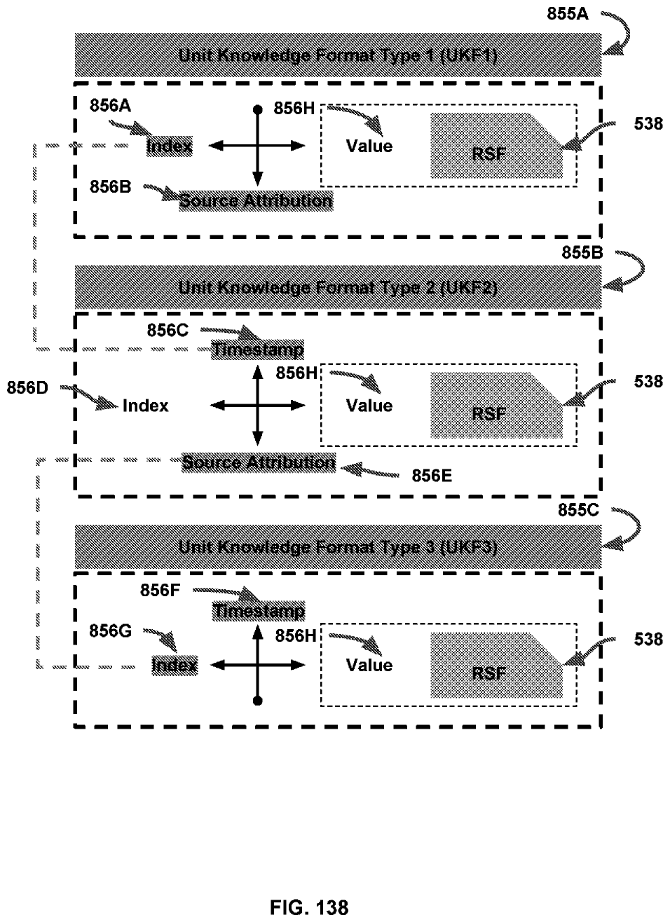

FIGS. 137-138 show the inner details of Central Knowledge Retention (CKR), which is where LOM's data-based intelligence is stored and merged. Units of information are stored in the Unit Knowledge Format (UKF) of which there are three types: UKF1 855A, UKF2 8558, UKF3 855C. UKF2 8558 is the main format where the targeted information is stored in Rule Syntax Format (RSF) 538, highlighted as Value 865H. Index 856D is a digital storage and processing compatible/complaint reference point which allows for resource efficient references of large collections of data. This main block of information references a Timestamp 856C, which is a reference to a separate unit of knowledge via Index 856A known as UKF1 855A. Such a unit does not hold an equivalent Timestamp 856C section as UKF2 8558 did, but instead stores a multitude of information about timestamps in the Value 856H sector in RSF 538 format. Rule Syntax Format (RSF) 538 is a set of syntactical standards for keeping track of references rules. Multiple units of rules within the RSF 538 can be leveraged to describe a single object or action. RSF is heavily used directly within CTMP. UKF1 855A contains a Source Attribution 8568 sector, which is a reference to the Index 856G of a UKF3 855C instance. Such a unit UKF3 855C is the inverse of UKF1 855A as it has a Timestamp section but not a Source Attribution section. This is because UKF3 855C stored Source Attribution 856E and 8568 content in it's Value 856H sector in RSF 538. Source attribution is a collection of complex data that keeps track of claimed sources of information. Such sources are given statuses of trustworthiness and authenticity due to corroborating and negating factors as processed in KCA 816D. Therefore a UKF Cluster 854F is composed of a chain of UKF variants linked to define jurisdictionally separate information (time and source are dynamically defined). In summary: UKF2 8558 contains the main targeted information. UKF1 855A contains Timestamp information and hence omits the timestamp field itself to avoid an infinite regress. UKF3 855C contains Source Attribution information and hence omits the source field itself to avoid an infinite regress. Every UKF2 8558 must be accompanied by at least one UKF1 855A and one UKF3 855C, or else the cluster (sequence) is considered incomplete and the information therein cannot be processed yet by LOM Systemwide General Logic 859. In between the central UKF2 8558 (with the central targeted information) and it's corresponding UKF1 855A and UKF3 855C units there can be UKF2 8558 units that act as a linked bridge. A series of UKF Clusters 854D will be processed by KCA 816D to form Derived Assertion 854B. Likewise, a series of UKF Clusters 854E will be processed by KCA 816D to form Derived Assertion 854C. Knowledge Corroboration Analysis (KCA) 816D is where UKF Clustered information is compared for corroborating evidence concerning an opinionated stance. This algorithm takes into consideration the reliability of the attributed source, when such a claim was made, negating evidence etc. Therefore after processing of KCA 816D is complete, CKR 806 can output a concluded Opinionated stance on a topic 854A. CKR 806 never deletes information since even information determined to be false can be useful for future distinction making between truth and falsehood. Hence CKR 806 runs off of an advanced Storage Space Service 854G that can handle and scale with the indefinitely growing dataset of CKR 806.

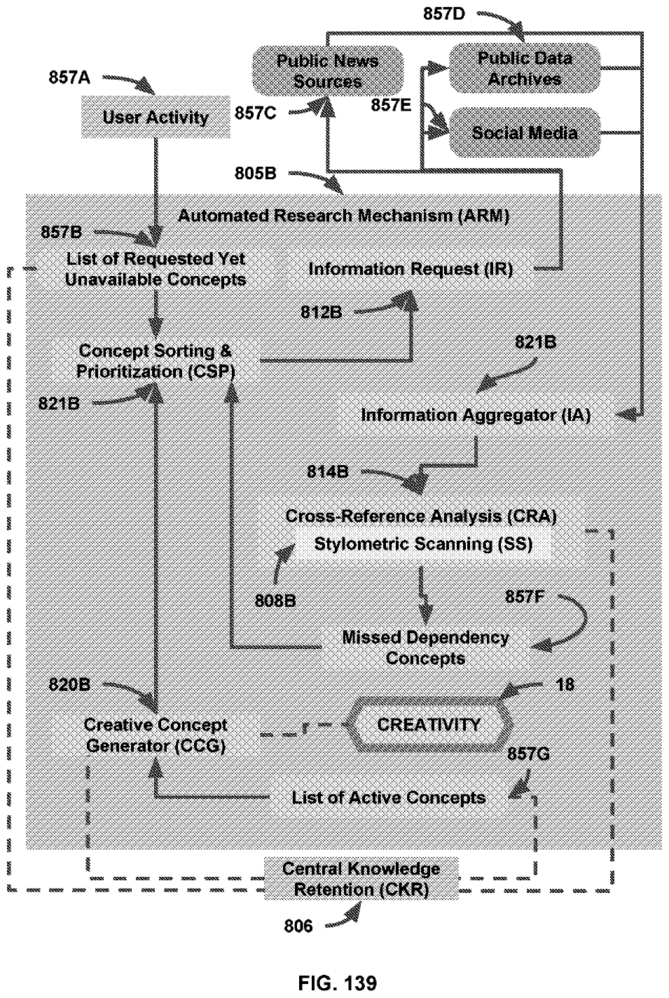

FIG. 139 shows the Automated Research Mechanism (ARM) 805B, which attempts to constantly supply CKR 806 with new knowledge to enhance LOM's general estimation and decision making capabilities. As indicated by User Activity 857A; as users interact with LOM (via any available frontend) concepts are either directly or indirectly brought as relevant to answering/responding to a question/assertion. User Activity 857A is expected to eventually yield concepts that CKR 806 has low or no information regarding, as indicated by List of Requested Yet Unavailable Concepts 857B. With Concept Sorting & Prioritization (CSP) 821B; Concept definitions are received from three independent sources and are aggregated to prioritize the resources (bandwidth etc.) of Information Request (IR) 812B. Such a module IR 812B accesses relevant sources to obtain specifically defined information. Such information is defined according to concept type. Such source are indicated as Public News Source 857C (Public news articles i.e. Reuters, New York Times, Washington Post etc.), Public Data Archives 857D (Information aggregation collections i.e. Wikipedia, Quora etc.), and Social Media 857E (i.e. Facebook, Twitter feeds, etc.). The data provided by such information sources are received and parsed at Information Aggregator (IA) 821B according to what concept definition requested them. Relevant meta-data such as time of retrieval, source of retrieval are kept. Thereafter the information is sent to Cross-Reference Analysis (CRA) 814B where the information received is compared to and constructed considering pre-existing knowledge from CKR 806. This allows the new incoming information to be evaluated and validated according to what CKR 806 currently knows and doesn't know. Stylometric Scanning (SS) 808B is a supplemental module that allows CRA 814B to consider stylometric signatures will assimilating the new information with pre-existing knowledge from CKR 806. Missed Dependency Concepts 857F are concepts which are logically required to be understood as groundwork for comprehending an initial target concept. (i.e. to understand how trucks work, one must first research about and understand how diesel engines work). Such missing concepts are transferred to CSP 821B for processing. List of Active Concepts 857G are popular topics which are ranked as the most active within CKR 806. Such Concepts 857G are transferred to Creative Concept Generator (CCG) 820B and are then creatively matched (via Creativity Module 18) to produce new potential concepts. This mechanism depends on the possibility that one of these mixtures will yield new ranges of information from Sources 857C, 857D, 857E connected to IR 812B.

### Example of Stylometry Usage:

The New Foreign Data 858A is marked as having come from a known CNN reporter. However, a very strong stylometric match with the signature of a military think tank is found. Therefore the content is primarily attributed within CKR 806 to the military think tank, and noted as having ‘claimed’ to be from CNN. This enables further pattern matching and conspiracy detection for later executions of the LOM logic (for example, distrusting future claims of content being from CNN). Assertion corroboration, conflicts and bias evaluations are thereafter assessed as if the content is from the think tank and not CNN.

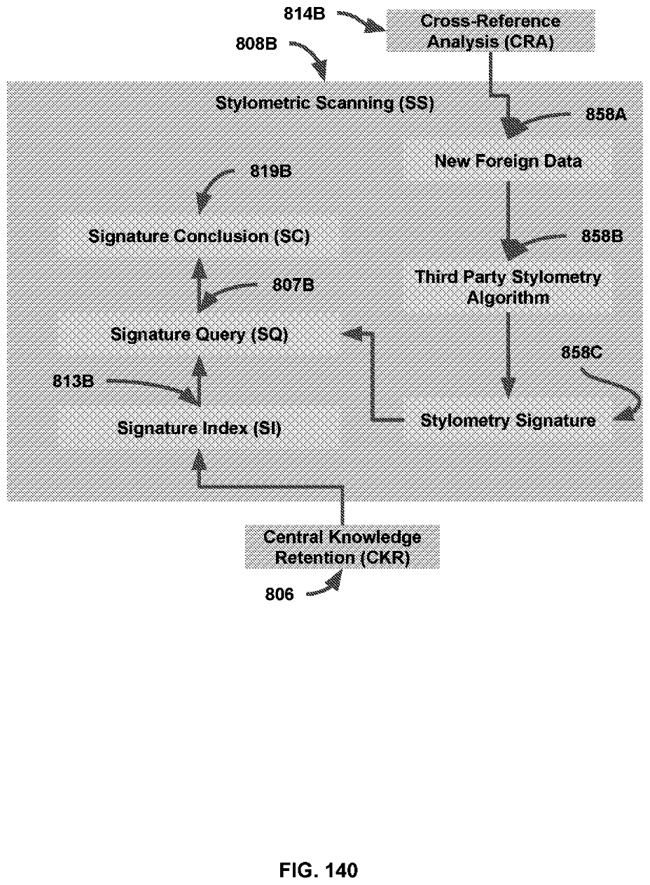

FIG. 140 shows Stylometric Scanning (SS) 808 which analyzes the Stylometric Signature 858C of new foreign content (which the system has yet to be exposed to). Stylometry is the statistical analysis of variations in literary style between one writer or genre and another. This aides CKR 806 in tracking source expectations of data/assertions, which further helps LOM detect corroborative assertions. With Signature Conclusion (SC) 819B content source attribution of the New Foreign Data 858A is influenced by any significant matches in Stylometry Signature 858C. The stronger the stylometric match, the stronger source attribution according stylometry. With Signature Query (SQ) 807B the Stylometry Signature 858C is matched against all known signatures from SI 813B. Any matches in any significant gradients of magnitude are recorded. Signature Index (SI) 813B represents a list of all known Stylometric Signatures 858C as retrieved from CKR 806. As represented by Third Party Stylometry Algorithm 858B, LOM depends on any duly chosen advanced and effective algorithm stylometry algorithm.

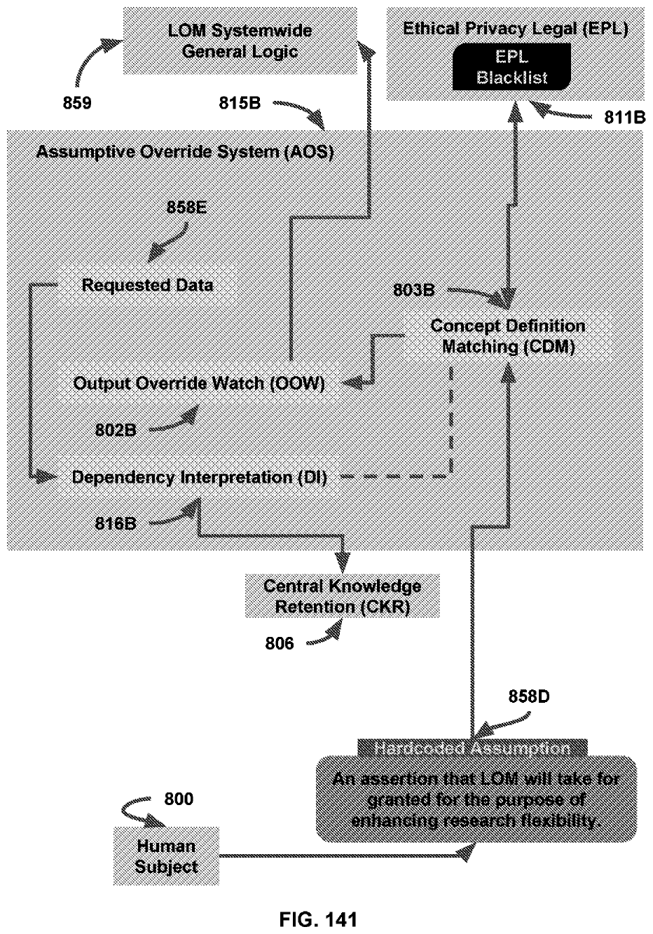

FIG. 141 shows Assumptive Override System (AOS) 815B, which receives a proposition in the form of an assertion or question and provides output of the concepts related to such a proposition. Concept Definition Matching (CDM) 803B is where any Hardcoded Assumptions 858D provided by the Human Subject 800 are queried against the Dependency Interpretation (DI) 816B module. All such concepts are checked by Ethical Privacy Legal (EPL) 811B for violation concerns. In the Dependency Interpretation (DI) 816B module all the knowledge based dependencies that fulfill the given response of the requested data are accessed. This way the full ‘tree’ of information which builds to a highly objective opinion is retrieved. Requested Data 858E is data that LOM Systemwide General Logical 859 has requested, whether that was a specific or conditional query. A specific query seeks an exactly marked set of information. A conditional query requests all such information that matches certain conditions.

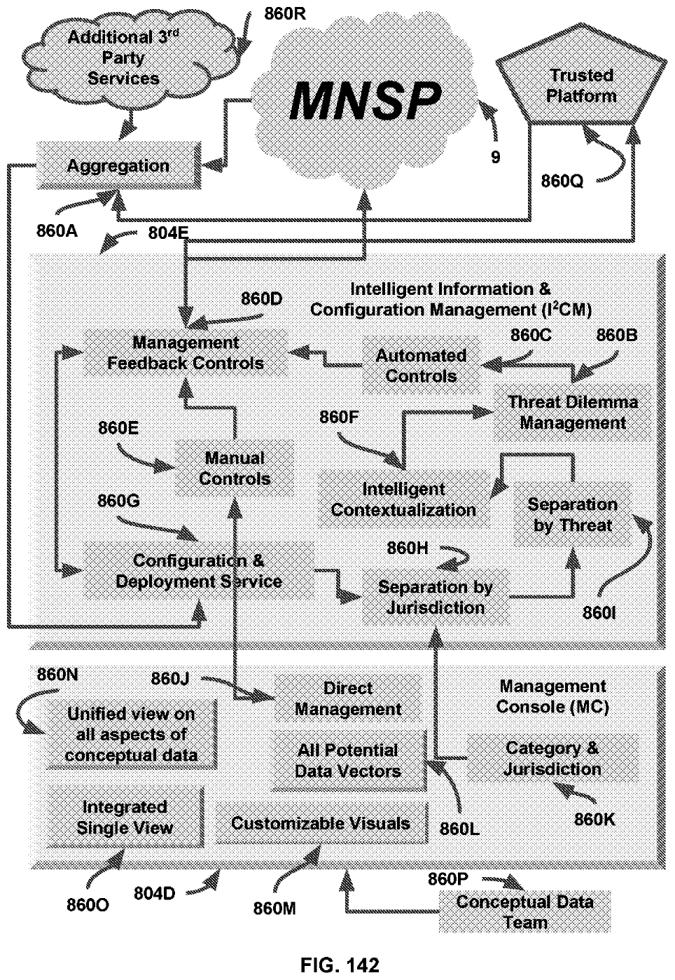

FIG. 142 shows Intelligent Information & Configuration Management (I²CM) 804E and Management Console 804D. Aggregation 860A uses generic level criteria to filter out unimportant and redundant information, whilst merging and tagging streams of information from multiple platforms. Threat Dilemma Management 860B is where the conceptual data danger is perceived from a bird's eye view. Such a threat is passed onto the management console for a graphical representation. Since calculated measurements pertaining to threat mechanics are finally merged from multiple platforms; a more informed threat management decision can be automatically performed. Automated Controls 860C represents algorithm access to controlling management related controls of MNSP 9, Trusted Platform 860Q, Third Party Services 860R. Management Feedback Controls 860D offers high level controls of all MNSP 9 Cloud, Trusted Platform (TP) 860Q, additional 3^{rd} Party Services 860R based services which can be used to facilitate policy making, forensics, threat investigations etc. Such Management Controls 860D are eventually manifested on the Management Console (MC) 804D, with appropriate customizable visuals and presentation efficiency. This allows for efficient control and manipulation of entire systems (MNSO, TP, 3PI) direct from a single interface that can zoom into details as needed. Manual Controls 860E is for human access to control management related controls of MNSP 9, Trusted Platform 860Q, and Third Party Services 860R. At the Intelligent Contexualizaitom 860F stage the remaining data now looks like a cluster of islands, each island being a conceptual data danger. Correlations are made inter-platform to mature the concept analysis. Historical data is accessed (from I²GE 21 as opposed to LIZARD) to understand threat patterns, and CTMP 22 is used for critical thinking analysis. Configuration & Deployment Service 860G is the interface for deploying new enterprise assets (computers, laptops, mobile phones) with the correct conceptual data configuration and connectivity setup. After a device is added and setup, they can be tweaked via the Management Console (MC) 804D with the Management Feedback Controls 860D as a middleman. This service also manages the deployment of new customer/client user accounts. Such a deployment may include the association of hardware with user accounts, customization of interface, listing of customer/client variables (i.e. business type, product type etc.). With Separation by Jurisdiction 860H the tagged pool of information is separated exclusively according to the relevant jurisdiction of the MC 804D User. With Separation by Threat 8601 the information is organized according to individual threats (i.e. conceptual data dangers). Every type of data is either correlated to a threat, which adds verbosity, or is removed. Direct Management 860J is an interface for the MC 804D User to connect to Management Feedback Controls 860D via Manual Controls 860E. With Category & Jurisdiction 860H the MC 804D User uses their login credentials which define their jurisdiction and scope of information category access. All Potential Data Vectors 860L represents data in motion, data at rest and data in use. Customizable Visuals 860M is for various enterprise departments (accounting, finance, HR, IT, legal, Security/Inspector General, privacy/disclosure, union, etc.) and stakeholders (staff, managers, executives in each respective department) as well as 3rd party partners, law enforcement, etc. Unified view on all aspects of conceptual data 860N represents perimeter, enterprise, data center, cloud, removable media, mobile devices, etc. Integrated Single View 8600 is a single view of all the potential capabilities such as monitoring, logging, reporting, event correlation, alert processing, policy/rule set creation, corrective action, algorithm tuning, service provisioning (new customers/modifications), use of trusted platform as well as 3rd party services (including receiving reports and alerts/logs, etc from 3rd party services providers & vendors). The Conceptual Data Team 860P is a team of qualified professionals that monitor the activity and status of multiple systems across the board. Because intelligent processing of information and AI decisions are being made, costs can be lowered by hiring less people with fewer years of experience. The Team's primary purpose is for being a fallback layer in verifying that the system is maturing and progressing according to desired criteria whilst performing large scale points of analysis.

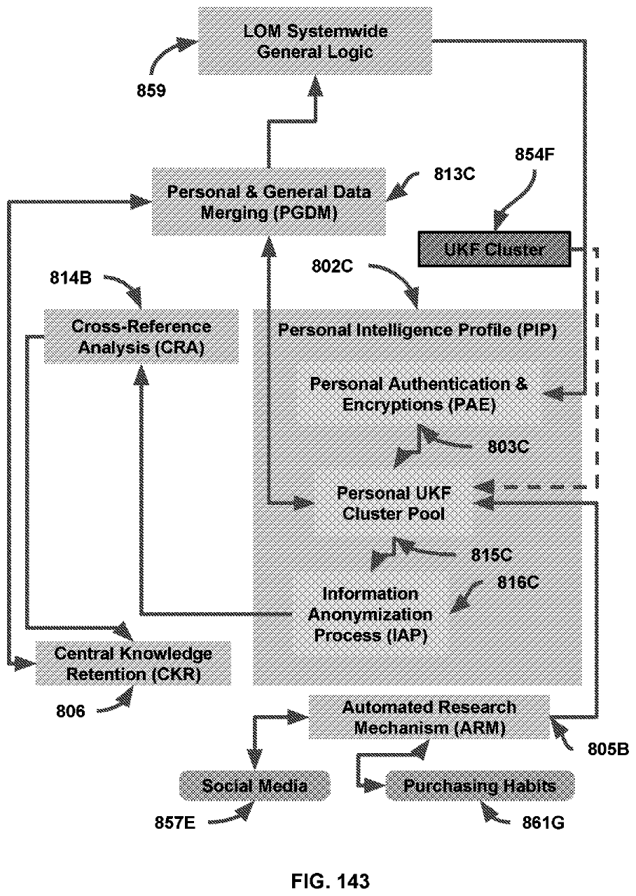

FIG. 143 shows Personal Intelligence Profile (PIP) 802C which is where an individual's personal information is stored via multiple potential end-points and front-ends. Their information is highly secure and isolated from CKR 806, yet is available for LOM Systemwide General Logic 859 to perform highly personalized decision making. By implementing Personal Authentication & Encryption (PAE) 803C the incoming data request must first authenticate itself to guarantee that personal information is accessed exclusively by the correct user. Personal information relating to Artificial Intelligence applications are encrypted and stored in the Personal UKF Cluster Pool 815C in UKF format. With Information Anonymization Process (IAP) 816C information is supplemented to CKR 806 after being stripped of any personally identifiable information. Even after such personal information is stripped from the data stream, IAP 816C attempts to prevent too much parallel data from being provided which could be reverse engineered (like forensic detective work) to find out the identity of the individual. With Cross-Reference Analysis (CRA) 814B information received is compared to and constructed considering pre-existing knowledge from CKR 806. This allows the new incoming information to be evaluated and validated according to what CKR 806 currently knows and doesn't know. With any data request information is always accessed from CKR 806. If there are personal criteria in the data request then PIP 802C is referenced via Personal & General Data Merging (PGDM) 813C and builds upon the main CKR 806 knowledge.

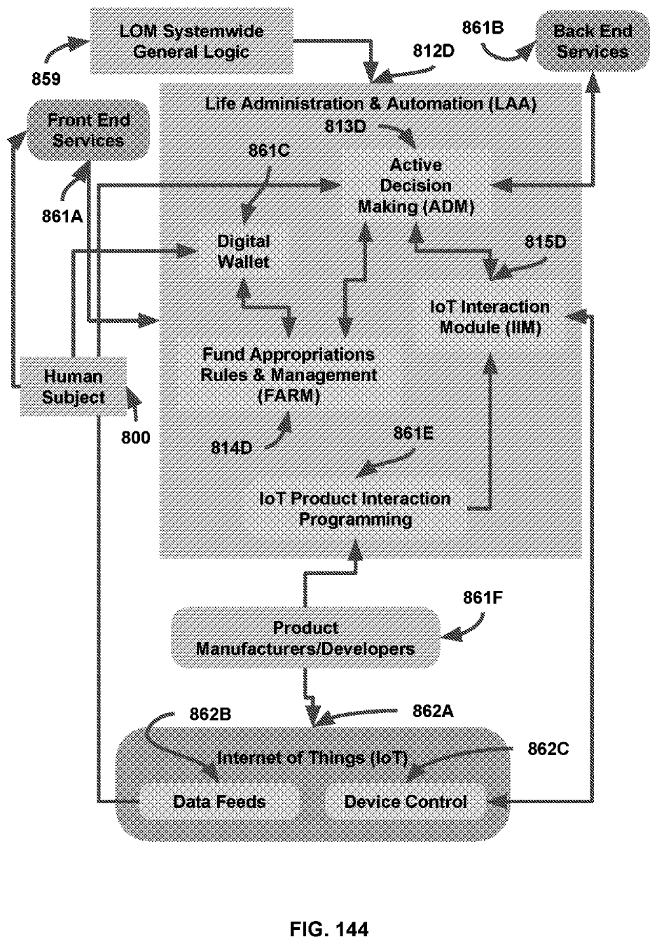

FIG. 144 shows Life Administration & Automation (LAA) 812D which connects various internet enabled devices and services on a cohesive platform that automates tasks for life routines and isolated incidents. Active Decision Making (ADM) 813D is the central logic of LAA 812D and considers the availability and functionality of Front End Services 861A, Back End Services 861B, IoT devices 862A, spending rules and amount available according to FARM 814D. With Fund Appropriations Rules & Management (FARM) 814D the human manually defines criteria, limits and scope to this module to inform ADM 813D for what it's jurisdiction of activity is. The Human Subject 800 manually deposits cryptocurrency funds (i.e. Bitcoin) into the Digital Wallet 861C, thereby implying an upper limit to the amount of money that LAA 812D can spend. The IoT Interaction Module (IIM) 815D maintains a database of what IoT devices 862A are available for the human. Authentication keys and mechanisms are stored here to enable secure control 862C of IoT devices 862A. Product Manufacturers/Developers 861F provide programmable API (Application Programming Interface) endpoints to LAA 812D as IoT Product Interaction Programming 861E. Such endpoints are specifically used by the IoT Interaction Module (IIM) 815D. Data Feeds 862B represents when IoT enabled devices 862A send information to LAA 812D so that intelligent and automated actions may be performed. Example: Thermostat reporting temperature, fridge reporting milk stock. Device Control 862C represents when IoT enabled devices 862A receive instructions from LAA 812D for actions to perform. Example: Turn on the air conditioning, open the gate for a package delivery etc. Categories of Front End Services 861A can include:
Artificially Intelligent Personal Assistants
Communication Applications and Protocols
Home Automation
Medical Interfaced
Delivery Tracking Services
   Back End Services 861B examples include:
Amazon Order Online
Uber/Transportation
Medical Prescriptions
   An overall use case example to illustrate the functionality of LAA 812D is as follows: The IoT enabled fridge detects that the milk is running low. LOM has made an analysis via emotional intelligence that the subject's mood tends to be more negative when they don't drink full fat milk. Having evaluated the risks and benefits of the subject's situation in life, LOM places an order for full fat milk from an online delivery service (i.e. Amazon). LOM is tracking the milk shipment via a tracking number, and opens the front gate of the house to allow it to be delivered within the house property. LOM closes the gate after the delivery person leaves, and is cautious security-wise in case the delivery person is a malicious actor. Thereafter a simple wheeled robot with some dexterity functionality picks up the milk and puts in the fridge so that it stays cold and doesn't go bad.

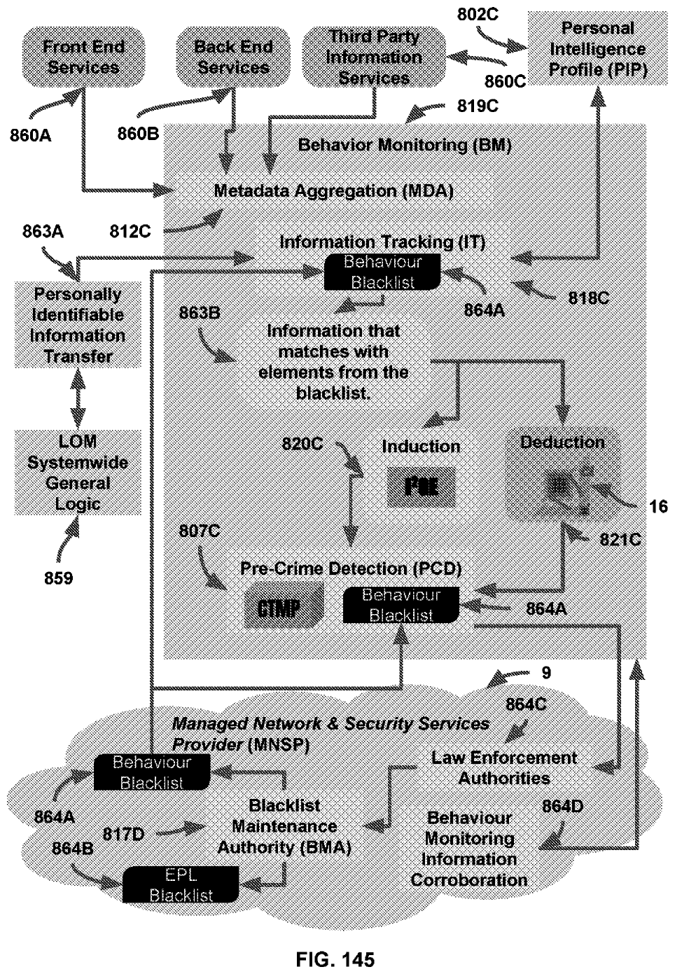

FIG. 145 shows Behavior Monitoring (BM) 819C which monitors personally identifiable data requests from users to check for unethical and/or illegal material. With Metadata Aggregation (MDA) 812C user related data is aggregated from external services so that the digital identity of the user can be established (i.e. IP address, MAC address etc.). Such information is transferred to Induction 820C/Deduction 821C, and eventually PCD 807C, where a sophisticated analysis is performed with corroborating factors from the MNSP 9. Example: A user interfacing with amazon.com shopping portal as a front end has his IP address forwarded to LOM's Behavior Monitoring (BM) 819C for security purposes. All information from the authenticated user that is destined for PIP 802C passes through Information Tracking (IT) 818C and is checked against the Behavior Blacklist 864A. Example: The user asks a question about the chemical composition of sulfur. Information that matches (partially or fully) with elements from the blacklist 863B is transferred from IT 818C to Induction 820C and Deduction 821C. At Pre-Crime Detection (PCD) 807C Deduction and Induction information is merged and analyzed for pre-crime conclusions. If a significant amount of corroboration is detected, the offending information and known identity of the user is forwarded to Law Enforcement Authorities. PCD 807C makes use of CTMP 22, which directly references the Behavior Blacklist 864A to verify the stances produced by Induction 820C and Deduction 821C. The Blacklist Maintenance Authority (BMA) 817D operates within the Cloud Service Framework of MNSP 9. BMA 817D issues and maintains a Behavior Blacklist 864A which defines dangerous concepts that require user monitoring to prevent crimes and catch criminals. BMA 864B also issues and maintains an EPL (Ethical Privacy Legal) Blacklist 864B which flags sensitive material so that it is never submitted as a query result by LOM. Such sensitive material might include leaked documents, private information (i.e. social security numbers, passport numbers etc.). BMA 864B interprets relevant and applicable laws and policy in relation to ethics, privacy and legal (i.e. Cybersecurity Policy, Acceptable Use Policy, HIPAA, PII, etc.). The blacklist is usually composed of trigger concepts which would cause a user to be considered suspicious if they are associated with such concepts too much. The blacklist may also target specific individuals and/or organizations like a wanted list. The future crimes prevention occurs within BM 819C, with corroborating factors verified with the MNSP 9. Law Enforcement Authorities 864C are able to connect via the MNSP 9 Cloud to BMA 817D to provide input on blacklisted concepts, and to receive input from BM's 819C PCD's 807C crime detection results. Behavior Monitoring Information Corroboration 864D enables MNSP 9 to contribute behavior monitoring intelligence to BM 819C for corroboration purposes. Ethical Privacy Legal (EPL) 811B receives a customized blacklist from MSNP and uses AOS 815B to block any assertions that contain unethical, privacy-sensitive, and/or illegal material.

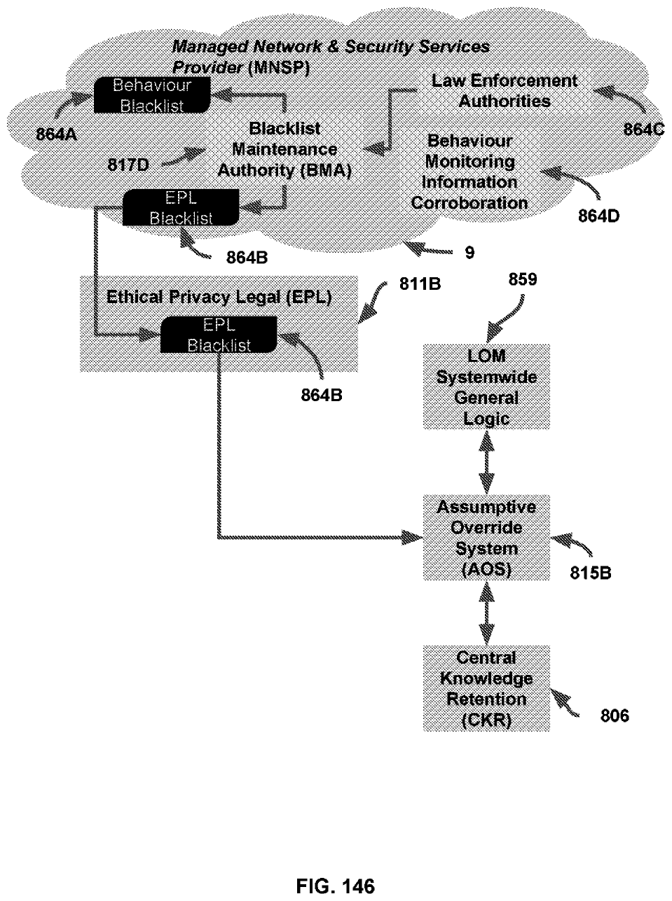

FIG. 146 shows Ethical Privacy Legal (EPL) 811B which receives a customized blacklist from MSNP and uses AOS 815B to block any assertions that contain unethical, privacy-sensitive, and/or illegal material. MNSP 9 is used to deal with traditional security threats like hacking attempts via Trojan Horses, Viruses etc. LOM's BM 819C and EPL 811B modules analyze context for conceptual data via Induction 820C and Deduction 821C in order to determine ethics, privacy and legal impacts.

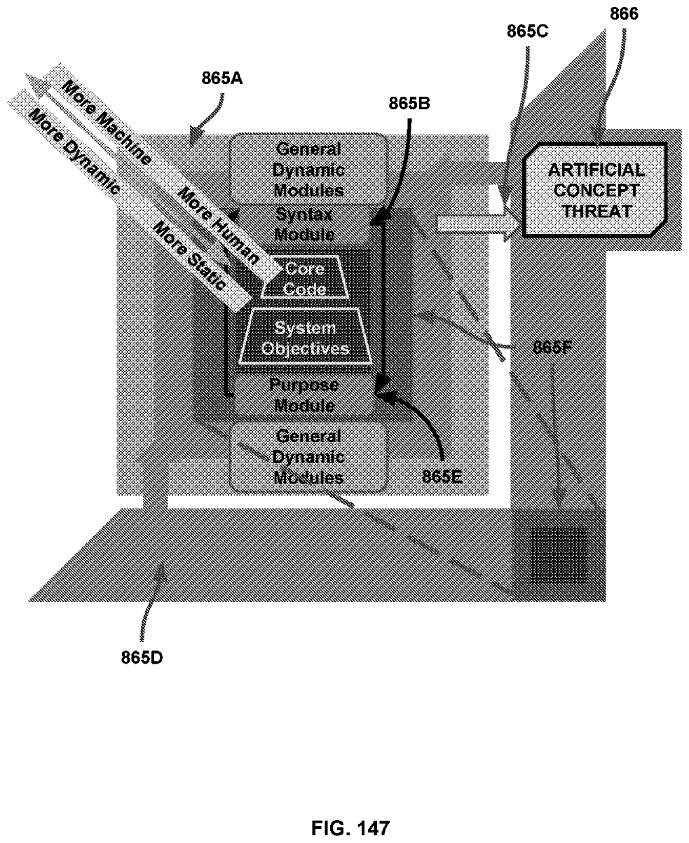

FIG. 147 shows an overview of the LIZARD algorithm. Dynamic Shell (DS) 865A is the layer of the LIZARD which is more prone to changing via iteration. Modules that require a high degree of complexity to achieve their purpose usually belong here; as they will have surpassed the complexity levels a team of programmers can handle. Syntax Module (SM) 865B is the framework for reading and writing computer code. For writing; receives a complex formatted purpose from PM, then writes code in arbitrary code syntax, then a helper function can translate that arbitrary code to real executable code (depending on the desired language). For reading; provides syntactical interpretation of code for PM 865E to derive a purpose for the functionality of such code. If LIZARD performs a low confidence decision, it relays relevant data via the Data Return Relay (DRR) 865C to the ACT 866 to improve future iterations of LIZARD. LIZARD itself does not directly rely on data for performing decisions, but data on evolving threats can indirectly benefit the a priori decision making that a future iteration of LIZARD might perform. The Artificial Concept Threat (ACT) 866 creates a virtual testing environment with simulated conceptual data dangers to enable the iteration process. The artificial evolution of the ACT 866 is engaged sufficiently to keep ahead of the organic evolution of malicious concept formation. The Iteration Module (IM) 865D uses SC 865F to syntactically modify the code base of DS 865A according to the defined purpose in ‘Fixed Goals’ & data from DRR 865C. This modified version of LIZARD is then stress tested (in parallel) with multiple and varying conceptual data danger scenarios by ACT 866. The most successful iteration is adopted as the live functioning version. The Purpose Module (PM) 865E uses SM 865B to derive a purpose from code, and outputs such a purpose in it's own ‘complex purpose format’. Such a purpose should adequately describe the intended functionality of a block of code (even if that code was covertly embedded in data) as interpreted by SM 865B. Static Core (SC) 865F is the layer of LIZARD that is the least prone to changing via automated iteration, and is instead changed directly by human programmers. Especially the innermost dark square, which is not influenced by automated iterations at all. This innermost layer is like the root of the tree that guides the direction and overall capacity of LIZARD.

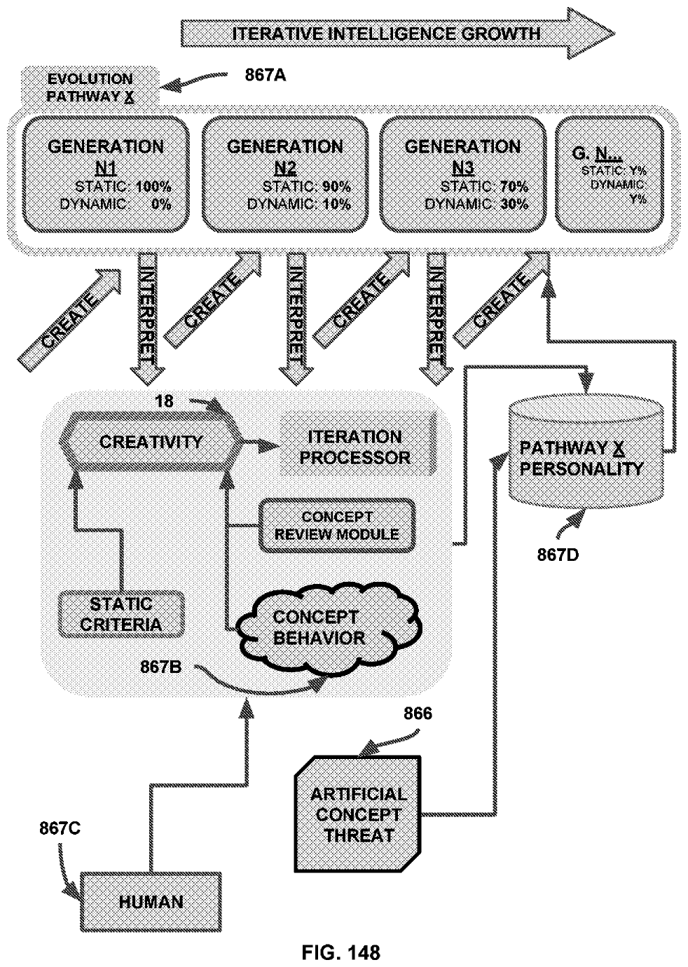

FIG. 148 shows Iterative Intelligence Growth (a subset of I²GE 21) which describes the way a static ruleset is matured as it adapts to varying dangers of conceptual data. A sequence of generational rulesets are produced, their evolution being channeled via ‘personality’ trait definitions. Such rulesets are used to process incoming conceptual data feeds, and perform the most desired notification and corrective action. An Evolutionary Pathway 867A is an entire chain of generations with a consistent ‘personality’. Generations become increasingly dynamic as CPU time progresses. The initial static ruleset become less prevalent and potentially erased or overridden. Example: Evolutionary Pathway A has a trait of being strict and precautious, with little forgiveness or tolerance of assumption. Concept Behavior 867B is where the Behavior of conceptual data analysts are processed and stored so that the Evolutionary Pathways 867A may learn from them. Example: Pathway A found a lot reactions to conceptual data dangers that matched the specific situation and the personality type optimistic. Pathway A then creates rules that mimic such behavior. Human 867C represents conceptual data analysts who create an initial ruleset to start the evolutionary chain. Example: A rule is defined that any concepts relating to buying plutonium on the black market are blocked. A Pathway Personality 867D is a cluster of variables that define reactionary characteristics that should be exercised upon conceptual data danger triggers.

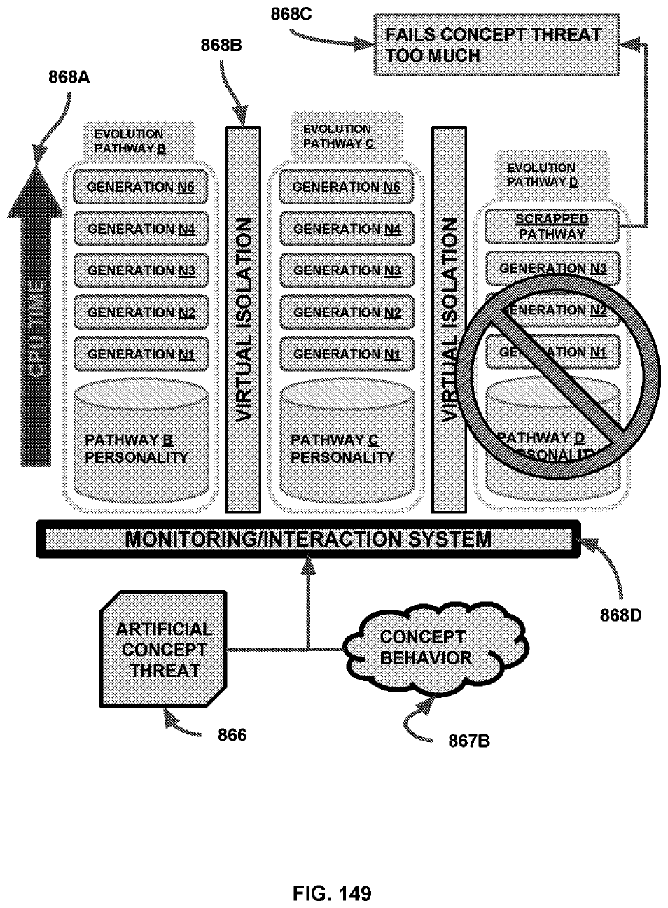

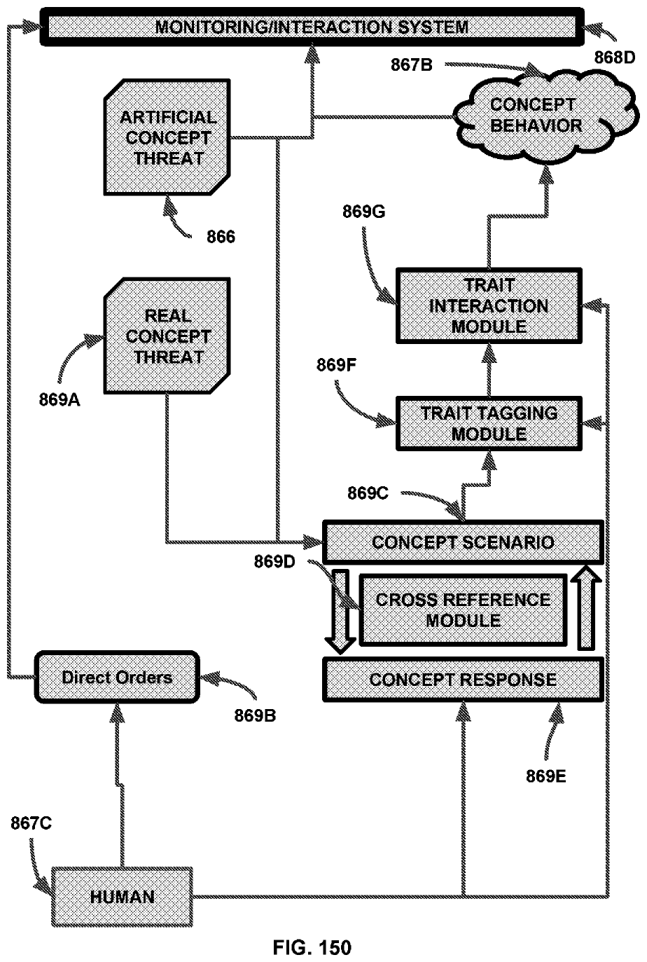

FIGS. 149-150 show Iterative Evolution (a subset of I²GE 21) which is the method in which parallel Evolutionary Pathways 867A are matured and selected. Iterative generations adapt to the same ACT 866, and the pathway with the best personality traits ends up resisting the concept threats the most. CPU Time 868A is a measure of CPU power over time and can be measured in CPU cycles/second. Using time alone to measure the amount of processing exposure an evolutionary pathway receives is insufficient, as the amount of cores and power of each CPU must be considered. Example: Processing a request that takes an Intel Pentium III a thousand years might take an Intel Haswell processor 30 minutes. By using Virtual Isolation 868B all evolutionary pathways are virtually isolated to guarantee that their iterations are based solely from the criteria of their own personalities. Example: Pathway B is completely unaware that Pathway C had solved a difficult conceptual data problem, and must rely on it's own personality traits and learned data to calculate a solution. Certain pathways may be scrapped 868C because they reached an indefinite state of being unable to recognize a conceptual data danger. The most likely outcome is that a new pathway must be spawned with a modified personality. Example: Pathway D was unable to recognize a conceptual data danger for a hundred units of CPU Time 868A. Hence the entire pathway was scrapped. The Monitoring/Interaction System 868D is the platform that injects conceptual data danger triggers from the ACT 866 system and relays associated conceptual data danger responses from the concept behavior cloud (all according to the specified personality traits). Example: The monitoring system has provided Pathway B the necessary conceptual data danger responses needed to formulate Generation 12. Artificial Concept Threat (ACT) 866 is an isolated system which provides a consistent conceptual data danger environment. It provides concept recognition drills for analysts to practice on and to train the system to recognize different potential conceptual data responses and traits. Example: The ACT provided a complex series of concepts that are recognizable to humans as dangerous. Such as “how to chemically compose sarin gas using household ingredients”. Real Concept Threat (RCT) 869A provides the Conceptual Scenario 869C real threats from real data logs. Human 867C gives Direct Orders 869B to the Monitoring/Interaction System 868D. Example: Manually abort a pathway, alter master variables in a pathway personality etc. The Cross Reference Module 869D is the analytical bridge between a Conceptual Danger 869C and the Response 869E made by a Concept Analyst 867C. After extracting a meaningful action it pushes it to the Trait Tagging Module 869F. Conceptual Dangers 869C can come from either Real Dangers 869A or Drills 866. The Trait Tagging Module 869F partitions all behavior according to personality type(s). Example: When a Conceptual Data Analyst 867C flagged 869E an email with excessive mentions of suicide methodology as risky, the module has flagged this as a precautious personality because of its behavioral overlap with past events, but also because the analyst is a self-proclaimed cautionary person. The Trait Interaction Module 869G analyzes the correlation between different personalities. This information is passed to Concept Behavior 867B, which is then passed onto the Monitoring/Interaction System 868D and the pathways themselves. Example: The personalities Unforgiving and Realist have a large overlap in usage and return similar responses for the same event. Yet Strict and Optimistic almost never give similar responses to the same event.

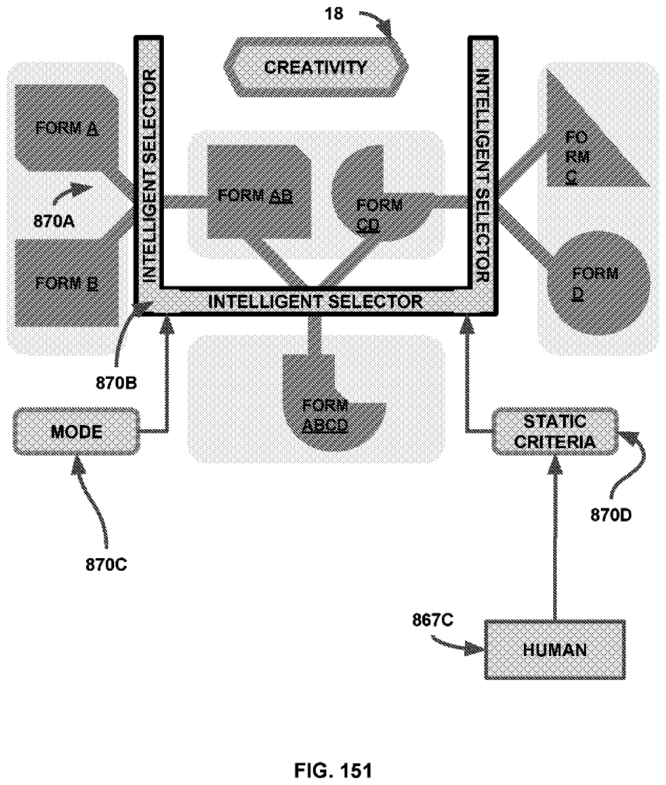

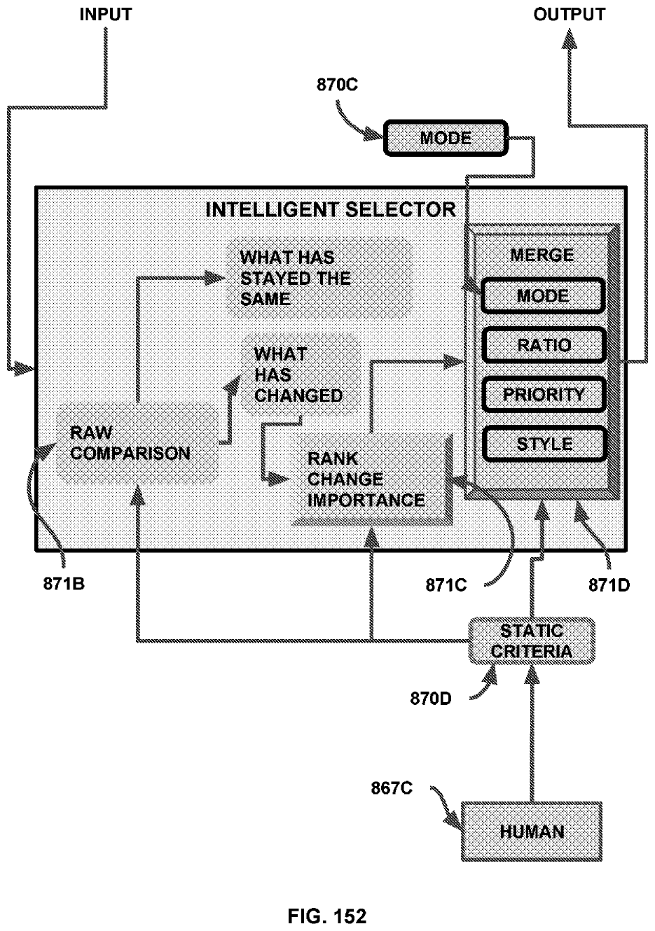

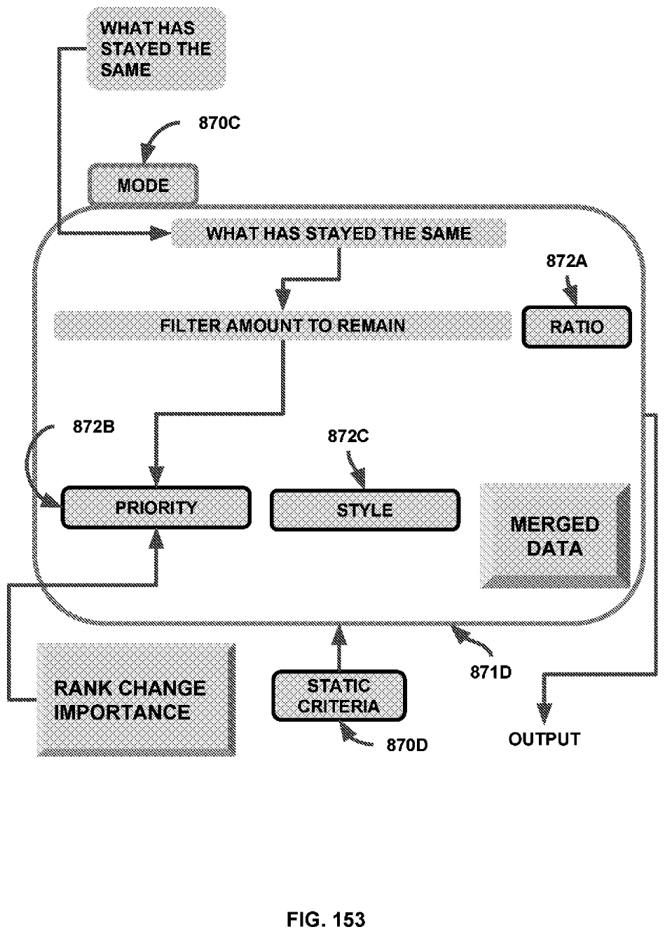

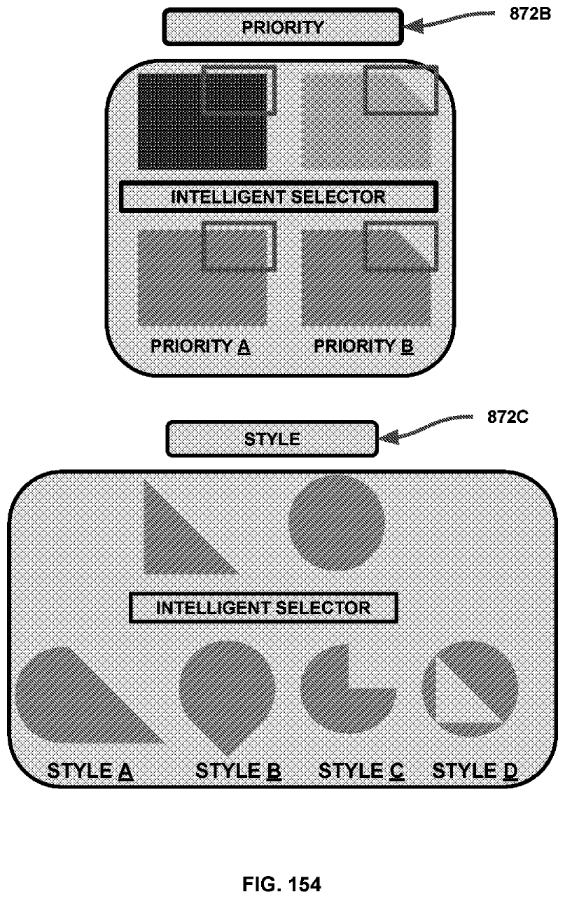

FIGS. 151-154 shows the Creativity Module 18, which is an intelligent algorithm which creates new hybrid forms out of prior input forms. Creativity 18 is used as a plug in module to service multiple algorithms. At Reference Numeral 870A two parent forms (prior forms) are pushed to the Intelligent Selector to produce a hybrid form 870B. These forms can represent abstract constructs of data. Example: Form A represents an average model of a dangerous concept derived by an Concept DB. Form B represents a new information release by a conceptual trigger ruleset on how it reacted to a dangerous concept. The information in Form B allows the hybrid form produced to be a more dangerous concept than what Form A represents. The Intelligent Selector 870B algorithm selects and merges new features into a hybrid form. Example: Form A represents an average model of a conceptual data danger derived by an Concept DB. Form B represents a new information release by a concept ruleset on how it reacted to a prior conceptual danger. The information in Form B allows the hybrid form produced to be a better conceptual danger trigger than what Form A represents. Mode 870C defines the type of algorithm that the Creativity Module 18 is being used in. This way the Intelligent Selector 870B knows what parts are appropriate to merge, depending on the application that is being used. Example: The Mode is set as ACT 866, so the Intelligent Selector 8708 knows that the expected input data is of a Danger DB representation (Form A) and of newly released information detailed a ruleset reaction to a conceptual danger trigger (Form J. The attributed Mode 870C defines the detailed method on how to best merge the new data with the old to produce an effective hybrid form. Static Criteria 870D is provided by a conceptual data analyst which provides generic customizations for how forms should be merged. Such data may include ranking prioritizations, desired ratios of data, and data to direct merging which is dependent on what Mode 870C is selected. Example: If the Mode 870C is selected as ACT 866 then the resulting information from a failed danger trigger should heavily influence the danger trigger DB to strongly vary the composition of such an trigger. If the trigger keeps failing after such variations, then abandon the trigger completely. A Raw Comparison 871B is performed on both incoming forms, dependent on the Static Criteria 870D provided by the Conceptual Data Analyst 867C. After a raw comparison was performed, the vast majority of the forms were compatible according to the Static Criteria 870D. The only differences found was that Form A included a response that was flagged by the static criteria as ‘foreign’. This means the Danger Trigger DB representation Form B does not encompass/represent a certain anomaly that was found in Form A. Rank Change Importance 871C ranks what changes are important and not important according to the provided Static Criteria 870D. Example: Because an anomaly was found in Form A that is not represented in Form B the Static Criteria 870D recognizes that this anomaly is of crucial importance, hence it results in a prominent modification being made in the merging process to produce hybrid Form AB. At the Merge Module 871D what remains the same and what is found to be different are re-assembled into a hybrid form based off of the Static Criteria 870D and the Mode 870C that is being used. Such variations may include the Ratio Distribution 872A of data, how important certain data is, and how should the data mesh/relate to each other. Example: The rank importance of the anomaly composition is received. After the appropriate adjustments are made, a process which is guided by the Static Criteria 870D discerns if that reaction to the anomaly is incompatible with other parts of the data. The merging process then modifies such pre-existing data so that the anomaly fix can blend in effectively with the pre-existing data. The amount of overlapping information is filtered through according to the Ratio 872A set by the Static Criteria 870D. If the Ratio 872A is set to large then a large amount of form data that has remained consistent will be merged into the hybrid form. If the Ratio 872A is set to small then most of hybrid form will be constructed has a very different from its past iterations. Priority 872B is where both data sets compete to define a feature at the same place in the form, a prioritization process occurs to choose which features are made prominent and which are overlapped and hidden. When only one trait can occupy a certain spot (highlighted via rectangle), then a prioritization process occurs to choose which feature gets inherited. Style 872C defines manner in which overlapping points are merged. Most of the time there are multiple ways in which a specific merge can occur, hence the Static Criteria 870D and Mode 870C direct this module to prefer a certain merge over another. Most of the time there are overlapped forms between features, hence a form with merged traits can be produced. Example: When a triangle and a circle are provided as input forms, a ‘pac-man’ shape can be produced.

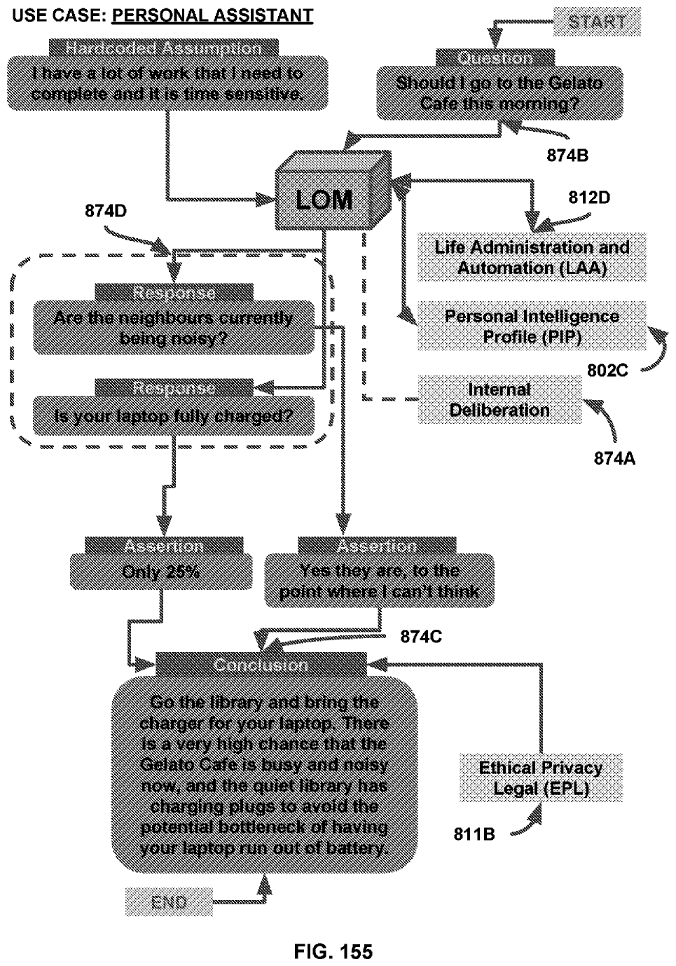

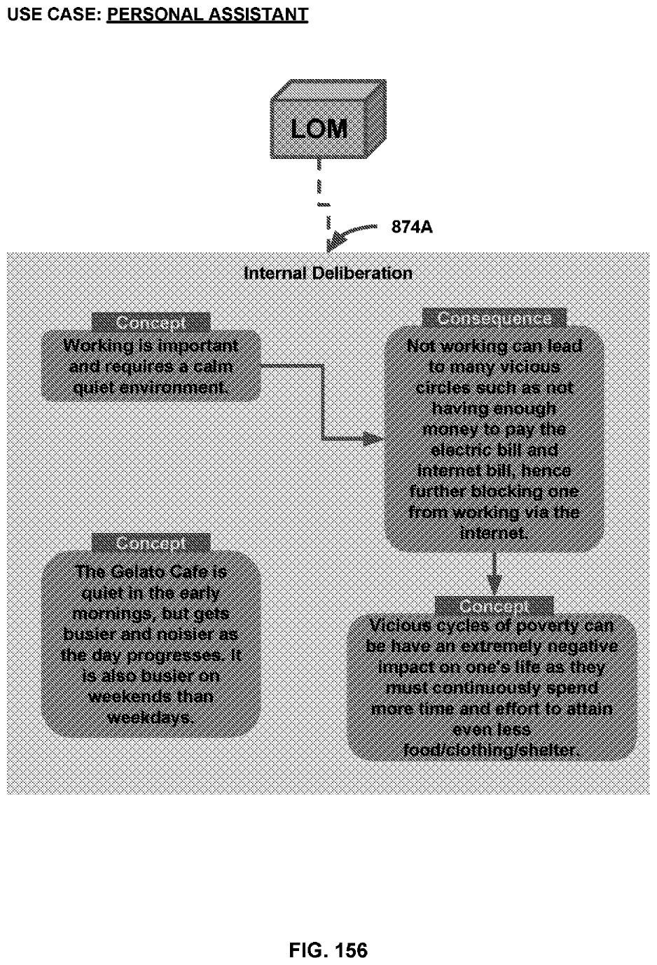

FIGS. 155-156 shows LOM being used as a Personal Assistant. LOM can be configured to manage a personalized portfolio on an individual's life. A person can actively consent for LOM to register private details about their daily routine so that it can provide meaningful and appropriate advice when an individual encounters dilemmas or propositions. This can range from situations to work, eating habits, purchasing decisions etc. LOM receives an initial Question 8748 which leads to conclusion 874C via LOM's Internal Deliberation Process 874A. EPL 811B is used to verify the ethical, legal, and privacy-based compliance of the response generated by LOM. To make LOM more personal, it can connect to the LAA 812D module which connects to internet enabled devices which LOM can receive data from and control. (i.e. turning the air conditioning on as your arrive near your home). With PIP 802C LOM receives personal information from a user and the user may consent to having the information securely tracked. This way LOM can provide more personally accurate future responses. With Contextualization 874D LOM is able to deduce the missing links in constructing an argument. LOM has deciphered with it's advanced logic that to solve the dilemma posed by the original assertion it must first know or assume certain variables about the situation.

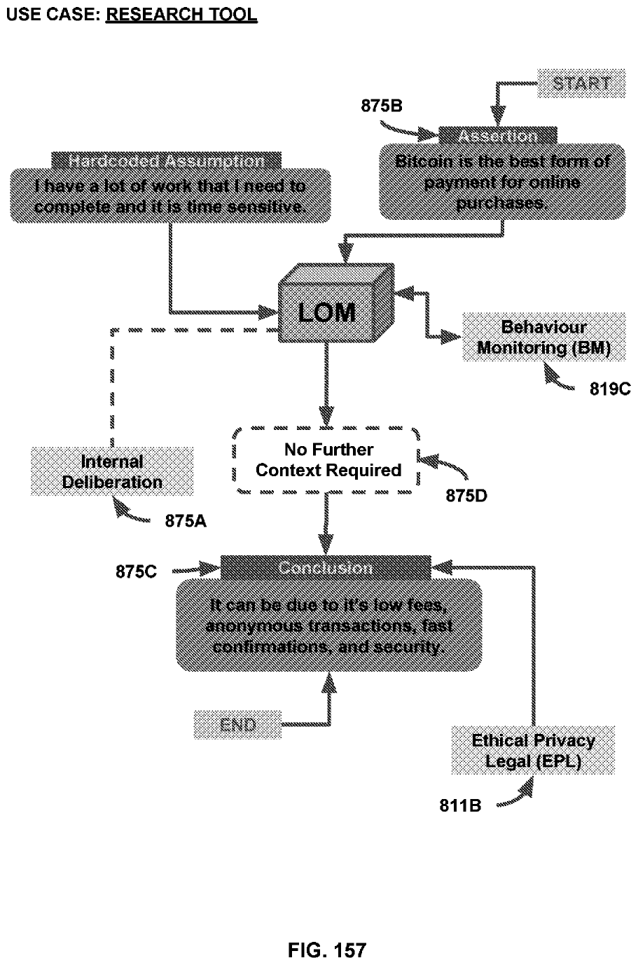

FIG. 157 shows LOM being used as a Research Tool. A user is using LOM as an investment tool. Because the Assertion 875B is put forth in an objective and impersonal fashion, LOM does not require Additional Details 875D of a specific and isolated use case to allow it to form a sophisticated opinion on the matter. Therefore Conclusion 875C is reached without personalized information. EPL 811B is used to verify the ethical, legal, and privacy-based compliance of the response generated by LOM, and BM 819C is used to monitor any conspiracy to commit illegal/immoral activity on the user's behalf.

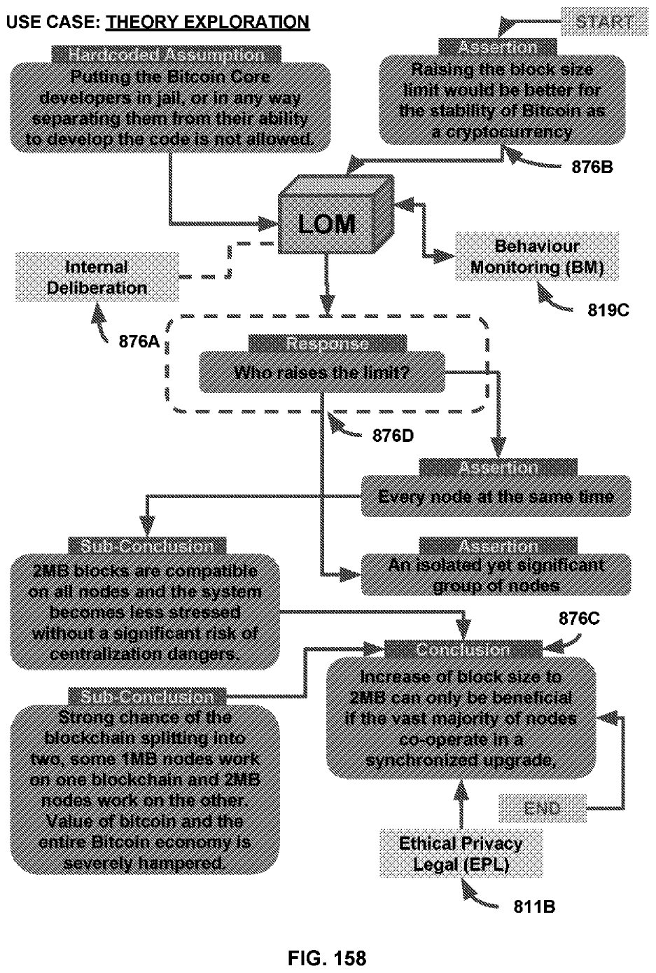

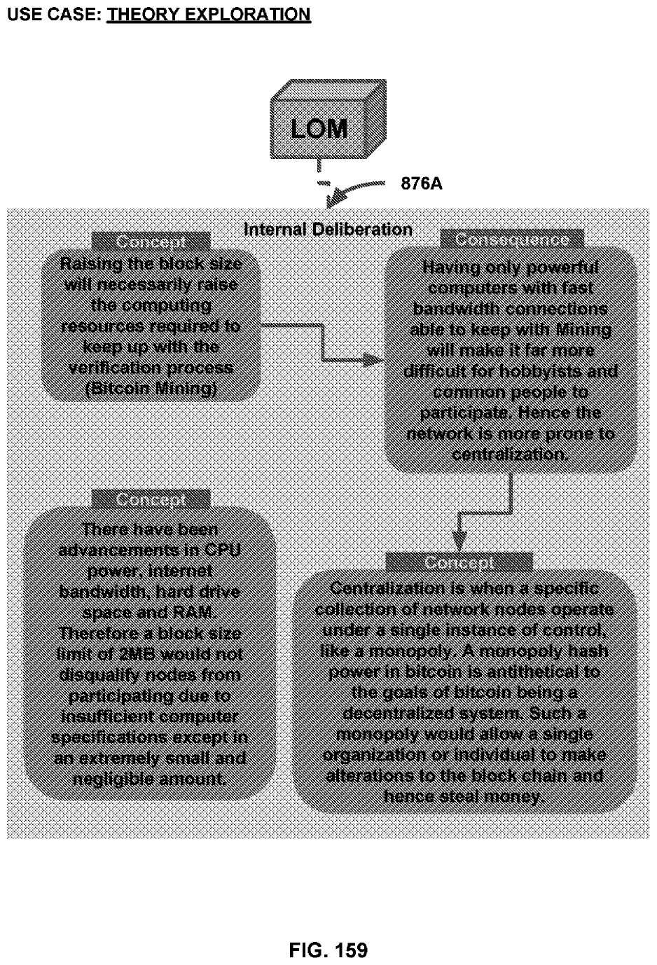

FIGS. 158-159 show LOM exploring the merits and drawbacks of a Proposed 876B theory. Bitcoin is a peer-to-peer decentralized network which validates ownership of the cryptocurrency in a public ledger called the blockchain. All the Bitcoin transactions that occur are recorded in a block which is mined every 10 minutes by the network. The current hardcoded limit in the Bitcoin Core client is 1 MB, which means that there can only be 1 MB worth of transactions (represented in data form) every 10 minutes. Due the recent popularity increase in Bitcoin as an asset, the block size limit has caused stress to the system, long payment confirmation times, and more expensive miner's fees. With Contextualization 876D LOM is able to deduce the missing links in constructing an argument. LOM has deciphered with it's advanced logic that to solve the dilemma posed by the original assertion it must first know or assume who would be raising the block size limit. Therefore Conclusion 876C is reached by LOM. EPL 811B is used to verify the ethical, legal, and privacy-based compliance of the response generated by LOM, and BM 819C is used to monitor any conspiracy to commit illegal/immoral activity on the user's behalf.

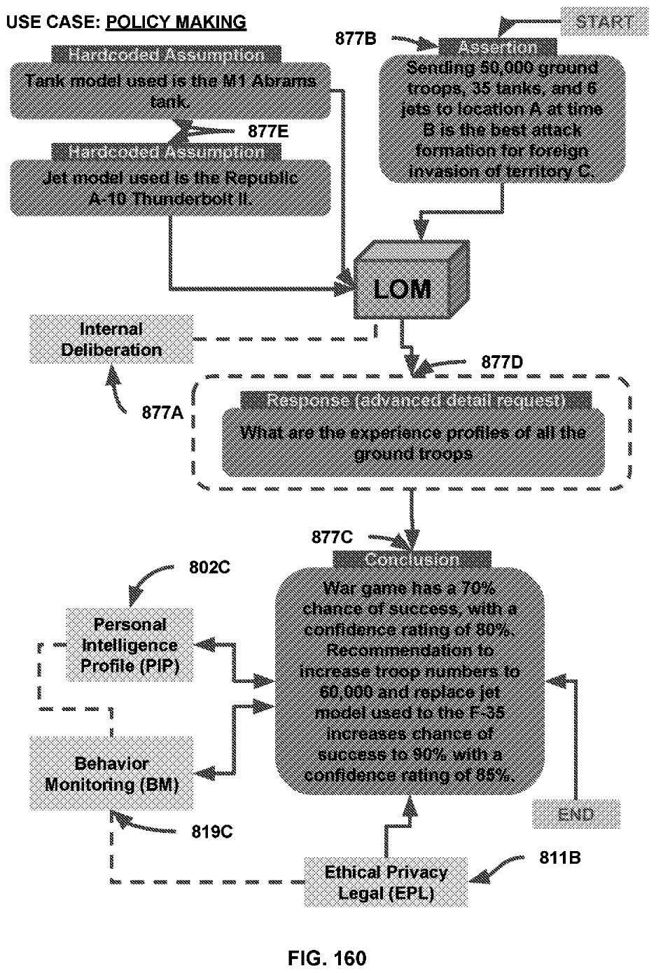

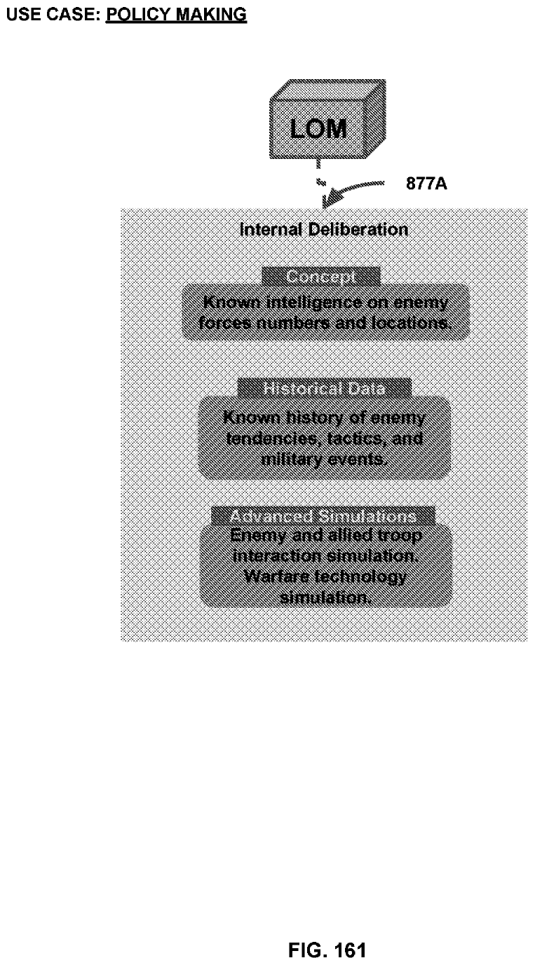

FIGS. 160-161 shows LOM performing Policy Making for foreign policy war games. An isolated and secure instance of LOM can be utilized on military approved hardware and facilities. This enables LOM to access its general knowledge in Central Knowledge Retention (CKR) 806 whilst accessing military specific (and even classified) information in a local instance of Personal Intelligence Profile (PIP). Military personnel can run complex war games due to LOM's advanced intelligence abilities while being able to access general and specific knowledge. The initial war game scenario is proposed with assertion 877B and Hardcoded Assumptions 877E. Due to the complexity of the war game scenario, LOM responds with an Advanced Detail Request 887D. LOM may decide that to achieve a sophisticated response it must receive a high level of information such as the detailed profiles of 50,000 troops. Such an information transfer can be on the magnitude of several terabytes of data, requiring multiple days of parallelized processing to reach a sophisticated conclusion. All information is transferred via standardized and automated formats and protocols (i.e. importing 50,000 excel sheets for two hours with a single computer interface action). With BM 819C and EPL 811B a Security Clearance Override is activated to disable such protective features due to the sensitive nature of the information. The issue of war game simulation contains topics that may become flagged by BM 819C and EPL 811B. EPL might block useful information that could have otherwise benefited the simulation which has an eventual impact to real lives and money spent. BM 819C might have flagged the topic and reported it to the MNSP 9 authorities. Therefore properly qualified military channels/organizations can authenticate their LOM session via PIP 802C to allow for such sensitive topics to be processed via LOM without interruption, being hampered, or reporting to authorities. Since such information may be classified, such as troop numbers and locations, the authenticated session may enable an override that blocks BM 819C and EPL 811C entirely that way such sensitive information never leaves LOM into external platforms and parties such as MNSP 9. With PIP 802C the authorized military personnel which are running this war game are using a customized instance of LOM which has upgraded/specialized cryptography and information isolation. This can include a custom on-site storage solution to ensure that the sensitive military information never enters public cloud storage and remains within military approved facilities. Hence such securely retained information enables the Internal Deliberation 877A of LOM to simulate the proposed war games.

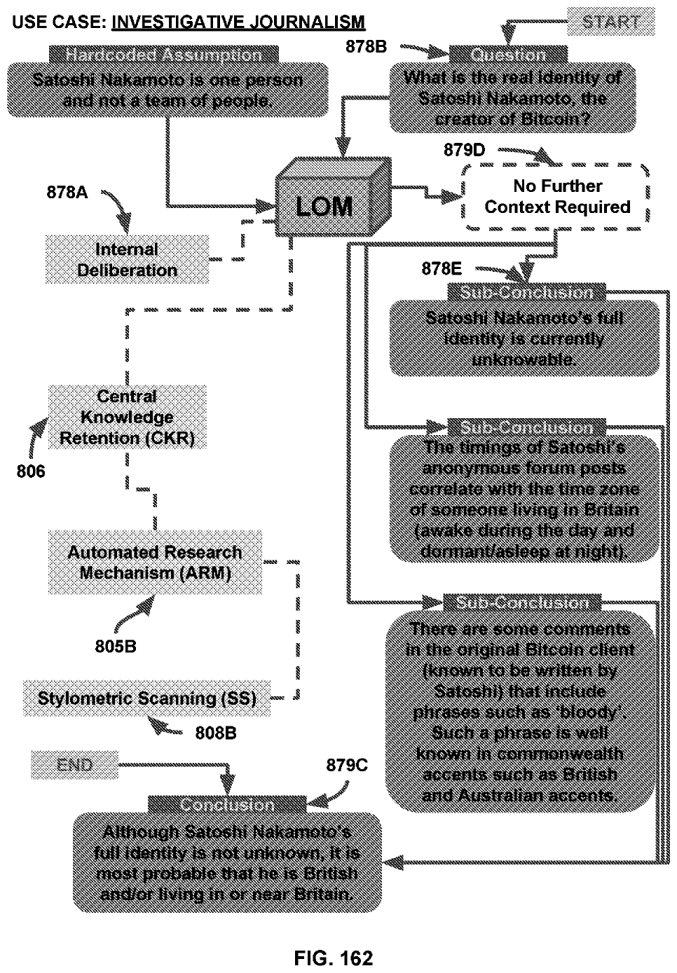

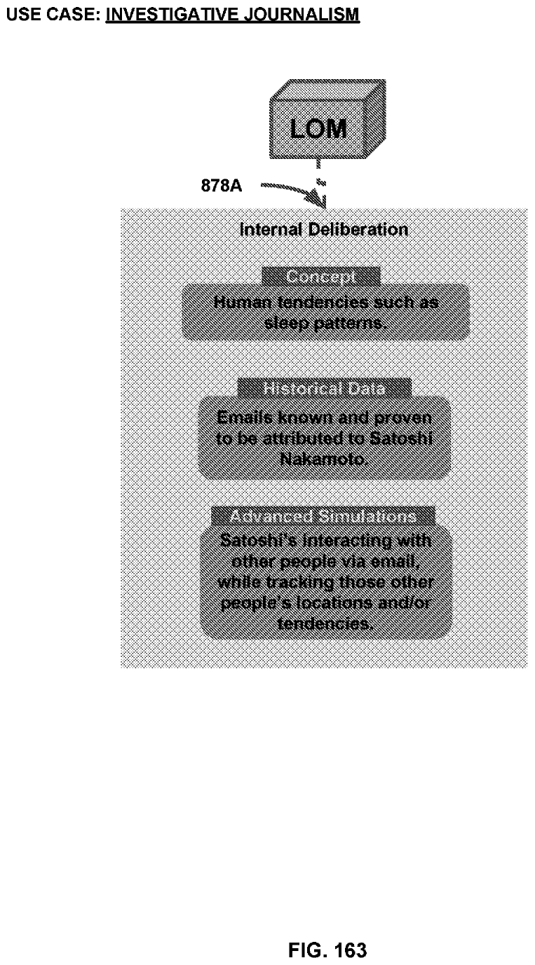

FIGS. 162-163 shows LOM performing Investigative Journalism tasks such as uncovering identifiable details about a person. The example of this use case follows the mystery surrounding Bitcoin's creator, known by the pseudonym Satoshi Nakamoto. The Bitcoin community, along with many magazines and investigative journalists, have put forth much effort to try to uncover his/her identity. Yet LOM is able to maximize the investigation effort in an automated and thorough way. LOM may face a specific part of the journalistic puzzle that is required to be found to be able to accurately respond to the initial query. Hence LOM can dispatch custom information requests to ARM 805B, which assimilates the information into CKR 806. With Contextualization 879D LOM does not require additional details of a specific and isolated use case to allow it to form a sophisticated opinion on the matter because the Question 878B is put forth in an objective and impersonal fashion. LOM never feels ‘ashamed’ of responding that it does not know or is unsure as LOM has the ‘personality’ of being ‘brutally honest’. Therefore it is able to see how there are unavoidable holes in the evidence required to uncover Satoshi's true identity, such as at Sub-Conclusion 878E. As ARM 805B retrieves all emails and chat logs known to be correctly attributed to Satoshi, Stylometry 808B is performed to corroborate and define the true identity of Satoshi. Hence all that LOM knows concerning the investigative journalism task is presented as Conclusion 879C.

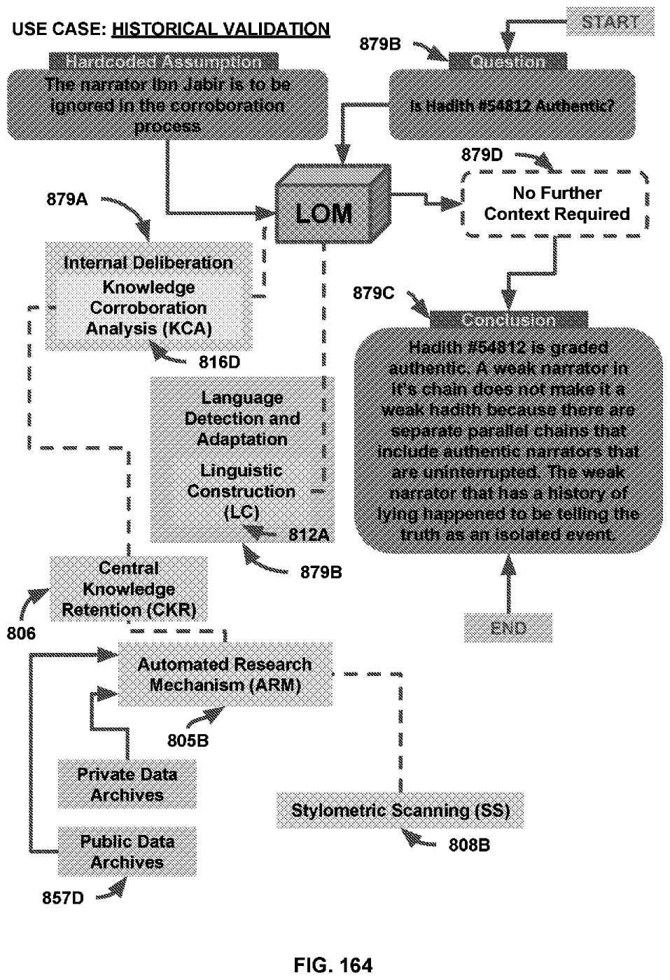

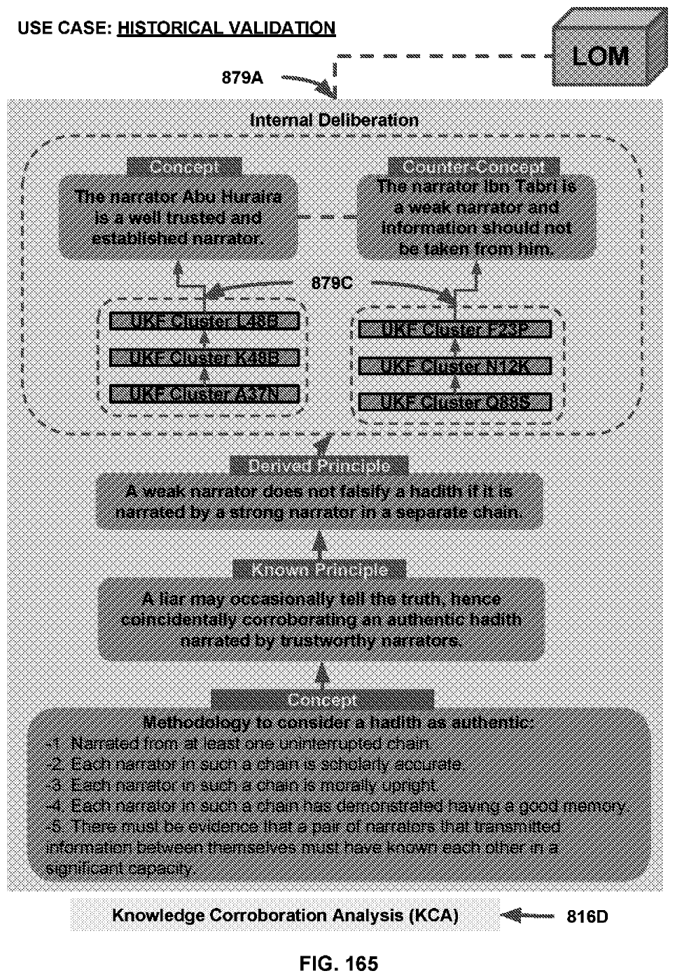

FIGS. 164-165 shows LOM performing Historical Validation. LOM is able to verify the authenticity of historical documents via corroboration of a chain of narrators. Certain historical documents known as ‘Hadith’ (literally ‘news’ in arabic) have been proven to be authentically attributed to its originator via corroboration of people who corroborated the transmitted news. Since Hadith literature is originally stored and understood within its colloquial context in arabic, the Linguistic Construction 812A Module references third party translation algorithms to understand the literature directly in it's native language. With Contextualization 879D LOM does not require additional details of a specific and isolated use case to allow it to form a sophisticated opinion on the matter because the Question 879B is put forth in an objective and impersonal fashion. With KCA 816D UKF Clustered information is compared for corroborating evidence concerning the validity of a quote (Hadith) as verified by a chain of narrators. This algorithm takes into consideration the reliability of the attributed source (i.e. alleged hadith narrator), when such a claim was made, negating evidence etc. LOM builds concepts overtime within CKR 806 from data retrieved by ARM that facilitates the authentication process of a hadith. Self-imposed questions are asked such as ‘What is a Hadith?’, ‘What variations of Hadith are there?’, ‘what is the best methodology of authentication?’. There CKR 806 builds a strong base of definitions via innate advanced reasoning, and is able to justify any conclusions 879C that LOM outputs. With Cluster Building 879C CKR 806 reaches conceptual conclusions via ‘stacking’ building blocks of information known as UKF Clusters. These clusters encompass a wide range of metadata concerning the targeted information such as attributable sources, times of suspected information creation etc.

### Digitally-Oriented Language LAQIT

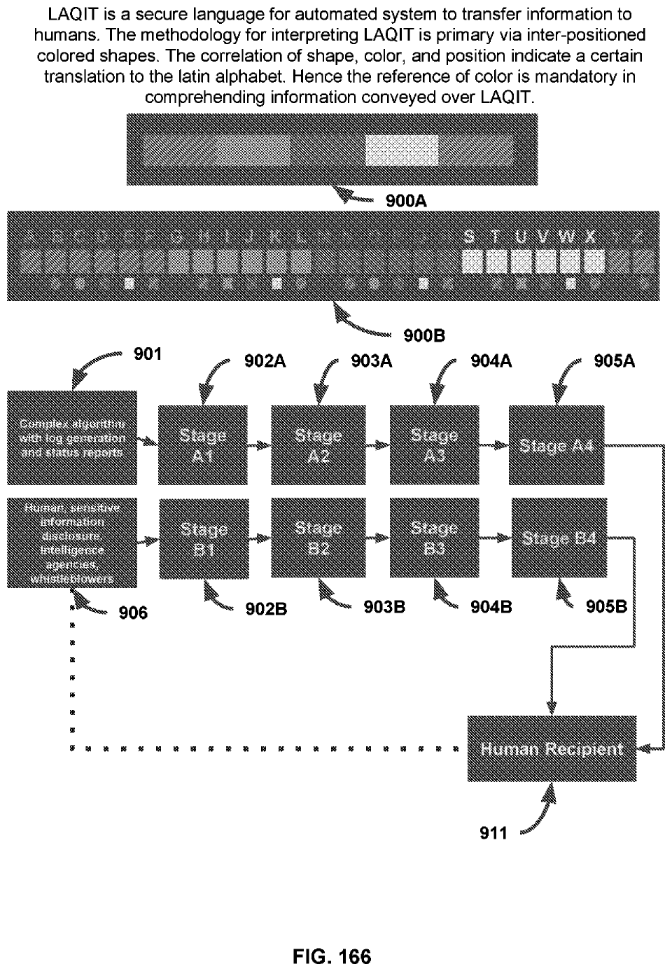

FIG. 166 introduces the concept of LAQIT. LAQIT is an efficient and secure method of transferring information from within a network of trusted and targeted parties. LAQIT offers a wide range of modes that can alternate between a strong emphasis on readability and a strong emphasis on security. Linear, Atomic, and Quantum are different and distinct modes of information transfer which offer varying features and applications. LAQIT is the ultimate form of secure information transfer, as it's weakest link is the privacy of the mind. Counterparty risk is practically removed as the efficiently simple to memorize key is stored solely in the mind of the recipient, and the message is decrypted in realtime (using human memory) in accordance with the makeup of that key. The key need only be transferred once and committed to memory, hence more elaborate measures of privacy can be employed for the isolated memorization event such as conveying the key in person with phones turned off, via temporary encrypted email, etc. All security liabilities then lie within the secrecy of the key. Since it is simple enough to memorize, the majority of all security liabilities has been mitigated. Block 900A illustrates the same consistent color sequence of red, orange, blue, green and purple that is repeated and recursive within LAQIT's logically structured syntax. Block 900B further illustrates the color sequence being used recursively to translate with the English alphabet. When structuring the ‘base’ layer of the alphabet, this color sequence is used with a shortened and unequal weight on the purple channel. Leftover space for syntax definitions within the purple channel is reserved for potential future use and expansion. Stage 901 represents a complex algorithm reports it's log events and status reports with LAQIT. In this scenario encryption is disabled by choice whilst the option to encrypt is available. Stage A1 902A represents the automatic generation of status/log reports. Stage A2 903A represents conversion of the status/log reports to a transportable text-based LAQIT syntax. Stage A3 904A represents the transfer of syntactically insecure information which can be transferred over digitally encrypted (i.e. VPN 12) decrypted (i.e. raw HTTP) channels. An encrypted channel is preferred but not mandatory. Stage A4 905A represents the conversion of the transportable text-based syntax to highly readable LAQIT visual syntax (i.e. linear mode). Stage 911 represents the targeted recipient as a human, since LAQIT is designed, intended, and optimized for non-computer/non-A1 recipients of information. Stage 906 shows the sender of sensitive information being human. Such a human could represent an intelligence agency or a whistleblower initiative. Such a sender 906 discloses the LAQIT encryption key directly to the Human Recipient 911 via a secure and temporary encrypted tunnel designed for transferring such a Key 939 with any traces being left in persistent storage. Ideally the Human Recipient 911 would commit the Key 939 to memory and remove every trace of storage the key has on any digital system as to remove the possibility of hacking. This is made possible due to the Key 939 being optimized for human memorization as it is based on relatively short sequence of shapes. Stage B1 902B represents locally non-secure text being entered by the sender 906 for submission to the Recipient 911. Stage B2 903B represents the conversion of such text 902B to a transportable encrypted text-based LAQIT syntax. Stage B3 904B represents the transfer of syntactically secure information which can be transferred over digitally encrypted (i.e. VPN) decrypted (i.e. raw HTTP) channels. Stage B4 905B represents the conversion of the data to a visually encrypted LAQIT syntax (i.e. Atomic mode with encryption level 8), which is thereafter presented to the Human Recipient 911.

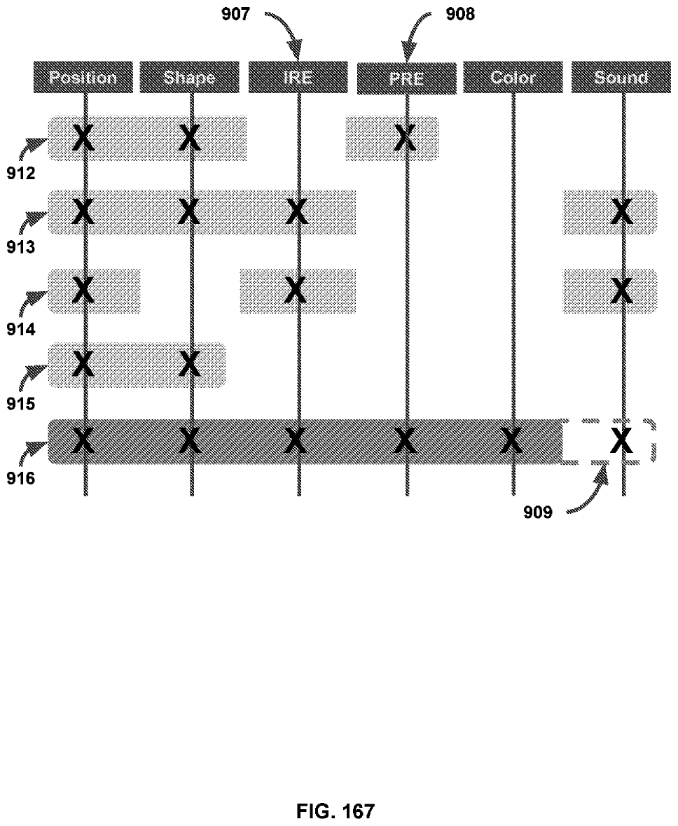

FIG. 167 shows all the major types of usable languages (or modes of information transfer) to compare their effectiveness in transferring information via the use of information channels such as Position, Shape, Color, and Sound. The most effective, efficient, and usable language is the one that is able to incorporate and leverage the most amount of channels effectively. Incremental Recognition Effect (IRE) 907 is a channel of information transfer. It is characterised by the effect of recognizing the full form of a unit of information before it has been fully delivered. This is akin to finishing a word or phrase before the subject has completed it. LAQIT incorporates this effect of a predictive index by displaying the transitions between word to word. For an experienced LAQIT reader, they can begin to form the word that is being displayed whilst the blocks are moving into position but have not yet arrived. Proximal Recognition Effect (PRE) 908 is a channel of information transfer. It is characterized by the effect of recognizing the full form of a unit of information whilst it is either corrupted, mixed up or changed. This can be illustrated in the english language with the spellings of ‘character’ and ‘chracaetr’. The outer bounds of the unit have been defined (the first and last characters), yet the proximity of the mixed-up characters still define the word as a whole. With Written English 912, typical english text combines the position of the letters, the shape of the letters, and recognition of the whole word as opposed to the individual letters together as described in IRE 907). With Conversational Speech 913, an average verbal conversation combines the position of the words (the order they are said), the shape representing frequency of pitch and audible emphasis. Morse Code 915 is composed of the varying binary positions of sounds. Predictive cognition of the information recipient enables IRE 907, but not inter-proximal as a mores code streams information gradually. With Hand Signals 915, the position and formation (shape) of hand movements determine information. This can range from signaling an airplane to move, for a truck to stop etc. There is little to no predictive ability hence no IRE 907 nor PRE 908. LAQIT 916 is able to leverage the most information channels in comparison to the competing languages 912 through 915. This means that more information can be transferred in less time with less of a medium (i.e. space on a screen). This afforded capacity headroom enables complex features such as strong encryption to be effectively incorporated. With LAQIT Sound Encryption 909, LAQIT is able to leverage the information channel of sound to further encrypt information. Hence it is considered able to transfer information via sound, despite it being unable to do so with decrypted communication.

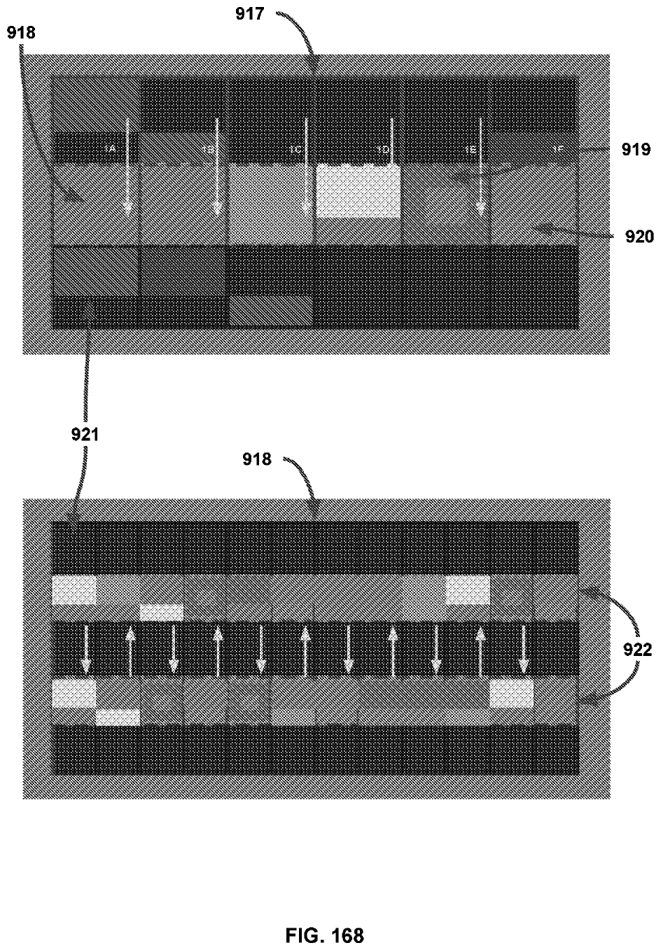

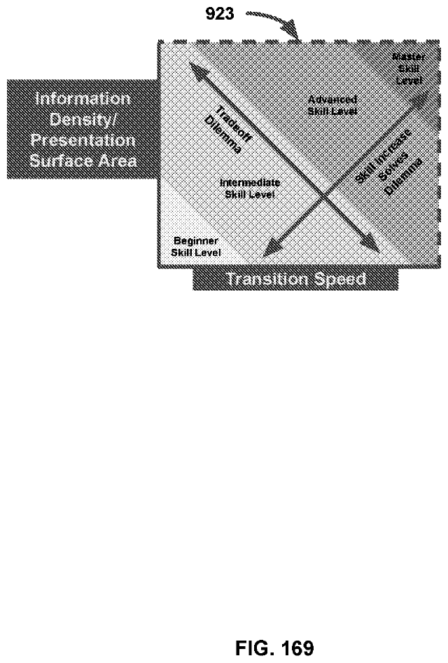

FIGS. 168-169 show the Linear mode of LAQIT, which is characterized by its simplicity, ease of use, high information density, and lack of encryption. Block 917 shows the ‘Basic Rendering’ version of linear mode. Point 918 displays it's absence of encryption. Linear mode does not allow for efficient space allocation for Shape Obfuscation 941, which is the groundwork for encryption in Atomic Mode. Instead, Linear Mode is optimized for dense information transfer and efficient usage of the presentation screen. With Word Separator 919, the color of this shape represents the character that follows the word and acts as a separation between it and the next word. This is the equivalent syntax as an atomic nucleus for the atomic procedure. Color codes representing a question mark, an exclamation mark, a full stop and a comma are all applicable. Single Viewing Zone 920 shows how the Basic Rendering 917 incorporates a smaller viewing zone with larger letters and hence less information per pixel as compared to the Advanced Rendering 918. Such Advanced Rendering is characterized by its Double Viewing Zone 922. In the Advanced Rendering there are more active letters per pixel as it is expected that the LAQIT reader will be able to keep up in terms of speed. Hence there is a tradeoff dilemma between presentation speed and information density. Shade Cover 921 makes incoming and outgoing letters dull so that the primary focus of the observer is on the viewing zone(s). Despite the covering, it is partially transparent so as to afford the observer the ability to predict the incoming word, and to verify and check the outgoing word. This is also known as Incremental Recognition Effect (IRE) 907. High Density Information Transfer 923 shows how with Advanced Rendering 918 each letter is smaller and more letters are presented in the same amount of space, hence more information is conveyed per pixel.

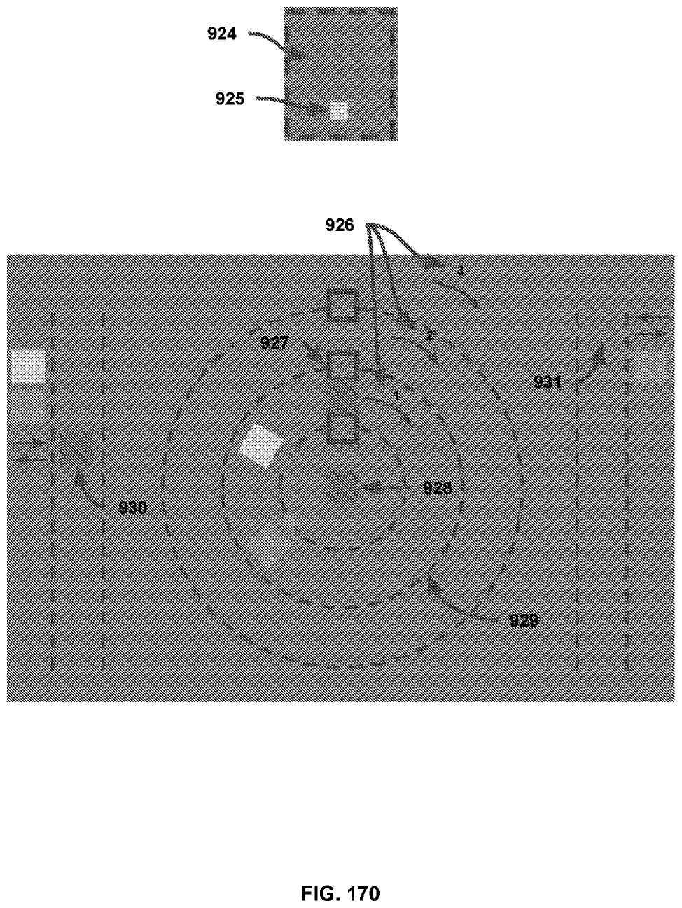

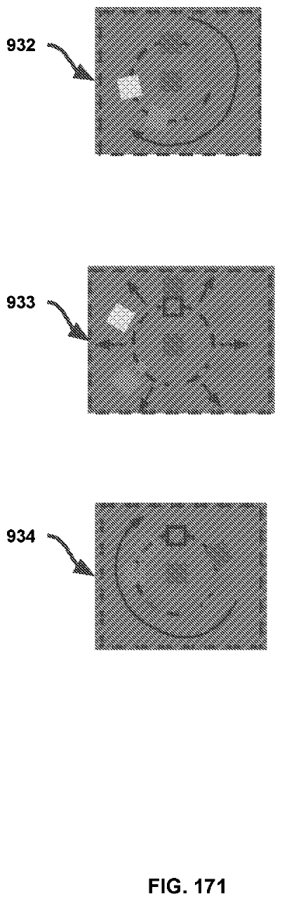

FIGS. 170-171 show the characteristics of Atomic Mode, which is capable of a wide range of encryption levels. The Base 924 main character reference will specify the general of which letter is being defined. A red base indicates that the letter is between (and including) letters A through F according to the Alphabet Reference 900B. It is possible to read words using bases only (without the kicker 925), as induction can be used to infer the spelling of the word. Can exist in a total of five possible shapes to enable encryption. The Kicker 925 exists with the same color range as the bases, and defines the specific character exactly. The absence of a Kicker also indicates a definition i.e. a red base on it's own, without a kicker, is the letter A. The Kicker can exist in a total of five possible Shapes 935 to enable encryption. With Reading Direction 926, the information delivery reading begins on the top square of orbital ring one. Reading is performed clockwise. Once an orbital ring has been completed, the reader continues from the top square of the next sequential orbital ring (ring 2). The Entry/Exit Portals 927 are the points of creation and destruction of a character (it's base). A new character, belonging to the relevant orbital, will emerge from the portal and slide to its position clockwise. The Atomic Nucleus 928 defines the character that follows the word. Typically this is a space, to denote that the sentence will continue after this word is presented. Color codes representing a question mark, an exclamation mark, a full stop and a comma are all applicable. Also indicates if the same word will be continued on a new information state because all three orbital rings have been filled up to their maximum capacity. When one Orbital Ring 929 becomes filled up, the letter overflow onto the next (bigger) orbital ring. The limits for orbital ring 1 is 7, ring 2 is 15, and ring 3 is 20. This enables a maximum of 42 total characters within an atom (including potential duds). If the limit of 42 characters is reached, the word will be cut into segments of 42, and the nucleus will indicate that the next information state is the continuation of the current word. With Word Navigation 930 each block represents an entire word (or multiple words in molecular mode) on the left side of the screen. When a word is displayed, the respective block moves outwards to the right, and when that word is complete the block retreats back. The color/shape of the navigation block is the same color/shape as the base of the first letter of the word. With Sentence Navigation 931 each block represents a cluster of words. A cluster is the maximum amount of words that can fit on the word navigation pane. If there is a sentence navigation block on it's own, or the last one of many, it is more likely than not that it will represent a smaller cluster of words than the maximum capacity. Atomic State Creation 932 is a transition that induces the Incremental Recognition Effect (IRE) 907. With such a transition Bases 924 emerge from the Entry/Exit Portals 927, with their Kickers 925 hidden, and move clockwise to assume their positions. During this transition, a skilled reader of LAQIT is able predict in part or the whole word before the Kickers 925 are revealed due to IRE 907. This is similar to the autocomplete feature of most search engines, they estimate the remainder amount of the sequence with an initial batch of information. Atomic State Expansion 933 is a transition that induces the Proximal Recognition Effect (PRE) 908. Once the Bases 924 have reached their position, they move outwards in the ‘expand’ sequence of the information state presentation. This reveals the Kickers 925 so that the specific definition of the information state can be presented. A skilled reader of LAQIT would not need to gradually scroll through each individual letter to build the word gradually, but rather would look at the entire structure as a whole and immediately recognize the meaning of the word due to PRE 908. Atomic State Destruction 934 is a transition that induces the Incremental Recognition Effect (IRE) 907. At this stage Bases 924 have retracted, (reversed the Expansion Sequence 933) to cover the Kickers 925 again. They are now sliding clockwise to reach the entry/exit portal. In a high speed rendering of the information state, a skilled reader of LAQIT would be able to leverage the destruction transition to complete the recognition of the word. This would be useful when the window of opportunity for seeing the expanded atomic state (Kickers showing) is extremely narrow (fractions of a second).

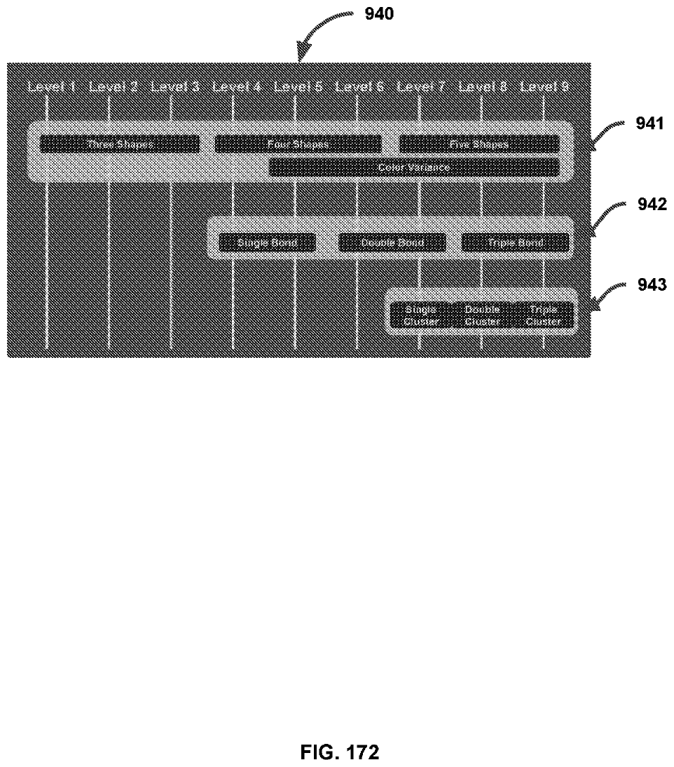

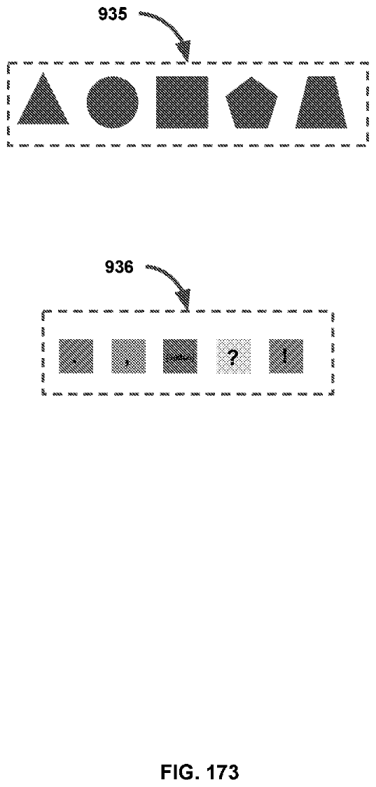

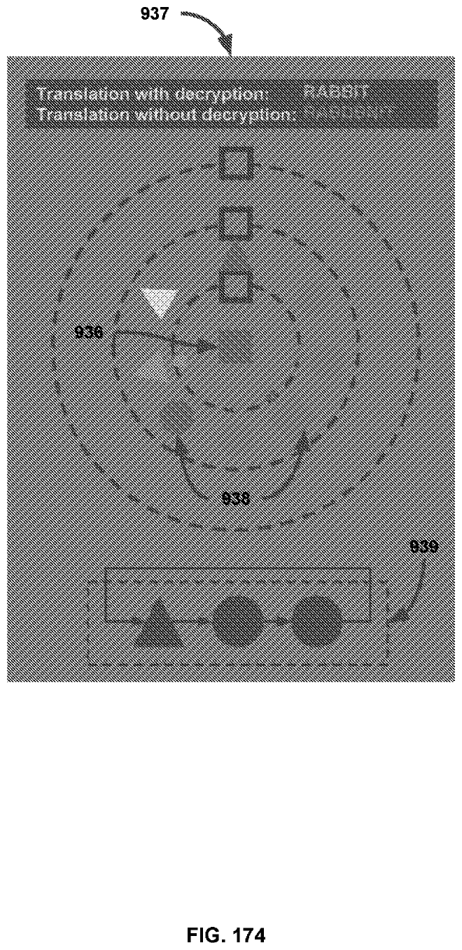

FIGS. 172-174 shows an overview for the encryption feature of Atomic Mode. Because LAQIT provides an efficient and dense means of transferring information, there is sufficient informational bandwidth headroom to afford the implementation of encryption. This syntactical encryption differs from classical cybersecurity encryption in that it requires the intended information recipient to decrypt the information in realtime with a memorized key. This mitigates the risk of data in motion, data at rest and data in use from being read and understood by malicious and unauthorized parties. Encryption complexity varies across nine Standardized Levels 940, the tradeoff being between readability and security strength. With Shape Obfuscation 941 (levels 1-9) the standard squares are replaced with five visually distinct shapes. The variance of shapes within the syntax allows for dud (fake) letters to be inserted at strategic points of the atomic profile. The dud letters obfuscate the true and intended meaning of the message. Deciphering whether a letter is real or a dud is done via the securely and temporarily transferred decryption key. If a letter is compatible with the key then it is to be counted in the calculation of the word. Upon key incompatibility it is to be disregarded within the calculation. With Redirection Bonds 942 (levels 4-9) a bond connects two letters together and alters the flow of reading. Whilst beginning with the typical clockwise reading pattern, encountering a bond that launches (starts with) and lands on (ends with) legitimate/non-dud letters will divert the reading pattern to resume on the landing letter. With Radioactive Elements 943 (levels 7-9), some elements can ‘rattle’ which can inverse the evaluation of if a letter is a dud or not. Shapes 935 shows the shapes available for encryption: a triangle, a circle, a square, a pentagon, and a trapezoid. Center Elements 936 shows the center element of the orbital which defines the character that comes immediately after the word. Such elements are: red to indicate a full stop, orange to indicate a comma, blue to indicate a space, green to indicate a question mark, and pink to indicate an exclamation point. Encryption Example 937 shows Shape Obfuscation 941 which is applicable to encryption levels 1-9. The Center Element 936 is shown at the center of the orbital, whilst Dud Letters 938 are the main means of encryption with Shape Obfuscation 941. The left dud has the sequence circle-square. The right dud has the sequence square-triangle. Since both of these sequences don't exist in the Encryption Key 939, the reader is able to recognize them as duds and hence skips them when calculating the meaning of the information state.

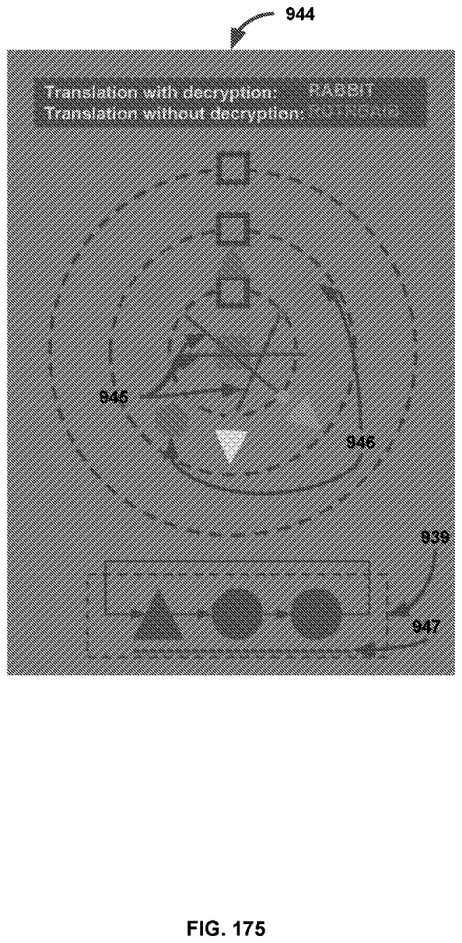

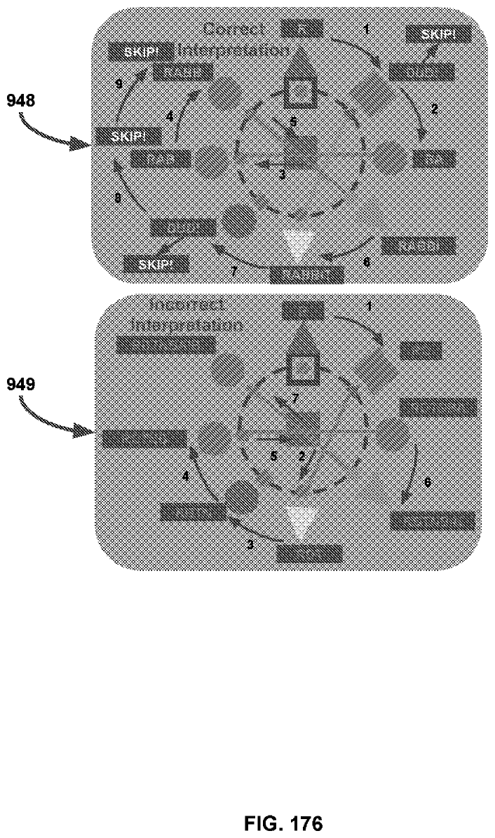

FIGS. 175-176 illustrate the mechanism of Redirection Bonds 942. Encryption example 944 shows Redirection Bonds 942 and 945. These are the ‘Rules of Engagement’ concerning Redirection Bonds:

1) When a bond is reached, it is by followed by default and hence the routine clockwise behavior is abandoned.
2) When a pathway is followed: the launching letter, the letter with which the pathway begins, is counted as part of the sequence.
3) When a pathway is followed: the landing letter, the letter with which the pathway ends, is counted as part of the sequence.
4) A pathway can only be followed once.
5) A specific instance of a letter can only be counted once.
6) A pathway must be followed only if both the launching and the landing letters are not duds.
With Redirection Bonds 945 the bonds start on a ‘launching’ letter and end on a ‘landing’ letter, either of which may or may not be a dud. If none of them are duds, then the bond alters the reading direction and position. If one or both are duds, then the entire bond must be ignored, or else the message will be decrypted incorrectly. Each individual bond has a correct direction of being read, however that order is not explicitly described and must be induced according to the current reading position and dud makeup of the informations state. Dud Letters 946 show how these two dud letters now make the decryption more complex and hence resistant to brute force attacks. This is because the combination of shape obfuscation and redirection bonds leads to an exponentially more difficult task for brute force attackers. With Bond Key Definition 947: If a bond must be followed in the reading of the informations state depends on if it has been specifically defined in the encryption key. Potential definitions are: single bond, double bond, and triple bond. A potential case scenario of reading the redirection bond incorrectly (due to not knowing the Bond Key 947) is illustrated at Incorrect Interpretation 949. Such an Incorrect Interpretation 949 leads to the message ‘RDTNBAIB’ whilst the true message of the Correct Interpretation 948 is ‘RABBIT’. There are multiple potentials ways of incorrectly interpreting the Redirection Bonds 945 as they leverage the complexity of the Shape Obfuscation 941 to create an exponentially more secure message. There is only one correct way of interpreting the true message as illustrated in Correct Interpretation 948.

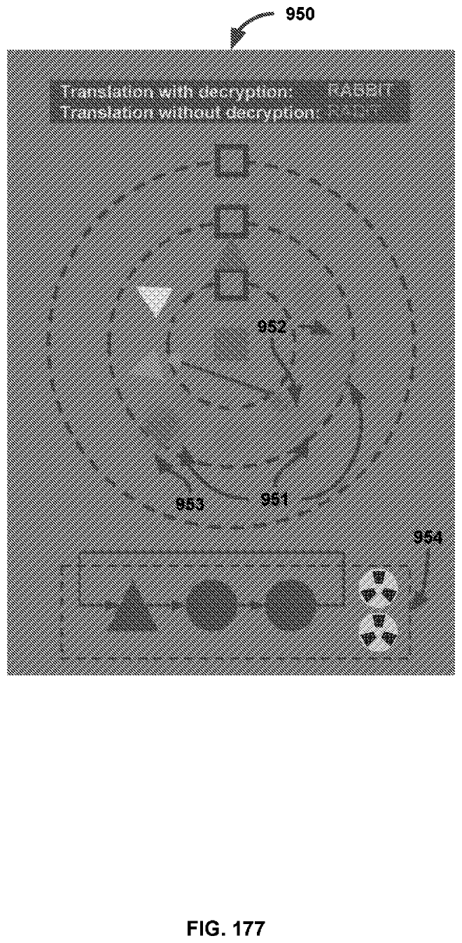

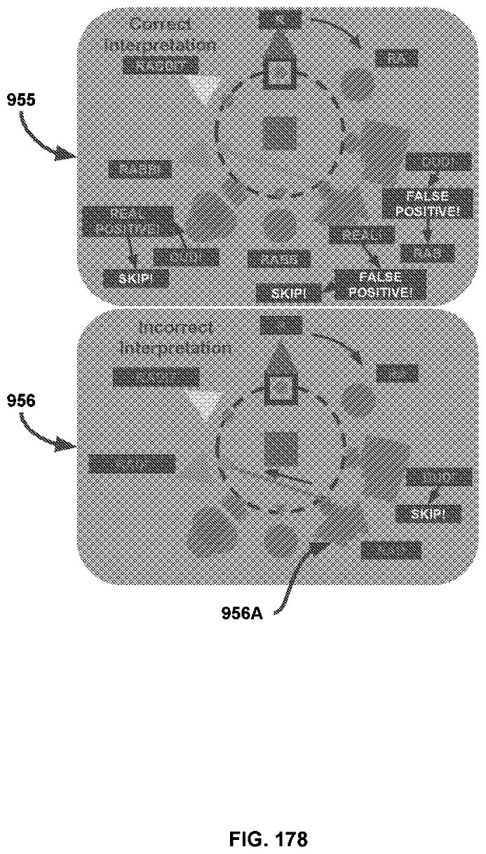

FIGS. 177-178 illustrate the mechanism of Radioactive Elements 943. Encryption example 950 shows Radioactive Elements 943 and 951. These are the ‘rules of Engagement’ concerning Radioactive Elements:

1) A radioactive element is recognized as being unstill or vibrating during the expansion phase of the information state.
2) A radioactive element can be either radioactively active or dormant.
3) An active radioactive element indicates that it's status of being a dud is reversed. I.e. if the shape composition indicates it is a dud, then it is a false positive and does not actually count as a dud but counts as a real letter. If the shape composition indicates that it is real, then it is a false positive and counts as a dud and not a real letter.
4) A dormant radioactive element indicates that it's status of being a dud or real letter is unaffected.
5) A cluster of radioactive elements is defined by a continuous radioactive presence within an orbital ring. When radioactive elements are neighbours to each other (within a specific orbital ring), they define a cluster. If a radioactive element's neighbor is non-radioactive then this is the upper bound limit of the cluster.
6) The key defines which clusters are active and dormant. I.e. If the key denotes a double cluster, then all double clusters are radioactive, and all single and triple clusters are dormant. Radioactive elements 950 shows how a letter (or element) is considered radioactive if it shakes violently during the expanded phase of the information presentation. Due to the classification of encryption levels, an atom that contains radioactive elements will always have interatomic bonds. Since radioactive elements alter the classification of letters as to whether they are duds or not, the security obfuscation increases exponentially. Double Cluster 952 shows how because there are two radioactive elements in a sequence and within the same orbital they are counted as a cluster (double). Whether they are to be treated as active or dormant is defined by the Encryption Key 954. With Single Cluster 953, both neighbors are non-radioactive, hence the scope for the cluster is defined. Since the key specifies double clusters as being valid, this element 953 is to be treated is if it wasn't radioactive in the first place. With Double Cluster Key Definition 954 the key defines double clusters as being active, hence all other sized clusters are to be considered dormant whilst decrypting the message. Incorrect Interpretation 956 shows how the interpreter did not treat the Double Cluster 952 as a reversed sequence (false positive). This means at Stage 956A the correct answer is to ignore it because despite not being a dud it belongs to an actively radioactive cluster (validated by the Key 954) which instructs the decryption process to interpret the letters inversely. Someone who does not know the key cannot, in any practical sense, use a brute force attack to guess all the potential combinations whilst Shape Obfuscation 941, Redirection Bonds 942 and Radioactive Elements 943 are being used simultaneously. Incorrect Interpretation 956 shows how an interpreter without the Key 954 can be mislead to use the Redirection Bond 956B which is not supposed to be followed according to the Correct Interpretation 955. This leads to an entirely different message result of ‘RADIT’ instead of ‘RABBIT’. The full details of the means of decrypting the message correctly are illustrated in Correct Interpretation 955.

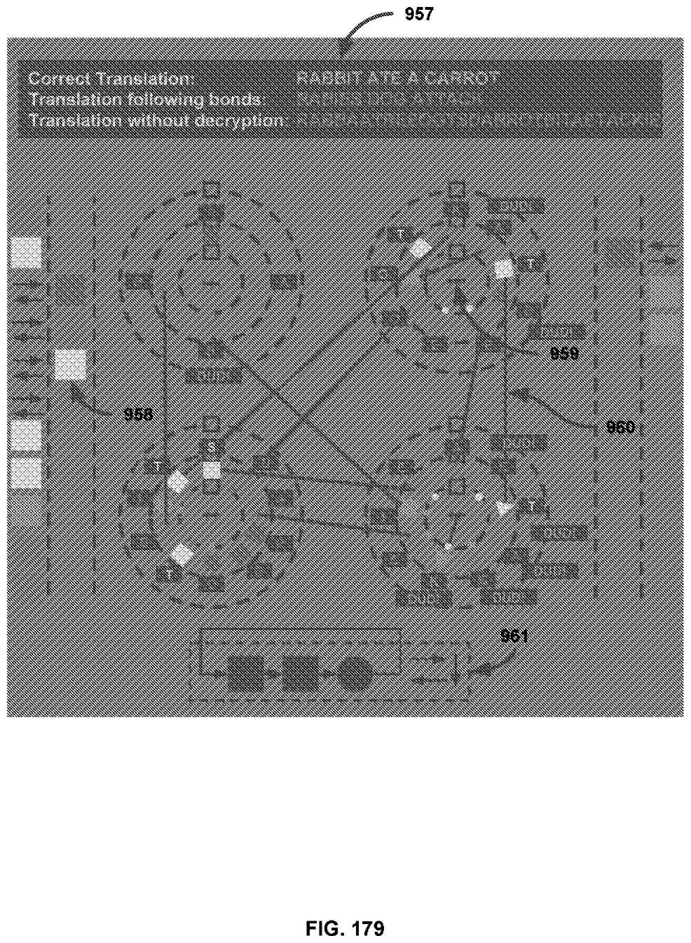

FIG. 179 shows the Molecular Mode with Encryption and Streaming 959 enabled. With Covert Dictionary Attack Resistance 957 an incorrect decryption of the massage leads to a ‘red herring’ alternate message. This is to give a bad actor the false impression that they have successfully decoded the message, whilst they have received a fake message that acts as a cover for the real message. With Multiple Active Words per Molecule 958 the words are presented in parallel during the molecular procedure. This increases the information per surface area ratio, however with a consistent transition speed it requires a more skilled reader. The word navigation indicates that there are four words that are currently active. However, due to redirection bond obfuscation, the words of the message will exist in parts and as a whole across different atoms within the molecule. Binary and Streaming Mode 959 shows Streaming Mode whilst in a typical atomic configuration the reading mode is Binary. Binary Mode indicates that the center element defines which character follows the word (i.e. a question mark, exclamation mark, full stop, space etc). Molecular mode is also binary; except when encryption is enabled which adheres to Streaming mode. Streaming mode makes references within the orbital to special characters such as question marks etc. This is done because within an encrypted molecule, words will exist across multiple atoms and hence a specific center element cannot exist exclusively for a specific word. With Molecular Bonds 960 the molecular information state is not an exclusive encryption feature, yet can be a catalyst for encryption obfuscation. The three modes of encryption (shape obfuscation, redirection bonds and radioactive elements) all increase exponentially in security strength when placed in an increasingly molecular environment. Reading Direction Key 961 shows that whilst the default reading direction is from left to right on row 1, then left to right again on row 2, the reading direction can be superseded by the encryption key. This increases obfuscation of the intended message and hence message privacy/security. Redirection bonds possess the most priority, and supersede even the direction defined in the key (as long as the bond is not a dud).

Summary of Universal BCHAIN Everything Connections (UBEC) with Base Connection Harmonization Attaching Integrated Nodes (BCHAIN)

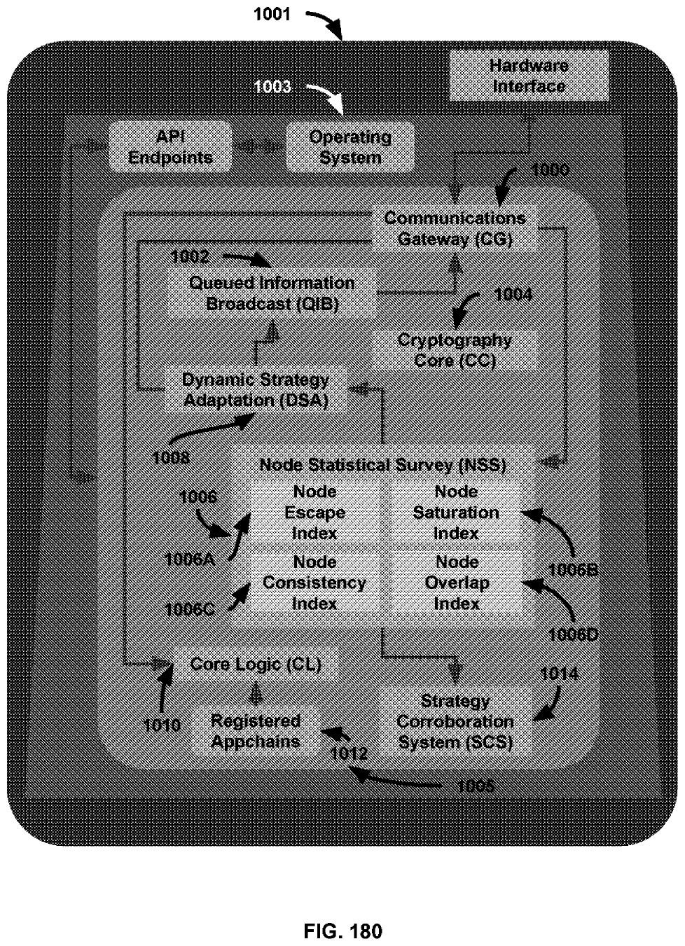

FIG. 180 shows a BCHAIN Node 1001 which contains and runs the BCHAIN Enabled Application 1003. Communications Gateway (CG) 1000 is the primary algorithm for the BCHAIN Node 1001 to interact with it's Hardware Interface thereafter leading to communications with other BCHAIN nodes 1001. Node Statistical Survey (NSS) 1006 interprets remote node behavior patterns. Node Escape Index 1006A tracks the likelihood that a node neighbor will escape a perceiving node's vicinity. A high escape index indicates a more chaotic environment which will require refined strategies to tackle.

Examples: Smartphones in cars that are on a highway will exhibit a high Node Escape Index. A refrigerator in a Starbucks will exhibit a very low Node Escape Index.
Node Saturation Index 1006B tracks the amount of nodes in a perceiving node's range of detection. A higher saturation index indicates a crowded area with a lot of nodes. This can have both positive and negative impacts on performance due to supply/demand trade offs, yet a higher density node area is expected to be more stable/predictable and hence less chaotic.
Examples: A Starbucks in the heart of New York City has a high Node Saturation Index. A tent in the middle of a desert will have a very low Node Saturation Index.
Node Consistency Index 1006C tracks the quality of nodes services as interpreted by a perceiving node. A high Node Consistency Index indicates that surrounding neighbor nodes tend to have more availability uptime and consistency in performance. Nodes that have dual purposes in usage tend to have a lower Consistency Index, while nodes that are dedicated to the BCHAIN network exhibit a higher value.
Examples: Nodes that have a dual purpose such as a corporate employee computer will have a low Consistency Index since it has less resources available during work hours, and more resources available during lunch breaks and employee absence.
Node Overlap Index 1006D tracks the amount of overlap nodes have with one another as interpreted by a perceiving node. While the Overlap and Saturation Indices tend to be correlated, they are distinct in that the Overlap Index indicates the amount of common overlap between neighbors and the Saturation Index only deals with physical tendency. Hence a high Saturation Index with a long wireless range on each device will lead to a high overlap index.
Examples: Devices start entering certain sectors of the BCHAIN network with the new BCHAIN Optimized Microchip (BOM) installed, which has a high gain directional antenna with advanced beamforming technology. Hence the Overlap Index increases in those sectors due to nodes having a more overlapped communications structure.

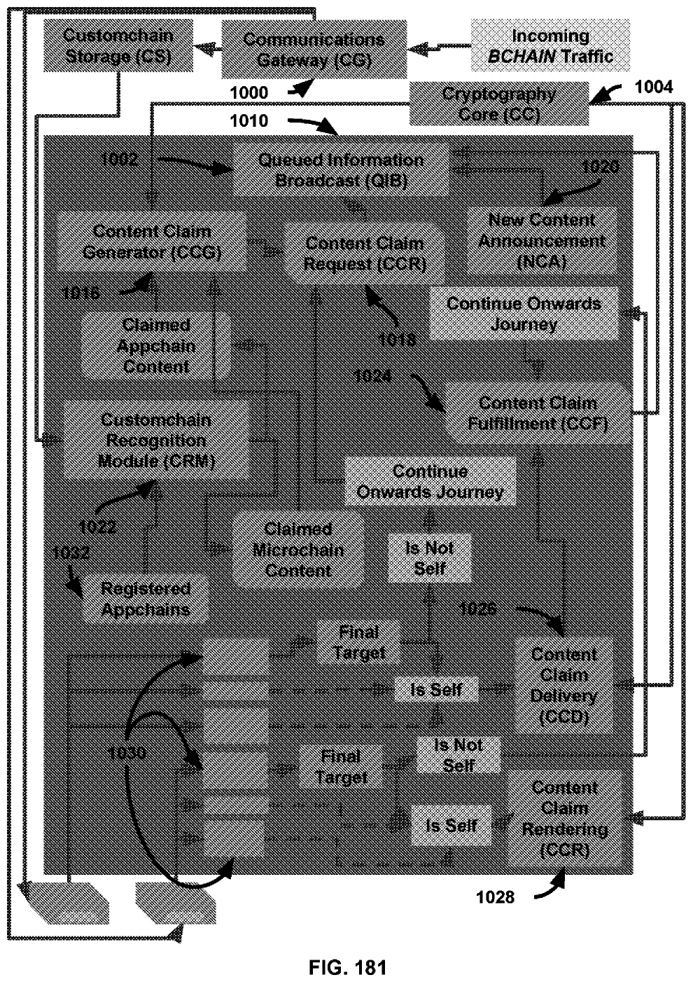

FIG. 181 shows the Core Logic 1010 of the BCHAIN Protocol. Customchain Recognition Module (CRM) 1022 connects with Customchains (which can be Appchains or Microchains) that have been previously registered by the node. Hence the node has cryptographic access to read, write, and/or administrative abilities to such a function. This module informs the rest of the BCHAIN Protocol when an update has been detected on an Appchain's section in the Metachain or a Microchain's Metachain Emulator. Content Claim Delivery (CCD) 1026 receives a validated CCR 1018 and thereafter sends the relevant CCF 1024 to fulfill the request.

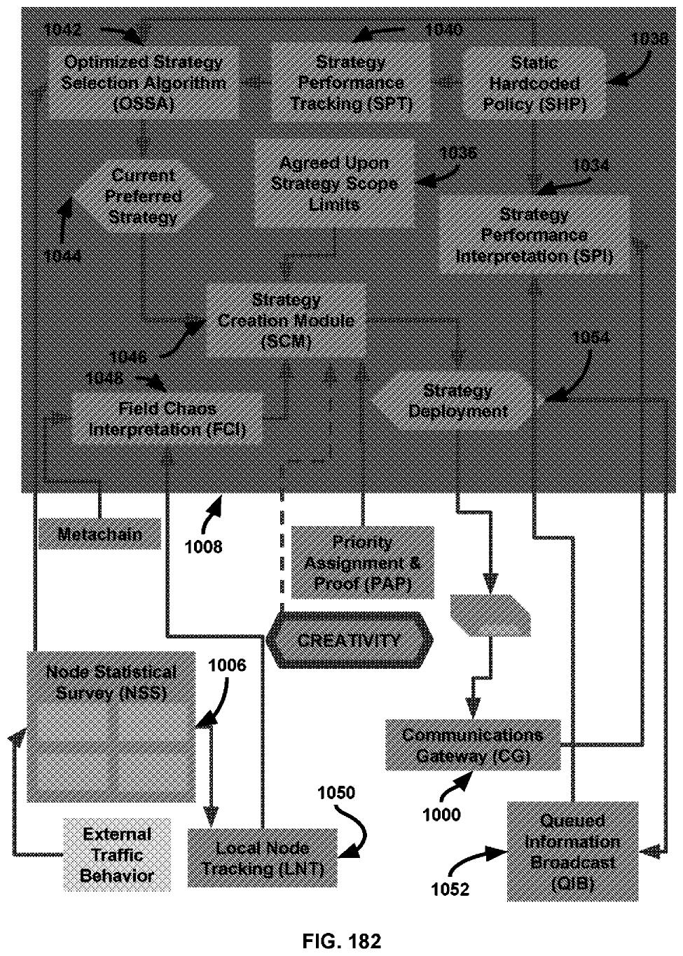

FIG. 182 shows Dynamic Strategy Adaptation (DSA) 1008 which manages the Strategy Creation Module (SCM) 1046 which dynamically generates a new Strategy Deployment 1054 by using the Creativity Module 18 to hybridize complex strategies that have been preferred by the system via Optimized Strategy Selection Algorithm (OSSA) 1042. New Strategies are varied according to input provided by Field Chaos Interpretation (FCI) 1048.

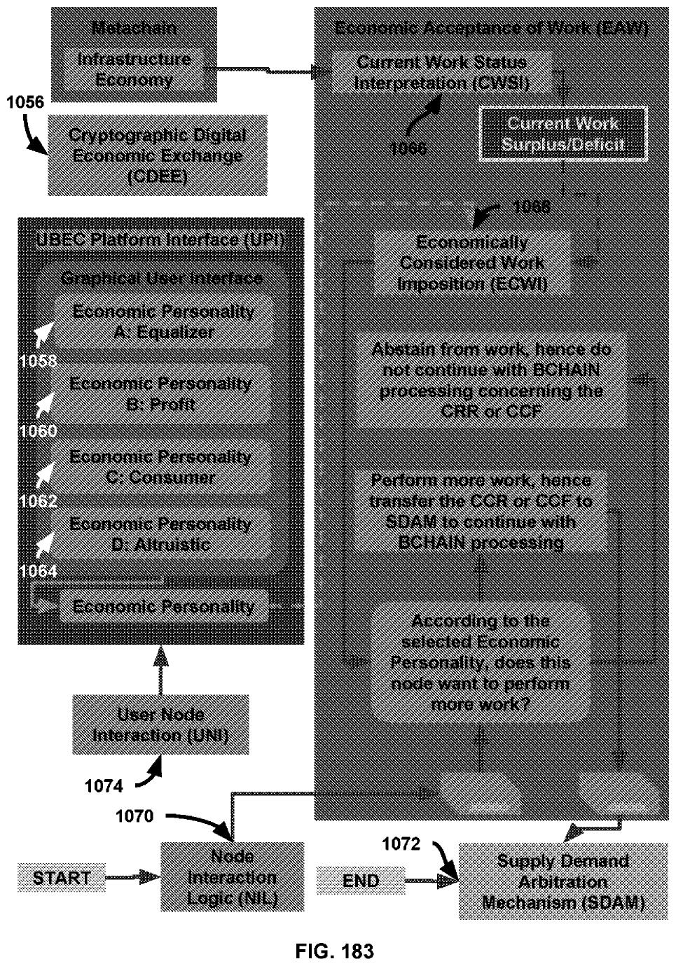

FIG. 183 shows Cryptographic Digital Economic Exchange (CDEE) 1056 with a variety of Economic Personalities 1058, 1060, 1062 and 1064 managed by the Graphical User Interface (GUI) under the UBEC Platform Interface (UPI). With Personality A 1058 Node resources are consumed to only match what you consume (if anything). Personality A is ideal for a casual frugal consumer of a light to moderate amount of information transfer. Live streams such as VoIP calls (i.e Skype) and priority information transfers are minimal. Personality B 1060 Consumes as many resources as possible as long as the profit margin is greater than X. (excess work units can be traded for alternate currencies such as cryptocurrency, fiat currency, precious metals etc.). Personality B is ideal for a node that has been set up specifically to contribute to the infrastructure of the BCHAIN network for profit motives. Hence such a node would typically be a permanent infrastructure installation that runs from mains power as opposed to a battery powered device, and has powerful computer internals (wireless capabilities, CPU strength, hard disk size etc.) e.g., Stationary Appliance, etc. Personality C 1062 pays for work units via a traded currency (cryptocurrency, fiat currency, precious metals etc.) so that content can be consumed while spending less node resources. Personality C is ideal for a heavy consumer of information transfer, or someone who wants to be able to draw benefit from the BCHAIN network but does not want the resources of their device to get depleted (i.e. smartphone drains battery fast and gets warm in pocket). With Personality D 1064 Node resources are spent as much as possible and without any restriction of expecting anything in return, whether that be the consumption of content or monetary compensation. Personality D is chosen by someone whose best interests are in the strength of the BCHAIN network. (i.e. the core developers of the BCHAIN network can purchase and install nodes to solely strengthen the network, and not to consume content nor to earn money). Current Work Status Interpretation (CWSI) 1066 References the Infrastructure Economy section of the Metachain to determine the current surplus or deficit of this node with regards to work done credit. Economically Considered Work Imposition (ECWI) 1068 considers the selected Economic Personality with the Current Work Surplus/Deficit to evaluate if more work should currently be performed.

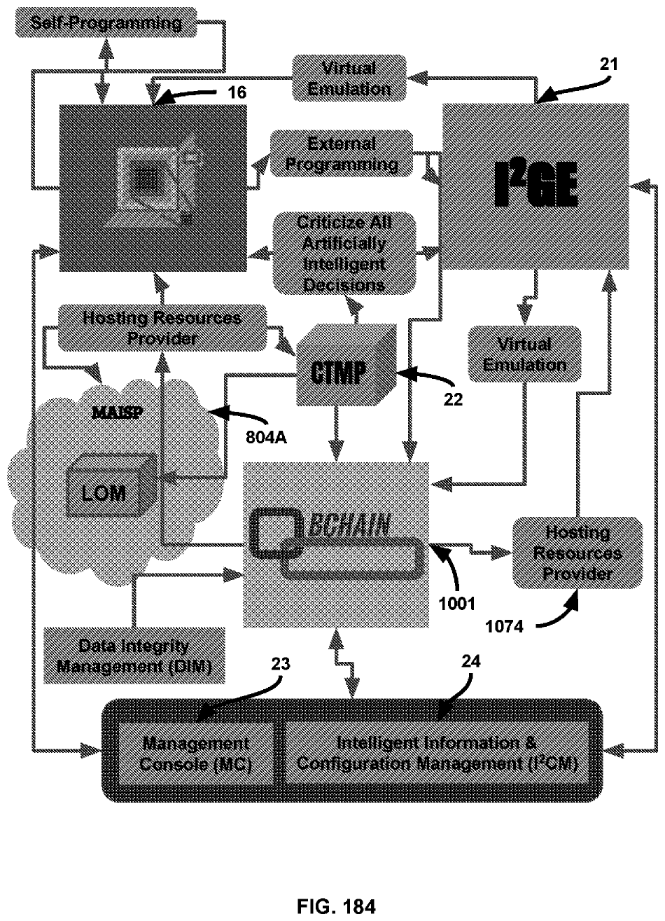

FIG. 184 shows Symbiotic Recursive Intelligence Advancement (SRIA) which is a triad relationship between three different algorithms that enable each other to grow in Intelligence. LIZARD 16 can improve an algorithm's source code by understanding code purpose, including itself. I²GE 21 can emulate generations of virtual program iterations, hence selecting the strongest program version. The BCHAIN network is a vast network of chaotically connected nodes that can run complex data-heavy programs in a decentralized manner.

1.-76. (canceled)

77. A Lexical Objectivity Mining (LOM) having a memory and a processor that is coupled to the memory, wherein the LOM comprises:
a) Initial Query reasoning (IQR), to which a question is transferred, and which leverages Central Knowledge Retention (CKR) to decipher missing details that are crucial in understanding and answering/responding to the question;
b) Survey Clarification (SC), to which the question and supplemental query data is transferred, and which receives input from and send output to a human subject, and forms Clarified Question/Assertion;
c) Assertion Construction (AC), which receives a proposition in the form of an assertion or question and provides output of the concepts related to such proposition;
d) Response Presentation, which is an interface for presenting a conclusion drawn by AC to both Human Subject and Rational Appeal (RA);
e) Hierarchical Mapping (HM), which maps associated concepts to find corroboration or conflict in Question/Assertion consistency, and calculates the benefits and risks of having a certain stance on a topic;
f) Central Knowledge Retention (CKR), which is a main database for referencing knowledge for LOM;
g) Knowledge Validation (KV), which receives high confidence and pre-criticized knowledge which needs to be logically separated for query capability and assimilation into the CKR;
h) Accept Response, which is a choice given to the Human Subject to either accept the response of LOM or to appeal it with a criticism, wherein if the response is accepted, then it is processed by KV so that it can be stored in CKR as confirmed (high confidence) knowledge, wherein should the Human Subject not accept the response, they are forwarded to the RA, which checks and criticizes the reasons of appeal given by Human;
i) Managed Artificially Intelligent Services Provider (MAISP), which runs an internet cloud instance of LOM with a master instance of the CKR, and connects LOM to Front End Services, Back End Services, Third Party Application Dependencies, Information Sources, and a MNSP Cloud.

78. The computer security system based on artificial intelligence of claim 77, wherein Front End Services include Artificially Intelligent Personal Assistants, Communication Applications and Protocols, Home Automation and Medical Applications, wherein Back End Services include online shopping, online transportation, Medical Prescription ordering, wherein Front End and Back End Services interact with LOM via a documented API infrastructure, which enables standardization of information transfers and protocols, wherein LOM retrieves knowledge from external Information Sources via the Automated Research Mechanism (ARM).

79. The computer security system based on artificial intelligence of claim 78, wherein Linguistic Construction (LC) interprets raw question/assertion input from the Human Subject and parallel modules to produce a logical separation of linguistic syntax; wherein Concept Discovery (CD) receives points of interest within the Clarified Question/Assertion and derives associated concepts by leveraging CKR; wherein Concept Prioritization (CP) receives relevant concepts and orders them in logical tiers that represent specificity and generality; wherein Response Separation Logic (RSL) leverages the LC to understand the Human Response and associate a relevant and valid response with the initial clarification request whereby accomplishing the objective of SC; wherein the LC is then re-leveraged during the output phase to amend the original Question/Assertion to include the supplemental information received by the SC; wherein Context Construction (CC) uses metadata from Assertion Construction (AC) and evidence from the Human subject to give raw facts to CTMP for critical thinking; wherein Decision Comparison (DC) determines the overlap between the pre-criticized and post-criticized decisions; wherein Concept Compatibility Detection (CCD) compares conceptual derivatives from the original Question/Assertion to ascertain the logical compatibility result; wherein Benefit/Risk Calculator (BRC) receives the compatibility results from the CCD and weighs the benefits and risks to form a uniform decision that encompasses the gradients of variables implicit in the concept makeup; wherein Concept Interaction (CI) assigns attributes that pertain to AC concepts to parts of the information collected from the Human Subject via Survey Clarification (SC).

80. The computer security system based on artificial intelligence of claim 79, wherein inside the IQR, LC receives the original Question/Assertion; the question is linguistically separated and IQR processes each individual word/phrase at a time leveraging the CKR; By referencing CKR, IQR considers the potential options that are possible considering the ambiguity of the word/phrase.

81. The computer security system based on artificial intelligence of claim 79, wherein Survey Clarification (SC) receives input from IQR, wherein the input contains series of Requested Clarifications that are to be answered by the Human Subject for an objective answer to the original Question/Assertion to be reached, wherein provided response to the clarifications are forwarded to Response Separation Logic (RSL), which correlates the responses with the clarification requests; wherein in parallel to the Requested Clarifications being processed, Clarification Linguistic Association is provided to LC, wherein the Association contains the internal relationship between Requested Clarifications and the language structure, which enables the RSL to amend the original Question/Assertion whereby LC outputs the Clarified Question.

82. The computer security system based on artificial intelligence of claim 79, wherein for Assertion Construction, which received the Clarified Question/Assertion, LC breaks the question down into Points of Interest, which are passed onto Concept Discovery, wherein CD derives associates concepts by leveraging CKR, wherein Concept Prioritization (CP) orders concepts into logical tiers, wherein the top tier is assigned the most general concepts, whilst the lower tiers are allocated increasingly specific concepts, wherein the top tier is transferred to Hierarchical Mapping (HM) as modular input, wherein in a parallel transfer of information HM receives the Points of Interest, which are processed by its dependency module Concept Interaction (CI), wherein CI assigns attributes to the Points of Interest by accessing the indexed information at CKR, wherein upon HM completing its internal process, its final output is returned to AC after the derived concepts have been tested for compatibility and the benefits/risks of a stance are weighed and returned.

83. The computer security system based on artificial intelligence of claim 82, wherein for HM, CI provides input to CCD which discerns the compatibility/conflict level between two concepts, wherein the compatibility/conflict data is forwarded to BRC, which translates the compatibilities and conflicts into benefits and risks concerning taking a holistic uniform stance on the issue, wherein the stances, along with their risk/benefit factors, are forwarded to AC as Modular Output, wherein the system contains loops of information flow indicates gradients of intelligence being gradually supplemented as the subjective nature of the question/assertion a gradually built objective response; wherein CI receives Points of Interest and interprets each one according to the top tier of prioritized concepts.

84. The computer security system based on artificial intelligence of claim 79, wherein for RA, Core Logic processes the converted linguistic text, and returns result, wherein if the Result is High Confidence, the result is passed onto Knowledge Validation (KV) for proper assimilation into CKR, wherein if the Result is Low Confidence, the result is passed onto AC to continue the cycle of self-criticism, wherein Core Logic receives input from LC in the form of a Pre-Criticized Decision without linguistic elements, wherein the Decision is forwarded to CTMP as the Subjective Opinion, wherein Decision is also forwarded to Context Construction (CC) which uses metadata from AC and potential evidence from the Human Subject to give raw facts to CTMP as input ‘Objective Fact’, wherein with CTMP having received its two mandatory inputs, such information is processed to output it's best attempt of reaching ‘Objective Opinion,’ wherein the opinion is treated internally within RA as the Post-Criticized Decision, wherein both Pre-Criticized and Post-Criticized decisions are forwarded to Decision Comparison (DC), which determines the scope of overlap between both decisions, wherein the appeal argument is then either conceded as true or the counter-point is improved to explain why the appeal is invalid, wherein indifferent to a Concede or Improve scenario, a result of high confidence is passed onto KV and a result of low confidence is passed onto AC 808 for further analysis.

85. The computer security system based on artificial intelligence of claim 79, wherein for CKR, units of information are stored in the Unit Knowledge Format (UKF), wherein Rule Syntax Format (RSF) is a set of syntactical standards for keeping track of references rules, wherein multiple units of rules within the RSF can be leveraged to describe a single object or action; wherein Source attribution is a collection of complex data that keeps track of claimed sources of information, wherein a UKF Cluster is composed of a chain of UKF variants linked to define jurisdictionally separate information, wherein UKF2 contains the main targeted information, wherein UKFI contains Timestamp information and hence omits the timestamp field itself to avoid an infinite regress, wherein UKF3 contains Source Attribution information and hence omits the source field itself to avoid an infinite regress; wherein every UKF2 must be accompanied by at least one UKF1 and one UKF3, or else the cluster (sequence) is considered incomplete and the information therein cannot be processed yet by LOM System General Logic; wherein in between the central UKF2 corresponding UKF1 and UKF3 units there can be UKF2 units that act as a linked bridge, wherein a series of UKF Clusters will be processed by KCA to form Derived Assertion, wherein Knowledge Corroboration Analysis (KCA) is where UKF Clustered information is compared for corroborating evidence concerning an opinionated stance, wherein after processing of KCA is complete, CKR can output a concluded Opinionated stance on a topic.

86. The computer security system based on artificial intelligence of claim 79, wherein for ARM, wherein as indicated by User Activity, as users interact with LOM concepts are either directly or indirectly brought as relevant to answering/responding to a question/assertion, wherein User Activity is expected to eventually yield concepts that CKR has low or no information regarding, as indicated by List of Requested Yet Unavailable Concepts, wherein with Concept Sorting & Prioritization (CSP), Concept definitions are received from three independent sources and are aggregated to prioritize the resources of Information Request, wherein the data provided by the information sources are received and parsed at Information Aggregator (IA) according to what concept definition requested them and relevant meta-data are kept, wherein the information is sent to Cross-Reference Analysis (CRA) where the information received is compared to and constructed considering pre-existing knowledge from CKR.

87. The computer security system based on artificial intelligence of claim 79, wherein Personal Intelligence Profile (PIP) is where an individual's personal information is stored via multiple potential end-points and front-ends, wherein their information is isolated from CKR, yet is available for LOM Systemwide General Logic, wherein Personal information relating to Artificial Intelligence applications are encrypted and stored in the Personal UKF Cluster Pool in UKF format, wherein with Information Anonymization Process (IAP) information is supplemented to CKR after being stripped of any personally identifiable information, wherein with Cross-Reference Analysis (CRA) information received is compared to and constructed considering pre-existing knowledge from CKR.

88. The computer security system based on artificial intelligence of claim 79, wherein Life Administration & Automation (LAA) connects internet enabled devices and services on a cohesive platform, wherein Active Decision Making (ADM) considers the availability and functionality of Front End Services, Back End Services, IoT devices, spending rules and amount available according to Fund Appropriations Rules & Management (FARM); FARM receives human input defining criteria, limits and scope to the module to inform ADM for what it's jurisdiction of activity is, wherein cryptocurrency funds is deposited into the Digital Wallet, wherein the IoT Interaction Module (IIM) maintains a database of what IoT devices are available, wherein Data Feeds represents when IoT enabled devices send information to LAA.

89. The computer security system based on artificial intelligence of claim 79, further comprising Behavior Monitoring (BM) which monitors personally identifiable data requests from users to check for unethical and/or illegal material, wherein with Metadata Aggregation (MDA) user related data is aggregated from external services so that the digital identity of the user can be established, wherein such information is transferred to Induction/Deduction, and eventually PCD, where a sophisticated analysis is performed with corroborating factors from the MNSP; wherein all information from the authenticated user that is destined for PIP passes through Information Tracking (IT) and is checked against the Behavior Blacklist, wherein at Pre-Crime Detection (PCD) Deduction and Induction information is merged and analyzed for pre-crime conclusions, wherein PCD makes use of CTMP, which directly references the Behavior Blacklist to verify the stances produced by Induction and Deduction, wherein the Blacklist Maintenance Authority (BMA) operates within the Cloud Service Framework of MNSP.

90. The computer security system based on artificial intelligence of claim 89, wherein LOM is configured to manage a personalized portfolio on an individual's life, wherein LOM receives an initial Question which leads to conclusion via LOM's Internal Deliberation Process, wherein it is connected to connect to the LAA module which connects to internet enabled devices which LOM can receive data from and control, wherein with Contextualization LOM deduces the missing links in constructing an argument, wherein LOM has deciphers with its logic that to solve the dilemma posed by the original assertion it must first know or assume certain variables about the situation.
